(19) United States
(12) Patent Application Publication
(10) Pub. No.: US 2022/0218009 A1
(43) Pub. Date: Jul. 14, 2022

(54) COMPOSITIONS, PREPARATION AND USES OF PARAMYLON

(71) Applicant: NOBLEGEN INC., Peterborough (CA)

(72) Inventors: Adam J. NOBLE, Peterborough, ON (CA); Angela SWAIN, Peterborough, ON (CA); Charles Jonathan CLARKE, Peterborough, ON (CA); Chonggang ZHANG, Peterborough, ON (CA); Somayeh SABOURI, Peterborough, ON (CA); Shaojun LI, Peterborough, ON (CA); Adam William LONG, Peterborough, ON (CA); Prasanth Kumar SASIDHARAN PILLAI, Peterborough, ON (CA)

(21) Appl. No.: 17/435,317

(22) PCT Filed: Mar. 2, 2020
(86) PCT No.: PCT/IB2020/051764

§ 371 Date: Aug. 31, 2021

Related U.S. Application Data
(60) Provisional application No. 62/812,767, filed on Mar. 1, 2019.

(51) Int. Cl. A23L 29/219; A23L 29/269; A23L 33/125; A23L 29/10

(52) U.S. Cl. CPC A23L 29/219; A23L 29/10; A23L 33/125; A23L 29/269

(57) ABSTRACT

Methods of forming a gelatinous food product, forming a whitened food product, increasing viscosity, increasing water binding, emulsifying, or sweetening a food product, comprising combining paramylon from Euglena sp. with a food composition, to form the food product thereof. The disclosure also relates to methods of encapsulating an oil with paramylon, to form an encapsulated oil thereof.

### FIELD

The present disclosure relates to methods of forming a gelatinous food product, forming a whitened food product, increasing the viscosity of a food product, increasing the water binding within a food product, emulsifying a food product, or sweetening a food product, comprising combining paramylon from Euglena sp. with a food composition, to form the food product thereof. The disclosure also relates to methods of encapsulating an oil with paramylon, to form an encapsulated oil thereof.

### BACKGROUND

β-glucan is a long-chain polysaccharide made of glucose monomers connected through glycosidic linkages. It is a structural component in fungi, algae, bacteria, and plants, including cereal grains such as oats, barley, wheat, and rye. Significant quantities of β-glucan are found in barley (2% to 20%), oat (3% to 8%), and sorghum (1.1% to 6.2%). Microalgae Euglena gracilis contains about 25% to 60% (w/w) of water-insoluble linear β-1,3-glucan, which is also known as paramylon.

Euglena gracilis produces paramylon as a fibrillar high molecular weight polymer of greater than 500 kDa. The crystallinity of paramylon in its native state approaches 90%. In Euglena cells, paramylon is deposited as granules (˜1 to 2 μm) that corresponds to 100% glucose in NMR spectra. Isolated paramylon is a fine, free flowing white powder.

Paramylon is structurally similar to curdlan, a linear β-1,3-glucan from bacteria. However, there are marked differences between paramylon and curdlan. Curdlan granules have low crystallinity of ˜30% and can be hydrated in aqueous solutions forming gels at 55° C. Curdlan's rheological and thermal properties have been investigated in the food industry as a thickening agent or fat-mimic substitute. In contrast, due to its high crystallinity and water-insolubility, paramylon is perceived to have less utility in food applications such as thickening and gelling. Accordingly, methods of emulsifying, whitening, water-binding, and sweetening food products, and methods of encapsulating oil, by paramylon have not been explored.

### SUMMARY

The following is intended to introduce the reader to the more detailed discussion to follow. The summary is not intended to limit or define the claims.

According to one aspect of this disclosure, a method is provided for forming a gelatinous food product, comprising:
combining paramylon from Euglena sp. having purity of at least about 70% with a food composition to form a food product,
maintaining a temperature at between about 0° C. and about 100° C. for about 2 min to about 2 h, at a pH of between about 2 and about 10,
wherein the paramylon is between about 0.1% and about 50% (w/v) of the food product,
optionally further comprising combining with the food composition calcium chloride of between about 0.05% and about 1.5% (w/v),
thereby gelatinizing the food product to form the gelatinous food product.

In an embodiment, the method of forming a gelatinous food product comprises a granule form paramylon. In another embodiment, the tensile strength of the gelatinous food product is increased by from about 0 g/cm² to about 3000 g/cm² compared to the food product prior to gelatinization. In an embodiment, the food product is selected from the group consisting of a spreadable food stuff product, a confectionery product, a savory product, a dairy product, a dairy substitute product, and a drink product. In an embodiment, the food product is selected form the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, and any food product described herein.

Also, provided in this disclosure is a method of producing a non-dairy creamer, comprising:

combining with water,
i) paramylon from Euglena sp. having purity of at least about 70%, wherein the paramylon is between about 1% and about 20% (w/v), optionally about 1%, about 5%, or about 10% (w/v), of the non-dairy creamer,
ii) an oil, optionally a canola oil, a sunflower oil, a medium chain triglyceride (MCT), a palm oil, a vegetable oil, a soy oil, a peanut oil, an avocado oil, or a grapeseed oil, wherein the oil is between about 5% and about 20% (w/v), optionally about 10% (w/v), of the non-dairy creamer, and
iii) a lecithin, optionally a soy lecithin, a mono-glyceride, a di-glyceride, or a sunflower lecithin, wherein the lecithin is between about 0.1% and about 5% (w/v), optionally about 1% (w/v), of the non-dairy creamer, to form a mixture,

homogenizing the mixture,

thereby forming the non-dairy creamer.

In another aspect, the disclosure relates to a method of emulsifying a food product, comprising:
combining paramylon from Euglena sp. having purity of at least about 70% with a food composition to form the food product, and
homogenizing the food product,
wherein the paramylon is between about 0.1% and about 50% (w/w) of the food product, and optionally wherein the emulsified food product is stable for up to six months,
thereby emulsifying the food product to form an emulsified food product.

In an embodiment, the paramylon comprises elongated and/or shell form paramylon.

In another aspect, the disclosure relates to a method of forming a whitened food product, comprising:
combining paramylon from Euglena sp. having purity of at least about 70% with a food composition to form a food product,
wherein the paramylon is between about 0.1% and about 50% (w/w) of the food product,
wherein the paramylon comprises a granule form paramylon, and
wherein the paramylon has a refractive index between about 1.3 and about 2.6 at λ=about 589 nm,
thereby whitening the food product to form the whitened food product.

In an embodiment, the paramylon is spray dried. In an embodiment, the paramylon increases the refractive index of the food product by between about 0.1 and about 1 at λ=about 589 nm. In an embodiment, the whitened food product is a dairy product, a non-dairy product, a confectionary, a non-dairy creamer, an ice cream, or an icing.

In another aspect, the disclosure relates to a method of increasing water binding in a food product, comprising
combining paramylon from Euglena sp. having purity of at least about 70%, with a food composition to form the food product,
wherein the paramylon comprises granule form, swollen form, shell form and/or elongated form, and
wherein the paramylon has a water holding capacity between about 0.70 g and about 1.50 g water per g paramylon, optionally between about 1.10 g and about 1.30 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises milled form, and
wherein the paramylon has a water holding capacity between about 3 g and about 7.8 g water per g paramylon, optionally between about 4.40 g and about 6.4 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises gelled form, wherein the gel has been formed with HCl, and
wherein the paramylon has a water holding capacity between about 6 g and about 10 g water per g paramylon, optionally between about 7 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises gelled form, wherein the gel has been formed with calcium chloride, and
wherein the paramylon has a water holding capacity between about 6 g and about 10 g water per g paramylon, optionally between about 7.4 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises gelled form, wherein the gel has been formed with calcium chloride, and
wherein the paramylon has a water holding capacity between about 5 g and about 15 g water per g paramylon, optionally between about 7.70 g and about 13.5 g water per g paramylon,
thereby forming the food product with increased water binding.

In an embodiment, the food product is a bakery product, dairy product, a dairy substitute product, a drink protein, a meat product, a protein substitute product, or a sauce.

In another aspect, the disclosure relates to a method of sweetening a food product, comprising
combining a hydrolyzed paramylon with a food composition to form the food product,
wherein the hydrolyzed paramylon comprises hydrolyzed paramylon from Euglena sp. that is enriched with glucose oligomers, and
wherein the paramylon has purity of at least about 70%, thereby sweetening the food product to form a sweetened food product.

In another aspect, the disclosure relates to a method of encapsulating an oil, comprising
combining paramylon from Euglena sp. having purity of at least about 70% with the oil to form a mixture,
homogenizing the mixture to form a homogenized mixture, and
spray drying the homogenized mixture,
wherein the molar ratio of paramylon to oil is from about 1:2 to about 1:100, wherein the paramylon comprises granule form, swollen form, elongated form, and/or shell form paramylon, and
wherein the microencapsulation efficiency is at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, at least about 99%, or about 100%,
thereby encapsulating the oil to form an encapsulated oil.

Also, provided in this disclosure is an encapsulated oil comprising an oil and paramylon from Euglena sp. having purity of at least about 70%, wherein the paramylon comprises granule form, swollen form, elongated form, and/or shell form paramylon, and wherein the molar ratio of paramylon to oil is from about 1:2 to about 1:100.

Further provided in this disclosure are a gelatinous food product, a whitened food product, a food product with increased water binder, a food product with increased viscosity, an emulsified food product, and a sweetened food product, comprising paramylon, wherein the paramylon comprises at least one of granule form, swollen form, shell form, or solubilized form.

Also provided are methods for improving e solubility and gelation of paramylon, as well as physical modification by milling. The properties of the resulting materials, such as water holding capacity, sedimentation, viscosity, theological properties, thermal and mechanical properties were investigated, and their applications in food industries were explored.

In this disclosure, the solubilization mechanism and related structures of paramylon were revealed. It was found that solubilization occurred in 5 distinct steps 1) swollen 2) elongation 3) gelation/shell 4) solubilization and 5) degradation and each step was dependent on the concentration of the alkaline solution and time. It is believed that paramylon can form a gel when a certain pH and time are applied.

In this disclosure, the chemical gelation was also investigated. The paramylon alkaline solution formed a gel with an organic acid/inorganic acid, or CaCl₂ by the forces of carboxyl bonding/hydrogen bonding, or ionic bonding, respectively. A reconstructed gel, so-called ready to gel (RTG) was developed, and it has high storage and compression modulus.

In this disclosure, a physical modification of paramylon via milling was carried out. The paramylon granule is formed by triple helix structures that have strong hydrogen bonding, but this was disrupted through milling which led to granule elongation. The elongation brought strong inter-hydrogen bonding among BGI chains. Water was trapped by the strong inter-hydrogen bonding or swollen into a triple helix structure to form a gel-like material.

In this disclosure, it was found that the modifications, produced by any of the methods disclosed herein, had significant effects on the properties and functionalities of paramylon, providing its capacity to be used for food products such as thickeners, jelly, paste, creamer, coatings and so on.

### BRIEF DESCRIPTION OF THE DRAWINGS

The present disclosure will now be described in greater detail with reference to the drawings, in which:

FIG. 1 shows glycosyl Linkage Analysis of Paramylon Concentrate. The samples were permethylated, reduced, re-permethylated, depolymerized, reduced, and acetylated. The resulting samples were partially methylated alditol acetates (PMAAs) analyzed by GC/MS.

FIG. 2 shows representative images of each form of paramylon. (A) Granule form; (B) Swollen Form; (C) Elongated form; (D) Shell Form; and (E) Solubilized form. Panels (B)-(E) are examples of the 4 states of granules observed over the course of solubilization.

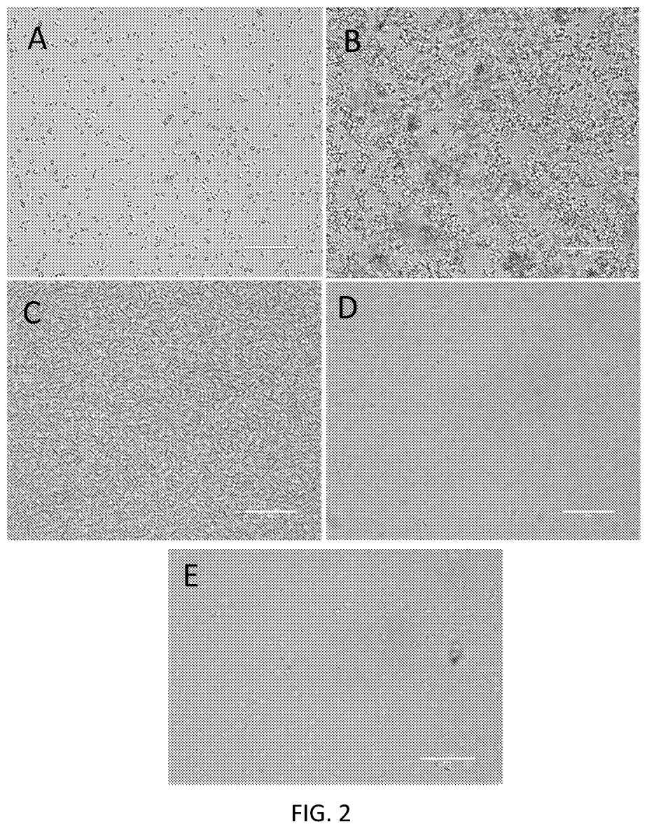

FIG. 3 shows results of freeze-drying elongated form of granules from a 1% paramylon solution prepared in 0.33 M NaOH at room temperature. (A) Freeze-dried powder of 1% (w/v) paramylon solution in 0.33 M NaOH. The powder was resuspended to the initial volume prior to before drying. (B) Undried solution of 1% (w/v) paramylon in 0.33 M NaOH.

FIG. 4 shows representative images of bulk solutions of paramylon upon heating after dissolving in base at 70° C. (A) 10% (w/v) paramylon dissolved in top, left to right: 1 M NaOH, 0.75 M NaOH, bottom, left to right: 0.5 M NaOH, 0.25 M NaOH, 0.125 M NaOH. (B) 5% (w/v) paramylon dissolved in top, left to right: 1 M NaOH, 0.75 M NaOH, bottom, left to right: 0.5 M NaOH, 0.25 M NaOH, 0.125 M NaOH. (C) 1% (w/v) paramylon dissolved in top, left to right: 1 M NaOH, 0.75 M NaOH, bottom, left to right: 0.5 M NaOH, 0.25 M NaOH, 0.125 M NaOH. (D) 0.1% (w/v) paramylon dissolved in top, left to right: 1 M NaOH, 0.75 M NaOH, bottom, left to right: 0.5 M NaOH, 0.25 M NaOH, 0.125 M NaOH.

FIG. 5 shows representative images of bulk solutions solubilized in 4° C. sodium hydroxide solutions. Tubes concentration left to right: 0.125 M, 0.25 M, 0.33 M, 0.5 M, 0.75M, 1 M NaOH. (A) 0.1% (w/v) paramylon; (B) 1% (w/v) paramylon; (C) 5% (w/v) paramylon; and (D) 10% (w/v) paramylon.

FIG. 6 shows images of paramylon gelation at various concentration. (A) 0.1% (w/v) paramylon solution did not gel, (B) 1% (w/v) formed a weak gel (gel score 1) and (C) 5% (w/v) formed firm gel (gel score 3).

FIG. 7 shows results of 1% (w/v) paramylon solution (pH 10.036) kept at 4° C. (top tube) or room temperature (bottom tube, as control) overnight. The sample kept at 4° C. formed a weak gel (gel score 0.5) with low opacity, while the control solution kept at room temperature remains clear thorough the experiment and did not form a gel.

FIG. 8 shows results of 5% (w/v) paramylon solution (pH 10.242) treated at 4° C. (top tube) or at room temperature (as control) overnight. The sample kept at 4° C. resulted in a firm gel (gel score 3) with higher opacity, while the control at room temperature is less firm (gel score 2) and has less opacity.

FIG. 9 shows results of 5% (w/v) paramylon solution (from left to right: (A) pH 13.014; (B) pH 12.240; and (C) pH 11.209 treated at 70° C. for 1 hour. The colour of samples became lighter as pH decreased.

FIG. 10 shows results of 1% (w/v) paramylon solution kept at −20° C. for overnight (A: treatment, left tube) or room temperature (B: control, right tube). At all pH levels, no difference was observed between 1% (w/v) paramylon solution kept at −20° C. or room temperature.

FIG. 11 shows control for the addition of calcium chloride to 10 mL 1 N NaOH, from left to right: 0.5 mL of 5% (A), 1.5% (B), 0.5% (C) (w/v) solutions, showing white precipitate.

FIG. 12 shows room temperature gels of 40 mL 1% (w/v) paramylon solutions with left to right additions of 1 mL 0.5% (A), 1.5% (B) and 5% (C) (w/v) calcium chloride solutions.

FIG. 13 shows room temperature gels of 40 mL 5% (w/v) paramylon solutions with left to right additions of 1 mL 0.5% (A), 1.5% (B) and 5% (C) (w/v) calcium chloride solutions.

FIG. 14 shows room temperature gels of 40 mL 10% paramylon solutions with left to right additions of 1 mL 0.5% (A), 1.5% (B) and 5% (C) (w/v) calcium chloride solutions.

FIG. 15 shows gels of 40 mL 1% (w/v) paramylon solutions with left to right additions of 1 mL 0.5% (A), 1.5% (B) and 5% (C) (w/v) calcium chloride solutions, stored overnight in oven at 70° C.

FIG. 16 shows gels of 40 mL 5% (w/v) paramylon solutions at different concentrations of 1 mL calcium chloride. All concentrations of calcium chloride after heating overnight at 70° C. had moderate darkening of the solutions (A) 1 mL of 0.5% (w/v) calcium chloride was added; (B) 1 mL of 1.5% (w/v) calcium chloride was added; (C) 1 mL of 5% (w/v) calcium chloride was added.

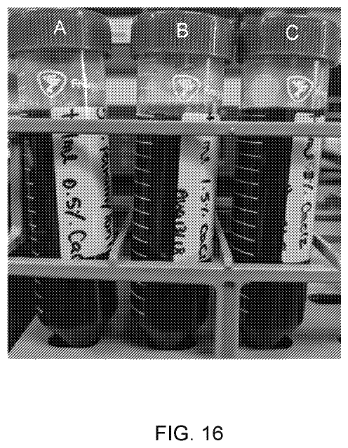

FIG. 17 shows gels of 40 mL 10% (w/v) paramylon solutions at different concentrations of 1 mL calcium chloride. All concentrations of calcium chloride after heating overnight at 70° C. had moderate darkening of the solutions. (A) 1 mL of 0.5% calcium chloride was added; (B) 1 mL of 1.5% calcium chloride was added; and (C) 1 mL of 5% calcium chloride was added.

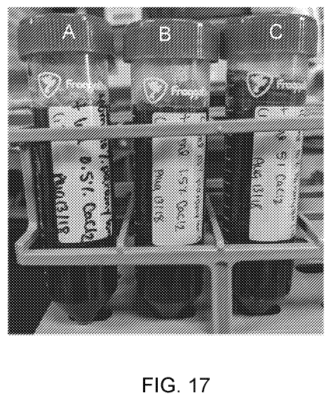

FIG. 18 shows gels of 40 mL 1% (w/v) paramylon solutions with left to right additions of 1 mL 0.5% (A), 1.5% (B) and 5% (C) w/v calcium chloride solutions, stored overnight in −20° C. freezer and then allowed to come to room temperature.

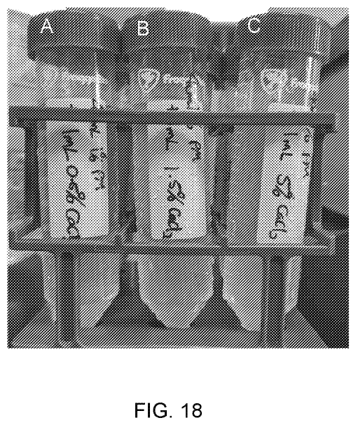

FIG. 19 shows gels of 40 mL 5% (w/v) paramylon solutions with left to right additions of 1 mL 0.5% (A), 1.5% (B) and 5% (C) (w/v) calcium chloride solutions, stored overnight in −20° C. freezer and then allowed to come to room temperature.

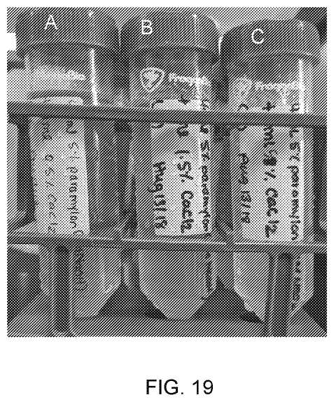

FIG. 20 shows gels of 40 mL 10% paramylon solutions with left to right additions of 1 mL 0.5% (A), 1.5% (B) and 5% (C) (w/v) calcium chloride solutions, stored overnight in −20° C. freezer and then allowed to come to room temperature.

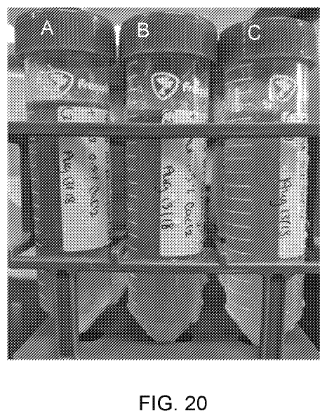

FIG. 21 shows images from light microscopy at 60× of the results of drying swollen granules (0.25 M NaOH). Top left (A): original solution (pH 12.945) of swollen paramylon granules, top right (B): freeze dried swollen paramylon resuspended in water, bottom (C): spray dried resuspension of elongated paramylon granules in water.

FIG. 22 shows images from light microscopy at 60× of the results of drying elongated granules (0.33 M NaOH). Top left (A): original solution (pH 13.001) of elongated paramylon granules, top right (B): freeze dried elongated paramylon granules resuspended in water, bottom (C): spray dried resuspension of elongated paramylon granules in water.

FIG. 23 shows images from light microscopy at 60× of the results of drying granule shells (0.5 M NaOH). Top left (A): original solution (pH 13.065) of shell form of paramylon, top right (B): freeze dried resuspension of the shell form of paramylon in water, bottom (C): spray dried resuspension of the shell form of paramylon in water.

FIG. 24 shows images from light microscopy at 60× of the results of drying solubilized granules (1.0 M NaOH). Top left (A): original solution (pH 13.225) of solubilized granules, top right (B): freeze dried resuspension of solubilized form in water, bottom (C): spray dried resuspension of solubilized granules in water.

FIG. 25 shows weak gel formation at pH 10.2 (i.e. high pH). At the low pH of 3.3, no gel was observed.

FIG. 26 shows fruit jelly made with solubilized paramylon with sucrose and fruit flavour, and pH adjusted with citric acid form the jelly.

FIG. 27 shows results of emulsification activity assay with untreated paramylon granules.

FIG. 28 shows results of emulsification activity using an acid-gel of paramylon. The aqueous phase is transparent, and the emulsion phase comprising the gel shows a white colour.

FIG. 29 shows scanned images of buttercream icing made using 0.1%, 1% or 5% (w/w) of paramylon, Avalanche, or TiO₂. (A) Control, no whitening agent; (B) 5% (w/w) paramylon granules; (C) 0.1% (w/w) Titanium dioxide; (D) 5% (w/w) Paramylon gel, pH 3; (E) 1% (w/w) Titanium dioxide; and (F) 5% (w/w) Avalanche; (G) Control, no whitening agent; (H) 0.1% (w/w) Avalanche; (I) 0.1% (w/w) Paramylon granules; (J) 1% (w/w) Avalanche; and (K) 1% (w/w) paramylon granules.

FIG. 30 shows visual observation of: A) Negative control creamer with no paramylon, B) Neilson half & half cream (dairy) as the positive control, C) Creamer with 5% (w/v) paramylon granules, and D) Creamer with 10% (w/v) paramylon granules.

FIG. 31 shows a graph representing purity and whiteness index of paramylon samples. X axis is the whiteness index, and Y axis is the percentage of purity.

FIG. 32 shows an example of a structure of beta-glucan i.e. a beta 1,3 unit linked to a beta 1,4 unit.

FIG. 33 A shows the full spectrum FTIR of paramylon granules BGI (1).

FIG. 33 B shows the zoomed in spectrum FTIR of paramylon granules BGI (1), showing characteristic peaks.

FIG. 33 C shows the full spectrum FTIR of paramylon granules BGI (2).

FIG. 33 D shows the zoomed in spectrum FTIR of paramylon granules BGI (2), showing characteristic peaks.

FIG. 34 A shows the SEM of spray dried BGI.

FIG. 34 B shows an amplified SEM of spray dried BGI.

FIG. 34 C shows the SEM of freeze dried BGI.

FIG. 34 D shows the SEM of wet BGI.

FIG. 34 E shows an amplified SEM of wet BGI.

FIG. 35 shows the particle size of paramylon granules by MALVERN Mastersizer 3000 particle size analyzer.

FIG. 36 shows the SEC 90° light scattering chromatograms (solid), refractive index chromatograms (dashed), and molar mass versus retention time plots.

FIG. 37 shows the UV absorption spectra of the BGI 1% (w/v) in 0.125M, 0.5M, 0.75M and 1M NaOH solution.

FIG. 38 shows the effect of stirring time on the UV-vis absorption of 1% BGI solution in 1M NaOH after 3 h stirring (1M-N) and after 12 h stirring (1M-O).

FIG. 39 shows the effect of stirring time on the UV-vis absorption of 1% BGI solution in 0.75M NaOH after 3 h stirring (0.75M-N) and after 12 h stirring (0.75M-O).

FIG. 40 shows the optical density of BGI (13) and BGI(N) as a function of pH.

FIG. 41 A shows the pH treated PP solution before turbidimetric titration.

FIG. 41 B shows the optical density of PP(13) and PP(N) as a function of pH.

FIG. 42 A shows the pH treated PP solution before turbidimetric titration optical density of PP(N) as a function of pH.

FIG. 42 B shows the pH treated PP solution before turbidimetric titration optical density of PP(13) as a function of pH.

FIG. 43 shows the mean turbidity curves for PP-BGI mixtures and a homogenous PP solution as a function of pH and biopolymer mixing ratio (n=3) [arrow around pH 6 shows the soluble complexation, and around pH4 (PP-BGI mixture) and 4.4 (PP) indicates its optimal pH with OD max.

FIG. 44 shows the maximum optical density displayed by biopolymer mixture.

FIG. 45 shows the electrical neutrality point of the PP-BGI admixtures.

FIG. 46 A shows the PP-BGI suspension stability at pH 7.

FIG. 46 B shows the PP-BGI suspension stability at pH 5.5.

FIG. 46 C shows the PP-BGI suspension stability at pH 4.

FIG. 46 D shows the PP-BGI suspension stability at pH 2.

FIG. 47 A shows the SEM of wet RTG.

FIG. 47 B shows the amplified SEM of wet RTG.

FIG. 47 C shows the SEM of freeze dried RTG.

FIG. 47 D shows the amplified SEM of freeze dried RTG.

FIG. 47 E shows the amplified SEM of spray dried RTG.

FIG. 47 F shows the amplified SEM of spray dried RTG.

FIG. 48 A shows the FUR spectra of freeze dry RTG (RTGF).

FIG. 48 B shows the amplified FTIR spectra of freeze dry RTG (RTGF).

FIG. 48 C shows the FTIR spectra of Spray Dry RTG (RTES).

FIG. 48 D shows the amplified FTIR spectra of Spray Dry RTG (RTGS).

FIG. 49 shows the structure of Sodium Citrate.

FIG. 50 A shows the microscopic image of Milled sample using 5, 20 metal beads.

FIG. 50 B shows the microscopic image of Milled sample using 40 metal beads.

FIG. 50 C shows the SEM of Milled sample using 5, 20 metal beads.

FIG. 50 D shows the SEM of Milled sample using 40 metal beads.

FIG. 51 A shows the microscopic image of dry milled BGI at 25% milling concentration.

FIG. 51 B shows the microscopic image of dry milled BGI at 20% milling concentration.

FIG. 51 C shows the SEM of dry milled BGI.

FIG. 51 D shows the SEM of wet milled BGI at 20% milling concentration.

FIG. 52 A shows the pellets made from milled BGI materials.

FIG. 52 B shows the fibres made from milled BGI materials.

FIG. 53 shows the SEM image of milled BGI: Dry milling and then wet milling using 40 metal beads; 1 g BGI in 15 mL milling sample holder.

FIG. 54 A shows the appearance of milled BGI.

FIG. 54 B shows the appearance of co-milled BGI.

FIG. 55 A shows the SEM of dry milled paramylon.

FIG. 55 B shows the SEM of wet milled BGI.

FIG. 55 C shows the SEM of wet co-grind BGI with 4% sugar.

FIG. 55 D shows the SEM of wet co-grind BGI with 4% NaCl.

FIG. 55 E shows the SEM of dry milled first and then wet milling BGI with 4% NaCl.

FIG. 55 E shows the SEM of dry milled first and then wet milling BGI with 7% NaCl.

FIG. 56 A shows the FTIR of BGI.

FIG. 56 B shows the FTIR of dry milled BGI.

FIG. 56 C shows the FTIR of wet milled paramylon.

FIG. 56 D shows the FTIR of dry milled BGI with 4% NaCl.

FIG. 56 E shows the FTIR of wet milled BGI with 4% NaCl.

FIG. 56 F shows the FTIR of wet milled paramylon with 4% sugar.

FIG. 57 A shows the settling time vs settling volume of differently milled BGI's

FIG. 57 B shows the settling volume at various times.

FIG. 57 C shows the cream-like consistency of milled paramylon at a concentration of 1 g/10 mL in water.

FIG. 57 D shows the milled paramylon particles settled slower than paramylon.

FIG. 58 A shows the comparison of milled and non-milled biomass in appearance and settling, 1 g biomass in 40 mL at time 0, left is milled and right is non-milled.

FIG. 58 B shows the comparison of milled and non-milled biomass in appearance and settling, 1 g biomass in 40 mL at time 10 mins, left is milled and right is non-milled.

FIG. 58 C shows the comparison of milled and non-milled biomass in appearance and settling, 10 g biomass in 100 mL at time 0, left is milled and right is non-milled.

FIG. 58 D shows the comparison of milled and non-milled biomass in appearance and settling, 10 g biomass in 100 mL at 2 hours, left is milled and right is non-milled.

FIG. 59 A shows the FTIR of milled paramylon by CMC-milling method.

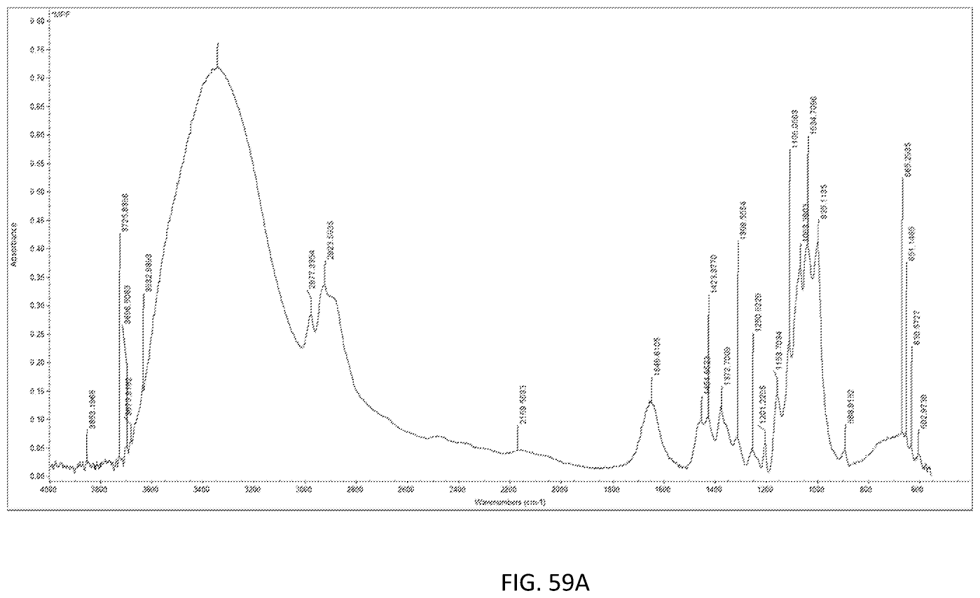

FIG. 59 B shows the amplified FTIR of milled paramylon by CMC-milling method.

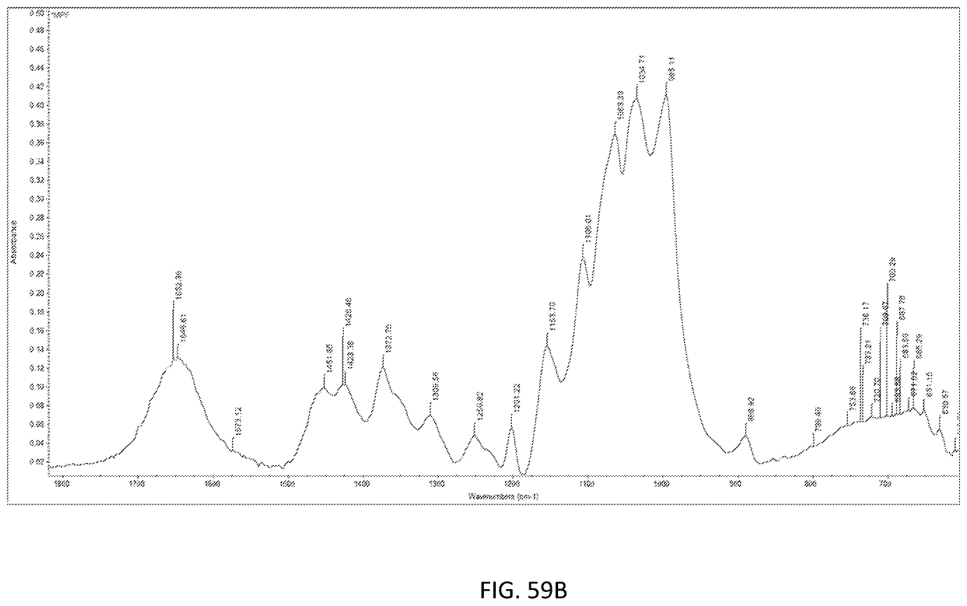

FIG. 60 A shows the BOI SEC 90° light scattering chromatograms (solid), refractive index chromatograms (dashed), and molar mass versus retention time plots.

FIG. 60 B shows the milled paramylon SEC 90° light scattering chromatograms (solid), refractive index chromatograms (dashed), and molar mass versus retention time plots.

FIG. 61 A shows the soaking temperature effect for RTG.

FIG. 61 B shows the soaking temperature effect for MPF.

FIG. 62 A shows the appearance of water saturated (WS) paramylon materials at 0 hours.

FIG. 62 B shows the appearance of water saturated (WS) paramylon materials at 24 hours.

FIG. 62 C shows the appearance of water saturated (WS) paramylon materials at 48 hours.

FIG. 63 shows the corrected WHC of RTG after a series of washing steps.

FIG. 64 shows the viscosity of paramylon granules with concentration.

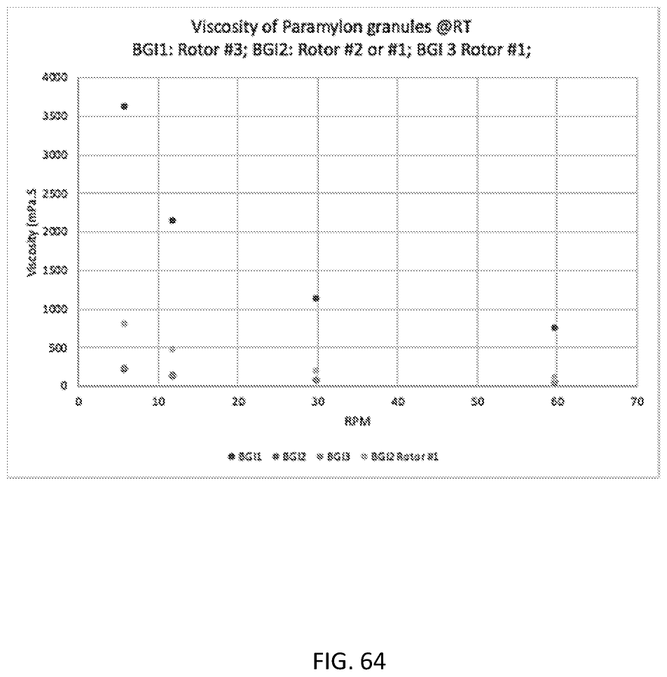

FIG. 65 shows the viscosity of BGI3 under different temperature (° C.) using rotor #1.

FIG. 66 shows the viscosity of BGI3 with time at RT using rotor #1.

FIG. 67 shows the viscosity of milled paramylon products.

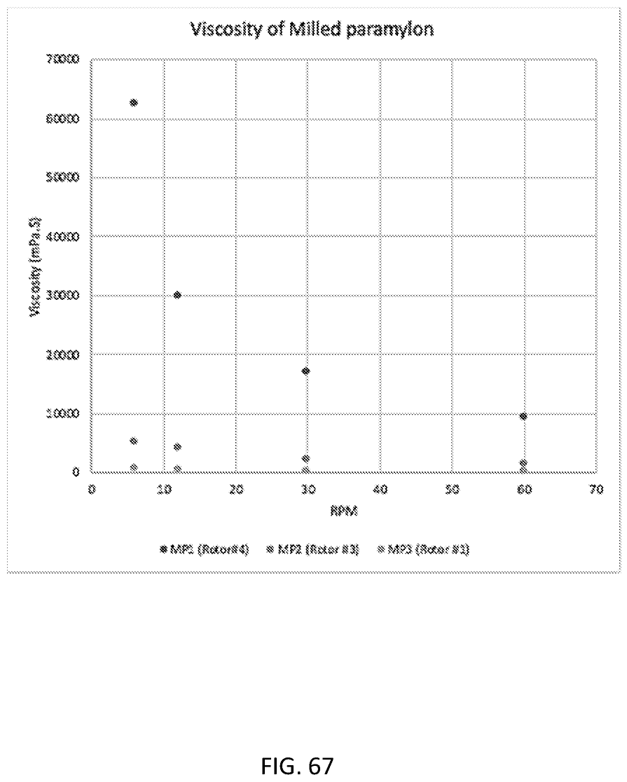

FIG. 68 shows the viscosity of MP3 vs temperature.

FIG. 69 A shows the viscosity of MP2 (rotor #3) vs time.

FIG. 69 B shows the viscosity of MP3 (rotor #1) vs time.

FIG. 70 A shows the viscosity of BGIs against concentration at different stirring rates (6, 12, 30 and 60 rpm).

FIG. 70 B shows the viscosity of MPs against concentration at different stirring rates (6, 12, 30 and 60 rpm).

FIG. 71 shows the comparison of the viscosity of different curdlan concentrations.

FIG. 72 A shows the overall viscosity comparison of the paramylon products, curdlan, common food thickener, and commercial food products.

FIG. 72 B shows the overall viscosity comparison of the paramylon products, curdlan, common food thickener, and additional commercial food products.

FIG. 73 A shows the shear Rate (l/s) vs Viscosity (Pa·S) of BGI at concentration of 27%.

FIG. 73 B shows the shear Rate (l/s) vs Viscosity (Pa·S) of BGI at concentration of 35%.

FIG. 73 C shows the shear Rate (l/s) vs Viscosity (Pa·S) of BGI at concentration of 44%.

FIG. 73 D shows the shear Rate (l/s) vs Viscosity (Pa·S) of sample #2.

FIG. 74 A shows the shear Rate (l/s) vs Viscosity (Pa·S) of MP at concentration of 3%.

FIG. 74 B shows the shear Rate (l/s) vs Viscosity (Pa·S) of MP at concentration of 6%.

FIG. 74 C shows the shear Rate (l/s) vs Viscosity (Pa·S) of MP at concentration of 11%.

FIG. 74 D shows the shear Rate (l/s) vs Viscosity (Pa·S) of sample #1.

FIG. 75 A shows the shear Rate (l/s) vs Viscosity (Pa·S) of RTG at concentration of 7.5%.

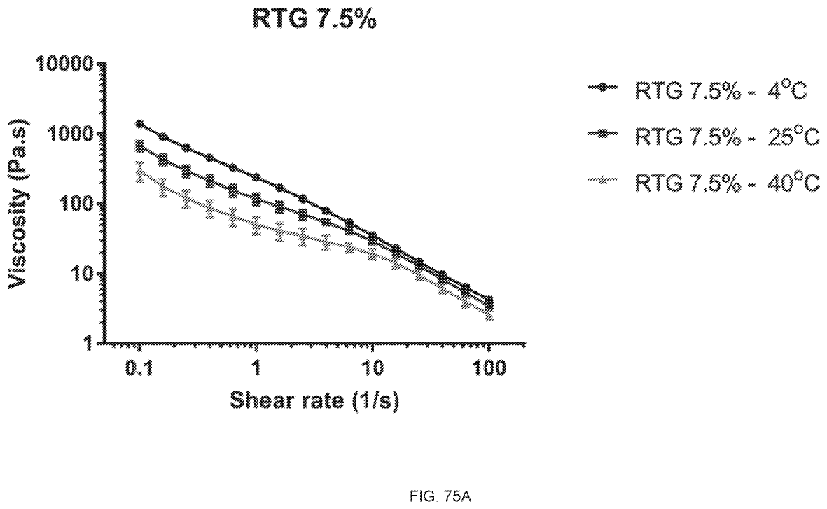

FIG. 75 B shows the shear Rate (l/s) vs Viscosity (Pa·S) of RTG at concentration of 10%.

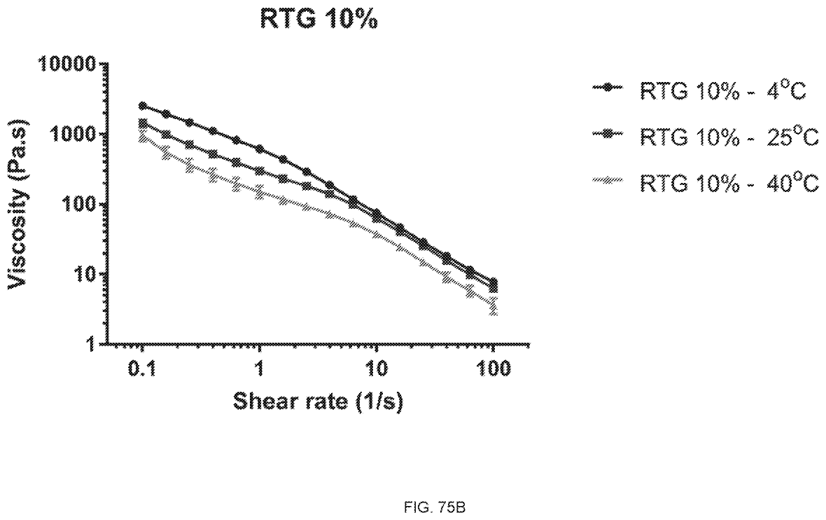

FIG. 75 C shows the shear Rate (l/s) vs Viscosity (Pa·S) of RTG at concentration of 15%.

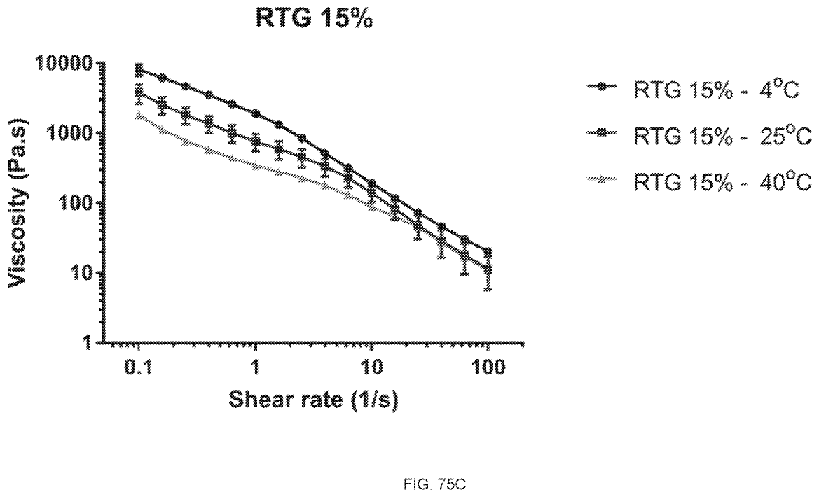

FIG. 76 A shows the storage/loss modulus of 10% RTG vs frequency.

FIG. 76 B shows the storage/loss modulus of 15% RTG vs frequency.

FIG. 76 C shows the storage/loss modulus of Sample #3 vs frequency.

FIG. 76 D shows the storage/loss modulus of 44% BGI vs frequency.

FIG. 76 E shows the storage/loss modulus of 35% BGI vs frequency.

FIG. 76 F shows the storage/loss modulus of 35% BGI vs strain.

FIG. 76 G shows the storage/loss modulus of 44% BGI vs strain.

FIG. 76 H shows the storage/loss modulus of 15% RTG vs strain.

FIG. 76 I shows the storage/loss modulus of 10% RTG vs strain.

FIG. 76 J shows the storage/loss modulus of sample #3 vs strain.

FIG. 77 A shows the compression test results for 10% RTG.

FIG. 77 B shows the compression test results for 15% RTG.

FIG. 77 C shows the compression test results for sample #3.

FIG. 78 shows an example of a DSC graph.

FIG. 79 shows an example of a TGA graph.

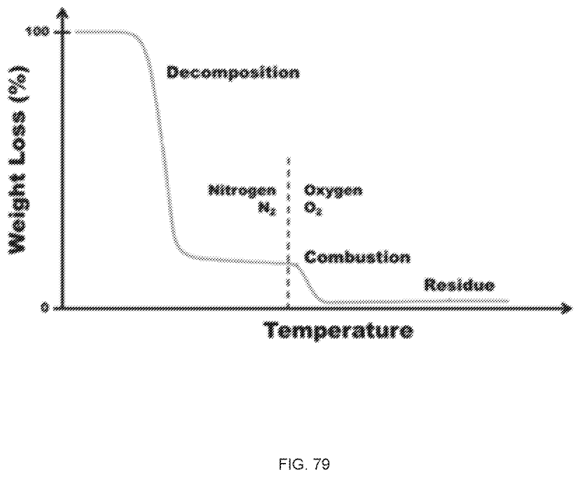

FIG. 80 shows the solubility (%) of protein with the protein concentration (%).

FIG. 81 shows the Water Holding Capacity (g/g), WHC: g water/g initial sample; Cor. WHC: g water/g remaining sample; Th WHC: Protein %*WHC1+BGI %*WHC2 (WHC1: WHC of 100% Protein; WHC2: WHC of 100% BGI).

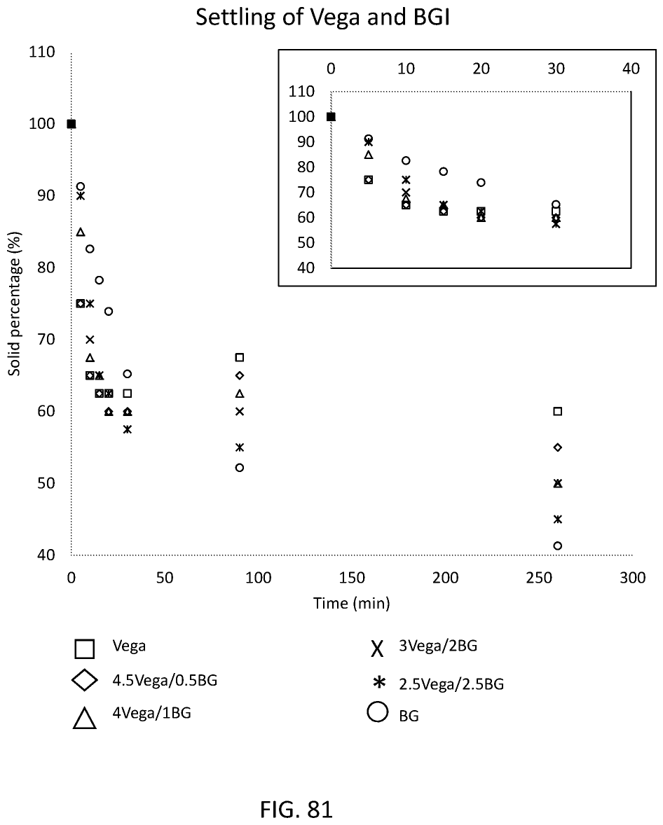

FIG. 82 A shows the settling of Protein, BGI and their mixtures with time without considering the solubility in full time range.

FIG. 82 B shows the settling of Protein, BGI and their mixtures with time without considering the solubility in 0-90 min.

FIG. 82 C shows the settling of Protein, BGI and their mixtures with time with considering the solubility in full time range.

FIG. 82 D shows the settling of Protein, BGI and their mixtures with time with considering the solubility in 0-90 min.

FIG. 83 shows the settling % against concentration of remaining solid content (%) at selected time, 5, 10 and 15 mins.

### DETAILED DESCRIPTION OF THE DISCLOSURE

### I. Definitions

The term “paramylon” as used herein means a carbohydrate having the structure:

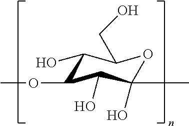

wherein n is from about 2 to about 3,600.

Paramylon is carbohydrate storage product produced by Euglenoid microalgae, for example, Euglena gracilis. Paramylon is primarily composed of polymerized glucose units linked by β-1,3 linkages, yielding a molecular weight of >500 kDa, optionally between about 250 kDa to about 600 kDa. It is the principal energy and carbon storage molecule of Euglena gracilis under aerobic conditions, and is deposited throughout the cytosol as membrane bound granules approximately 1-2 microns in size. Isolated paramylon is highly crystalline, in granule form, and can be processed into swollen form, elongated form, shell form or solubilized form, after treatment of the paramylon granules with a chemical or physical manipulation, for example, sodium hydroxide, which changes the shape and size of the paramylon granules in a concentration dependent fashion. Each of these forms can be determined microscopically. The swollen form of paramylon shows volume expansion along the long and short axis of the paramylon granule. The elongated form of paramylon shows greater expansion along the long axis of the granules than the swollen form, and with narrowing across the short axis. The shell form of paramylon appears to be disrupted paramylon granules consisting of loose aggregates of the microfibril. The solubilized form of paramylon refers to complete dissolution of the granules, such that no structures are observed under light microscopy.

The term “beta-glucan” as used herein refers to any polymer of glucose, in which the glucose monomers are principally linked by beta-type linkages as opposed to alpha-type linkages. The type of linkages refers to the orientation of the glycosidic linkage in space.

Beta-glucan such as paramylon can be characterized in terms of purity. Purity refers to a percentage measurement pertaining to how much of a material is made of a described constituent. For example, paramylon powder purity may be below 100% by the presence of other carbohydrates or proteins from the Euglena cell which contaminate the final product.

The term “biomass” as used herein refers to concentration of Euglena cells with minimal residual media as the media is removed through centrifugation or settling.

The term “food product” as used herein refers to any edible composition suitable for human or animal consumption. Such a product can be in solid or liquid form, and includes any drink product.

The term “functional food product” as used herein refers to a food product given an additional function by adding new ingredients or more of existing ingredients, for example, where paramylon is added to a food product to provide an additional function, for example, whitening, gelling, increasing water holding capacity, increasing viscosity, emulsifying and/or sweetening a food product.

The term “forming a gelatinous”, “gelling”, or “gelificate”, or a derivative thereof as used herein referring to a food composition or a food product, is defined as the process of turning a substance into a gelatinous form, thereby forming a gelatinous food product. It refers to combining a substance or food additive such as paramylon with a food composition to form a gelatinous food product by providing the food product a semi-solid nature by incorporating solids and liquids into a uniform three dimensional structure. A gelatinous food product is considered a soft gel when its tensile strength is in the range of 500-1000 g/cm², as seen in, for example, jelly and jams, nut butters (e.g. just nuts versions), jelly-like products, and fondant. A gelatinous food product is considered a hard gel when its tensile strength is in the range of 1000-3000 g/cm², as seen in, for example, gummy candy, confectionary gels (i.e. cookie filling), fruit gel bars, and fruit snacks.

As used in this disclosure, the term “whitening” or a derivative thereof refers to where a substance or food additive such as paramylon when combining with a food composition or food product, increases the overall whiteness as perceived by a human observer, or as measured by the methods described herein, thereby forming a whitened food product.

As used in this disclosure, the term “emulsifying” or a derivative thereof refers to where a substance or food additive such as paramylon maintaining in a food composition or food product a single-phase mixture in a normally two-phase system of oil and water. An emulsion thus refers to a kinetically stable mixture of two normally immiscible liquids. For example, in mayonnaise in which oil is dispersed in water. In some other foods, the water is dispersed in oil.

As used in this disclosure, the term “thickening” and derivatives thereof refer to where a substance or food additive such as paramylon providing thickness consistency to a food composition or food product. The thickness consistency may be provided by an increase in viscosity, for example, in the presence of paramylon.

As used in this disclosure, the term “sweetening” and derivatives thereof refer to where a substance or food additive such as paramylon imparting the perception of sweetness in a food composition or food product to a human observer, or sweetness as measured by the methods described herein.

As used herein, the term “enriched” and derivatives thereof refers to relative quantity of glucose oligomers (i.e. oligosaccharides containing glucose) in a paramylon sample that has undergone hydrolysis. Paramylon isolated from Euglena sp. can be hydrolyzed by, for example, glucanases such as endo-glucanases or exo-glucanases, or by acid, to breakdown the paramylon into smaller oligomers, for example, down to oligomers between two and ten glucose units, and optionally glucose oligomers of these sizes are isolated by, for example, size exclusion chromatography. Typically, hydrolyzed paramylon from Euglena sp. that is enriched with glucose oligomers contains from about 50% to about 90% (w/w) glucose oligomers in the total paramylon.

As used herein, the term “stability” and derivatives thereof refer to heat stability, freeze thaw stability, light stability, emulsion stability, or storage stability. Heat stability is the ability of a product or material to retain the same properties after exposure to a high heat for a set period of time, which could be cycled. Freeze thaw stability is the ability of a product or material to retain the same properties after being frozen and subsequently thawed, which can be cycled to determine the number of freeze thaw cycles a material is stable for. Light stability is the ability of a product or material to retain the same properties after exposure to a light, such as sunlight or indoor light for a set period of time, which could be cycled. Emulsion stability is the ability of a product or material to retain an emulsion and to prevent separating, over time. Further, the term “stabilizer” relates to a material that provides stability described herein when added to a product or another material. For example, a stabilizer may be an ingredient incorporated into a final food formulation which preserves the structure and sensory characteristics of a food product over time, which would not otherwise be maintained in the absence of the stabilizer.

The term “homogenize” or a derivative thereof as used herein refers to shearing, grinding, or blending process of at least two components in a mixture into a homogeneous mixture. Homogenization is commonly known to the person skilled in the art. Homogenization can be carried out in the presence of a liquid, for example, water, or a solvent, or a buffered solvent. The mixture can be resuspended biomass. The components in a mixture can be at least a solid and a liquid, at least two liquids, or at least two solids. Homogenization can be carried with a homogenizer, for example Polytron PTA-7 and OMNI GLH-01. The homogenizer can be a high pressure homogenizer.

The term “solution” as used herein refers to a homogeneous mixture of a substance (solute) dispersed through a liquid medium (solvent) that cannot be separated by the forces of gravity alone.

The term “encapsulating” or a derivative thereof as used herein relating to paramylon refers to a process in which paramylon forms are surrounding a core, for example, an oil, including a canola oil, a soybean oil, a sunflower oil, an olive oil, a palm oil, a safflower oil, a peanut oil, a sesame oil, a grapeseed oil, a cottonseed oil, an avocado oil, and an Euglena derived oil, and components in these oils include but not limited to medium-chain triglycerides (MCT), palmitic acid, omega-3 fatty acids eicosapentaenoic acid (EPA) and docosahexaenoic acid (DHA), and oleic acid.

The term “water holding capacity” (“WHC”) or a derivative thereof as used herein relating to food composition or product refers to the ability to hold the food's own and added water during the application of forces, pressing, centrifugation, or heating. WHC may also be described as a physical property, for example, the ability of a food structure to prevent water from being released from the three-dimensional structure of, for example, a gel.

The term “sludge” as used herein refers to a material with high moisture content, between 30-60%, but not exhibiting free flow. Paramylon sludge is a white material which has moisture content, between 30-60%, but is adhesive to the touch and does not flow.

The term “reconstitution” or a derivative thereof as used herein refers a procedure applied to a material following a treatment as disclosed herein that returns the materials chemical and physical properties to the same or similar conditions as they were before the aforementioned treatment. In the context of paramylon, reconstitution can be exemplified on a gel that is prepared, and then spray dried. The drying treatment may or may not change the properties. Reconstitution would be some act, for example, on the powder which returned it to its original gel state, or returned it to any other original state or function. The paramylon that has undergone reconstitution is referred to as “reconstituted” paramylon. The reconstituted paramylon retains functional property, for example, for forming a gelatinous food product, whitening a food product, emulsifying a food product, increasing viscosity of a food product, increasing water binding of a food product, sweetening a food product, bulking a food product, and/or encapsulating an oil. The reconstituted paramylon can also retain the ability to thicken or to maintain thickening of a food product.

The term “dispersion” as used herein refers to an evenly distributed mixture of a powder phase in a liquid phase where the two phases are separable by the force of gravity. For example, paramylon can be dispersed through water in its granule state but eventually sediments.

The term “milling” as used herein refers to a process involving grinding and/or crushing that yields a product with a smaller particle size. For example, paramylon may be ground thereby yielding particles smaller than 2 microns.

The term “aggregates” as used herein refers to clusters of loosely associated particles that do not break apart under normal Brownian motion. For example, paramylon may form aggregates of particles whereby many granules stick together.

The term “chaotropic agent” as used herein refers to a molecule which acts to destabilize a hydrogen bonding network. In the context of paramylon related uses and functions, a chaotropic agent may be added to a paramylon solution, gel, or food product, to disrupt the crystallinity imparted by the extended hydrogen bonding network.

The term “fruit jelly” as used herein refers to a gel network containing a sweetener and/or fruit flavoring agent which resembles spreadable products that are commonly consumed such as raspberry jam.

As used herein, the term “hydrocolloid” refers to long chain polymers of either carbohydrates (i.e. polysaccharides) or proteins that form a viscous solution or gel in water. This is due to the high number of hydroxyl groups allowing for increased binding to water.

The term “functional properties” as used herein relating to paramylon refers to forming a gelatinous food product (or gelling a food product), whitening a food product, emulsifying a food product, increasing viscosity of a food product, increasing water binding of a food product, sweetening a food product, bulking a food product, and encapsulating an oil.

The term “modifying” and derivatives thereof as used herein relating to a food product refer to any physical and chemical changes of the food product, as well as any changes in the food product as perceived by a human observer such as a consumer, for example, changes relating to how the food product is being perceived by a human observer's sensory.

The phrase “substantially free” as used herein refers to the complete or near complete lack of an action, characteristic, property, state, structure, item, or result. For example, a composition that is “substantially free of” animal phospholipid would either completely lack animal phospholipid, or so nearly completely lack animal phospholipid that the effect would be the same as if it completely lacked animal phospholipid. In other words, a composition that is “substantially free of” an ingredient or element may still actually contain such item as long as there is no measurable effect thereof. For example, a composition that is substantially free of an ingredient or element comprises less than about 1% by wt or less than about 1% vol/vol (v/v) of the ingredient or element in the composition.

The term (w/v) as used herein refers to a measure of the concentration of a solution obtained by dividing the mass or weight of the solute by the volume of the solution.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. In embodiments or claims where the term comprising is used as the transition phrase, such embodiments can also be envisioned with replacement of the term “comprising”, “including”, “having” and their derivatives with the terms “consisting of” or “consisting essentially of” The term “consisting” and its derivatives, are intended to be close ended terms that specify the presence of stated features, elements, components, groups, integers, and/or steps, and also exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristics of these features, elements, components, groups, integers, and/or steps. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this specification and the appended claims, the singular forms “a”, “an” and “the” include plural references unless the content clearly dictates otherwise. Thus, for example, a composition containing “a cholesterol” includes a mixture of two or more cholesterols. It should also be noted that the term “or” is generally employed in its sense including “and/or” unless the content clearly dictates otherwise.

The recitation of numerical ranges by endpoints herein includes all numbers and fractions subsumed within that range (e.g. 1 to 5 includes for example 1, 1.5, 2, 2.75, 3, 3.90, 4, and 5). It is also to be understood that all numbers and fractions thereof are presumed to be modified by the term “about.”

The definitions and embodiments described in particular sections are intended to be applicable to other embodiments herein described for which they are suitable as would be understood by a person skilled in the art.

### II. Methods, Uses, Compositions, and Products

This disclosure relates to methods in food applications and food products involving paramylon.

The paramylon disclosed herein is also useful as for forming a gelatinous food product, for example, by creating a bonding network amidst itself and with water molecules in an organized three dimensional structure.

Accordingly, in one aspect, the disclosure relates to a method of forming a gelatinous food product, comprising:
combining paramylon from Euglena sp. having purity of at least about 70% with a food composition to form a food product,
maintaining a temperature at between about 0° C. and about 100° C. for about 2 min to about 2 h, at a pH of between about 2 and about 10,
wherein the paramylon is between about 0.1% and about 50% (w/v) of the food product,
optionally further comprising combining with calcium chloride of between about 0.05% and about 1.5% (w/v),
thereby gelatinizing the food product to form the gelatinous food product.

Accordingly, in one aspect, the disclosure relates to a method of forming a gelatinous food product, comprising:
combining paramylon from Euglena sp. having purity of at least about 70% with a food composition to form a food product,
maintaining a temperature at between about 0° C. and about 100° C. for about 2 min to about 2 h, at a pH of between about 3 and about 13.
wherein the paramylon is between about 0.1% and about 50% (w/v) of the food product,
optionally further comprising combining with citric acid of between about 1% and about 10% (w/v),
thereby gelatinizing the food product to form the gelatinous food product.

The purity of paramylon can be determined by the methods described herein, including the ASC method, the Megazyme kit method, and the Total Dietary Fibre method. The ASC method is the preferred method for determining purity. In an embodiment, the ASC method for determining paramylon purity comprises: 1) adding paramylon, optionally about 0.5 g, and a magnetic bar to an empty centrifuge tube; 2) adding deionized water, optionally at a ratio of about 50 mL per gram paramylon, into the tube, and stirring for >8 hours at room temperature; 3) sedimenting the stirred sample by centrifugation, optionally at about 4,700×g for about 10 min, and decanting supernatant after centrifugation; 4) adding SDS solution, optionally 2% SDS solution, optionally equal volume as the deionized water, to the pellet, and heating the tube at about 110° C., optionally in an oil bath, for about 30 min with stirring; 5) sedimenting the stirred sample by centrifugation at about 4,700×g for about 10 min, and decanting supernatant after centrifugation; 6) repeating steps 4-5; 7) adding 70% isopropyl alcohol, optionally at equal volume as the deionized water, to the pellet, and resuspending and vortexing the pellet for about 15 min; 8) re-sedimenting the resuspended and vortexed sample by centrifugation at about 4,700×g for 10 about min, and decanting supernatant after centrifugation; 9) added 95% ethanol, optionally equal volume as the deionized water, and resuspending and vortexing the pellet for about 5 min; 10) removing the stir bar from the tube; 11) sedimenting the resuspended and vortexed pellet by centrifugation at about 4,700×g for about 10 min, and decanting supernatant after centrifugation; 12) freezing drying the pellet prior to recording the final weight, optionally storing the pellet at −80° C. prior to freeze-drying; 13) determining the purity of paramylon by dividing the final sample weight by the initial sample weight and multiplying by 100%.

In any of the embodiments described herein, the paramylon from Euglena sp. having purity of at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 95.1%, at least about 95.2%, at least about 95.3%, at least about 95.4%, at least about 95.5%, at least about 95.6%, at least about 95.7%, at least about 95.8%, at least about 95.9%, at least about 96%, at least about 96.1%, at least about 96.2%, at least about 96.3%, at least about 96.4%, at least about 96.5%, at least about 96.6%, at least about 96.7%, at least about 96.8%, at least about 96.9%, at least about 97%, at least about 97.1%, at least about 97.2%, at least about 97.3%, at least about 97.4%, at least about 97.5%, at least about 97.6%, at least about 97.7%, at least about 97.8%, at least about 97.9%, at least about 98%, at least about 98.1%, at least about 98.2%, at least about 98.3%, at least about 98.4%, at least about 98.5%, at least about 98.6%, at least about 98.7%, at least about 98.8%, at least about 98.9%, at least about 99%, at least about 99.1%, at least about 99.2%, at least about 99.3%, at least about 99.4%, at least about 99.5%, at least about 99.6%, at least about 99.7%, at least about 99.8%, at least about 99.9%, at least about 99.91%, at least about 99.92%, at least about 99.93%, at least about 99.94%, at least about 99.95%, at least about 99.96%, at least about 99.97%, at least about 99.98%, at least about 99.99%, at least about 99.999%, at least about 99.9999%, or about 100%.

In any of the embodiments described herein, the paramylon comprises from about 0.01% to about 100% (w/w) granule form, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) swollen form, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) elongated form, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) shell form, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) solubilized form, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) hydrolyzed paramylon, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) milled paramylon, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, the paramylon comprises from about 0.01% to about 100% (w/w) gelled paramylon, optionally from about 0.1% to about 100% (w/w), optionally from about 1% to about 100% (w/w), optionally from about 2% to about 100% (w/w), optionally from about 5% to about 100% (w/w), optionally from about 10% to about 100% (w/w), optionally from about 5% to about 100% (w/w), optionally from about 15% to about 100% (w/w), optionally from about 20% to about 100% (w/w), optionally from about 25% to about 100% (w/w), optionally from about 30% to about 100% (w/w), optionally from about 35% to about 100% (w/w), optionally from about 40% to about 100% (w/w), optionally from about 45% to about 100% (w/w), optionally from about 50% to about 100% (w/w), optionally from about 55% to about 100% (w/w), optionally from about 60% to about 100% (w/w), optionally from about 65% to about 100% (w/w), optionally from about 70% to about 100% (w/w), optionally from about 75% to about 100% (w/w), optionally from about 80% to about 100% (w/w), optionally from about 85% to about 100% (w/w), optionally from about 90% to about 100% (w/w), optionally from about 95% to about 100% (w/w), optionally from about 0.1% to about 50% (w/w), optionally from about 1% to about 50% (w/w), optionally from about 2% to about 50% (w/w), optionally from about 5% to about 50% (w/w), optionally from about 10% to about 50% (w/w), optionally from about 15% to about 50% (w/w), optionally from about 20% to about 50% (w/w), optionally from about 25% to about 50% (w/w), optionally from about 30% to about 50% (w/w), optionally from about 35% to about 50% (w/w), optionally from about 40% to about 50% (w/w), optionally from about 45% to about 50% (w/w), optionally from about 20% to about 80% (w/w), optionally from about 25% to about 80% (w/w), optionally from about 30% to about 80% (w/w), optionally from about 35% to about 80% (w/w), optionally from about 40% to about 80% (w/w), optionally from about 45% to about 80% (w/w), optionally from about 50% to about 80% (w/w), optionally from about 55% to about 80% (w/w), optionally from about 60% to about 80% (w/w), optionally from about 65% to about 80% (w/w), optionally from about 70% to about 80% (w/w), optionally from about 75% to about 80% (w/w), optionally from about 20% to about 60% (w/w), optionally from about 25% to about 60% (w/w), optionally from about 30% to about 60% (w/w), optionally from about 35% to about 60% (w/w), optionally from about 40% to about 60% (w/w), optionally from about 45% to about 60% (w/w), optionally from about 50% to about 60% (w/w), optionally from about 55% to about 60% (w/w), of the total paramylon.

In any of the embodiments described herein, maintaining a temperature comprises maintaining the temperature at between about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., or about 20° C. and about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 110° C., about 120° C., about 130° C., about 140° C., about 150° C., about 160° C., about 170° C., about 180° C., about 190° C., or 200° C., optionally between about 0° C. and about 10° C., optionally between about 0° C. and about 10° C., optionally between about 10° C. and about 20° C., optionally between about 20° C. and about 30° C., optionally between about 30° C. and about 40° C., optionally between about 40° C. and about 50° C., optionally between about 50° C. and about 60° C., optionally between about 60° C. and about 70° C., optionally between about 70° C. and about 80° C., optionally between about 80° C. and about 90° C., optionally between about 90° C. and about 100° C., optionally between about 100° C. and about 120° C., optionally between about 120° C. and about 140° C., optionally between about 140° C. and about 160° C., optionally between about 160° C. and about 180° C., optionally between about 180° C. and about 200° C., optionally about 4° C., optionally about 14° C., optionally about 20° C., optionally about 25° C., optionally about 68° C., optionally about 70° C., optionally about 75° C., optionally about 100° C. In any of the embodiments described herein, maintaining a temperature comprises maintaining the temperature for about 2 min, about 3 min, about 4 min, about 5 min, about 6 min, about 7 min, about 8 min, about 9 min, about 10 min, about 12 min, about 15 min, about 20 min, about 25 min, or about 30 min to about 45 min, about 60 min, about 75 min, about 90 min, about 105 min, about 120 min, about 135 min, about 150 min, about 165 min, about 180 min, about 195 min, about 210 min, about 225 min, or about 240 min, optionally about 2 min to about 4 h, optionally about 2 min to about 2 h, optionally about 2 min to about 1 hour, optionally about 2 min to about 1 hour, optionally about 2 min to about 30 min, optionally about 2 min to about 15 min, optionally about 15 min to about 30 min, optionally about 30 min to about 45 min, optionally about 45 min to about 60 min, optionally about 60 min to about 75 min, optionally about 75 min to about 90 min, optionally about 90 min to about 105 min, optionally about 105 min to about 120 min. In any of the embodiments described herein, maintaining a temperature comprises maintaining the temperature at a pH between about 2, about 2.5, about 3, about 3.5, about 4, about 4.5, about 5, about 5.5, about 6, about 6.5, and about 7, about 7.5, about 8, about 8.5, about 9, about 9.5, about 10, about 10.5, about 11, about 11.5, or about 12, optionally between about 2 and about 12, optionally between about 2 and about 11, optionally between about 2 and about 10, optionally between about 2 and about 9, optionally between about 3 and about 9, optionally between about 3 and about 5, optionally between about 5 and about 9, optionally between about 5 and about 7, optionally between about 6 and about 8, optionally between about 2.5 and about 8.5, optionally between about 4.5 and about 10.5, optionally between about 9 and about 12, optionally between about 6 and about 10.

In any of the embodiments described herein, the combining with calcium chloride comprises from about 0.05%, about 0.10%, about 0.15%, about 0.20%, about 0.25%, about 0.3%, about 0.35%, about 0.4%, about 0.45%, about 0.5%, about 0.55%, about 0.6%, about 0.65%, about 0.7%, or about 0.75%, to about 0.8%, about 0.85%, about 0.9%, about 0.95%, about 1%, about 1.05%, about 1.1%, about 1.15%, about 1.2%, about 1.25%, about 1.3%, about 1.35%, about 1.4%, about 1.45%, or about 1.5% (w/v), optionally between about 0.05% and about 1.5% (w/v), optionally between about 0.1% and about 1.5% (w/v), optionally between about 0.25% and about 1.5% (w/v), optionally between about 0.05% and about 1.5% (w/v), optionally between about 0.05% and about 1.5% (w/v), optionally between about 0.05% and about 1.5% (w/v), optionally between about 0.05% and about 1.5% (w/v), optionally between about 0.05% and about 1.5% (w/v), optionally between about 0.05 and about 1.5% (w/v), optionally between about 0.05% and about 1.5% (w/v), optionally between about 0.05% and about 0.75% (w/v), optionally between about 0.75% and about 1.5% (w/v), optionally between about 0.05% and about 0.5% (w/v), optionally between about 0.5% and about 1% (w/v), optionally between about 1% and about 1.5% (w/v), optionally between about 0.5% and about 1.25% (w/v), optionally between about 0.25% and about 1% (w/v).

In any of the embodiments described herein, the combining with citric acid comprises from about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, or about 10% (w/v), optionally between about 0.5% and about 10% (w/v), optionally between about 1% and about 10% (w/v), or about 10.5% (w/v), or about 11% (w/v), or about 11.5% (w/v), or about 12% (w/v), or about 12.5% (w/v), or about 13% (w/v), or about 13.5% (w/v), or about 14% (w/v), or about 14.5% (w/v), or about 15% (w/v), or about 15.5% (w/v), or about 16% (w/v), or about 16.5% (w/v), or about 17% (w/v), or about 17.5% (w/v), or about 18% (w/v), or about 18.5% (w/v), or about 19% (w/v), or about 19.5% (w/v), or about 20% (w/v), or about 20.5% (w/v), or about 21% (w/v), or about 21.5% (w/v), or about 22% (w/v), or about 22.5% (w/v), or about 23% (w/v), or about 23.5% (w/v), or about 24% (w/v), or about 24.5% (w/v), or about 25% (w/v), or about 25.5% (w/v), or about 26% (w/v), or about 26.5% (w/v), or about 27% (w/v), or about 27.5% (w/v), or about 28% (w/v), or about 28.5% (w/v), or about 29% (w/v), or about 29.5% (w/v), or about 30% (w/v), optionally between about 2% and about 15% (w/v), optionally between about 0.5% and about 20% (w/v), optionally between about 0.5% and about 19% (w/v), optionally between about 0.5% and about 18% (w/v), optionally between about 0.5% and about 17% (w/v), optionally between about 0.5% and about 16% (w/v), optionally between about 0.5% and about 15% (w/v), optionally between about 1% and about 15% (w/v), optionally between about 1.5% and about 15% (w/v), optionally between about 2% and about 15% (w/v), optionally between about 2.5% and about 15% (w/v), optionally between about 3% and about 15% (w/v), optionally between about 0.5% and about 4% (w/v), optionally between about 2.5% and about 4.5% (w/v), optionally between about 3% and about 4% (w/v).

In any of the embodiments described herein, the paramylon is between about 0.1% and about 50% (w/v) of the food product, optionally between about 0.2% and about 40% (w/v), optionally between about 0.5% and about 30% (w/v), optionally between about 1% and about 25% (w/v), optionally between about 2.5% and about 20% (w/v), optionally between about 5% and about 15% (w/v), optionally between about 10% and about 20% (w/v), optionally between about 0.1% and about 20% (w/v), optionally between about 0.2% and about 20% (w/v), optionally between about 0.5% and about 20% (w/v), optionally between about 1% and about 20% (w/v), optionally between about 2.5% and about 20% (w/v), optionally between about 5% and about 20% (w/v). In any of the embodiments described herein, the paramylon is a granule form paramylon, swollen form paramylon, elongated form paramylon, shell form paramylon, soluble form paramylon, and/or hydrolyzed paramylon.

In an embodiment, the food product is selected from the group consisting of a spreadable food stuff product, a confectionery product, a savory product, a dairy product, a dairy substitute product, and a drink product. In an embodiment, the food product is selected form the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, and any food product described herein.

The strength of a gel is affected by temperature, pH, and the amount of paramylon in the food product. The gel strength of the food product comprising solubilized, granular, or milled, paramylon can be measured by a tensiometer. The gel strength can also be measured by a texture analyzer, such as TA.XT Express or TA.XTPlus (Texture Technologies), FTC Texture Analyzer (Food Technology Corporation), and LFRA texture analyzer (Brookfield Engineering), which through compression and tensile data, can measure a number of physical properties, including tensile strength, i.e. a measurement of the force required to pull the gelatinous or “gelled” food product to the point where it breaks. Texture analyzers also test the crunchiness, gumminess, adhesiveness, chewiness, and general texture of many smaller things from animal crackers to zucchini. Texture analyzers measure tensile strength (i.e. in lb/int or psi) and compressive strength (i.e. psi or MPa) of materials. The principle of a texture measurement system is to physically deform a test sample in a controlled manner and measure its response. The characteristics of the force response are as a result of the sample's mechanical properties, which correlate to specific sensory texture attributes. A texture analyzer applies this principle by performing the procedure automatically and indicating the results visually on a digital numerical display, or screen. In an embodiment, the paramylon gelling increases tensile strength of the food product by about 1 g/cm² to about 3000 g/cm². In another embodiment, the paramylon gelling provides a food product with tensile strength of from about 1 g/cm² to about 3000 g/cm². In an embodiment, the method of forming a gelatinous food product comprises a granule form paramylon. In another embodiment, the tensile strength of the gelatinous food product is increased by about 0 g/cm² to about 3000 g/cm², optionally from about 1 g/cm², about 2 g/cm², about 3 g/cm², about 4 g/cm², about 5 g/cm², about 6 g/cm², about 7 g/cm², about 8 g/cm², about 9 g/cm², about 10 g/cm², about 20 g/cm², about 25 g/cm², about 30 g/cm², about 40 g/cm², about 50 g/cm², about 60 g/cm², about 70 g/cm², about 80 g/cm², about 90 g/cm², about 100 g/cm², about 150 g/cm², about 200 g/cm², about 250 g/cm², about 300 g/cm², about 350 g/cm², about 450 g/cm², or about 500 g/cm², to about 550 g/cm², about 600 g/cm², about 650 g/cm², about 700 g/cm², about 750 g/cm², about 800 g/cm², about 850 g/cm², about 900 g/cm², about 950 g/cm², about 1000 g/cm², about 1050 g/cm², about 1100 g/cm², about 1150 g/cm², about 1200 g/cm², about 1250 g/cm², about 1300 g/cm², about 1350 g/cm², about 1400 g/cm², about 1450 g/cm², about 1500 g/cm², about 1550 g/cm², about 1600 g/cm², about 1650 g/cm², about 1700 g/cm², about 1750 g/cm², about 1800 g/cm², about 1850 g/cm², about 1900 g/cm², about 1950 g/cm², about 2000 g/cm², about 2050 g/cm², about 2100 g/cm², about 2150 g/cm², about 2200 g/cm², about 2250 g/cm², about 2300 g/cm², about 2350 g/cm², about 2400 g/cm², about 2450 g/cm², about 2500 g/cm², about 2550 g/cm², about 2600 g/cm², about 2650 g/cm², about 2700 g/cm², about 2800 g/cm², about 2850 g/cm², about 2900 g/cm², about 2950 g/cm², or about 3000 g/cm², optionally from about 1 g/cm² to about 500 g/cm², optionally from about 1 g/cm² to about 400 g/cm², optionally from about 1 g/cm² to about 300 g/cm², optionally from about 1 g/cm² to about 300 g/cm², optionally from about 1 g/cm² to about 200 g/cm², optionally from about 1 g/cm² to about 100 g/cm², optionally from about 1 g/cm² to about 50 g/cm², optionally from about 1 g/cm² to about 25 g/cm², optionally from about 1 g/cm² to about 10 g/cm², optionally from about 1 g/cm² to about 5 g/cm², optionally from about 10 g/cm² to about 250 g/cm², optionally from about 100 g/cm² to about 200 g/cm², optionally from about 10 g/cm² to about 500 g/cm², optionally from about 20 g/cm² to about 1000 g/cm², optionally from about 50 g/cm² to about 1500 g/cm², optionally from about 100 g/cm² to about 1000 g/cm², optionally from about 200 g/cm² to about 2000 g/cm², optionally from about 1000 g/cm² to about 2000 g/cm², optionally from about 1500 g/cm² to about 2000 g/cm², optionally from about 1000 g/cm² to about 3000 g/cm², optionally from about 1500 g/cm² to about 3000 g/cm², optionally from about 2000 g/cm² to about 3000 g/cm², optionally from about 1500 g/cm² to about 2500 g/cm², optionally from about 1500 g/cm² to about 2200 g/cm², compared to the food product prior to gelatinization.

In an embodiment, the gelatinous food product is a soft gel food product. In an embodiment, the tensile strength of the soft gel product is from about 500 g/cm² to about 1000 g/cm², optionally from about 550 g/cm² to about 950 g/cm², optionally from about 600 g/cm² to about 900 g/cm², optionally from about 650 g/cm² to about 850 g/cm², optionally from about 700 g/cm² to about 800 g/cm², optionally from about 500 g/cm² to about 600 g/cm², optionally from about 600 g/cm² to about 700 g/cm², optionally from about 700 g/cm² to about 800 g/cm², optionally from about 800 g/cm² to about 900 g/cm², optionally from about 900 g/cm² to about 1000 g/cm², optionally from about 500 g/cm² to about 750 g/cm², optionally from about 750 g/cm² to about 1000 g/cm². In an embodiment, the gelatinous food product is a hard gel food product. In an embodiment, the tensile strength of the hard gel product is from about 1000 g/cm² to about 3000 g/cm², optionally from about 1250 g/cm² to about 2750 g/cm², optionally from about 1500 g/cm² to about 2500 g/cm², optionally from about 1750 g/cm² to about 2250 g/cm², optionally from about 1000 g/cm² to about 2000 g/cm², optionally from about 1500 g/cm² to about 2250 g/cm², optionally from about 2000 g/cm² to about 3000 g/cm², optionally from about 1000 g/cm² to about 1500 g/cm², optionally from about 1500 g/cm² to about 2000 g/cm², optionally from about 2000 g/cm² to about 2500 g/cm², optionally from about 2500 g/cm² to about 3000 g/cm², optionally from about 2750 g/cm² to about 3000 g/cm².

In an embodiment, the gelatinous food product is a jam. In an embodiment, the tensile strength of the jam is from about 5 g/cm² to about 15 g/cm², optionally from about 5 g/cm² to about 10 g/cm², optionally from about 7.5 g/cm² to about 12.5 g/cm², optionally from about 10 g/cm² to about 15 g/cm². In an embodiment, the gelatinous food product is a jelly. In an embodiment, the tensile strength of the jelly is from about 50 g/cm² to about 600 g/cm², optionally from about 50 g/cm² to about 200 g/cm², optionally from about 150 g/cm² to about 300 g/cm², optionally from about 250 g/cm² to about 400 g/cm², optionally from about 350 g/cm² to about 500 g/cm², optionally from about 450 g/cm² to about 600 g/cm². In an embodiment, the gelatinous food product is a soft gummy candy. In an embodiment, the tensile strength of the soft gummy candy is from about 650 g/cm² to about 850 g/cm², optionally from about 650 g/cm² to about 750 g/cm², optionally from about 700 g/cm² to about 800 g/cm², optionally from about 750 g/cm² to about 850 g/cm². In an embodiment, the gelatinous food product is a cream cheese. In an embodiment, the tensile strength of the cream cheese is from about 1000 g/cm² to about 1500 g/cm², optionally from about 1000 g/cm² to about 1150 g/cm², optionally from about 1100 g/cm² to about 1250 g/cm², optionally from about 1200 g/cm² to about 1350 g/cm², optionally from about 1300 g/cm² to about 1450 g/cm², optionally from about 1350 g/cm² to about 1500 g/cm². In an embodiment, the gelatinous food product is a fondant. In an embodiment, the tensile strength of the fondant is from about 500 g/cm² to about 1000 g/cm², optionally from about 500 g/cm² to about 750 g/cm², optionally from about 750 g/cm² to about 1000 g/cm², optionally from about 600 g/cm² to about 900 g/cm², optionally from about 700 g/cm² to about 800 g/cm². In an embodiment, the gelatinous food product is a nut butter. In an embodiment, the tensile strength of the nut butter is from about 15 g/cm² to about 35 g/cm², optionally from about 15 g/cm² to about 25 g/cm², optionally from about 20 g/cm² to about 30 g/cm², optionally from about 25 g/cm² to about 35 g/cm². In an embodiment, the gelatinous food product is a yogurt. In an embodiment, the tensile strength of the yogurt is from about 50 g/cm² to about 300 g/cm², optionally from about 50 g/cm² to about 150 g/cm², optionally from about 100 g/cm² to about 200 g/cm², optionally from about 150 g/cm² to about 250 g/cm², optionally from about 200 g/cm² to about 300 g/cm². In an embodiment, the gelatinous food product is a cheese. In an embodiment, the tensile strength of the cheese is from about 2500 g/cm² to about 3500 g/cm², optionally from about 2500 g/cm² to about 3250 g/cm², optionally from about 2750 g/cm² to about 3500 g/cm², optionally from about 2750 g/cm² to about 3250 g/cm², optionally about 3000 g/cm².

The person skilled in the art can also readily recognize that gel strength can also be determined by penetration test, i.e. Bloom strength test, for example, by a texture analyzer. This test determines the weight in grams needed by a specified plunger (for example, with a diameter of 0.5 inch) to depress the surface of the gel by 4 mm without breaking it at a specified temperature. The number of grams is termed the Bloom value, and most gelatins are between 30 g and 300 g Bloom. The higher a Bloom value, the higher the melting and gelling points of a gel, and the shorter its gelling time. Where Bloom value is >200, the strength is considered high, here Bloom value is <120, the strength is considered low, and anything in between is considered as medium strength gels. In another embodiment, the gelling provides a food product with Bloom value of from about 30 g to about 325 g. Further, the firmness of the gel can be measured, for example, by the force at 40% compression on a texture analyzer. The elasticity of a paramylon gel can be measured as the force that is remaining after a 5-inch relaxation on a texture analyzer.

A measurable property of paramylon gel or solution is its opacity. Opacity relates to how poorly light passes through an object. Aqueous dispersions of paramylon are referred to as opaque if light fails to pass through them, where light is being scattered and not transmitted by the suspension. The opacity of paramylon solution or gels can be determined by measuring the turbidity of the solution or the gel. This is measured spectrophotometry based on the absorbance in a range of 300-750 nm. For example, opacity can be measured by using a colorimeter (e.g. manufactured by Hunterlab). The colorimeter can obtain monk and scattering coefficient (k measuring the extinction coefficient at a number of wavelengths) which inform the amount of light observed per unit of material (g)/cm at a series of wavelengths of light. For example, UV/VIS spectrophotometer measures samples at red, blue and green and infer “white light”, i.e. at 450 nm, 540 nm, 680 nm and determine the mass absorption coefficient at each wavelength. In an embodiment, the paramylon gel or solution is clear with low opacity. In another embodiment, the paramylon gel or solution is opaque with high opacity.

Other common gelling agents come from natural sources and include agar-agar, gelatin, carrageenan, gellan gum, pectin and methylcellulose. In an embodiment, the paramylon is combined with a second gelling agent and a food composition to form a gelatinous food product.

In an embodiment, the gelatinous food product is a fruit jelly, comprising between about 1% and about 5% (w/v) paramylon, optionally between about 1% and about 2.5% (w/v) paramylon, optionally between about 1% and about 2% (w/v) paramylon, optionally about 1.5%, about 1.6%, about 1.7%, about 1.8%, about 1.9%, or about 2.0% (w/v) paramylon, optionally about 1.8% (w/v) paramylon. In an embodiment, the fruit jelly further comprises NaOH, optionally at between about 55% and about 60% (w/v) of 1M NaOH, optionally about 58% (w/v) 1M NaOH, sugar, optionally between about 10% and about 30% (w/v) sugar, optionally about 20% (w/v) sugar, citric acid, optionally between about 10% and about 30% (w/v) citric acid, optionally between about 10% and about 20% (w/v) citric acid, optionally about 20% (w/v) citric acid, optionally about 10% (w/v) citric acid), and/or fruit flavour, optionally between about The skill person can readily identify the type of sugar and fruit flavour suitable for a fruit jelly. In an embodiment, the fruit flavour is an apple, a pineapple, a coconut, a watermelon, a citric fruit such as an orange, a tangerine, a lemon, or a lime, a banana, a berry such as a strawberry, a raspberry, a blackberry or a blueberry, a grape, a grapefruit, a guava, a kiwi, a jackfruit, a loquat, a lychee, a pear, a mango, a peach, or a plum.

The paramylon disclosed herein is also useful for increasing viscosity of a food product, for example, thereby thickening the food product. Paramylon works as a thickening agent by increasing the viscosity of a solution, i.e. food matrix, where paramylon is added to a solution, the solution becomes more viscous. Increasing viscosity or thickening activity is a numerical representation of the increase in viscosity obtained in a food matrix by the addition of a thickening agent, specifically, paramylon and its derivatives. Viscosity is a numerical representation of the resistance of a fluid to flow under an applied force. This is characterized by rheology, i.e. the study of flow in liquids and soft solids which have plastic flow instead of deformation. For example, thickening of a food product can be determined by measuring viscosity of the food product using a viscometer, for example, by a Brookfield viscometer (AMETEK Brookfield). The measurement is reported in centipoise (cP), where 1 cP=1 mPa·s (one millipascal·second). The skilled person can also readily recognize that thickening effects can be determined by thixotropy, rheometry (including dynamic oscillatory rheometry) via rheometers, structural characterization, microscopy such as scanning electron microscopy and atomic force microscopy, molecular characterization via viscometers, texture measuring systems, differential scanning calorimetry, nuclear magnetic resonance (NMR), near infrared analysis (NIR), and small deformation tests involving oscillatory rheometric, creep tests and stress relaxation test.

In another aspect, the present disclosure includes a method of increasing viscosity of a food product, comprising adding paramylon from Euglena sp. having purity of at least about 70% to the food product, wherein the paramylon is between about 0.1% and about 50% (w/w) of the food product, wherein the paramylon comprises elongated form, shell form or soluble form, and wherein the paramylon increases viscosity of the food product by about 1 mPa·s to about 100,000 mPa·s at 25° C.

The viscosity of gels can also be determined by measuring the flow time of 100 mL of a certain percentage of sample solution through a standard pipette at 60° C. It can be calculated by the following formula:

V=(At−B/t)×dV

where, V is viscosity in millipoises (mP), A and B are pipette constants, t is efflux time in seconds, and d is the solution density.

In another aspect, the disclosure relates to a method of increasing viscosity of a food product, comprising
combining paramylon from Euglena sp. having purity of at least about 70%, with a food composition to form the food product,
wherein the paramylon is between about 0.1% and about 50% (w/w) of the food product, and
wherein the paramylon increases viscosity of the food product by about 1 mPa·s to about 100,000 mPa·s at 25° C.,
thereby forming the food product with increased viscosity.

Increased viscosity provided by the intermediate forms of paramylon known as the swollen, elongated and shell form is due to the increase in availability of hydroxyl groups available to bind to water. As well, these molecules disperse in a solution and increase the viscosity of the solution. In an embodiment, the paramylon comprises shell, elongated, and/or soluble form paramylon. In another embodiment, the food product with increased viscosity is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, a soup, a dumpling, a gravy, a pasta, a jelly, or a cake product. In an embodiment, paramylon increases viscosity of the food product by about 1 mPa·s to about 4000 mPa·s at 25° C., optionally from about 1 mPa·s, about 2 mPa·s, about 3 mPa·s, about 4 mPa·s, about 5 mPa·s, about 6 mPa·s, about 7 mPa·s, about 8 mPa·s, about 9 mPa·s, about 10 mPa·s, about 20 mPa·s, about 25 mPa·s, about 30 mPa·s, about 40 mPa·s, about 50 mPa·s, about 60 mPa·s, about 70 mPa·s, about 80 mPa·s, about 90 mPa·s, about 100 mPa·s, about 150 mPa·s, about 200 mPa·s, about 250 mPa·s, about 300 mPa·s, about 350 mPa·s, about 450 mPa·s, or about 500 mPa·s, to about 550 mPa·s, about 600 mPa·s, about 650 mPa·s, about 700 mPa·s, about 750 mPa·s, about 800 mPa·s, about 850 mPa·s, about 900 mPa·s, about 950 mPa·s, about 1000 mPa·s, about 1050 mPa·s, about 1100 mPa·s, about 1150 mPa·s, about 1200 mPa·s, about 1250 mPa·s, about 1300 mPa·s, about 1350 mPa·s, about 1400 mPa·s, about 1450 mPa·s, about 1500 mPa·s, about 1550 mPa·s, about 1600 mPa·s, about 1650 mPa·s, about 1700 mPa·s, about 1750 mPa·s, about 1800 mPa·s, about 1850 mPa·s, about 1900 mPa·s, about 1950 mPa·s, about 2000 mPa·s at 25° C., about 2100 mPa·s at 25° C., about 2200 mPa·s at 25° C., about 2300 mPa·s at 25° C., about 2400 mPa·s at 25° C., about 2500 mPa·s at 25° C., about 2600 mPa·s at 25° C., about 2700 mPa·s at 25° C., about 2800 mPa·s at 25° C., about 2900 mPa·s at 25° C., about 3000 mPa·s at 25° C., about 3100 mPa·s at 25° C., about 3200 mPa·s at 25° C., about 3300 mPa·s at 25° C., about 3400 mPa·s at 25° C., about 3500 mPa·s at 25° C., about 3600 mPa·s at 25° C., about 3700 mPa·s at 25° C., about 3800 mPa·s at 25° C., about 3900 mPa·s at 25° C., about 4000 mPa·s at 25° C., optionally from about 1 mPa·s to about 500 mPa·s at 25° C., optionally from about 20 mPa·s to about 1000 mPa·s at 25° C., optionally from about 50 mPa·s to about 1500 mPa·s at 25° C., optionally from about 100 mPa·s to about 1000 mPa·s at 25° C., optionally from about 200 mPa·s to about 2000 mPa·s at 25° C., optionally from about 1000 mPa·s to about 2000 mPa·s at 25° C., optionally from about 1500 mPa·s to about 2000 mPa·s at 25° C. optionally from about 200 mPa·s to about 4000 mPa·s at 25° C., optionally from about 1000 mPa·s to about 4000 mPa·s at 25° C., optionally from about 1500 mPa·s to about 4000 mPa·s at 25° C., optionally from about 2000 mPa·s to about 4000 mPa·s at 25° C., optionally from about 2500 mPa·s to about 4000 mPa·s at 25° C., optionally from about 3000 mPa·s to about 4000 mPa·s at 25° C., optionally from about 3500 mPa·s to about 4000 mPa·s at 25° C. In an embodiment, the food product is a non-dairy creamer. In an embodiment, the viscosity of the non-dairy creamer is from about 15 mPa·s to about 65 mPa·s, optionally from about 15 mPa·s to about 35 mPa·s, optionally from about 25 mPa·s to about 45 mPa·s, optionally from about 35 mPa·s to about 55 mPa·s, optionally from about 45 mPa·s to about 65 mPa·s, optionally from about 15 mPa·s to about 35 mPa·s. In an embodiment, the food product is a chocolate syrup. In an embodiment, the viscosity of the chocolate syrup is from about 10 mPa·s to about 25 mPa·s, optionally from about 10 mPa·s to about 20 mPa·s, optionally from about 15 mPa·s to about 25 mPa·s, optionally from about 15 mPa·s to about 20 mPa·s, optionally from about 20 mPa·s to about 25 mPa·s. In an embodiment, the food product is a protein shake. In an embodiment, the protein shake comprises whey. In an embodiment, the viscosity of the protein shake is from about 200 mPa·s to about 1600 mPa·s, optionally from about 200 mPa·s to about 600 mPa·s, optionally from about 400 mPa·s to about 800 mPa·s, optionally from about 600 mPa·s to about 1000 mPa·s, optionally from about 800 mPa·s to about 1200 mPa·s, optionally from about 1000 mPa·s to about 1400 mPa·s, optionally from about 1200 mPa·s to about 1600 mPa·s, optionally from about 1400 mPa·s to about 1800 mPa·s, optionally from about 1600 mPa·s to about 2000 mPa·s, optionally from about 1800 mPa·s to about 2200 mPa·s, optionally from about 2000 mPa·s to about 2400 mPa·s, optionally from about 2200 mPa·s to about 2600 mPa·s, optionally from about 2400 mPa·s to about 2800 mPa·s, optionally from about 2600 mPa·s to about 3000 mPa·s, optionally from about 2800 mPa·s to about 3200 mPa·s, optionally from about 3000 mPa·s to about 3400 mPa·s, optionally from about 3200 mPa·s to about 3600 mPa·s, optionally from about 3400 mPa·s to about 3800 mPa·s, optionally from about 3600 mPa·s to about 4000 mPa·s.

Increased viscosity provided by the granule form of paramylon as these molecules disperse in a solution and increase the viscosity of the solution. In another embodiment, the food product with increased viscosity is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, a soup, a dumpling, a gravy, a pasta, a jelly, or a cake product. In an embodiment, paramylon increases viscosity of the food product by about 1 mPa·s to about 4000 mPa·s at 25° C., optionally from about 1 mPa·s, about 2 mPa·s, about 3 mPa·s, about 4 mPa·s, about 5 mPa·s, about 6 mPa·s, about 7 mPa·s, about 8 mPa·s, about 9 mPa·s, about 10 mPa·s, about 20 mPa·s, about 25 mPa·s, about 30 mPa·s, about 40 mPa·s, about 50 mPa·s, about 60 mPa·s, about 70 mPa·s, about 80 mPa·s, about 90 mPa·s, about 100 mPa·s, about 150 mPa·s, about 200 mPa·s, about 250 mPa·s, about 300 mPa·s, about 350 mPa·s, about 450 mPa·s, or about 500 mPa·s, to about 550 mPa·s, about 600 mPa·s, about 650 mPa·s, about 700 mPa·s, about 750 mPa·s, about 800 mPa·s, about 850 mPa·s, about 900 mPa·s, about 950 mPa·s, about 1000 mPa·s, about 1050 mPa·s, about 1100 mPa·s, about 1150 mPa·s, about 1200 mPa·s, about 1250 mPa·s, about 1300 mPa·s, about 1350 mPa·s, about 1400 mPa·s, about 1450 mPa·s, about 1500 mPa·s, about 1550 mPa·s, about 1600 mPa·s, about 1650 mPa·s, about 1700 mPa·s, about 1750 mPa·s, about 1800 mPa·s, about 1850 mPa·s, about 1900 mPa·s, about 1950 mPa·s, about 2000 mPa·s at 25° C., about 2100 mPa·s at 25° C., about 2200 mPa·s at 25° C., about 2300 mPa·s at 25° C., about 2400 mPa·s at 25° C., about 2500 mPa·s at 25° C., about 2600 mPa·s at 25° C., about 2700 mPa·s at 25° C., about 2800 mPa·s at 25° C., about 2900 mPa·s at 25° C., about 3000 mPa·s at 25° C., about 3100 mPa·s at 25° C., about 3200 mPa·s at 25° C., about 3300 mPa·s at 25° C., about 3400 mPa·s at 25° C., about 3500 mPa·s at 25° C., about 3600 mPa·s at 25° C., about 3700 mPa·s at 25° C., about 3800 mPa·s at 25° C., about 3900 mPa·s at 25° C., about 4000 mPa·s at 25° C., optionally from about 1 mPa·s to about 500 mPa·s at 25° C., optionally from about 20 mPa·s to about 1000 mPa·s at 25° C., optionally from about 50 mPa·s to about 1500 mPa·s at 25° C., optionally from about 100 mPa·s to about 1000 mPa·s at 25° C., optionally from about 200 mPa·s to about 2000 mPa·s at 25° C., optionally from about 1000 mPa·s to about 2000 mPa·s at 25° C., optionally from about 1500 mPa·s to about 2000 mPa·s at 25° C. optionally from about 200 mPa·s to about 4000 mPa·s at 25° C., optionally from about 1000 mPa·s to about 4000 mPa·s at 25° C., optionally from about 1500 mPa·s to about 4000 mPa·s at 25° C., optionally from about 2000 mPa·s to about 4000 mPa·s at 25° C., optionally from about 2500 mPa·s to about 4000 mPa·s at 25° C., optionally from about 3000 mPa·s to about 4000 mPa·s at 25° C., optionally from about 3500 mPa·s to about 4000 mPa·s at 25° C. In an embodiment, the food product is a non-dairy creamer. In an embodiment, the viscosity of the non-dairy creamer is from about 15 mPa·s to about 65 mPa·s, optionally from about 15 mPa·s to about 35 mPa·s, optionally from about 25 mPa·s to about 45 mPa·s, optionally from about 35 mPa·s to about 55 mPa·s, optionally from about 45 mPa·s to about 65 mPa·s, optionally from about 15 mPa·s to about 35 mPa·s. In an embodiment, the food product is a chocolate syrup. In an embodiment, the viscosity of the chocolate syrup is from about 10 mPa·s to about 25 mPa·s, optionally from about 10 mPa·s to about 20 mPa·s, optionally from about 15 mPa·s to about 25 mPa·s, optionally from about 15 mPa·s to about 20 mPa·s, optionally from about 20 mPa·s to about 25 mPa·s. In an embodiment, the food product is a protein shake. In an embodiment, the protein shake comprises whey. In an embodiment, the viscosity of the protein shake is from about 200 mPa·s to about 1600 mPa·s, optionally from about 200 mPa·s to about 600 mPa·s, optionally from about 400 mPa·s to about 800 mPa·s, optionally from about 600 mPa·s to about 1000 mPa·s, optionally from about 800 mPa·s to about 1200 mPa·s, optionally from about 1000 mPa·s to about 1400 mPa·s, optionally from about 1200 mPa·s to about 1600 mPa·s, optionally from about 1400 mPa·s to about 1800 mPa·s, optionally from about 1600 mPa·s to about 2000 mPa·s, optionally from about 1800 mPa·s to about 2200 mPa·s, optionally from about 2000 mPa·s to about 2400 mPa·s, optionally from about 2200 mPa·s to about 2600 mPa·s, optionally from about 2400 mPa·s to about 2800 mPa·s, optionally from about 2600 mPa·s to about 3000 mPa·s, optionally from about 2800 mPa·s to about 3200 mPa·s, optionally from about 3000 mPa·s to about 3400 mPa·s, optionally from about 3200 mPa·s to about 3600 mPa·s, optionally from about 3400 mPa·s to about 3800 mPa·s, optionally from about 3600 mPa·s to about 4000 mPa·s.

Increased viscosity provided by the Ready To Gel (RTG) form of paramylon as these molecules disperse in a solution and increase the viscosity of the solution. In another embodiment, the food product with increased viscosity is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, a soup, a dumpling, a gravy, a pasta, a jelly, or a cake product. In an embodiment, paramylon increases viscosity of the food product by about 1000 mPa·s to about 100,000 mPa·s at 25° C., optionally from about 1000 mPa·s, about 1050 mPa·s, about 1100 mPa·s, about 1150 mPa·s, about 1200 mPa·s, about 1250 mPa·s, about 1300 mPa·s, about 1350 mPa·s, about 1400 mPa·s, about 1450 mPa·s, about 1500 mPa·s, about 1550 mPa·s, about 1600 mPa·s, about 1650 mPa·s, about 1700 mPa·s, about 1750 mPa·s, about 1800 mPa·s, about 1850 mPa·s, about 1900 mPa·s, about 1950 mPa·s, about 2000 mPa·s at 25° C., about 2100 mPa·s at 25° C., about 2200 mPa·s at 25° C., about 2300 mPa·s at 25° C., about 2400 mPa·s at 25° C., about 2500 mPa·s at 25° C., about 2600 mPa·s at 25° C., about 2700 mPa·s at 25° C., about 2800 mPa·s at 25° C., about 2900 mPa·s at 25° C., about 3000 mPa·s at 25° C., about 3100 mPa·s at 25° C., about 3200 mPa·s at 25° C., about 3300 mPa·s at 25° C., about 3400 mPa·s at 25° C., about 3500 mPa·s at 25° C., about 3600 mPa·s at 25° C., about 3700 mPa·s at 25° C., about 3800 mPa·s at 25° C., about 3900 mPa·s at 25° C., about 4000 mPa·s at 25° C., about 4100 mPa·s at 25° C., about 4200 mPa·s at 25° C., about 4300 mPa·s at 25° C., about 4400 mPa·s at 25° C., about 4500 mPa·s at 25° C., about 4600 mPa·s at 25° C., about 4700 mPa·s at 25° C., about 4800 mPa·s at 25° C., about 4900 mPa·s at 25° C., about 5000 mPa·s at 25° C., about 5100 mPa·s at 25° C., about 5200 mPa·s at 25° C., about 5300 mPa·s at 25° C., about 5400 mPa·s at 25° C., about 5500 mPa·s at 25° C., about 5600 mPa·s at 25° C., about 5700 mPa·s at 25° C., about 5800 mPa·s at 25° C., about 5900 mPa·s at 25° C., about 6000 mPa·s at 25° C., about 6100 mPa·s at 25° C., about 6200 mPa·s at 25° C., about 6300 mPa·s at 25° C., about 6400 mPa·s at 25° C., about 6500 mPa·s at 25° C., about 6600 mPa·s at 25° C., about 6700 mPa·s at 25° C., about 6800 mPa·s at 25° C., about 6900 mPa·s at 25° C., about 7000 mPa·s at 25° C., about 7100 mPa·s at 25° C., about 7200 mPa·s at 25° C., about 7300 mPa·s at 25° C., about 7400 mPa·s at 25° C., about 7500 mPa·s at 25° C., about 7600 mPa·s at 25° C., about 7700 mPa·s at 25° C., about 7800 mPa·s at 25° C., about 7900 mPa·s at 25° C., about 8000 mPa·s at 25° C., about 8100 mPa·s at 25° C., about 8200 mPa·s at 25° C., about 8300 mPa·s at 25° C., about 8400 mPa·s at 25° C., about 8500 mPa·s at 25° C., about 8600 mPa·s at 25° C., about 8700 mPa·s at 25° C., about 8800 mPa·s at 25° C., about 8900 mPa·s at 25° C., about 9000 mPa·s at 25° C., about 9100 mPa·s at 25° C., about 9200 mPa·s at 25° C., about 9300 mPa·s at 25° C., about 9400 mPa·s at 25° C., about 9500 mPa·s at 25° C., about 9600 mPa·s at 25° C., about 9700 mPa·s at 25° C., about 9800 mPa·s at 25° C., about 9900 mPa·s at 25° C., about 10,000 mPa·s at 25° C., about 11,000 mPa·s at 25° C., about 12,000 mPa·s at 25° C., about 13,000 mPa·s at 25° C., about 14,000 mPa·s at 25° C., about 15,000 mPa·s at 25° C., about 16,000 mPa·s at 25° C., about 17,000 mPa·s at 25° C., about 18,000 mPa·s at 25° C., about 19,000 mPa·s at 25° C., about 20,000 mPa·s at 25° C., about 2,000 mPa·s at 25° C., about 22,000 mPa·s at 25° C., about 23,000 mPa·s at 25° C., about 24,000 mPa·s at 25° C., about 25,000 mPa·s at 25° C., about 26,000 mPa·s at 25° C., about 27,000 mPa·s at 25° C., about 28,000 mPa·s at 25° C., about 29,000 mPa·s at 25° C., about 30,000 mPa·s at 25° C., about 31,000 mPa·s at 25° C., about 32,000 mPa·s at 25° C., about 33,000 mPa·s at 25° C., about 34,000 mPa·s at 25° C., about 35,000 mPa·s at 25° C., about 36,000 mPa·s at 25° C., about 37,000 mPa·s at 25° C., about 38,000 mPa·s at 25° C., about 39,000 mPa·s at 25° C., about 40,000 mPa·s at 25° C., about 41,000 mPa·s at 25° C., about 42,000 mPa·s at 25° C., about 43,000 mPa·s at 25° C., about 44,000 mPa·s at 25° C., about 45,000 mPa·s at 25° C., about 46,000 mPa·s at 25° C., about 47,000 mPa·s at 25° C., about 48,000 mPa·s at 25° C., about 49,000 mPa·s at 25° C., about 50,000 mPa·s at 25° C., about 51,000 mPa·s at 25° C., about 52,000 mPa·s at 25° C., about 53,000 mPa·s at 25° C., about 54,000 mPa·s at 25° C., about 55,000 mPa·s at 25° C., about 56,000 mPa·s at 25° C., about 57,000 mPa·s at 25° C., about 58,000 mPa·s at 25° C., about 59,000 mPa·s at 25° C., about 60,000 mPa·s at 25° C., about 61,000 mPa·s at 25° C., about 62,000 mPa·s at 25° C., about 63,000 mPa·s at 25° C., about 64,000 mPa·s at 25° C., about 65,000 mPa·s at 25° C., about 66,000 mPa·s at 25° C., about 67,000 mPa·s at 25° C., about 68,000 mPa·s at 25° C., about 69,000 mPa·s at 25° C., about 70,000 mPa·s at 25° C., about 71,000 mPa·s at 25° C., about 72,000 mPa·s at 25° C., about 83,000 mPa·s at 25° C., about 74,000 mPa·s at 25° C., about 75,000 mPa·s at 25° C., about 76,000 mPa·s at 25° C., about 77,000 mPa·s at 25° C., about 78,000 mPa·s at 25° C., about 79,000 mPa·s at 25° C., about 80,000 mPa·s at 25° C., about 81,000 mPa·s at 25° C., about 82,000 mPa·s at 25° C., about 83,000 mPa·s at 25° C., about 84,000 mPa·s at 25° C., about 85,000 mPa·s at 25° C., about 86,000 mPa·s at 25° C., about 87,000 mPa·s at 25° C., about 88,000 mPa·s at 25° C., about 6899,000 mPa·s at 25° C., about 90,000 mPa·s at 25° C., about 91,000 mPa·s at 25° C., about 92,000 mPa·s at 25° C., about 93,000 mPa·s at 25° C., about 94,000 mPa·s at 25° C., about 95,000 mPa·s at 25° C., about 96,000 mPa·s at 25° C., about 97,000 mPa·s at 25° C., about 98,000 mPa·s at 25° C., about 99,000 mPa·s at 25° C., about 100,000 mPa·s at 25° C. In an embodiment, the food product is a non-dairy creamer. In an embodiment, the viscosity of the non-dairy creamer is from about 1000 mPa·s to about 100,000 mPa·s, optionally from about 1000 mPa·s to about 2000 mPa·s, optionally from about 1500 mPa·s to about 2000 mPa·s, optionally from about 2000 mPa·s to about 2500 mPa·s, optionally from about 2500 mPa·s to about 3000 mPa·s, optionally from about 3000 mPa·s to about 3500 mPa·s, optionally from about 3500 mPa·s to about 4000 mPa·s, optionally from about 4000 mPa·s to about 4500 mPa·s, optionally from about 4500 mPa·s to about 5000 mPa·s, optionally from about 5000 mPa·s to about 5500 mPa·s, optionally from about 5000 mPa·s to about 6500 mPa·s, optionally from about 6500 mPa·s to about 7000 mPa·s, optionally from about 7000 mPa·s to about 7500 mPa·s, optionally from about 7500 mPa·s to about 8000 mPa·s, optionally from about 8000 mPa·s to about 8500 mPa·s, optionally from about 8500 mPa·s to about 9000 mPa·s, optionally from about 9000 mPa·s to about 9500 mPa·s, optionally from about 9500 mPa·s to about 10,000 mPa·s, optionally from about 10,000 mPa·s to about 11,000 mPa·s, optionally from about 11,000 mPa·s to about 12,000 mPa·s, optionally from about 12,000 mPa·s to about 13,000 mPa·s, optionally from about 13,000 mPa·s to about 14,000 mPa·s, optionally from about 14,000 mPa·s to about 15,000 mPa·s, optionally from about 15,000 mPa·s to about 16,000 mPa·s, optionally from about 16,000 mPa·s to about 17,000 mPa·s, optionally from about 17,000 mPa·s to about 18,000 mPa·s, optionally from about 18,000 mPa·s to about 19,000 mPa·s, optionally from about 19,000 mPa·s to about 20,000 mPa·s, optionally from about 20,000 mPa·s to about 21,000 mPa·s, optionally from about 21,000 mPa·s to about 22,000 mPa·s, optionally from about 22,000 mPa·s to about 23,000 mPa·s, optionally from about 23,000 mPa·s to about 24,000 mPa·s, optionally from about 24,000 mPa·s to about 25,000 mPa·s, optionally from about 25,000 mPa·s to about 26,000 mPa·s, optionally from about 26,000 mPa·s to about 27,000 mPa·s, optionally from about 27,000 mPa·s to about 28,000 mPa·s, optionally from about 28,000 mPa·s to about 29,000 mPa·s, optionally from about 29,000 mPa·s to about 30,000 mPa·s, optionally from about 30,000 mPa·s to about 31,000 mPa·s, optionally from about 31,000 mPa·s to about 32,000 mPa·s, optionally from about 32,000 mPa·s to about 33,000 mPa·s, optionally from about 33,000 mPa·s to about 34,000 mPa·s, optionally from about 34,000 mPa·s to about 35,000 mPa·s, optionally from about 35,000 mPa·s to about 36,000 mPa·s, optionally from about 36,000 mPa·s to about 37,000 mPa·s, optionally from about 37,000 mPa·s to about 38,000 mPa·s, optionally from about 38,000 mPa·s to about 39,000 mPa·s, optionally from about 39,000 mPa·s to about 40,000 mPa·s, optionally from about 40,000 mPa·s to about 41,000 mPa·s, optionally from about 41,000 mPa·s to about 42,000 mPa·s, optionally from about 42,000 mPa·s to about 43,000 mPa·s, optionally from about 43,000 mPa·s to about 44,000 mPa·s, optionally from about 44,000 mPa·s to about 45,000 mPa·s, optionally from about 45,000 mPa·s to about 46,000 mPa·s, optionally from about 46,000 mPa·s to about 47,000 mPa·s, optionally from about 47,000 mPa·s to about 48,000 mPa·s, optionally from about 48,000 mPa·s to about 49,000 mPa·s, optionally from about 49,000 mPa·s to about 50,000 mPa·s, optionally from about 50,000 mPa·s to about 51,000 mPa·s, optionally from about 51,000 mPa·s to about 52,000 mPa·s, optionally from about 52,000 mPa·s to about 53,000 mPa·s, optionally from about 53,000 mPa·s to about 54,000 mPa·s, optionally from about 54,000 mPa·s to about 55,000 mPa·s, optionally from about 55,000 mPa·s to about 56,000 mPa·s, optionally from about 56,000 mPa·s to about 57,000 mPa·s, optionally from about 57,000 mPa·s to about 58,000 mPa·s, optionally from about 58,000 mPa·s to about 59,000 mPa·s, optionally from about 59,000 mPa·s to about 60,000 mPa·s, optionally from about 60,000 mPa·s to about 61,000 mPa·s, optionally from about 61,000 mPa·s to about 62,000 mPa·s, optionally from about 62,000 mPa·s to about 63,000 mPa·s, optionally from about 63,000 mPa·s to about 64,000 mPa·s, optionally from about 64,000 mPa·s to about 65,000 mPa·s, optionally from about 65,000 mPa·s to about 66,000 mPa·s, optionally from about 66,000 mPa·s to about 67,000 mPa·s, optionally from about 67,000 mPa·s to about 68,000 mPa·s, optionally from about 68,000 mPa·s to about 69,000 mPa·s, optionally from about 69,000 mPa·s to about 70,000 mPa·s, optionally from about 70,000 mPa·s to about 71,000 mPa·s, optionally from about 71,000 mPa·s to about 72,000 mPa·s, optionally from about 72,000 mPa·s to about 73,000 mPa·s, optionally from about 73,000 mPa·s to about 74,000 mPa·s, optionally from about 74,000 mPa·s to about 75,000 mPa·s, optionally from about 75,000 mPa·s to about 76,000 mPa·s, optionally from about 76,000 mPa·s to about 77,000 mPa·s, optionally from about 77,000 mPa·s to about 78,000 mPa·s, optionally from about 78,000 mPa·s to about 79,000 mPa·s, optionally from about 79,000 mPa·s to about 80,000 mPa·s, optionally from about 80,000 mPa·s to about 81,000 mPa·s, optionally from about 81,000 mPa·s to about 82,000 mPa·s, optionally from about 82,000 mPa·s to about 83,000 mPa·s, optionally from about 83,000 mPa·s to about 84,000 mPa·s, optionally from about 84,000 mPa·s to about 85,000 mPa·s, optionally from about 85,000 mPa·s to about 86,000 mPa·s, optionally from about 86,000 mPa·s to about 87,000 mPa·s, optionally from about 87,000 mPa·s to about 88,000 mPa·s, optionally from about 88,000 mPa·s to about 89,000 mPa·s, optionally from about 89,000 mPa·s to about 90,000 mPa·s, optionally from about 90,000 mPa·s to about 91,000 mPa·s, optionally from about 91,000 mPa·s to about 92,000 mPa·s, optionally from about 92,000 mPa·s to about 93,000 mPa·s, optionally from about 93,000 mPa·s to about 94,000 mPa·s, optionally from about 94,000 mPa·s to about 95,000 mPa·s, optionally from about 95,000 mPa·s to about 96,000 mPa·s, optionally from about 96,000 mPa·s to about 97,000 mPa·s, optionally from about 97,000 mPa·s to about 98,000 mPa·s, optionally from about 98,000 mPa·s to about 99,000 mPa·s, optionally from about 99,000 mPa·s to about 100,000 mPa·s.

Increased viscosity provided by the milled form of paramylon form is due to the increase in availability of hydroxyl groups available to bind to water. As well, these molecules disperse in a solution and increase the viscosity of the solution. In another embodiment, the food product with increased viscosity is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, a soup, a dumpling, a gravy, a pasta, a jelly, or a cake product. In an embodiment, paramylon increases viscosity of the food product by about 200 mPa·s to about 70,000 mPa·s at 25° C., optionally from about 200 mPa·s, about 250 mPa·s, about 300 mPa·s, about 350 mPa·s, about 450 mPa·s, or about 500 mPa·s, to about 550 mPa·s, about 600 mPa·s, about 650 mPa·s, about 700 mPa·s, about 750 mPa·s, about 800 mPa·s, about 850 mPa·s, about 900 mPa·s, about 950 mPa·s, about 1000 mPa·s, about 1050 mPa·s, about 1100 mPa·s, about 1150 mPa·s, about 1200 mPa·s, about 1250 mPa·s, about 1300 mPa·s, about 1350 mPa·s, about 1400 mPa·s, about 1450 mPa·s, about 1500 mPa·s, about 1550 mPa·s, about 1600 mPa·s, about 1650 mPa·s, about 1700 mPa·s, about 1750 mPa·s, about 1800 mPa·s, about 1850 mPa·s, about 1900 mPa·s, about 1950 mPa·s, about 2000 mPa·s at 25° C., about 2100 mPa·s at 25° C., about 2200 mPa·s at 25° C., about 2300 mPa·s at 25° C., about 2400 mPa·s at 25° C., about 2500 mPa·s at 25° C., about 2600 mPa·s at 25° C., about 2700 mPa·s at 25° C., about 2800 mPa·s at 25° C., about 2900 mPa·s at 25° C., about 3000 mPa·s at 25° C., about 3100 mPa·s at 25° C., about 3200 mPa·s at 25° C., about 3300 mPa·s at 25° C., about 3400 mPa·s at 25° C., about 3500 mPa·s at 25° C., about 3600 mPa·s at 25° C., about 3700 mPa·s at 25° C., about 3800 mPa·s at 25° C., about 3900 mPa·s at 25° C., about 4000 mPa·s at 25° C., about 4100 mPa·s at 25° C., about 4200 mPa·s at 25° C., about 4300 mPa·s at 25° C., about 4400 mPa·s at 25° C., about 4500 mPa·s at 25° C., about 4600 mPa·s at 25° C., about 4700 mPa·s at 25° C., about 4800 mPa·s at 25° C., about 4900 mPa·s at 25° C., about 5000 mPa·s at 25° C., about 5100 mPa·s at 25° C., about 5200 mPa·s at 25° C., about 5300 mPa·s at 25° C., about 5400 mPa·s at 25° C., about 5500 mPa·s at 25° C., about 5600 mPa·s at 25° C., about 5700 mPa·s at 25° C., about 5800 mPa·s at 25° C., about 5900 mPa·s at 25° C., about 6000 mPa·s at 25° C., about 6100 mPa·s at 25° C., about 6200 mPa·s at 25° C., about 6300 mPa·s at 25° C., about 6400 mPa·s at 25° C., about 6500 mPa·s at 25° C., about 6600 mPa·s at 25° C., about 6700 mPa·s at 25° C., about 6800 mPa·s at 25° C., about 6900 mPa·s at 25° C., about 7000 mPa·s at 25° C., about 7100 mPa·s at 25° C., about 7200 mPa·s at 25° C., about 7300 mPa·s at 25° C., about 7400 mPa·s at 25° C., about 7500 mPa·s at 25° C., about 7600 mPa·s at 25° C., about 7700 mPa·s at 25° C., about 7800 mPa·s at 25° C., about 7900 mPa·s at 25° C., about 8000 mPa·s at 25° C., about 8100 mPa·s at 25° C., about 8200 mPa·s at 25° C., about 8300 mPa·s at 25° C., about 8400 mPa·s at 25° C., about 8500 mPa·s at 25° C., about 8600 mPa·s at 25° C., about 8700 mPa·s at 25° C., about 8800 mPa·s at 25° C., about 8900 mPa·s at 25° C., about 9000 mPa·s at 25° C., about 9100 mPa·s at 25° C., about 9200 mPa·s at 25° C., about 9300 mPa·s at 25° C., about 9400 mPa·s at 25° C., about 9500 mPa·s at 25° C., about 9600 mPa·s at 25° C., about 9700 mPa·s at 25° C., about 9800 mPa·s at 25° C., about 9900 mPa·s at 25° C., about 10,000 mPa·s at 25° C., about 11,000 mPa·s at 25° C., about 12,000 mPa·s at 25° C., about 13,000 mPa·s at 25° C., about 14,000 mPa·s at 25° C., about 15,000 mPa·s at 25° C., about 16,000 mPa·s at 25° C., about 17,000 mPa·s at 25° C., about 18,000 mPa·s at 25° C., about 19,000 mPa·s at 25° C., about 20,000 mPa·s at 25° C., about 2,000 mPa·s at 25° C., about 22,000 mPa·s at 25° C., about 23,000 mPa·s at 25° C., about 24,000 mPa·s at 25° C., about 25,000 mPa·s at 25° C., about 26,000 mPa·s at 25° C., about 27,000 mPa·s at 25° C., about 28,000 mPa·s at 25° C., about 29,000 mPa·s at 25° C., about 30,000 mPa·s at 25° C., about 31,000 mPa·s at 25° C., about 32,000 mPa·s at 25° C., about 33,000 mPa·s at 25° C., about 34,000 mPa·s at 25° C., about 35,000 mPa·s at 25° C., about 36,000 mPa·s at 25° C., about 37,000 mPa·s at 25° C., about 38,000 mPa·s at 25° C., about 39,000 mPa·s at 25° C., about 40,000 mPa·s at 25° C., about 41,000 mPa·s at 25° C., about 42,000 mPa·s at 25° C., about 43,000 mPa·s at 25° C., about 44,000 mPa·s at 25° C., about 45,000 mPa·s at 25° C., about 46,000 mPa·s at 25° C., about 47,000 mPa·s at 25° C., about 48,000 mPa·s at 25° C., about 49,000 mPa·s at 25° C., about 50,000 mPa·s at 25° C., about 51,000 mPa·s at 25° C., about 52,000 mPa·s at 25° C., about 53,000 mPa·s at 25° C., about 54,000 mPa·s at 25° C., about 55,000 mPa·s at 25° C., about 56,000 mPa·s at 25° C., about 57,000 mPa·s at 25° C., about 58,000 mPa·s at 25° C., about 59,000 mPa·s at 25° C., about 60,000 mPa·s at 25° C., about 61,000 mPa·s at 25° C., about 62,000 mPa·s at 25° C., about 63,000 mPa·s at 25° C., about 64,000 mPa·s at 25° C., about 65,000 mPa·s at 25° C., about 66,000 mPa·s at 25° C., about 67,000 mPa·s at 25° C., about 68,000 mPa·s at 25° C., about 69,000 mPa·s at 25° C., about 70,000 mPa·s at 25° C. In an embodiment, the food product is a non-dairy creamer. In an embodiment, the viscosity of the non-dairy creamer is from about 200 mPa·s to about 70,000 mPa·s, optionally from about 200 mPa·s to about 1200 mPa·s, optionally from about 400 mPa·s to about 1400 mPa·s, optionally from about 600 mPa·s to about 1600 mPa·s, optionally from about 800 mPa·s to about 1800 mPa·s, optionally from about 1000 mPa·s to about 2000 mPa·s, optionally from about 1500 mPa·s to about 2000 mPa·s, optionally from about 2000 mPa·s to about 2500 mPa·s, optionally from about 2500 mPa·s to about 3000 mPa·s, optionally from about 3000 mPa·s to about 3500 mPa·s, optionally from about 3500 mPa·s to about 4000 mPa·s, optionally from about 4000 mPa·s to about 4500 mPa·s, optionally from about 4500 mPa·s to about 5000 mPa·s, optionally from about 5000 mPa·s to about 5500 mPa·s, optionally from about 5000 mPa·s to about 6500 mPa·s, optionally from about 6500 mPa·s to about 7000 mPa·s, optionally from about 7000 mPa·s to about 7500 mPa·s, optionally from about 7500 mPa·s to about 8000 mPa·s, optionally from about 8000 mPa·s to about 8500 mPa·s, optionally from about 8500 mPa·s to about 9000 mPa·s, optionally from about 9000 mPa·s to about 9500 mPa·s, optionally from about 9500 mPa·s to about 10,000 mPa·s, optionally from about 10,000 mPa·s to about 11,000 mPa·s, optionally from about 11,000 mPa·s to about 12,000 mPa·s, optionally from about 12,000 mPa·s to about 13,000 mPa·s, optionally from about 13,000 mPa·s to about 14,000 mPa·s, optionally from about 14,000 mPa·s to about 15,000 mPa·s, optionally from about 15,000 mPa·s to about 16,000 mPa·s, optionally from about 16,000 mPa·s to about 17,000 mPa·s, optionally from about 17,000 mPa·s to about 18,000 mPa·s, optionally from about 18,000 mPa·s to about 19,000 mPa·s, optionally from about 19,000 mPa·s to about 20,000 mPa·s, optionally from about 20,000 mPa·s to about 21,000 mPa·s, optionally from about 21,000 mPa·s to about 22,000 mPa·s, optionally from about 22,000 mPa·s to about 23,000 mPa·s, optionally from about 23,000 mPa·s to about 24,000 mPa·s, optionally from about 24,000 mPa·s to about 25,000 mPa·s, optionally from about 25,000 mPa·s to about 26,000 mPa·s, optionally from about 26,000 mPa·s to about 27,000 mPa·s, optionally from about 27,000 mPa·s to about 28,000 mPa·s, optionally from about 28,000 mPa·s to about 29,000 mPa·s, optionally from about 29,000 mPa·s to about 30,000 mPa·s, optionally from about 30,000 mPa·s to about 31,000 mPa·s, optionally from about 31,000 mPa·s to about 32,000 mPa·s, optionally from about 32,000 mPa·s to about 33,000 mPa·s, optionally from about 33,000 mPa·s to about 34,000 mPa·s, optionally from about 34,000 mPa·s to about 35,000 mPa·s, optionally from about 35,000 mPa·s to about 36,000 mPa·s, optionally from about 36,000 mPa·s to about 37,000 mPa·s, optionally from about 37,000 mPa·s to about 38,000 mPa·s, optionally from about 38,000 mPa·s to about 39,000 mPa·s, optionally from about 39,000 mPa·s to about 40,000 mPa·s, optionally from about 40,000 mPa·s to about 41,000 mPa·s, optionally from about 41,000 mPa·s to about 42,000 mPa·s, optionally from about 42,000 mPa·s to about 43,000 mPa·s, optionally from about 43,000 mPa·s to about 44,000 mPa·s, optionally from about 44,000 mPa·s to about 45,000 mPa·s, optionally from about 45,000 mPa·s to about 46,000 mPa·s, optionally from about 46,000 mPa·s to about 47,000 mPa·s, optionally from about 47,000 mPa·s to about 48,000 mPa·s, optionally from about 48,000 mPa·s to about 49,000 mPa·s, optionally from about 49,000 mPa·s to about 50,000 mPa·s, optionally from about 50,000 mPa·s to about 51,000 mPa·s, optionally from about 51,000 mPa·s to about 52,000 mPa·s, optionally from about 52,000 mPa·s to about 53,000 mPa·s, optionally from about 53,000 mPa·s to about 54,000 mPa·s, optionally from about 54,000 mPa·s to about 55,000 mPa·s, optionally from about 55,000 mPa·s to about 56,000 mPa·s, optionally from about 56,000 mPa·s to about 57,000 mPa·s, optionally from about 57,000 mPa·s to about 58,000 mPa·s, optionally from about 58,000 mPa·s to about 59,000 mPa·s, optionally from about 59,000 mPa·s to about 60,000 mPa·s, optionally from about 60,000 mPa·s to about 61,000 mPa·s, optionally from about 61,000 mPa·s to about 62,000 mPa·s, optionally from about 62,000 mPa·s to about 63,000 mPa·s, optionally from about 63,000 mPa·s to about 64,000 mPa·s, optionally from about 64,000 mPa·s to about 65,000 mPa·s, optionally from about 65,000 mPa·s to about 66,000 mPa·s, optionally from about 66,000 mPa·s to about 67,000 mPa·s, optionally from about 67,000 mPa·s to about 68,000 mPa·s, optionally from about 68,000 mPa·s to about 69,000 mPa·s, optionally from about 69,000 mPa·s to about 70,000 mPa·s.

The paramylon disclosed herein is also useful for emulsifying a food product. Paramylon acts as an emulsifying agent by binding to both oil and water forcing them into proximity, as opposed to separating into two phases. Emulsification of a food product can be determined by measuring emulsifying activity, which is a numerical expression relating to the amount of water and oil that can be emulsified by a given ingredient at a given concentration. Emulsification activity is measured by combining a set amount of oil and water, in the presence of a set amount of emulsifier, homogenizing the mixture, allowing phase separation and then calculating the ratio of the emulsified phase volume to the total mixture volume. For example, emulsifying activity index (EAI) of β-lactoglobulin was determined by a turbidimetric procedure in which two milliliters of a β-lactoglobulin solution (1%, w/v) and 0.5 ml of soybean oil were mixed and homogenized at 30° C. for 3 min by a Polytron PTA-7 (Kinematica, Switzerland) at maximum speed. An aliquot (0.5 ml) of the emulsion was diluted with a 0.1% sodium dodecyl sulfate solution and its turbidity was measured at 500 nm. Alternatively, emulsion activity can be calculated by taking a known amount of test ingredient with water and oil followed by homogenization, for example, at 10,000 rpm for one min, and centrifugation, for example, at 1,300×g for 5 min in a measurable centrifuge tube. Emulsion activity (EA) is calculated as EA=100×(height of emulsified layer (in mm)/total height of mixture in test tube (in mm)). A higher number indicates a larger emulsion has been formed. Emulsification activity can also be determined by measuring the particle size distribution of dispersed phase. Smaller droplets of more uniform size means better emulsion and vice versa. Droplet size can be determined by Beckmann coulter counter particle size analyzer or other laser diffraction instruments such as mastersizer S (Malvern instruments, Malvern, UK). In another aspect, the present disclosure includes a method of emulsifying a food product, comprising adding paramylon from Euglena sp. having purity of at least about 70% to the food product, wherein the paramylon comprises from about 0.1% to about 1% (w/v) granule form, elongated form, swollen form, shell form, soluble form, or combination thereof. In an embodiment, the emulsifying comprises maintaining the food product having paramylon at pH from about 3 to about 9. In an embodiment, the emulsifying comprises maintaining the food product temperature between about −40° C. and about 100° C.

In another aspect, the disclosure relates to a method of emulsifying a food product, comprising
combining paramylon from Euglena sp. having purity of at least about 70% with a food composition to form the food product, and
homogenizing the food product,
wherein the paramylon is between about 0.1% and about 50% (w/w) of the food product, and optionally wherein the emulsified food product is stable for up to six months,
thereby emulsifying the food product to form an emulsified food product.

In an embodiment, the emulsifying a food product comprises the paramylon in elongated and/or shell form.

The paramylon disclosed herein is useful for whitening a food product. Paramylon granules are useful as a whitening agent in food matrices such as a creamer and icing to increase the perceived whiteness of these products, countering the yellowing caused by other ingredients in these foods. The whitening property of paramylon can be measured by refractive index of paramylon itself, or changes in refractive index of a food product before and after treatment by paramylon. The refractive index is ratio of speed of light in a vacuum over the speed of light in a measured substance. A refractometer such as a hand-held refractometer can be used to measure the refractive index, where a diluted sample is placed on the meter, light is passed through the sample whereby the light direction is changed, and the angle at which the light is bent is detected and used to calculate the refractive index according to Snell's law. A higher number indicates a higher refractive index. High refractive index indicates that light is being scattered more, and which in turns looks more white to human eyes, as long as all visible wavelengths of light (450 nm-700 nm) are bent nearly equally. If a visual spectrum light was not reflected, then the object would appear as the colour corresponding to the wavelength. Therefore, having a high refractive index indicates that there is more scattering of the light, and the object appears whiter. For example, titanium dioxide has a high refractive index at 2.4-2.6. Particle size of paramylon, for example after spray drying and/or milling, can also affect the refractive index, as smaller particles increase the scattering. The skilled person also readily recognizes that Whiteness Index (WI) is used to yield numbers correlating closely with consumers preferences for white colours and can also represent the extent of discolouration in foods. WI can be measured using CIELAB (Commission Internationale de I'Eclairage L, a, b) colour space, which is a colour space defined by the International Commission on Illumination (CIE) in 1976. WI mathematically combines lightness and yellow-blue into a single item, and is represented as:

WI=100−(√((100˜L²)+a²+b²))

L is the lightness variable, which represents the degree of greyness and thus corresponds to brightness as well. A high L indicates a high whiteness or high brightness. a and b are chromaticity coordinates. a represents the red-green axis, and b represents the blue-yellow axis. CIELAB was designed to be perceptually uniform with respect to human colour vision, such that the same amount of numerical change in these values corresponds to about the same amount of visually perceived change.

For comparison, TiO₂ whitening can be measured and reported in cream/icing form and used as a benchmark in comparing relative whiteness. The paramylon has a refractive index between about 1.3 and about 2.6 at λ=about 589 nm.

In another aspect, the disclosure relates to a method of forming a whitened food product, comprising:
combining paramylon from Euglena sp. having purity of at least about 70% with a food composition to form a food product,
wherein the paramylon is between about 0.1% and about 50% (w/w) of the food product,
wherein the paramylon comprises granule form paramylon, and
wherein the paramylon has a refractive index between about 1.3 and about 2.6 at λ=about 589 nm,
thereby whitening the food product to form the whitened food product.

In an embodiment, the paramylon is spray dried. In an embodiment, the paramylon increases the refractive index of the food product by between about 0.1 and about 1 at λ=about 589 nm. In an embodiment, the whitened food product is a dairy product, a dairy substitute product, a confectionary product, or a drink product. In an embodiment, the whitened food product is a creamer, a yogurt, an ice cream, a whipped cream, a pudding, a powdered milk base product, a cheese, a cream cheese, a sour cream, a low fat dairy product, a non-dairy creamer, a non-dairy ice cream, a non-dairy yogurt, a non-dairy whipped cream, a non-dairy pudding, a non-dairy milk base product, a non-dairy cream, a non-dairy sour cream, a low fat non-dairy food product, a chocolate with a hard coating, a chocolate without a hard coating, a hard candy, a soft gummy candy, a marshmallows, an icing, a fondant, a jelly bean, a flavoured syrup, a chocolate syrup, a protein shake, a meal replacement shake.

The paramylon disclosed herein is also useful for water binding a food product. Water binding of paramylon refers to Water Holding Capacity (WHC), i.e. the amount of water on a mass or volume basis that can be retained by a given mass or volume of material. WHC can be measured via gravity-based drip method known in the art or by applying force, for example, via low-pressure centrifugation or rapid paper filter method. These methods quantify how much water separates from, for example, a paramylon gel, either over time with drip or instantly post-centrifugation. For example, WHC can be determined by measuring the amount of water required per amount of paramylon to make a paramylon gel, and the amount of syneresis, i.e. the water expelled out over time, which occurs when liquid weeps out of a gel over time (for example, as happens in custards). A comparison group may be agar, as it is prone to syneresis, as water can be expelled by pressing on it. Some gels only experience syneresis after long periods of time. If a gel is susceptible to damage by freezing, it tends to weep when thawed. Within a given hydrocolloid system, harder gels tend to weep more than softer ones. Alternatively, WHC can be determined by constructing a moisture sorption isotherm, i.e., water activity versus moisture content. In another aspect, the present disclosure includes a method of increasing water binding in a food product, comprising adding paramylon from Euglena sp. having purity of at least about 70% to the food product, wherein the paramylon comprises from about 0.1% to about 5% (w/v) granule form, from about 0.1% to about 5% (w/v) swollen form, and/or from about 0.1% to about 5% (w/v) elongated form, and wherein the paramylon has a water holding capacity between about 1.10 g to 1.30 g water per g paramylon.

In another aspect, the disclosure relates to a method of increasing water binding in a food product, comprising
combining paramylon from Euglena sp. having purity of at least about 70%, with a food composition to form the food product,
wherein the paramylon comprises granule form, swollen form, shell form and/or elongated form, and
wherein the paramylon has a water holding capacity between about 0.70 g to 1.50 g water per g paramylon, optionally 1.10 g to 1.30 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises milled form, and
wherein the paramylon has a water holding capacity between about 3 g and about 7.8 g water per g paramylon, optionally between about 4.40 g and about 6.4 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises gelled form, wherein the gel has been formed with HCl, and
wherein the paramylon has a water holding capacity between about 6 g and about 10 g water per g paramylon, optionally between about 7 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises gelled form, wherein the gel has been formed with calcium chloride, and
wherein the paramylon has a water holding capacity between about 6 g and about 10 g water per g paramylon, optionally between about 7.4 g water per g paramylon,
thereby forming the food product with increased water binding.

In another aspect, the disclosure relates to a method of increasing water binding in a food product, comprising
combining paramylon from Euglena sp. having purity of at least about 70%, with a food composition to form the food product,
wherein the paramylon comprises gelled form, wherein the gel has been formed with calcium chloride, and
wherein the paramylon has a water holding capacity between about 5 g and about 15 g water per g paramylon, optionally between about 7.70 g and about 13.5 g water per g paramylon,

thereby forming the food product with increased water binding

In an embodiment, the food product with increased water binding is selected from the group consisting of a bakery product, a dairy product, a dairy substitute product, a drink product, a meat product, a protein substitute product, and a sauce. In an embodiment, the food product is selected for the group consisting of a toasted pastry products, a donut, a muffin, a cookie, a cake product, a protein bar, a granola bar, a creamer, a yogurt, an ice cream, a whipped cream, a pudding, a powdered milk base product, a cheese, a cream cheese, a protein shake, a meal replacement shake, a meat casing, a sausages such as a pork, a beef, a chicken, or a turkey sausage, a patty such as a beef, a chicken, a pork, or a turkey sausage, a ground meat such as a beef, a chicken, a pork, or a turkey sausage, a protein substitute product such as a chicken meat substitute, a beef substitute, a pork substitute, a turkey meat substitute, an egg substitute, an egg protein substitute, a soy protein substitute, or a pea protein substitute, a salad dressing, a mayonnaise, a ketchup, a mustard, a tomato pasta sauce, a tomato sauce, a vinaigrette, a marinade, a BBQ sauce, a gravy and any product described herein.

Ice formation in ice cream provides an undesirable texture. Paramylon granules when added to an ice cream can disrupt the ice crystal formation of the water by, for example, exclusion and increased water holding capacity. To monitor ice formation in an ice cream matrix comprising paramylon, ice crystal size can be measured microscopically by a light microscope for example, EVOS by life technologies, and then over time, such as keeping it in the −20° C. freezer for 1 day, 3 days, 5 days, 7 days 14 days, 21 days, 28 days, 3 months and 6 months to determine the size of the ice crystal over time. Ice crystal size in ice cream may range from 1 micron to 150 microns, with average tending to be 25 microns. Microns smaller than 50 microns are desirable because these are reported as maintaining a smooth texture, whereas if significant amounts of crystals larger than 50 microns are present the texture is gritty. An ice cream comprising paramylon can have fewer and small ice crystal formation. In an embodiment, an ice cream matrix comprising paramylon having ice crystal ranges from about 1 micron to about 150 microns, optionally from about 5 microns to about 125 microns, optionally from about 10 microns to about 100 microns, optionally from about 10 microns to about 75 microns, optionally from about 10 microns to about 50 microns, optionally from about 1 micron to about 30 microns, optionally on average of about 10 microns, about 15 microns, about 20 microns, about 25 microns, about 30 microns, about 35 microns, about 40 microns, about 45 microns or about 50 microns, optionally less than about 50 microns, less than about 45 microns, less than about 40 microns, less than about 35 microns, less than about 30 microns, less than about 25 microns, less than about 20 microns, less than about 15 microns, less than about 10 microns, less than about 9 microns, less than about 8 microns, less than about 7 microns, less than about 6 microns, less than about 5 microns, less than about 4 microns, less than about 3 microns, less than about 2 microns, or less than about 1 micron, optionally less than about 50 microns, optionally less than about 25 microns, optionally less than about 10 microns, optionally less than about 5 microns.

The paramylon disclosed herein is also useful for sweetening a food product, when after liberation of small chains of glucose oligomer units, for example, after hydrolysis, these glucose units are able to bind to human sugar receptors on the tongue. Sweetening effect of paramylon or hydrolyzed paramylon can be determined by reference to, for example, a 1 to 10% sucrose solution which is standard for food industry. Sucrose given a rating of 1.0, and impact of sweetening is determined as initial sweetening, sustainable sweetening, and late sweetening impact. pH is known to impact sweetening effect. Paramylon or hydrolyzed paramylon may be screened against sucrose in a solution for parity or for defining sweetness index.

Paramylon hydrolysis can be carried out by enzymes or acid. In enzymatic hydrolysis for obtaining glucose oligomers, paramylon granules are added to deionized water to a final concentration of, for example, 1% (w/v), or any other concentration disclosed herein, and incubated with a beta-glucanase, for example, an endo-beta-1,3-glucanase or an exo-beta-1,3-glucanase, in sequence or in combination. The endo-beta-1,3-glucanase can be in a concentration of, for example, 0.2 U/mL in a suitable buffer, for example, 100 mM sodium acetate buffer at pH 5.0. The digestion, for example, can be carried out for about 16 to 24 hours at 40° C. with stirring. If using an exo-beta-1,3-glucanase, the incubation can be, for example, at a concentration of 200 U/mL in ultrapure water at 25° C., for example, for 24 hours with stirring. If the hydrolysis is for obtaining glucose monomers, beta-glucosidase can be used. For example, 5 U/mL beta-glucosidase in a suitable buffer, for example, 100 mM sodium acetate buffer at pH 5.0, for about 16 to 24 hours at 40° C. with stirring. Hydrolysis of paramylon can be increased if the paramylon granules are microwaved in water prior to enzyme addition. For example, microwaving can be carried out at 170° C. for 2 min. Glucose oligomers from the reaction mixtures can be recovered using a cation-exchange resin, such as 200-400 mesh resin in a Strata-X 33u polymeric reversed phase column. The recovered glucose oligomers can be vacuum evaporated. The size of the glucose oligomers obtained from the enzymatic reaction can be measured by High Performance Liquid Chromatography (HPLC), for example, using an HPLC system equipped with refractive index detector and an Ultraspherogel SEC-4000 column. For smaller glucose oligomers, such as less than 10 glucose units, a Hi-Plex Na column can be used. Enzymatically treated paramylon samples can be compared to standard solutions containing known lengths of glucose oligomers, to determine the size of hydrolyzed paramylon in the sample. In the alternative, acid can be used to hydrolyze the paramylon into different sized glucose oligomers. In this method, for example, a 1% (w/v) mixture of paramylon granules in concentrated hydrochloric acid is incubated at 50° C. for up to 5 hours or 8 hours, optimally with vigorous stirring. Concentrated hydrochloric acid can be about 36% to about 40% (w/w) hydrochloric acid, or about 11.6M to about 23M. The resulting sizes of hydrolyzed paramylon can be determined using HPLC as above. The range of sizes of the glucose oligomers can include 2-38 glucose units, or 2-10 glucose units. Specific sizes of glucose oligomers of various number of glucose units can be isolated by size exclusion chromatography.

In another aspect, the disclosure relates to a method of sweetening a food product, comprising
combining a hydrolyzed paramylon to a food composition to form the food product,
wherein the hydrolyzed paramylon comprises hydrolyzed paramylon from Euglena sp. that is enriched with glucose oligomers, and
wherein the paramylon has purity of at least about 70%,
thereby sweetening the food product to form a sweetened food product.

In an embodiment, the food product comprises between about 0.1%, about 0.2%, about 0.3%, about 0.4%, about 0.5%, about 1%, about 2%, about 2.5%, about 3%, about 4%, or about 5%, and about 6%, about 7%, about 8%, about 9%, about 10%, about 15%, about 20%, about 25%, about 30%, about 35%, about 40%, about 45%, or about 50% (w/w) hydrolyzed paramylon, optionally between about 0.1% and about 50% (w/w), optionally between about 0.1% and about 20% (w/w), optionally between about 0.1% and about 10% (w/w), optionally between about 0.1% and about 10% (w/w), optionally between 0.1% and about 10% (w/w), optionally between about 0.1% and about 10% (w/w), optionally between about 10% and about 20% (w/w), optionally between 20% and about 30% (w/w), optionally between about 30% and about 40% (w/w), optionally between about 40% and about 50% (w/w), optionally between about 0.1% and about 25% (w/w), optionally between about 25% and about 50% (w/w), optionally between about 0.1% and about 5% (w/w), optionally between about 5% and about 50% (w/w). In an embodiment, the hydrolyzed paramylon from Euglena sp. that is enriched with glucose oligomers comprises from about 50%, about 55%, about 60%, or about 65%, to about 70%, about 75%, about 80%, about 85%, or about 90% (w/w) glucose oligomers, optionally between about 50% and about 90% (w/w), optionally between about 60% and about 90% (w/w), optionally between about 70% and about 90% (w/w), optionally between about 80% and about 90% (w/w), optionally at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or about 100% (w/w). In an embodiment, the hydrolyzed paramylon comprises glucose oligomers having between two to ten units. In an embodiment, the hydrolyzed paramylon is isolated by size exclusion chromatography.

In an embodiment, the hydrolysis of paramylon comprises treating the paramylon with a beta-glucanase at from about 37° C. to about 42° C., for about 16 h to about 24 h, optionally at about 40° C. for about 16 h, or from about from 20° C. to about 25° C., for about 16 h to about 24 h, optionally at about 25° C. for about 16 h, at a pH from about 3 to about 7, optionally a pH from about 4 to about 6, optionally at about pH 5. In an embodiment, the hydrolysis of paramylon comprises combining the beta-glucanase with a liquid, an aqueous solution or a buffer. In an embodiment, the beta-glucanase is an endo-glucanase, optionally an endo-beta-1,3-glucanase, or an exo-glucanase, optionally an exo-beta-1,3-glucanase. In an embodiment, the hydrolysis of paramylon comprises treating the paramylon with an endo-glucanase, optionally an endo-beta-1,3-glucanase, at from about 37° C. to about 42° C., for about 16 h to about 24 h, optionally at about 40° C. for about 16 h. In an embodiment, the hydrolysis of paramylon comprises treating the paramylon with an exo-glucanase, optionally an exo-beta-1,3-glucanase, at from about from 20° C. to about 25° C., for about 16 h to about 24 h, optionally at about 25° C. for about 16 h, at a pH from about 3 to about 7, optionally a pH from about 4 to about 6, optionally at about pH 5. In an embodiment, the endo-glucanase is in a concentration from about 0.02 U/mL to about 2 U/mL, optionally from about 0.05 U/mL to about 0.5 U/mL, optionally about 0.2 U/mL. In an embodiment, the exo-glucanase is in a concentration from about 20 U/mL to about 2000 U/mL, optionally from about 50 U/mL to about 500 U/mL, optionally about 200 U/mL. In an embodiment, the hydrolysis of paramylon further comprises treating the paramylon with a chitinase. In an embodiment, the hydrolysis of paramylon comprises treating the paramylon with an acid, optionally a concentrated hydrochloric acid, optionally hydrochloric acid from about 36% to about 40% (w/w), optionally hydrochloric acid from about 11.6M to about 23M, at a temperature from about 45° C. to about 55° C., optionally from about 47° C. to about 53° C., optionally from about 49° C. to about 51° C., optionally about 50° C., for about 1 h to about 8 h, optionally from about 2 h to about 8 h, optionally from about 3 h to about 8 h, optionally from about 4 h to about 8 h, optionally from about 5 h to about 8 h, optionally from about 4 h to about 6 h, optionally for about 1 h, optionally for about 1.5 h, optionally for about 2 h, optionally for about 2.5 h, optionally for about 3 h, optionally for about 4 h, optionally for about 4.5 h, optionally for about 5 h, optionally for about 5.5 h, optionally for about 6 h, optionally for about 6.5 h, optionally for about 7 h, optionally for about 7.5 h, optionally for about 8 h. In an embodiment, the paramylon is microwaved prior to treating with a beta-glucanase. In an embodiment, the microwaving is from about 130° C. to about 210° C. for about 30 s to about 4 min, optionally for about 1 min to about 3 min, optionally from about 150° C. to about 190° C. for about 30 s to about 4 min, optionally for about 1 min to about 3 min, optionally about 170° C. for about 2 min. In an embodiment, the hydrolyzed paramylon comprises a glucose oligomer having two to thirty-eight glucose units, optionally two to ten glucose units. In an embodiment, the hydrolysis of paramylon comprises treating the paramylon with a beta-glucosidase, at from about 37° C. to about 42° C., for about 16 h to about 24 h, optionally at about 40° C. for about 16 h. In an embodiment, the hydrolysis of paramylon comprises stirring or vigorous stirring. In an embodiment, the hydrolyzed paramylon comprises glucose monomers. In an embodiment, the length of the glucose oligomer is determined by High Performance Liquid Chromatography (HPLC).

In an embodiment, the food product is a drink product or a custard product. In an embodiment, the food product is selected from the group consisting of a drink crystal, a trifle, a custard, a pudding, and any food product described here.

The methods described herein involving paramylon can be applied to a range of food products. In an embodiment, the method of forming a gelatinous food product, the method of increasing viscosity of a food product, the method of forming a whitened food product, the method of increasing water binding in a food product, the method of emulsifying a food product, the method of sweetening a food product, or any methods described herein for modifying a food product, comprises a food product selected from the group consisting of a functional food product, a dairy product, a dairy substitute product, a bakery product, a confectionery product, a sauce, a drink product, a drink mix product, a meat product, a protein substitute product, a spreadable food stuff product, a savory product, and a custard product. In another embodiment, the method of forming a gelatinous food product, the method of increasing viscosity of a food product, the method of forming a whitened food product, the method of increasing water binding in a food product, the method of emulsifying a food product, the method of sweetening a food product, or any methods described herein for modifying a food product, comprises a creamer, a yogurt, an ice cream, a whipped cream, a pudding, a powdered milk base product, a cheese, a cream cheese, a sour cream, a low fat dairy product, a non-dairy creamer, a non-dairy ice cream, a non-dairy yogurt, a non-dairy whipped cream, a non-dairy pudding, a non-dairy milk base product, a non-dairy cream, a non-dairy sour cream, a low fat non-dairy food product, a chocolate with a hard coating, a chocolate without a hard coating, a hard candy, a soft gummy candy, a marshmallows, an icing, a fondant, a jelly bean, a flavoured syrup, a chocolate syrup, a protein shake, a meal replacement shake, a toasted pastry products, a donut, a muffin, a cookie, a cake product, a protein bar, a granola bar, a meat casing, a sausages such as a pork, a beef, a chicken, or a turkey sausage, a patty such as a beef, a chicken, a pork, or a turkey sausage, a ground meat such as a beef, a chicken, a pork, or a turkey sausage, a protein substitute product such as a chicken meat substitute, a beef substitute, a pork substitute, a turkey meat substitute, an egg substitute, an egg protein substitute, a soy protein substitute, or a pea protein substitute, a salad dressing, a mayonnaise, a ketchup, a mustard, a tomato pasta, a tomato sauce, a vinaigrette, a marinade, a BBQ sauce, a gravy, a drink crystal, a jam, a jelly, a nut butter, a hard candy, a gummy candy such as a soft gummy candy, a fruit snack, a fruit gel bar, a gelatin substitute product, an aspic, a trifle, a custard, a pasta, a soup, a dumpling, any food product in Table 8, and any food product described herein.

The paramylon disclosed herein is also useful for encapsulating an oil with paramylon. The method relates to a process in which paramylon forms surrounding a core, for example, an oil, including a canola oil, a soybean oil, a sunflower oil, an olive oil, a palm oil, a safflower oil, a peanut oil, a sesame oil, a grapeseed oil, a cottonseed oil, an avocado oil, and an Euglena derived oil, and components in these oils include but not limited to medium-chain triglycerides (MCT), palmitic acid, omega-3 fatty acids eicosapentaenoic acid (EPA) and docosahexaenoic acid (DHA), and oleic acid. Microencapsulation of the core by paramylon gives useful effects, for example, to provide protection from, for example, oxidation, which is a reaction involving the loss of electrons, for example, where those electrons are lost via the formation of a new bond between the oxidized molecule and oxygen. The encapsulation of the oil or components therein can be measured by oxidative stability, which is defined as how much oxygen is exposed to the oil causing oxidization of the oil, i.e. measured as peroxide value. Higher number means the oil is more oxygenated. The peroxide values are expressed as mEq/Kg in the range of 0.1 to 30. For example, a value of greater than 2.5 is considered excessive oxidation, and the value following microencapsulation is preferably less than one.

In another aspect, the disclosure relates to a method of encapsulating an oil, comprising
combining paramylon from Euglena sp. having purity of at least about 70% with the oil to form a mixture,
homogenizing the mixture to form a homogenized mixture, and
spray drying the homogenized mixture,
wherein the molar ratio of paramylon to oil is from about 1:2 to about 1:100,
wherein the paramylon comprises granule form, swollen form, elongated form, and/or shell form paramylon, and
wherein the microencapsulation efficiency is at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, at least about 99%, or about 100%,
thereby encapsulating the oil to form an encapsulated oil.

In an embodiment, the oil is selected from the group consisting of a canola oil, a soybean oil, a sunflower oil, an olive oil, a palm oil, a safflower oil, a peanut oil, a sesame oil, a grapeseed oil, a cottonseed oil, an avocado oil, and an Euglena derived oil. In an embodiment, wherein the oil comprises medium-chain triglycerides (MCT), palmitic acid, omega-3 fatty acids eicosapentaenoic acid (EPA) and docosahexaenoic acid (DHA), or oleic acid. In an embodiment, the homogenizing comprises high pressure homogenizing. In an embodiment, the encapsulated oil has a peroxide value lower than the oil prior to encapsulation. In an embodiment, the encapsulated oil has a peroxide value of less than about 2.5 mEq/Kg, less than about 2 mEq/Kg, less than about 1.5 mEq/Kg, less than about 1.4 mEq/Kg, less than about 1.3 mEq/Kg, less than about 1.2 mEq/Kg, less than about 1.1 mEq/Kg, less than about 1 mEq/Kg, less than about 0.9 mEq/Kg, less than about 0.8 mEq/Kg, less than about 0.7 mEq/Kg, less than about 0.6 mEq/Kg, less than about 0.5 mEq/Kg, less than about 0.4 mEq/Kg, less than about 0.3 mEq/Kg, or less than about 0.2 mEq/Kg, optionally less than about 2.5 mEq/Kg, optionally less than about 1 mEq/Kg, optionally at about 0.1 mEq/Kg. In an embodiment, the encapsulated oil has a peroxide value of less than about 2.5 mEq/Kg.

In another embodiment, the encapsulated oil has a peroxide value of less than about 1 mEq/Kg.

In another aspect, the disclosure relates to a method for preparing a food additive comprising paramylon from Euglena sp., comprising
i) suspending Euglena biomass with aqueous solution, optionally water, to between 5-15% (w/w) solids, preferred 10% (w/w), optionally adjusting pH to between about 3 and about 10, optionally 4.5, homogenizing the resuspended Euglena biomass, optionally at between about 12 L/h and about 36 L/h, optionally at about 24 L/h,
ii) obtaining a homogenate target product comprising paramylon,
iii) collecting a second pellet containing paramylon by centrifugation, and
iv) washing the second pellet containing paramylon with aqueous solution, optionally water or base, by resuspending the second pellet, centrifuging the second pellet, and removing supernatant, optionally adjusted to pH between about 9 and about 11, optionally about 10,
wherein the iv) washing is repeated at least five times,
thereby forming the food additive.

In an embodiment, the homogenate target product is a paramylon pellet, optionally obtained by centrifugation.

In an embodiment, the method for preparing a food additive further comprises after ii), suspending the pellet in aqueous solution, optionally water, equal to between about 75% and about 125%, optionally between about 85 and about 115%, optionally between about 90% and about 110%, optionally between about 95% and about 105%, optionally about 100%, of weight of the biomass, with agitation at between about pH 9 and about pH 11, optionally between about pH 9 and about pH 11, optionally between about pH 9.5 and about pH 10.5, optionally between about pH 9.8 and about pH 10.2, optionally between about pH 9.9 and about pH 10.1, optionally about pH 10, optionally for about 10 min to about 1 hour, optionally about 10 min to about 20 min, optionally about 20 min and about 30 min, optionally about 30 min to about 40 min, optionally about 40 min to about 50 min, optionally about 50 min to about 60 min.

In any of the embodiments described herein, the Euglena sp. is selected from the group consisting of Euglena gracilis, Euglena sanguinea, Euglena deses, Euglena mutabilis, Euglena acus, Euglena virdis, Euglena anabaena, Euglena geniculata, Euglena oxyuris, Euglena proxima, Euglena tripteris, Euglena chlamydophora, Euglena splendens, Euglena texta, Euglena intermedia, Euglena polymorpha, Euglena ehrenbergii, Euglena adhaerens, Euglena clara, Euglena elongata, Euglena elastica, Euglena oblonga, Euglena pisciformis, Euglena cantabrica, Euglena granulata, Euglena obtusa, Euglena limnophila, Euglena hemichromata, Euglena variabilis, Euglena caudata, Euglena minima, Euglena communis, Euglena magnifica, Euglena terricola, Euglena velata, Euglena repulsans, Euglena clavata, Euglena lata, Euglena tuberculata, Euglena contabrica, Euglena ascusformis, Euglena ostendensis, and combinations thereof.

In any of the embodiments described herein, the food additive comprising paramylon from Euglena sp., wherein the paramylon has a purity of at least about 70%, wherein the paramylon is in granule form, swollen form, elongated form, shell form, solubilized form, or combination thereof, optionally the paramylon is substantially free of at least one of granule form, swollen form, elongated form, shell form, or solubilized form. In any of the embodiments described herein, the food additive is for use in gelling, thickening, emulsifying, whitening, water-binding, or sweetening a food product, optionally the paramylon is a dried powder, optionally in solution. In any of the embodiments described herein, the paramylon is a dried powder.

In an embodiment, the food additive is for use in forming a gelatinous food product.

In an embodiment, the food additive is for use in increasing viscosity a food product.

In an embodiment, the paramylon increases tensile strength of the food product by about 0 g/cm² to about 3000 g/cm² after maintaining a temperature at between about 0° C. and about 100° C., for about 2 min to about 2 h, at a pH of between about 2 and about 10, wherein the paramylon is between about 0.1% and about 50% (w/v) of the food product, optionally further comprising calcium chloride of between about 0.05% and about 1.5% (w/v), and wherein the food product is a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, a soup, a dumpling, a gravy a pasta, a jelly, or a cake product. In an embodiment, the paramylon has a hydrophilic-lipophilic balance (HLB) of from about 0, about 0, about 1, about 2, about 3, about 4, about 5, about 6, about 7, about 8, or about 9, to about 10, about 11, about 12, about 13, about 14, about 15, about 16, about 17, about 18, about 19, or about 20, optionally between about 0 and about 20, optionally between about 5 and about 15, optionally between about 0 and about 5, optionally between about 5 and about 10, optionally between about 10 and about 15, optionally between about 15 and about 20. In an embodiment, the paramylon increases viscosity of the food product by about 1 mPa·s to about 2000 mPa·s at 25° C., optionally from about 1 mPa·s, about 2 mPa·s, about 3 mPa·s, about 4 mPa·s, about 5 mPa·s, about 6 mPa·s, about 7 mPa·s, about 8 mPa·s, about 9 mPa·s, about 10 mPa·s, about 20 mPa·s, about 25 mPa·s, about 30 mPa·s, about 40 mPa·s, about 50 mPa·s, about 60 mPa·s, about 70 mPa·s, about 80 mPa·s, about 90 mPa·s, about 100 mPa·s, about 150 mPa·s, about 200 mPa·s, about 250 mPa·s, about 300 mPa·s, about 350 mPa·s, about 450 mPa·s, to about 550 mPa·s, about 600 mPa·s, about 650 mPa·s, about 700 mPa·s, about 750 mPa·s, about 800 mPa·s, about 850 mPa·s, about 900 mPa·s, about 950 mPa·s, about 1000 mPa·s, about 1050 mPa·s, about 1100 mPa·s, about 1150 mPa·s, about 1200 mPa·s, about 1250 mPa·s, about 1300 mPa·s, about 1350 mPa·s, about 1400 mPa·s, about 1450 mPa·s, about 1500 mPa·s, about 1550 mPa·s, about 1600 mPa·s, about 1650 mPa·s, about 1700 mPa·s, about 1750 mPa·s, about 1800 mPa·s, about 1850 mPa·s, about 1900 mPa·s, about 1950 mPa·s, about 2000 mPa·s at 25° C., about 2100 mPa·s at 25° C., about 2200 mPa·s at 25° C., about 2300 mPa·s at 25° C., about 2400 mPa·s at 25° C., about 2500 mPa·s at 25° C., about 2600 mPa·s at 25° C., about 2700 mPa·s at 25° C., about 2800 mPa·s at 25° C., about 2900 mPa·s at 25° C., about 3000 mPa·s at 25° C., about 3100 mPa·s at 25° C., about 3200 mPa·s at 25° C., about 3300 mPa·s at 25° C., about 3400 mPa·s at 25° C., about 3500 mPa·s at 25° C., about 3600 mPa·s at 25° C., about 3700 mPa·s at 25° C., about 3800 mPa·s at 25° C., about 3900 mPa·s at 25° C., about 4000 mPa·s at 25° C., about 4100 mPa·s at 25° C., about 4200 mPa·s at 25° C., about 4300 mPa·s at 25° C., about 4400 mPa·s at 25° C., about 4500 mPa·s at 25° C., about 4600 mPa·s at 25° C., about 4700 mPa·s at 25° C., about 4800 mPa·s at 25° C., about 4900 mPa·s at 25° C., about 5000 mPa·s at 25° C., about 5100 mPa·s at 25° C., about 5200 mPa·s at 25° C., about 5300 mPa·s at 25° C., about 5400 mPa·s at 25° C., about 5500 mPa·s at 25° C., about 5600 mPa·s at 25° C., about 5700 mPa·s at 25° C., about 5800 mPa·s at 25° C., about 5900 mPa·s at 25° C., about 6000 mPa·s at 25° C., about 6100 mPa·s at 25° C., about 6200 mPa·s at 25° C., about 6300 mPa·s at 25° C., about 6400 mPa·s at 25° C., about 6500 mPa·s at 25° C., about 6600 mPa·s at 25° C., about 6700 mPa·s at 25° C., about 6800 mPa·s at 25° C., about 6900 mPa·s at 25° C., about 7000 mPa·s at 25° C., about 7100 mPa·s at 25° C., about 7200 mPa·s at 25° C., about 7300 mPa·s at 25° C., about 7400 mPa·s at 25° C., about 7500 mPa·s at 25° C., about 7600 mPa·s at 25° C., about 7700 mPa·s at 25° C., about 7800 mPa·s at 25° C., about 7900 mPa·s at 25° C., about 8000 mPa·s at 25° C., about 8100 mPa·s at 25° C., about 8200 mPa·s at 25° C., about 8300 mPa·s at 25° C., about 8400 mPa·s at 25° C., about 8500 mPa·s at 25° C., about 8600 mPa·s at 25° C., about 8700 mPa·s at 25° C., about 8800 mPa·s at 25° C., about 8900 mPa·s at 25° C., about 9000 mPa·s at 25° C., about 9100 mPa·s at 25° C., about 9200 mPa·s at 25° C., about 9300 mPa·s at 25° C., about 9400 mPa·s at 25° C., about 9500 mPa·s at 25° C., about 9600 mPa·s at 25° C., about 9700 mPa·s at 25° C., about 9800 mPa·s at 25° C., about 9900 mPa·s at 25° C., about 10,000 mPa·s at 25° C., about 11,000 mPa·s at 25° C., about 12,000 mPa·s at 25° C., about 13,000 mPa·s at 25° C., about 14,000 mPa·s at 25° C., about 15,000 mPa·s at 25° C., about 16,000 mPa·s at 25° C., about 17,000 mPa·s at 25° C., about 18,000 mPa·s at 25° C., about 19,000 mPa·s at 25° C., about 20,000 mPa·s at 25° C., about 2,000 mPa·s at 25° C., about 22,000 mPa·s at 25° C., about 23,000 mPa·s at 25° C., about 24,000 mPa·s at 25° C., about 25,000 mPa·s at 25° C., about 26,000 mPa·s at 25° C., about 27,000 mPa·s at 25° C., about 28,000 mPa·s at 25° C., about 29,000 mPa·s at 25° C., about 30,000 mPa·s at 25° C., about 31,000 mPa·s at 25° C., about 32,000 mPa·s at 25° C., about 33,000 mPa·s at 25° C., about 34,000 mPa·s at 25° C., about 35,000 mPa·s at 25° C., about 36,000 mPa·s at 25° C., about 37,000 mPa·s at 25° C., about 38,000 mPa·s at 25° C., about 39,000 mPa·s at 25° C., about 40,000 mPa·s at 25° C., about 41,000 mPa·s at 25° C., about 42,000 mPa·s at 25° C., about 43,000 mPa·s at 25° C., about 44,000 mPa·s at 25° C., about 45,000 mPa·s at 25° C., about 46,000 mPa·s at 25° C., about 47,000 mPa·s at 25° C., about 48,000 mPa·s at 25° C., about 49,000 mPa·s at 25° C., about 50,000 mPa·s at 25° C., about 51,000 mPa·s at 25° C., about 52,000 mPa·s at 25° C., about 53,000 mPa·s at 25° C., about 54,000 mPa·s at 25° C., about 55,000 mPa·s at 25° C., about 56,000 mPa·s at 25° C., about 57,000 mPa·s at 25° C., about 58,000 mPa·s at 25° C., about 59,000 mPa·s at 25° C., about 60,000 mPa·s at 25° C., about 61,000 mPa·s at 25° C., about 62,000 mPa·s at 25° C., about 63,000 mPa·s at 25° C., about 64,000 mPa·s at 25° C., about 65,000 mPa·s at 25° C., about 66,000 mPa·s at 25° C., about 67,000 mPa·s at 25° C., about 68,000 mPa·s at 25° C., about 69,000 mPa·s at 25° C., about 70,000 mPa·s at 25° C., about 71,000 mPa·s at 25° C., about 72,000 mPa·s at 25° C., about 83,000 mPa·s at 25° C., about 74,000 mPa·s at 25° C., about 75,000 mPa·s at 25° C., about 76,000 mPa·s at 25° C., about 77,000 mPa·s at 25° C., about 78,000 mPa·s at 25° C., about 79,000 mPa·s at 25° C., about 80,000 mPa·s at 25° C., about 81,000 mPa·s at 25° C., about 82,000 mPa·s at 25° C., about 83,000 mPa·s at 25° C., about 84,000 mPa·s at 25° C., about 85,000 mPa·s at 25° C., about 86,000 mPa·s at 25° C., about 87,000 mPa·s at 25° C., about 88,000 mPa·s at 25° C., about 6899,000 mPa·s at 25° C., about 90,000 mPa·s at 25° C., about 91,000 mPa·s at 25° C., about 92,000 mPa·s at 25° C., about 93,000 mPa·s at 25° C., about 94,000 mPa·s at 25° C., about 95,000 mPa·s at 25° C., about 96,000 mPa·s at 25° C., about 97,000 mPa·s at 25° C., about 98,000 mPa·s at 25° C., about 99,000 mPa·s at 25° C., about 100,000 mPa·s at 25° C., optionally from about 1 mPa·s to about 500 mPa·s at 25° C., optionally from about 20 mPa·s to about 1000 mPa·s at 25° C., optionally from about 50 mPa·s to about 1500 mPa·s at 25° C., optionally from about 100 mPa·s to about 1000 mPa·s at 25° C., optionally from about 200 mPa·s to about 2000 mPa·s at 25° C., optionally from about 1000 mPa·s to about 2000 mPa·s at 25° C., optionally from about 1500 mPa·s to about 2000 mPa·s at 25° C., optionally from about 2000 mPa·s to about 2500 mPa·s at 25° C., optionally from about 2500 mPa·s to about 3000 mPa·s at 25° C., optionally from about 3000 mPa·s to about 3500 mPa·s at 25° C., optionally from about 3500 mPa·s to about 4000 mPa·s at 25° C., optionally from about 4000 mPa·s to about 4500 mPa·s at 25° C., optionally from about 4500 mPa·s to about 5000 mPa·s at 25° C., optionally from about 5000 mPa·s to about 5500 mPa·s at 25° C., optionally from about 5000 mPa·s to about 6500 mPa·s at 25° C., optionally from about 6500 mPa·s to about 7000 mPa·s at 25° C., optionally from about 7000 mPa·s to about 7500 mPa·s at 25° C., optionally from about 7500 mPa·s to about 8000 mPa·s at 25° C., optionally from about 8000 mPa·s to about 8500 mPa·s at 25° C., optionally from about 8500 mPa·s to about 9000 mPa·s at 25° C., optionally from about 9000 mPa·s to about 9500 mPa·s at 25° C., optionally from about 9500 mPa·s to about 10,000 mPa·s at 25° C., optionally from about 10,000 mPa·s to about 11,000 mPa·s at 25° C., optionally from about 11,000 mPa·s to about 12,000 mPa·s at 25° C., optionally from about 12,000 mPa·s to about 13,000 mPa·s at 25° C., optionally from about 13,000 mPa·s to about 14,000 mPa·s at 25° C., optionally from about 14,000 mPa·s to about 15,000 mPa·s at 25° C., optionally from about 15,000 mPa·s to about 16,000 mPa·s at 25° C., optionally from about 16,000 mPa·s to about 17,000 mPa·s at 25° C., optionally from about 17,000 mPa·s to about 18,000 mPa·s at 25° C., optionally from about 18,000 mPa·s to about 19,000 mPa·s at 25° C., optionally from about 19,000 mPa·s to about 20,000 mPa·s at 25° C., optionally from about 20,000 mPa·s to about 21,000 mPa·s at 25° C., optionally from about 21,000 mPa·s to about 22,000 mPa·s at 25° C., optionally from about 22,000 mPa·s to about 23,000 mPa·s at 25° C., optionally from about 23,000 mPa·s to about 24,000 mPa·s at 25° C., optionally from about 24,000 mPa·s to about 25,000 mPa·s at 25° C., optionally from about 25,000 mPa·s to about 26,000 mPa·s at 25° C., optionally from about 26,000 mPa·s to about 27,000 mPa·s at 25° C., optionally from about 27,000 mPa·s to about 28,000 mPa·s at 25° C., optionally from about 28,000 mPa·s to about 29,000 mPa·s at 25° C., optionally from about 29,000 mPa·s to about 30,000 mPa·s at 25° C., optionally from about 30,000 mPa·s to about 31,000 mPa·s at 25° C., optionally from about 31,000 mPa·s to about 32,000 mPa·s at 25° C., optionally from about 32,000 mPa·s to about 33,000 mPa·s at 25° C., optionally from about 33,000 mPa·s to about 34,000 mPa·s at 25° C., optionally from about 34,000 mPa·s to about 35,000 mPa·s at 25° C., optionally from about 35,000 mPa·s to about 36,000 mPa·s at 25° C., optionally from about 36,000 mPa·s to about 37,000 mPa·s at 25° C., optionally from about 37,000 mPa·s to about 38,000 mPa·s at 25° C., optionally from about 38,000 mPa·s to about 39,000 mPa·s at 25° C., optionally from about 39,000 mPa·s to about 40,000 mPa·s at 25° C., optionally from about 40,000 mPa·s to about 41,000 mPa·s at 25° C., optionally from about 41,000 mPa·s to about 42,000 mPa·s at 25° C., optionally from about 42,000 mPa·s to about 43,000 mPa·s at 25° C., optionally from about 43,000 mPa·s to about 44,000 mPa·s at 25° C., optionally from about 44,000 mPa·s to about 45,000 mPa·s at 25° C., optionally from about 45,000 mPa·s to about 46,000 mPa·s at 25° C., optionally from about 46,000 mPa·s to about 47,000 mPa·s at 25° C., optionally from about 47,000 mPa·s to about 48,000 mPa·s at 25° C., optionally from about 48,000 mPa·s to about 49,000 mPa·s at 25° C., optionally from about 49,000 mPa·s to about 50,000 mPa·s at 25° C., optionally from about 50,000 mPa·s to about 51,000 mPa·s at 25° C., optionally from about 51,000 mPa·s to about 52,000 mPa·s at 25° C., optionally from about 52,000 mPa·s to about 53,000 mPa·s at 25° C., optionally from about 53,000 mPa·s to about 54,000 mPa·s at 25° C., optionally from about 54,000 mPa·s to about 55,000 mPa·s at 25° C., optionally from about 55,000 mPa·s to about 56,000 mPa·s at 25° C., optionally from about 56,000 mPa·s to about 57,000 mPa·s at 25° C., optionally from about 57,000 mPa·s to about 58,000 mPa·s at 25° C., optionally from about 58,000 mPa·s to about 59,000 mPa·s at 25° C., optionally from about 59,000 mPa·s to about 60,000 mPa·s at 25° C., optionally from about 60,000 mPa·s to about 61,000 mPa·s at 25° C., optionally from about 61,000 mPa·s to about 62,000 mPa·s at 25° C., optionally from about 62,000 mPa·s to about 63,000 mPa·s at 25° C., optionally from about 63,000 mPa·s to about 64,000 mPa·s at 25° C., optionally from about 64,000 mPa·s to about 65,000 mPa·s at 25° C., optionally from about 65,000 mPa·s to about 66,000 mPa·s at 25° C., optionally from about 66,000 mPa·s to about 67,000 mPa·s at 25° C., optionally from about 67,000 mPa·s to about 68,000 mPa·s at 25° C., optionally from about 68,000 mPa·s to about 69,000 mPa·s at 25° C., optionally from about 69,000 mPa·s to about 70,000 mPa·s at 25° C., optionally from about 70,000 mPa·s to about 71,000 mPa·s at 25° C., optionally from about 71,000 mPa·s to about 72,000 mPa·s at 25° C., optionally from about 72,000 mPa·s to about 73,000 mPa·s at 25° C., optionally from about 73,000 mPa·s to about 74,000 mPa·s at 25° C., optionally from about 74,000 mPa·s to about 75,000 mPa·s at 25° C., optionally from about 75,000 mPa·s to about 76,000 mPa·s at 25° C., optionally from about 76,000 mPa·s to about 77,000 mPa·s at 25° C., optionally from about 77,000 mPa·s to about 78,000 mPa·s at 25° C., optionally from about 78,000 mPa·s to about 79,000 mPa·s at 25° C., optionally from about 79,000 mPa·s to about 80,000 mPa·s at 25° C., optionally from about 80,000 mPa·s to about 81,000 mPa·s at 25° C., optionally from about 81,000 mPa·s to about 82,000 mPa·s at 25° C., optionally from about 82,000 mPa·s to about 83,000 mPa·s at 25° C., optionally from about 83,000 mPa·s to about 84,000 mPa·s at 25° C., optionally from about 84,000 mPa·s to about 85,000 mPa·s at 25° C., optionally from about 85,000 mPa·s to about 86,000 mPa·s at 25° C., optionally from about 86,000 mPa·s to about 87,000 mPa·s at 25° C., optionally from about 87,000 mPa·s to about 88,000 mPa·s at 25° C., optionally from about 88,000 mPa·s to about 89,000 mPa·s at 25° C., optionally from about 89,000 mPa·s to about 90,000 mPa·s at 25° C., optionally from about 90,000 mPa·s to about 91,000 mPa·s at 25° C., optionally from about 91,000 mPa·s to about 92,000 mPa·s at 25° C., optionally from about 92,000 mPa·s to about 93,000 mPa·s at 25° C., optionally from about 93,000 mPa·s to about 94,000 mPa·s at 25° C., optionally from about 94,000 mPa·s to about 95,000 mPa·s at 25° C., optionally from about 95,000 mPa·s to about 96,000 mPa·s at 25° C., optionally from about 96,000 mPa·s to about 97,000 mPa·s at 25° C., optionally from about 97,000 mPa·s to about 98,000 mPa·s at 25° C., optionally from about 98,000 mPa·s to about 99,000 mPa·s at 25° C., optionally from about 99,000 mPa·s to about 100,000 mPa·s at 25° C. In an embodiment, the food additive is for use in emulsifying a food product. In an embodiment, the food additive is for use in whitening a food product. In an embodiment, the paramylon has a refractive index between about 1.1, about 1.2, about 1.3, about 1.4, about 1.5, about 1.6, about 1.7, or about 1.9, and about 2.0, about 2.1, about 2.2, about 2.3, about 2.4, about 2.5, or about 2.6, optionally between about 1.3 and about 2, optionally between about 2 and about 2.6, optionally at least about 2, at least about 2.05, at least about 2.1, at least about 2.15, at least about 2.2, at least about 2.25, at least about 2.3, at least about 2.35, at least about 2.4, at least about 2.45, at least about 2.5, or at least about 2.55, optionally about 2.3, optionally about 2.6, at λ=about 589 nm, and wherein the paramylon comprises granule form paramylon. In an embodiment, the paramylon increases refractive index of the food product by between about 0.1, about 0.2, about 0.3, about 0.4, or about 0.5, and about 0.6, about 0.7, about 0.8, about 0.9, or about 1, optionally between about 0.1 and about 1, optionally between about 0.3 and about 0.9, optionally between about 0.4 and about 0.8, optionally between about 0.5 and about 0.7, at λ=about 589 nm. In an embodiment, the food additive is spray dried. In an embodiment, the food additive is for use in water-binding a food product. In an embodiment, paramylon has a water holding capacity between about 0.70 g, about 0.71. about 0.72 g, about 0.73 g, about 0.74 g, about 0.75 g, about 0.76 g, or about 0.77, and about 0.78 g, about 0.79 g, about 0.80 g, about 0.81 g, about 0.82 g, about 0.83 g, about 0.84 g, or about 0.85 g water per g paramylon, optionally between about 0.70 g and about 0.85 g, optionally about 0.74 g and about 0.79 g, about 0.80 g, about 0.81 g, about 0.82 g, about 0.83 g, about 0.84 g, about 0.85 g, about 0.86 g, about 0.87 g, about 0.88 g, about 0.89 g, about 0.90 g, about 0.91 g, about 0.92 g, about 0.93 g, about 0.94 g, about 0.95 g, about 0.96 g, about 0.97 g, about 0.98 g, about 0.99 g, about 1.0 g, about 1.1 g, about 1.2 g, about 1.3 g, about 1.4 g, about 1.5 g, about 1.6 g, about 1.7 g, about 1.8 g, about 1.9 g, about 2.0 g, about 2.1 g, about 2.2 g, about 2.3 g, about 2.4 g, about 2.5 g, about 2.6 g, about 2.7 g, about 2.8 g, about 2.9 g, about 3.0 g, about 3.1 g, about 3.2 g, about 3.3 g, about 3.4 g, about 3.5 g, about 3.6 g, about 3.7 g, about 3.8 g, about 3.9 g, about 4.0 g, about 4.1 g, about 4.2 g, about 4.3 g, about 4.4 g, about 4.5 g, about 4.6 g, about 4.7 g, about 4.8 g, about 4.9 g, about 5.0 g, about 5.1 g, about 5.2 g, about 5.3 g, about 5.4 g, about 5.5 g, about 5.6 g, about 5.7 g, about 5.8 g, about 5.9 g, about 6.0 g, about 6.1 g, about 6.2 g, about 6.3 g, about 6.4 g, about 6.5 g, about 6.6 g, about 6.7 g, about 6.8 g, about 6.9 g, about 7.0 g, about 7.1 g, about 7.2 g, about 7.3 g, about 7.4 g, about 7.5 g, about 7.6 g, about 7.7 g, about 7.8 g, about 7.9 g, about 8.0 g, about 8.1 g, about 8.2 g, about 8.3 g, about 8.4 g, about 8.5 g, about 8.6 g, about 8.7 g, about 8.8 g, about 8.9 g, about 9.0 g, about 9.1 g, about 9.2 g, about 9.3 g, about 9.4 g, about 9.5 g, about 9.6 g, about 9.7 g, about 9.8 g, about 9.9 g, about 10.0 g, about 10.1 g, about 10.2 g, about 10.3 g, about 10.4 g, about 10.5 g, about 10.6 g, about 10.7 g, about 10.8 g, about 10.9 g, about 11.0 g, about 11.1 g, about 11.2 g, about 11.3 g, about 11.4 g, about 11.5 g, about 11.6 g, about 11.7 g, about 11.8 g, about 11.9 g, about 12.0 g, about 12.1 g, about 12.2 g, about 12.3 g, about 12.4 g, about 12.5 g, about 12.6 g, about 12.7 g, about 12.8 g, about 12.9 g, about 13.0 g, about 13.1 g, about 13.2 g, about 13.3 g, about 13.4 g, about 13.5 g, about 13.6 g, about 13.7 g, about 13.8 g, about 13.9 g, about 14.0 g, about 14.1 g, about 14.2 g, about 14.3 g, about 14.4 g, about 14.5 g, about 14.6 g, about 14.7 g, about 14.8 g, about 14.9 g, about 15.0 g water per g paramylon. In an embodiment, the paramylon increases water holding capacity of the food product between about 1.10 g, about 1.12 g, about 1.14 g, about 1.15 g, about 1.16 g, about 1.18 g, or about 1.2, and about 1.21 g, about 1.22 g, about 1.23 g, about 1.24 g, about 1.25 g, about 1.26 g, about 1.27 g, about 1.28 g, about 1.29 g, or about 1.30 g water per g paramylon, optionally between about 1.10 g and about 1.30 g water per g paramylon, optionally between about 1.10 g and about 1.20 g water per g paramylon, optionally between about 1.20 g and about 1.30 g water per g paramylon, optionally between about 1.25 g and about 1.30 g water per g paramylon, optionally between about 1.30 g and about 1.40 g water per g paramylon, about 1.40 g and about 1.50 g water per g paramylon, about 1.50 g and about 1.60 g water per g paramylon, about 1.60 g and about 1.70 g water per g paramylon, about 1.70 g and about 1.80 g water per g paramylon, about 1.80 g and about 1.90 g water per g paramylon, about 1.90 g and about 2.0 g water per g paramylon, about 2.0 g and about 3.0 g water per g paramylon, 3.0 g and about 4.0 g water per g paramylon, 4.0 g and about 5.0 g water per g paramylon, 5.0 g and about 6.0 g water per g paramylon, 6.0 g and about 7.0 g water per g paramylon, 7.0 g and about 8.0 g water per g paramylon, 8.0 g and about 9.0 g water per g paramylon, 9.0 g and about 10.0 g water per g paramylon, 10.0 g and about 11.0 g water per g paramylon, 11.0 g and about 12.0 g water per g paramylon, 12.0 g and about 13.0 g water per g paramylon, 13.0 g and about 14.0 g water per g paramylon, 14.0 g and about 15.0 g water per g paramylon. In an embodiment, the food additive is for use in sweetening a food product. The sweetness of paramylon can be determined by a taste panel of individuals comparing the sweetness of the paramylon sample compared to a standard 1% sucrose solution. In an embodiment, the paramylon is hydrolyzed paramylon having sweetness in the range of from about 0.1, about 0.15, about 0.2, about 0.25, or about 0.3, to about 0.35, about 0.4, about 0.45, about 0.5, about 0.55, about 0.6, about 0.65, or about 0.7, optionally from about 0.4 to about 0.7, optionally from about 0.5 to about 0.7, optionally from about 0.6 to about 0.7, optionally from about 0.1 to about 0.5, optionally from about 0.1 to about 0.4, optionally from about 0.1 to about 0.3, optionally from about 0.1 to about 0.2, relative to sucrose, whereby sweetness perception rating of sucrose at 1. In an embodiment, the food product comprises between about 0.1% and about 50% (w/w) of hydrolyzed paramylon, optionally between about 0.5% and about 40% (w/w), optionally between about 1% and about 30% (w/w), optionally between about 2.5% and about 25% (w/w), optionally between about 5% and about 20% (w/w), optionally between about 7.5% and about 15% (w/w), optionally between about 10% and about 15% (w/w). In an embodiment, the hydrolysis comprises treating the paramylon with a beta-glucanase at about 37° C. to 42° C., for about 16 h to about 24 hours, optionally at about 40° C. for about 16 h.

In another aspect, the disclosure relates to an encapsulated oil comprising an oil and paramylon from Euglena sp. having purity of at least about 70%, wherein the paramylon comprises granule form, swollen form, elongated form, and/or shell form paramylon, and wherein the molar ratio of paramylon to oil is from about 1:0.5, about 1:1, about 1:1.5, about 1:2, about 1:2.5, about 1:5, about 1:10, about 1:15, about 1:20, about 1:25, about 1:30, about 1:35, about 1:40, about 1:45, about 1:50, to about 1:55, about 1:60, about 1:65, about 1:70, about 1:75, about 1:80, about 1:85, about 1:90, about 1:95, or about 1:100, optionally between about 1:10 and about 1:100, optionally between about 1:10 and about 1:25, optionally between about 1:25 and about 1:50, optionally between about 1:50 and about 1:75, optionally between about 1:75 and about 1:100, optionally between about 1:25 and about 1:75. In an embodiment, the oil is selected from the group consisting of a canola oil, a soybean oil, a sunflower oil, an olive oil, a palm oil, a safflower oil, a peanut oil, a sesame oil, a grapeseed oil, a cottonseed oil, an avocado oil, and an Euglena derived oil. In an embodiment, the oil comprises a medium-chain triglyceride (MCT), a palmitic acid, an omega-3 fatty acids eicosapentaenoic acid (EPA), a docosahexaenoic acid (DHA), or an oleic acid.

In another aspect, the disclosure relates to a gelatinous food product comprising a food composition and paramylon from Euglena sp. having purity of at least about 70%, wherein the paramylon is between about 0.1% and about 50% (w/v) of the gelatinous food product, optionally further comprising calcium chloride of between about 0.05% and about 1.5% (w/v). In an embodiment, the paramylon comprises granule form paramylon. In an embodiment, the tensile strength of the food product is from about 1 g/cm² to about 3000 g/cm². In an embodiment, the food product is selected from the group consisting of a spreadable food stuff product, a confectionery product, a savory product, a dairy product, a dairy substitute product, and a drink product. In an embodiment, the food product is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, and any food product described herein.

In another aspect, the disclosure relates to a whitened food product comprising a food composition and paramylon from Euglena sp. having purity of at least about 70%, wherein the paramylon is between about 0.1% and about 50% (w/w) of the whitened food product, wherein the paramylon comprises granule form paramylon, and wherein the paramylon has a refractive index between about 1.3 and about 2.6 at λ=about 589 nm. In an embodiment, the paramylon is spray dried. In an embodiment, the refractive index of the whitened food product is at least about 0.1 at λ=about 589 nm. In an embodiment, the food product is selected from the group consisting of a dairy product, a dairy substitute product, a confectionary product, or a drink product. In an embodiment, the whitened food product is a creamer, a yogurt, an ice cream, a whipped cream, a pudding, a powdered milk base product, a cheese, a cream cheese, a sour cream, a low fat dairy product, a non-dairy creamer, a non-dairy ice cream, a non-dairy yogurt, a non-dairy whipped cream, a non-dairy pudding, a non-dairy milk base product, a non-dairy cream, a non-dairy sour cream, a low fat non-dairy food product, a chocolate with a hard coating, a chocolate without a hard coating, a hard candy, a soft gummy candy, a marshmallows, an icing, a fondant, a jelly bean, a flavoured syrup, a chocolate syrup, a protein shake, a meal replacement shake, or any food product described herein.

In another aspect, the disclosure relates to a sweetened food product comprising a food composition and a hydrolyzed paramylon, wherein the hydrolyzed paramylon comprises glucose oligomers from hydrolyzing paramylon from Euglena sp., and wherein the paramylon has purity of at least about 70%. In an embodiment, the sweetened food product comprises between about 0.1% and about 50% (w/w) of hydrolyzed paramylon. In an embodiment, the sweetened food product is any product described herein.

In another aspect, the disclosure relates to a non-dairy creamer comprising paramylon from Euglena sp. having purity of at least about 70%, an oil, and a lecithin, wherein the paramylon is between about 0.1% and about 50% (w/v) of the non-dairy creamer, optionally comprises calcium chloride of between about 0.05% and about 1.5% (w/v). In an embodiment, the oil is a canola oil, and wherein the canola oil is between about 5% and about 20% (w/v), optionally about 10% (w/v), of the non-dairy creamer. In an embodiment, the oil is between about 5%, about 6%, about 7%, about 8%, about 9%, about 10%, about 11%, or about 12%, and about 13%, about 14%, about 15%, about 16%, about 17%, about 18%, about 19%, or about 20% (w/v), optionally between about 5% and about 20% (w/v), optionally between about 5% and about 10% (w/v), optionally between about 10% and about 15% (w/v), optionally between about 15% and about 20% (w/v), optionally between about 5% and about 15% (w/v), optionally between about 7.5% and about 12.5% (w/v), optionally about 5%, about 6%, about 7%, about 8%, about 9%, about 10%, about 11%, about 12%, about 13%, about 14%, about 15%, about 16%, about 17%, about 18%, about 19%, or about 20% (w/v), optionally about 10% (w/v), of the non-dairy creamer. In an embodiment, the lecithin is a soy lecithin, a mono-glyceride, a di-glyceride, and/or a sunflower lecithin, and wherein the lecithin is between about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, or about 2.0%, and about 2.2%, about 2.4%, about 2.5%, about 2.6%, about 2.8%, about 3.0%, about 3.25%, about 3.5 3.75%, about 4%, about 4.1%, about 4.2%, about 4.3%, about 4.4%, about 4.5%, about 4.6%, about 4.7%, about 4.8%, about 4.9%, or about 5% (w/v), optionally between about 0.1% and 5% (w/v), optionally between about 0.5% and about 5%, optionally between about 0.5% and about 2.5% (w/v), optionally between about 0.5% and about 1% (w/v), optionally between about 1% and about 2.5% (w/v), optionally between about 2.5% and about 5% (w/v), optionally between about 4% and about 5% (w/v), optionally about 1% (w/v), optionally about 2% (w/v), optionally about 2.5% (w/v), optionally about 3% (w/v), optionally about 4% (w/v), optionally about 5% (w/v), of the non-dairy creamer.

In another aspect, the disclosure relates to a method of producing a non-dairy creamer, comprising:
combining with water,
i) paramylon from Euglena sp. having purity of at least about 70%, wherein the paramylon is between about 1% and about 20% (w/v), optionally about 1%, about 5%, or about 10% (w/v), of the non-dairy creamer,
ii) an oil, optionally a canola oil, a sunflower oil, a MCT, a palm oil, a vegetable oil, a soy oil, a peanut oil, an avocado oil, or a grapeseed oil, wherein the oil is between about 5% and about 20% (w/v), optionally about 10% (w/v), of the non-dairy creamer, and
iii) a lecithin, optionally a soy lecithin, a mono-glyceride, a di-glyceride, or a sunflower lecithin, wherein the lecithin is between about 0.1% and about 5% (w/v), optionally about 1% (w/v), of the non-dairy creamer, to form a mixture,
homogenizing the mixture,
thereby forming the non-dairy creamer.

In an embodiment, the paramylon is in a dried powder or a wet gel form. In an embodiment, the paramylon was processed by solubilizing in alkali base prior to adjusting using an acid to a pH from about 6, about 6.1, about 6.2, about 6.3, about 6.4, about 6.5, about 6.6, about 6.7, about 6.8, about 6.9, or about 7.0, to about 7.1, about 7.2, about 7.3, about 7.4, about 7.5, about 7.6, about 7.7, about 7.8, about 7.9, or about 8, optionally pH from about 6 to about 7.1, optionally pH from about 6 to about 6.5, optionally pH from about 7 to about 8.0, optionally pH from about 7.5 to about 8, optionally pH from about 6.3 to about 7.7, optionally pH from about 6.5 to about 7.5, optionally pH from about 6.7 to about 7.3, optionally pH from about 6.9 to about 7.1, optionally about pH 7. In an embodiment, the oil is from about 5%, about 6%, about 7%, about 8%, about 9%, about 10%, about 11%, or about 12%, to about 13%, about 14%, about 15%, about 16%, about 17%, about 18%, about 19%, or about 20% (w/v), optionally between about 5% and about 20% (w/v), optionally between about 5% and about 10% (w/v), optionally between about 10% and about 15% (w/v), optionally between about 15% and about 20% (w/v), optionally between about 5% and about 15% (w/v), optionally between about 7.5% and about 12.5% (w/v), optionally about 5%, about 6%, about 7%, about 8%, about 9%, about 10%, about 11%, about 12%, about 13%, about 14%, about 15%, about 16%, about 17%, about 18%, about 19%, or about 20% (w/v), optionally about 10% (w/v), of the non-dairy creamer. In an embodiment, the lecithin is from about 0.1%, about 0.2%, about 0.3%, about 0.4%, about 0.5%, about 0.6%, about 0.7%, about 0.8%, about 0.9%, about 1%, about 1.2%, about 1.4%, about 1.5%, about 1.6%, about 1.7%, about 1.8%, about 1.9%, or about 2%, to about 2.2%, about 2.4%, about 2.5%, about 2.6%, about 2.8%, about 3.0%, about 3.25%, about 3.5%, about 3.75%, about 4%, about 4.1%, about 4.2%, about 4.3%, about 4.4%, about 4.5%, about 4.6%, about 4.7%, about 4.8%, about 4.9%, or about 5% (w/v), optionally between about 0.5% and about 5%, optionally between about 0.5% and about 2.5% (w/v), optionally between about 0.5% and about 1% (w/v), optionally between about 1% and about 2.5% (w/v), optionally between about 2.5% and about 5% (w/v), optionally between about 4% and about 5% (w/v), optionally between about 0.1% and about 5% (w/v), optionally about 1% (w/v), optionally about 2% (w/v), optionally about 2.5% (w/v), optionally about 3% (w/v), optionally about 4% (w/v), optionally about 5% (w/v), of the non-dairy creamer. In an embodiment, the alkali base is sodium hydroxide, and wherein the acid is hydrochloric acid. In an embodiment, the wet gel form paramylon further comprises calcium chloride of between about 0.05% and about 1.5% (w/v).

In another aspect, the disclosure relates to a method of synergistically emulsifying, increasing viscosity, or forming a gelatinous food product, comprising:
combining with a food composition,
i) paramylon from Euglena sp. having purity of at least about 70%, and
ii) a gum,
wherein the paramylon is between about 1% and about 20% (w/v), optionally about 1%, about 5%, or about 10% (w/v), of the food product,
thereby forming the food product.

In an embodiment, the gum is selected a group consisting of a carboxymethyl cellulose (CMC), a kappa carrageenan, an iota carrageenan, a lambda carrageenan, a high methoxyl pectin, a low methoxyl pectin, a xanthan gum, a guar gum, a locust bean gum, a konjac gum, a gellan gum, a gum arabic, Xanthan, Methyl cellulose (MC), hydroxypropylmethyl cellulose (HPMC), Gum Arabic, Galactomannans (Guar gum, Locust bean gum and tara gum), Konjac mannan, Gum Tragacanth, Propylene glycol alginate (PGA), Modified starch, Microcrystalline cellulose (MCC), Carrageenan, Konjac glucomannan, Fenugreek gum, Konjac gum, Pectin, Cellulose derivatives, Gelatin, Alginate, and any combination thereof. In an embodiment, the gum is between about 0.25% and about 5% (w/v), optionally between about 0.5% and about 5% (w/v), optionally between about 0.5% and about 1% (w/v), optionally about 0.5%, about 0.75%, about 1%, or about 5% (w/v), optionally about 0.5% (w/v), optionally about 1% (w/v), of the food product.

In any of the embodiments described herein, the paramylon described herein in any form, optionally granule form, swollen form, elongated form, shell form, solubilized form, has a purity of at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 95.1%, at least about 95.2%, at least about 95.3%, at least about 95.4%, at least about 95.5%, at least about 95.6%, at least about 95.7%, at least about 95.8%, at least about 95.9%, at least about 96%, at least about 96.1%, at least about 96.2%, at least about 96.3%, at least about 96.4%, at least about 96.5%, at least about 96.6%, at least about 96.7%, at least about 96.8%, at least about 96.9%, at least about 97%, at least about 97.1%, at least about 97.2%, at least about 97.3%, at least about 97.4%, at least about 97.5%, at least about 97.6%, at least about 97.7%, at least about 97.8%, at least about 97.9%, at least about 98%, at least about 98.1%, at least about 98.2%, at least about 98.3%, at least about 98.4%, at least about 98.5%, at least about 98.6%, at least about 98.7%, at least about 98.8%, at least about 98.9%, at least about 99%, at least about 99.1%, at least about 99.2%, at least about 99.3%, at least about 99.4%, at least about 99.5%, at least about 99.6%, at least about 99.7%, at least about 99.8%, at least about 99.9%, at least about 99.91%, at least about 99.92%, at least about 99.93%, at least about 99.94%, at least about 99.95%, at least about 99.96%, at least about 99.97%, at least about 99.98%, at least about 99.99%, at least about 99.999%, or about 100%. The skilled person can readily determine the purity of paramylon using the analytical methods described herein. In an embodiment, the purity is determined by any suitable analytical method described herein, preferably the ASC method.

In another aspect, the disclosure relates to a method for producing at least one of swollen, elongated, shell, and soluble form paramylon comprising combining a base with the granule form paramylon to form at least one of swollen, elongated, shell, and soluble form paramylon. In an embodiment, the base is an alkali hydroxide, optionally sodium hydroxide, potassium hydroxide, or lithium hydroxide. In an embodiment, the base is between about 0.25M and about 1M, optionally about 0.25M and about 0.5M, optionally about 0.5M and about 0.75M, optionally about 0.75M and 1M, optionally about 0.25M, about 0.33M, about 0.5M, about 0.75M, or about 1M, optionally about 0.25M, optionally about 0.33M, optionally about 0.5M, optionally about 0.75M, optionally about 1M.

In an embodiment, the method for producing swollen form paramylon comprises combining a base with a granule form paramylon in solution, maintaining a pH of from about 12.0 to about 13.5, optionally from about 12.2 to about 13.3, optionally from about 12.5 to about 13.0, maintaining a temperature of about 0° C. to about 40° C., optionally from about 0° C. to about 15° C., optionally from about 2° C. to about 10° C., optionally from about 10° C. to about 15° C., optionally from about 12° C. to about 30° C., optionally from about 15° C. to about 28° C., optionally from about 18° C. to about 28° C., optionally from about 18° C. to about 25° C., optionally from about 20° C. to about 25° C., optionally about 1° C., about 2° C. about 3° C., about 4° C., about 5° C., about 6° C., about 7° C., about 8° C., about 9° C., or about 10° C., optionally about 4° C., optionally about 18° C., about 19° C., about 20° C., about 21° C., about 22° C., about 23° C., about 24° C., about 25° C., about 26° C., about 27° C., or about 28° C., optionally about 25° C., wherein the granule form paramylon in the solution is from about 0.05% to about 20% (w/v), optionally from about 0.1% to about 10% (w/v), optionally about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19% or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the swollen form paramylon.

In another embodiment, the method for producing swollen form paramylon comprises combining a base with a granule form paramylon in solution, maintaining a pH of from about 10.5 to about 12.0, optionally from about 10.5 to about 11.8, optionally from about 10.7 to about 11.5, optionally from about 10.9 to about 11.4, optionally from about 10.9 to about 11.35, maintaining a temperature of from about 40° C. to about 110° C., optionally from about 50° C. to about 100° C., optionally from about 60° C. to about 90° C., optionally from about 65° C. to about 80° C., optionally from about 65° C. to about 75° C., optionally from about 67° C. to about 73° C., optionally from about 69° C. to about 71° C., optionally about 65° C., about 66° C., about 67° C., about 68° C., about 69° C., about 70° C., about 71° C., about 72° C., about 73° C., about 74° C., or about 75° C., optionally about 70° C., wherein the granule form paramylon in the solution is from about 0.05% to about 20% (w/v), optionally from about 0.1% to about 10% (w/v), optionally about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19%, or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the swollen form paramylon.

In an embodiment, the method for producing elongated form paramylon comprises combining a base with a granule form paramylon in solution, maintaining a pH of from about 12.2 to about 13.7, optionally from about 12.4 to about 13.5, optionally from about 12.7 to about 13.2, maintaining a temperature of from about 0° C. to about 40° C., optionally from about 0° C. to about 15° C., optionally from about 2° C. to about 10° C., optionally from about 10° C. to about 15° C., optionally from about 12° C. to about 30° C., optionally from about 15° C. to about 28° C., optionally from about 18° C. to about 28° C., optionally from about 18° C. to about 25° C., optionally from about 20° C. to about 25° C., optionally about 1° C., about 2° C., about 3° C., about 4° C., about 5° C., about 6° C., about 7° C., about 8° C., about 9° C., or about 10° C., optionally about 4° C., optionally about 18° C., about 19° C., about 20° C., about 21° C., about 22° C., about 23° C., about 24° C., about 25° C., about 26° C., about 27° C., or about 28° C., optionally about 25° C., wherein the granule form paramylon in the solution is from about 0.05% to about 20% (w/v), optionally from about 0.1% to about 10% (w/v), about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19% or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the elongated form paramylon.

In another embodiment, the method for producing elongated form paramylon comprises combining a base with a granule form paramylon in solution, maintaining a pH of from about 10.7 to about 12.2, optionally from about 10.7 to about 12.0, optionally from about 10.9 to about 11.7, optionally from about 11.1 to about 11.5, optionally from about 11.1 to about 11.45, maintaining a temperature of from about 40° C. to about 110° C., optionally from about 50° C. to about 100° C., optionally from about 60° C. to about 90° C., optionally from about 65° C. to about 80° C., optionally from about 65° C. to about 75° C., optionally from about 67° C. to about 73° C., optionally from about 69° C. to about 71° C., optionally about 65° C., about 66° C., about 67° C., about 68° C., about 69° C., about 70° C., about 71° C., about 72° C., about 73° C., about 74° C., or about 75° C., optionally about 70° C., wherein the granule form paramylon in the solution is from about 0.05% to about 20% (w/v), optionally from about 0.1% to about 10% (w/v), optionally about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19%, or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the elongated form paramylon.

In an embodiment, the method for producing shell form paramylon comprises combining a base with a granule form paramylon in solution, maintaining a pH of from about 12.3 to about 13.8, optionally from about 12.5 to about 13.6, optionally from about 12.7 to about 13.3, optionally from about 12.75 to about 13.1, maintaining a temperature of from about 0° C. to about 40° C., optionally from about 0° C. to about 15° C., optionally from about 2° C. to about 10° C., optionally from about 10° C. to about 15° C., optionally from about 12° C. to about 30° C., optionally from about 15° C. to about 28° C., optionally from about 18° C. to about 28° C., optionally from about 18° C. to about 25° C., optionally from about 20° C. to about 25° C., optionally about 1° C., about 2° C., about 3° C., about 4° C., about 5° C., about 6° C., about 7° C., about 8° C., about 9° C., or about 10° C., optionally about 4° C., optionally about 18° C., about 19° C., about 20° C., about 21° C., about 22° C., about 23° C., about 24° C., about 25° C., about 26° C., about 27° C., or about 28° C., optionally about 25° C., wherein the granule form paramylon in the solution is from about 0.05% to about 20% (w/v), optionally from about 0.1% to about 10% (w/v), about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19%, or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the shell form paramylon.

In an embodiment, the method for producing shell form paramylon comprises combining a base with a granule form paramylon in solution, maintaining a pH of from about 10.8 to about 12.3, optionally from about 10.8 to about 12.1, optionally from about 11.0 to about 11.8, optionally from about 11.2 to about 11.7, optionally from about 11.2 to about 11.55, optionally from about 11.4 to about 11.5, maintaining a temperature of from about 40° C. to about 110° C., optionally from about 50° C. to about 100° C., optionally from about 60° C. to about 90° C., optionally from about 65° C. to about 80° C., optionally from about 65° C. to about 75° C., optionally from about 67° C. to about 73° C., optionally from about 69° C. to about 71° C., optionally about 65° C., about 66° C., about 67° C., about 68° C., about 69° C., about 70° C., about 71° C., about 72° C., about 73° C., about 74° C., or about 75° C., optionally about 70° C., wherein the granule form paramylon in the solution is from about 0.05% to about 20% (w/v), optionally from about 0.1% to about 10% (w/v), optionally about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19%, or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the shell form paramylon.

In an embodiment, the method for producing soluble form paramylon comprises combining a base with a granule form paramylon in solution, maintaining a pH of at least about 12.0, at least about 12.1, at least about 12.2, at least about 12.3, at least about 12.4, at least about 12.5, at least about 12.6, at least about 12.7, at least about 12.8, at least about 12.9, at least about 13.0, at least about 13.1, at least about 13.2, at least about 13.3, at least about 13.4, at least about 13.5, at least about 13.6, at least about 13.7, at least about 13.8, at least about 13.9, or at least about 14.0, optionally at least about 12.0, optionally at least about 12.5, optionally at least about 12.7, optionally at least about 12.75, optionally at least about 12.8, optionally at least about 12.85, maintaining a temperature of from about 0° C. to about 40° C., optionally from about 0° C. to about 15° C., optionally from about 2° C. to about 10° C., optionally from about 10° C. to about 15° C., optionally from about 12° C. to about 30° C., optionally from about 15° C. to about 28° C., optionally from about 18° C. to about 28° C., optionally from about 18° C. to about 25° C., optionally from about 20° C. to about 25° C., optionally about 1° C., about 2° C., about 3° C., about 4° C., about 5° C., about 6° C., about 7° C., about 8° C., about 9° C., or about 10° C., optionally about 4° C., optionally about 18° C., about 19° C., about 20° C., about 21° C., about 22° C., about 23° C., about 24° C., about 25° C., about 26° C., about 27° C., or about 28° C., optionally about 25° C., wherein the granule form paramylon in the solution is from about 0.05% to about 20% (w/v), optionally from about 0.1% to about 10% (w/v), optionally about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19%, or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the soluble form paramylon.

In an embodiment, the method for producing soluble form paramylon comprises combining a base with a granule form paramylon in solution, maintaining a pH of at least about 10.5, at least about 10.6, at least about 10.7, at least about 10.8, at least about 10.9, at least about 11.0, at least about 11.1, at least about 11.2, at least about 11.3, at least about 11.4, at least about 11.5, at least about 11.6, at least about 11.7, at least about 11.8, at least about 11.9, at least about 12.0, at least about 12.1, at least about 12.2, at least about 12.3, at least about 12.4, or at least about 12.5, optionally at least about 10.5, optionally at least about 11.0, optionally at least about 11.1, optionally at least about 11.2, optionally at least about 11.3, optionally at least about 11.35, maintaining a temperature of from about 40° C. to about 110° C., optionally from about 50° C. to about 100° C., optionally from about 60° C. to about 90° C., optionally from about 65° C. to about 80° C., optionally from about 65° C. to about 75° C., optionally from about 67° C. to about 73° C., optionally from about 69° C. to about 71° C., optionally about 65° C., about 66° C., about 67° C., about 68° C., about 69° C., about 70° C., about 71° C., about 72° C., about 73° C., about 74° C., or about 75° C., optionally about 70° C., wherein the granule form paramylon in the solution is from about 0.05% to about 20% (w/v), optionally from about 0.1% to about 10% (w/v), optionally about 0.05%, about 0.1%, about 0.2%, about 0.25%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 12.5%, about 13%, about 14%, about 15%, about 16%, about 17%, about 18%, about 19%, or about 20% (w/v), optionally about 0.1% (w/v), optionally about 0.25% (w/v), optionally about 0.5% (w/v), optionally about 1% (w/v), optionally about 2% (w/v), optionally about 2.5% (w/v), optionally about 5% (w/v), optionally about 7.5% (w/v), optionally about 10% (w/v), thereby forming the soluble form paramylon.

In an embodiment, the methods described herein comprises homogenizing paramylon, optionally high pressure homogenization.

In an aspect, the disclosure also relates a method for stabilizing a food product with paramylon. In an embodiment, the paramylon provides heat stability, freeze thaw stability, light stability, emulsion stability, or storage stability. In an embodiment, emulsion stability is measured at time 0 min, 5 min, 10 min, 20 min, 30 min, 40 min, or 60 min, or at 2 h, 4 h, 6 h, 8 h, 10 h, 12 h, 14 h, 16 h, 18 h, 20 h, 24 h, 30 h, 36 h, 42 h, or 48 h, or at 1 day, 2 days, 3 days, 4 days, 5 days, 6 days, or 7 days after emulsification.

In an aspect, the disclosure also relates a method for reconstituting paramylon, and a reconstituted paramylon thereof. In an embodiment, reconstituted paramylon retains any functional property described herein. In an embodiment, the functional property comprises forming a gelatinous food product, whitening a food product, emulsifying a food product, increasing viscosity of a food product, increasing water binding of a food product, sweetening a food product, bulking a food product, and/or encapsulating an oil. In any of the embodiments described herein, the paramylon is a reconstituted paramylon. In any of the embodiments described herein, the paramylon comprises a reconstituted paramylon. In any of the embodiments described herein, the food product comprises a reconstituted paramylon. In an embodiment, solubilized paramylon is dried, thereby reconstituted as a powder. In an embodiment, dried paramylon is reconstituted as a solution or a gel. In an embodiment, dried paramylon is reconstituted as a solution. In an embodiment, dried paramylon is reconstituted as a gel. In an embodiment, the paramylon is swollen form, elongated form, shell form, solubilized form, and/or hydrolyzed paramylon. In an embodiment, reconstituted gel form paramylon retains functional properties of dried form paramylon. In an embodiment, reconstituted gel form paramylon retains+/−1 pH of dried form paramylon. In an embodiment, the reconstituted paramylon retains functional property comprising forming a gelatinous food product. In an embodiment, the reconstituted paramylon retains functional property comprising forming a gelatinous food product. In an embodiment, the reconstituted paramylon retains functional property comprising forming a gelatinous food product. In an embodiment, the reconstituted paramylon retains functional property comprising whitening a food product. In an embodiment, the reconstituted paramylon retains functional property comprising emulsifying a food product. In an embodiment, the reconstituted paramylon retains functional property comprising increasing viscosity of a food product. In an embodiment, the reconstituted paramylon retains functional property comprising increasing water binding of a food product. In an embodiment, the reconstituted paramylon retains functional property comprising sweetening a food product. In an embodiment, the reconstituted paramylon retains functional property comprising bulking a food product. In an embodiment, the reconstituted paramylon retains functional property comprising encapsulating an oil. In an embodiment, the reconstituted paramylon comprises a ready to gel powder, optionally as shown in Example 7A.

In an aspect, paramylon is useful as a flavour adsorbent. In an aspect, paramylon adsorbs undesirable flavour compounds. In an embodiment, the undesirable flavour compound is hexanal or saponin.

In an aspect, the disclosure also relates to a jelly fruit comprising paramylon.

In an aspect, the disclosure also relates to a dairy product comprising paramylon, optionally the dairy product is an ice cream product or a yogurt.

In an aspect, the disclosure also relates to a bakery product comprising paramylon, optionally the bakery product is a cookie. In an embodiment, the cookie comprises from about 20% to about 30% (w/w) unsalted butter, optionally about 25% (w/w) unsalted butter, optionally about 24.7% (w/w) unsalted butter, from about 20% to about 40% (w/w) sugar, optionally from about 25% to about 35% (w/w) sugar, optionally about 30% (w/w) sugar, optionally about 30.7% (w/w) sugar, from about 0.1% to about 1% (w/w) salt, optionally about 0.5% (w/w) salt, from about 0.5% to about 2% (w/w) paramylon, optionally about 0.5%, about 0.6%, about 0.7%, about 0.8%, about 0.9%, or about 1.0% (w/w) paramylon, optionally about 0.8% (w/w) paramylon, optionally about 0.79% (w/w) paramylon, from about 0.4% to about 1% (w/w) vegetable oil, optionally about 0.64%, about 0.65%, about 0.66%, about 0.67%, about 0.68%, about 0.69%, or about 0.7% (w/w) vegetable oil, optionally about 0.67% (w/w) vegetable oil, from about 1% to about 2% (w/w) vanilla extract, optionally from about 1%, about 1.1%, about 1.2%, about 1.3%, about 1.4%, about 1.5%, about 1.6%, about 1.7%, about 1.8%, about 1.9%, or about 2% (w/w) vanilla extract, optionally about 1.6% (w/w) vanilla extract, about 30% to about 40% (w/w) baking powder, optionally from about 33% to about 38% (w/w) all purpose flour, optionally about 35% (w/w) all purpose flour, optionally about 35.1% (w/w) all purpose flour, and from about 0.5% to about 1.5% (w/w) baking powder, optionally about 0.5, about 0.6, about 0.7%, about 0.8%, about 0.9%, about 1.0%, about 1.1%, about 1.2%, about 1.3%, about 1.4%, about, or about 1.5% (w/w) baking powder, optionally about 1% (w/w) baking powder, optionally about 1.1% (w/w) baking powder. In an embodiment, the paramylon has been spray dried prior to combining with unsalted butter, sugar, salt, vegetable oil, vanilla extract, all purpose flour, and/or baking powder. The skilled person can readily recognize the suitable unsalted butter, sugar, salt, vegetable oil, all purpose flour and baking powder for making a cookie described herein. The skilled person can readily recognize substitution for vanilla extract to provide any flavour described herein.

In an aspect, the disclosure also relates to protein drink product comprising paramylon, optionally the protein drink product is a plant-based protein drink product.

In an aspect, the disclosure also relates a method for bulking a food product with paramylon.

### General Methods and Instrumental Techniques

### Spray Drying

In a plant scale, Spray drying was conducted using a Wild Horse International Spray Dryer, S/S, Model LPG-5 with an operating inlet temperature of 250 C and a variable feed rate of slurry to maintain an outlet temperature of 85-95 C. Slurry feed solids content ranged from 5% w/w to 25% w/w.

In a lab scale, Paramylon Sample was resuspended in an equal mass of room temperature water to form paramylon slurry and drying using a Lab-Plant SD-06 Laboratory Scale Spray Dryer. The slurry was fed into the two-fluid nozzle using a peristaltic pump with a flow rate of 10 mL/min and a compressed air pressure of 10 psi. The inlet temperature was set to 160° C.

### Freeze Drying

Freeze dry was carried out using a FreeZone 6 Litre Freeze Dry System (model number 7934020) or Freezone bulk tray dryer (model number 78060). This consisted of placing the material in a −80° C. freezer overnight to ensure freezing of the water present, and then was placed into the freeze drier for overnight to 2 days to remove the moisture from the sample under vacuum.

In any embodiment described herein, the drying method can be selected from spray drying, drum drying, falling film evaporation, oven drying, vacuum drying, freeze drying, and solar drying.

### Purity of Paramylon

Purity of paramylon in the lab was tested using the following processes. A 50 mL empty centrifuge tube was weighed on an analytical balance the weight recorded. 0.5 g of sample and a magnetic bar into each tube and record the weight. 25 mL of DI H₂O was added and the tube was set on a magnetic stirrer set to 800 rom for >8 hours (i.e. overnight). Afterwards the sample was centrifuged at 5000 rom for 10 minutes. The supernatant was decanted. 25 mL 2% SDS solution to the pellet and the tube was heated to 110° C. oil bath for 30 minutes with stirring. The mixture was centrifuged at 5000 rpm for 10 minutes and the supernatant was decanted. The addition of SDS and centrifugation was repeated. 25 mL of 70% Isopropyl alcohol was added and pellet was broken up with a stainless steel tablespoon and vortexed for 15 minutes. Afterwards, it was centrifuged at 5000 rpm for 10 minutes and the supernatant was decanted. 25 mL of 95% ethanol was added and the sample vortexed for 5 minutes. The stir bar is removed and the sample centrifuged at 5000 rom for 10 minutes and the supernatant decanted. The sample is frozen in a −80° C. freezer for 2-24 hours and then transferred to a freezer dryer to freeze dry overnight. The sample was weighed the purity was determined by dividing the final sample weight by the initial sample weight and multiplying by 100%.

### Microscopy

Optical microscopy was conducted using an EVOS FL Auto imaging system with a zoom rang from 10× to 60×.

### Glycosyl Linkage Analysis

The glycosyl linkage was analyzed using a NaOH method. The sample was permethylated, depolymerized, reduced, and acetylated; and the resulting partially methylated alditol acetates (PMAAs) analyzed by gas chromatography-mass spectrometry (GC-MS). Detailly, an aliquot of each sample was suspended in about 200 ul of dimethyl sulfoxide and placed on a magnetic stirrer for 1-2 days. The samples were then permethylated (treatment with sodium hydroxide and methyl iodide in dry DMSO). The sample was subjected to the NaOH base for 10 minutes then methyl iodide was added and left for 10 minutes. More methyl iodide was then added for 40 minutes. The base was then added for 10 minutes and finally more methyl iodide was added for 40 minutes. This addition of more methyl iodide and NaOH base was to ensure complete methylation of the polymer. Following sample workup, the permethylated material was hydrolyzed using 2 M trifluoroacetic acid (2 h in sealed tube at 121° C.), reduced with NaBD₄, and acetylated using acetic anhydride/trifluoroacetic acid. The resulting PMAAs were analyzed on a Hewlett Packard 5890 GC interfaced to a 5970 MSD (mass selective detector, electron impact ionization mode); separation was performed on a 30 m Supelco 2330 bonded phase fused silica capillary column.

### Whitening

The whiteness was both analyzed by visual inspection and by computer software designed internally. For software analysis, icings were put into 6 deep well plates and scanned to keep consistent light conditions, and degree of whiteness was analyzed from image obtained and whiteness score (% whiteness) was given by software.

Sample preparation was as follows. In non-plastic mixing bowl whip butter using a Kitchenaid hand mixer on high speed for 4-5 min until butter was uniformly whipped. To the milk, the whitening agent being tested was mixed in. The icing sugar, vanilla paste and milk are mixed together and then added to the whipped butter and mixed for 5 min on high speed. The resulting buttercream icing mix is stored in a resealable sandwich bag and labeled.

### Density

### Bulk Density Measurement

1 gram of sample into the graduated cylinder and the volume is recorded. The bulk density is calculated as: bulk density=Mass (g)/Volume (mL).

### True Density Measurement

A true density was measured by a volumetric cylinder containing 0.5 g BGI and 3 mL dH₂O, and the calculated using the following formula: True density=Mass (g)/(volume added-Initial volume (mL)). The measurement is based on an assumption that samples have zero solubility in water.

pH

The pH was measured using Thermo Scientific Orion Star A112.

### GPC

The absolute molar mass distributions of the samples were measured using size exclusion chromatography (SEC) with multi-angle light scattering (MALS) detection. The Paramylon Milled BGI-) sample was dried overnight in a vacuum oven with no heat. The samples were dissolved in dimethyl sulfoxide (DMSO) at a nominal concentration of 9.5 mg/mL. Each preparation was heated to approximately 70° C. for 90 minutes. At the end of the sample dissolution, the Paramylon Original sample appeared visually clear while the Paramylon-RTG and Paramylon-Milled samples were hazy. One milliliter of each solution was further diluted with 1.11% LiCl in DMAc solution in 10 mL volumetric flasks for a nominal concentration of 0.95 mg/mL. All sample dilutions were centrifuged for 30 minutes to remove any insoluble material. Undissolved material was noted in the centrifuge tubes for samples Paramylon-RTG and Paramylon-Milled. The absolute molar mass distribution of the sample was calculated using multi-angle light scattering. A key parameter for these calculations is the specific refractive index increment, or dn/dc. The dn/dc value used in this study for the light scattering calculations was 0.1293 mL/g, as calculated assuming 100% mass recovery for Paramylon.

### Size Analysis

Size analysis was done on MALVERN Mastersizer 3000. Prior to the test, Malvern Mastersizer is allowed to warm up for at least 1 hr prior to use. For wet method particle size distribution, the Hydro LV module is used. The Hydro LV module is filled, by the instrument, with reverse osmosis (RO) water (generated on campus) and the instrument goes through a self-alignment of the laser system, followed by a water background correction. The sample is introduced into the Hydro LV module until an obscuration limit between 2% to 20% is reach by the detector system. The sample is sonicated in the Hydro LV bath for 5 min to allow for equilibration, followed by a run that measures that sample five times to obtain a statistical readout. Following each run, the Hydro LV module goes through a self-cleaning stage to prepare for the next sample.

### Water Holding Capacity

Water holding capacity (WHC) is the water holding weight per gram materials. Given the certain amount of paramylon materials can be dissolved in water, a correction of WHC was provided as Cor. WHC.

WHC=(Ww−Ws)/Ws

Cor.WHC=(Ww−(Ws−Ws))/(Ws−Wd)

WSI=Wd/Ws
WHC: Water holding Capacity; WSI: Water solubility index;
Ww: Weight of wet samples; Ws: Weight of samples; Wd: Weight of dissolved sample;

They were measured as follows:
1. 0.5 g sample in 20 mL of distilled water.
2. The samples were vortexed for 30 s to bring all the samples into suspension. The suspension was allowed to rest for 10 min.
3. Repeat 2 for 7 times.
4. The sample was centrifuged at 1600 g for 25 min.
5. The supernatant was decanted and dried to get WSI.
6. The centrifuge tube is placed mouth down at an angle of 15-20 degree at 50° C. for 25 min for draining.
7. The tube is cooled in a desiccator and weighted. The WHC is recorded as g water per g sample.

### Optical Density and Uv-Vis Spectrum

Turbidity measurements were performed by determining the optical density (OD) of the solution at each pH point (0.5 units) at an ambient temperature as a function of pH (pH13-1.5) and biopolymer ratio (PP:BGI; 1:1, 2:1, 4:1, 8:1 and 10:1) using a UV-visible spectrophotometer (Spectra Max, M3) at 600 nm. OD of homogenous PP (0.05% w/w) and BGI (0.05% w/w) solutions were also determined for comparison purposes. Critical pH values of complex formation was graphically determined as described in previous studies. All measurements were carried out in triplicate.

Optionally biomass is homogenized at pH 10 and 12,500 psi. Under these conditions, the granules may exhibit some form of swelling and binding with protein as observed by formation of aggregates of granules observable by light microscopy. These granules are no longer able to be washed to 95% purity using aqueous, acidic or basic washing conditions. These results imply interpenetration beta glucan chains of granules with neighboring granules, possibly also involving bond formation with protein present in the biomass. This modified beta glucan material may also have unique properties with application directly in food system.

The key finding in the report was that the biomass at the higher pH caused the modification of the beta-glucan WITHIN the biomass and not extracted out and that it can contain a combination of any of the forms. That way as well, we do not have to have a purity level.

For the test, aqueous biopolymer mixtures containing PP and BGI were prepared at a total biopolymer concentration of 0.05% and 1% (w/v). The solution pH was adjusted to desired value by the addition of NaOH and HCl [using 0.1, 0.5N and 2N], and was gradually lowered to pH 1.5 by controlled dropwise addition of HCl[using 0.1, 0.5N and 2N].

UV-Vis Absorption: The UV/VIS-spectra of the different NaOH (0.125M, 0.25M, 0.33M, 0.5M 0.75M and 1M) solubilized 1% (w/v) BGI samples were obtained in the wavelength range of 800-200 nm using a Varian Cary 50 Bio UV-Visible spectrophotometer. The data was analysed using Cary 60 software, version 3.

### Viscosity Test

Viscosity was tested on a CGOLDENWALL NDJ-5S Digital Rotational Viscosity Meter with a range of 1-100K mPa·s, rotational testing speeds of 6, 12, 30, 60 rpm, accuracy of ±3.0% of range, and four detachable rotors. The rotor and rotational speed were selected in order for the testing aperture angle percentage to fall between 20% and 85% for accurate viscosity measurements. All of the data was recorded after 30 seconds of mixing.

### SEM

The samples were mounted onto SEN stubs with double sized carbon tape. Paramylon granules were then placed in the chamber of Polaron Model E5100 sputter coaster (Polaron Equipment Ltd, Watfor, Hertfordshire) and approximately 25 nm of gold was deposited onto stubs, and then were viewed in a Tescan Vega II LUS scanning electron microscope (Tescan USA, PA operating at 20 kV. Other samples were visualized on a Hitachi FlexSEM 1000 with EDX utilizing a pre-centered tungsten filament under high vacuum and accelerating voltage of 5.00 kV.

### Rheological Test

The rheological properties of the samples were measured using the Discovery Hybrid Rheometer (from TA Instruments) operating under parallel-plate geometry with a plate diameter of 20 mm and a plate spacing of 1 mm. A strain sweep from 0.1 to 100% strain was first conducted at 1 Hz to identify the linear viscoelastic range of the hydrogels. A strain was then selected from within this linear range and set as a constant to perform a frequency sweep from 1 to 100 rad rad/s to measure the storage modulus (G′) and loss modulus (G″). Each measurement was taken from approximately 0.4 mL of sample. All measurements were conducted at 25° C., with error bars representing the standard deviation of the replicated measurements (n=3 independent samples).

### Viscosity Vs Shear Rate Test

The shear thinning properties of the samples were measured using the Discovery Hybrid Rheometer (from TA Instruments) operating under a 20 mm diameter parallel-plate geometry and a plate spacing of 1 mm. A shear sweep between 0.1 to 100 rad/s was used to measure the viscosity at 4° C., 25° C., and 40° C. Each measurement was taken from approximately 0.4 mL of sample. All measurements were repeated 3 times using independent samples, with error bars representing one standard deviation of the replicated measurements (n=3).

### Elasticity Testing

The compressive modulus of the samples was measured using the MACH-1 (Micromechanical System) under unconstrained compression with the plate diameter of 12.7 mm. The probe was brought to contact, and the sample was subsequently compressed to 20% of its original height at a rate of 0.03 mm per second. All measurements were conducted at 25° C., with error bars representing the standard deviation of the replicate measurements (n=3 independent samples).

### Thermogravimetric Analysis

Thermogravimetric Analysis (TGA) was carried out on a Mettler Toledo TGA/DSC 1 Star System. 10 mg samples was directly weighted into a ceramic pan and then heated from 25 C to 500° C. at a heat rate of 10° C./min.

### Dynamic Scanning Calorimetry

Dynamic Scanning calorimetry (DSC) was carried out on Mettler Toledo Polymer DSC. 3 mg sample was directly weighted into an aluminum pan and heated from −20° C. to 300° C. at a heat rate of 5° C./min with a 5-minute isothermal hold at −20° C. It should be noted that DSC results in this study reflect the thermal memory of materials, meaning that the results are related to the sample's processing methods.

Both TGA and DSC data were analyzed using Software—Mettler STARe version 16.

### Fourier-Transform Infrared Spectroscopy (FTIR)

FT-IR spectra of paramylon products were recorded on a Thermo Scientific Nicolet IS50 FTIR spectrophotometer, equipped with an ATR accessory, at 4000-500 cm⁻¹; 32 scans were performed with a resolution of 4 cm⁻¹. The spectra were analyzed using EZ Ominz software.

In embodiment 1, the food additive comprises paramylon from Euglena sp., wherein the paramylon has a purity of at least about 70%, wherein the paramylon is in granule form, swollen form, elongated form, shell form, solubilized form, gelled form, milled form, or combination thereof, optionally the paramylon is substantially free of at least one of granule form, swollen form, elongated form, shell form, or solubilized form.

In embodiment 2, the food additive comprises biomass from Euglena sp containing paramylon, wherein the paramylon is modified within the biomass, wherein the paramylon is in granule form, swollen form, elongated form, shell form, solubilized form, gelled form, milled form, of combinations thereof.

The food additive of embodiments 1 or 2, wherein the paramylon is in granule form and is more swollen resulting in the biomass becoming more viscous at pH 10 and 12,000 psi.

The food additive of embodiments 1 or 2, wherein the food additive is for use in gelling, thickening, emulsifying, whitening, water-binding, or sweetening a food product, optionally the paramylon is a dried powder, optionally in solution.

The food additive of embodiments 1 or 2, wherein the food additive is for use in forming a gelatinous food product.

The food additive of embodiments 1 or 2, wherein the food additive is for use in increasing viscosity of a food product.

The food additive of embodiments 1 or 2, wherein the paramylon increases tensile strength of the food product by about 0 g/cm2 to about 3000 g/cm2 after maintaining a temperature at 0° C. and about 100° C. for about 2 min to about 2 h, at a pH of between about 2 and about 10, wherein the paramylon is between about 0.1% and about 50% (w/v) of the food product, optionally further comprising calcium chloride of between about 0.05% and about 1.5% (w/v), and wherein the food product is a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake, a soup, a dumpling, a gravy, a pasta, a jelly, or a cake product.

The food additive of embodiments 1 or 2, wherein the paramylon has a hydrophilic-lipophilic balance (HLB) of between about 0 and about 20.

The food additive of embodiments 1 or 2, wherein the paramylon increases viscosity of the food product by about 1 mPa·s to about 100,000 mPa·s at 25° C.

The food additive of the above embodiments, wherein the food additive is for use in emulsifying a food product.

The food additive of embodiments 1 or 2, wherein the food additive is for use in whitening a food product.

The food additive of the above embodiment, wherein the paramylon has a refractive index between about 1.3 and about 2.6 at λ=about 589 nm, and wherein the paramylon comprises granule form paramylon.

The food additive of the above embodiments, wherein the paramylon increases refractive index of the food product by between about 0.1 and about 1 at λ=about 589 nm.

The food additive of embodiments 1 or 2, wherein the food additive is spray dried.

The food additive of the above embodiments, wherein the spray dried method is selected from the group consisting of spray drying, drum drying, falling film evaporation, oven drying, vacuum drying, freeze drying, and solar drying.

The food additive of embodiments 1 or 2, wherein the food additive is for use in water-binding a food product.

The food additive of the above embodiments, wherein the paramylon has a water holding capacity between about 0.70 g and about 1.50 g water per g paramylon, optionally about 1.10 g and about 1.30 g water per g paramylon.

The food additive of the above embodiments, wherein the paramylon increases water holding capacity of the food product between about 1.10 g and about 1.30 g water per g paramylon.

The food additive of embodiments 1 or 2, wherein the paramylon is for use in sweetening a food product.

The food additive of the above embodiments, wherein the paramylon is hydrolyzed paramylon having sweetness between about 0.1 and about 0.7 relative to sucrose.

The food additive of the above embodiments, wherein the food additive is between about 0.1% and about 50% (w/w) of the food product.

The food additive of the above embodiments, wherein the hydrolysis comprises treating the paramylon with a beta-glucanase at from about 37° C. to about 42° C. for about 16 h to about 24 h, optionally at about 40° C. for about 16 h.

In embodiment 3, the encapsulated oil comprises an oil and paramylon from Euglena sp. having purity of at least about 70%, wherein the paramylon comprises granule form, swollen form, elongated form, and/or shell form paramylon, and wherein the molar ratio of paramylon to oil is from about 1:2 to about 1:100.

The encapsulated oil of embodiment 3, wherein the oil is selected from the group a canola oil, a soybean oil, a sunflower oil, an olive oil, a palm oil, a safflower oil, a peanut oil, a sesame oil, a grapeseed oil, a cottonseed oil, an avocado oil, and an Euglena derived oil.

The encapsulated oil of the above embodiments, wherein the oil comprises medium-chain triglycerides (MCT), palmitic acid, omega-3 fatty acids eicosapentaenoic acid (EPA) and docosahexaenoic acid (DHA), or oleic acid.

In embodiment 4, the gelatinous food product comprises a food composition and paramylon from Euglena sp. having purity of at least about 70%, wherein the paramylon is between about 0.1% and about 50% (w/v) of the gelatinous food product, optionally further comprising calcium chloride of between about 0.05% and about 1.5% (w/v).

The gelatinous food product of embodiment 4, wherein the paramylon comprises granule form paramylon.

The gelatinous food product of the above embodiments, wherein the tensile strength of the food product is from about 1 g/cm2 to about 3000 g/cm2.

The gelatinous food product of the above embodiments, wherein the food product is selected from the group consisting of a spreadable food stuff product, a confectionery product, a savory product, a dairy product, a dairy substitute product, and a drink product.

The gelatinous food product of the above embodiments, wherein the food product is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, and a meal replacement shake.

In embodiment 5, the whitened food product comprises a food composition and paramylon from Euglena sp. having purity of at least about 70%, wherein the paramylon is between about 0.1% and about 50% (w/w) of the whitened food product, wherein the paramylon comprises granule form paramylon, and wherein the paramylon has a refractive index between about 1.3 and about 2.6 at λ=about 589 nm.

The whitened food product of embodiment 5, wherein the paramylon is spray dried.

The whitened food product of the above embodiments, wherein the refractive index of the whitened food product is at least about 0.1 at λ=about 589 nm.

The whitened food product of the above embodiments, wherein the food product is selected from the group consisting of a dairy product, a dairy substitute product, a confectionary product, and a drink product.

The whitened food product of the above embodiments, wherein the food product is selected from the group consisting of a creamer, a yogurt, an ice cream, a whipped cream, a pudding, a powdered milk base product, a cheese, a cream cheese, a sour cream, a low fat dairy product, a non-dairy creamer, a non-dairy ice cream, a non-dairy yogurt, a non-dairy whipped cream, a non-dairy pudding, a non-dairy milk base product, a non-dairy cream, a non-dairy sour cream, a low fat non-dairy food product, a chocolate with a hard coating, a chocolate without a hard coating, a hard candy, a soft gummy candy, a marshmallows, an icing, a fondant, a jelly bean, a flavoured syrup, a chocolate syrup, a protein shake, and a meal replacement shake.

In embodiment 6, the sweetened food product comprises a food composition and a hydrolyzed paramylon, wherein the hydrolyzed paramylon comprises glucose oligomers from Euglena sp., and wherein the paramylon has purity of at least about 70%.

The sweetened food product of embodiment 6, wherein the food product is a drink product or a custard product.

The sweetened food product of the above embodiments, wherein the food product is selected from the group consisting of a drink crystal, a trifle, a custard, and a pudding.

In embodiment 7, the non-dairy creamer comprises paramylon from Euglena sp. having purity of at least about 70%, an oil, and a lecithin, wherein the paramylon is between about 0.1% and about 50% (w/v) of the non-dairy creamer, optionally comprises calcium chloride of between about 0.05% and about 1.5% (w/v).

The non-dairy creamer of embodiment 7, wherein the oil is a canola oil, and wherein the oil is between about 5% and about 20% (w/v), optionally about 10% (w/v), of the non-dairy creamer.

The non-dairy creamer of the above embodiments, wherein the lecithin is a soy lecithin, a mono-glyceride, a di-glyceride, or a sunflower lecithin, and wherein the lecithin is between about 0.1% and about 5% (w/v), optionally about 1% (w/v), of the non-dairy creamer.

In embodiment 8, the method of forming a gelatinous food product, comprises: combining paramylon from Euglena sp. having purity of at least about 70% with a food composition to form a food product, maintaining a temperature at between about 0° C. and about 100° C. for about 2 min to about 2 h, at a pH of between about 2 and about 10, wherein the paramylon is between about 0.1% and about 50% (w/v) of the food product, optionally further comprising combining calcium chloride of between about 0.05% and about 1.5% (w/v), thereby gelatinizing the food product to form the gelatinous food product.

The method of embodiment 8, wherein the paramylon comprises granule form paramylon.

The method of the above embodiments, wherein the tensile strength of the gelatinous food product is increased by about 0 g/cm2 to about 3000 g/cm2 compared to the food product prior to gelatinization.

The method of the above embodiments, wherein the food product is selected from the group consisting of a spreadable food stuff product, a confectionery product, a savory product, a dairy product, a dairy substitute product, and a drink product.

The method of the above embodiments, wherein the food product is selected from the group consisting of a jam, a jelly, a nut butter, a hard candy, a gummy candy including a soft gummy candy, a chocolate syrup, a flavoured syrup, a fruit snack, a fruit gel bar, a gelatin substitute product, an aspic, a creamer, a yogurt, a cheese, a cream cheese, a sour cream, a low fat dairy product, a non-dairy creamer, a non-diary yogurt, a non-dairy cream cheese, a non-dairy sour cream, a low fat non-dairy product, a protein shake, a meal replacement shake.

In embodiment 9, the method of increasing viscosity of a food product, comprises: combining paramylon from Euglena sp. having purity of at least about 70%, with a food composition to form the food product, wherein the paramylon is between about 0.1% and about 50% (w/w) of the food product, and wherein the paramylon increases viscosity of the food product by about 1 mPa·s to about 100,000 mPa·s at 25° C., thereby forming the food product with increased viscosity.

The method of the above embodiments, wherein the paramylon comprises shell, elongated, and/or soluble form paramylon.

The method of the above embodiments, wherein the food product is selected from the group consisting of a dairy product, a bakery product, a confectionery, a sauce, and a savory product.

The method of the above embodiments, wherein the food product is selected from the group consisting of a gum, a hard candy, a chocolate with a hard coating/shell, a chocolate without a hard coating/shell, a creamer, an instant breakfast shake, a coffee flavouring agent, a pudding, a powdered milk based product, a marshmallow, a chocolate syrup, a low-fat dairy product, a mayonnaise, a whipped cream, a salad dressing, an icing, a drink crystal, a donuts, a toasted pastry, an ice cream, a meat casing, and a yogurt.

In embodiment 10, the method of emulsifying a food product, comprises: combining paramylon from Euglena sp. having purity of at least about 70% with a food composition to form the food product, and homogenizing the food product, wherein the paramylon is between about 0.1% and about 50% (w/w) of the food product, and optionally wherein the emulsified food product is stable for up to six months, thereby emulsifying the food product to form an emulsified food product.

The method of the above embodiments, wherein the paramylon comprises elongated and/or shell form paramylon.

The method of the above embodiments, wherein the food product is a dairy product, or a sauce.

The method of the above embodiments, wherein the food product is selected from the group consisting of a creamer, yogurt, whipped cream, a salad dressing, and a mayonnaise.

In embodiment 11, the method of forming a whitened food product, comprises: combining paramylon from Euglena sp. having purity of at least about 70% with a food composition to form a food product, wherein the paramylon is between about 0.1% and about 50% (w/w) of the food product, wherein the paramylon comprises granule form paramylon, and wherein the paramylon has a refractive index between about 1.3 and about 2.6 at λ=about 589 nm, thereby whitening the food product to form the whitened food product.

The method of the above embodiments, wherein the paramylon is spray dried.

The method of the above embodiments, wherein the paramylon increases the refractive index of the food product by between about 0.1 and about 1 at λ=about 589 nm.

The method of the above embodiments, wherein the food product is selected from the group consisting of a dairy product, a dairy substitute product, a confectionary product, and a drink product.

The method of the above embodiments, wherein the food product is selected from the group consisting of a creamer, a yogurt, an ice cream, a whipped cream, a pudding, a powdered milk base product, a cheese, a cream cheese, a sour cream, a low fat dairy product, a non-dairy creamer, a non-dairy ice cream, a non-dairy yogurt, a non-dairy whipped cream, a non-dairy pudding, a non-dairy milk base product, a non-dairy cream, a non-dairy sour cream, a low fat non-dairy food product, a chocolate with a hard coating, a chocolate without a hard coating, a hard candy, a soft gummy candy, a marshmallows, an icing, a fondant, a jelly bean, a flavoured syrup, a chocolate syrup, a protein shake, and a meal replacement shake.

In embodiment 12, the method of increasing water binding in a food product, comprises: combining paramylon from Euglena sp. having purity of at least about 70%, with a food composition to form the food product, wherein the paramylon comprises granule form, swollen form, shell form and/or elongated form, and wherein the paramylon has a water holding capacity from about 0.70 g to about 0.85 g water per g paramylon, optionally from about 0.74 g to about 0.79 g water per g paramylon, thereby forming the food product with increased water binding.

The method of the above embodiments, wherein the food product is selected from the group consisting of a bakery product, a dairy product, a dairy substitute product, a drink product, a meat product, a protein substitute product, and a sauce.

The method of the above embodiments, wherein the food composition comprises a food product selected from the group consisting of a toasted pastry products, a donut, a muffin, a cookie, a cake product, a protein bar, a granola bar, a creamer, a yogurt, an ice cream, a whipped cream, a pudding, a powdered milk base product, a cheese, a cream cheese, a protein shake, a meal replacement shake, a meat casing, a sausages such as a pork, a beef, a chicken, or a turkey sausage, a patty such as a beef, a chicken, a pork, or a turkey sausage, a ground meat such as a beef, a chicken, a pork, or a turkey sausage, a chicken meat substitute, a beef substitute, a pork substitute, a turkey meat substitute, an egg substitute, an egg protein substitute, a soy protein substitute, a pea protein substitute, a salad dressing, a mayonnaise, a ketchup, a mustard, a tomato pasta sauce, a tomato sauce, a vinaigrette, a marinade, a BBQ sauce, and a gravy.

In embodiment 13, the method of sweetening a food product, comprises: combining a hydrolyzed paramylon to a food composition to form the food product, wherein the hydrolyzed paramylon comprises hydrolyzed paramylon from Euglena sp. that is enriched with glucose oligomers, and wherein the paramylon has purity of at least about 70%, thereby sweetening the food product to form a sweetened food product.

The method of the above embodiments, wherein the hydrolysis of paramylon comprises treating the paramylon with a beta-glucanase, at from about 37° C. to about 42° C. for about 16 h to about 24 h, optionally at about 40° C. for about 16 h.

The method of the above embodiments, wherein the food product is a drink product or a custard product.

The method of the above embodiments, wherein the food product is selected from the group consisting of a drink crystal, a trifle, a custard, and a pudding.

In embodiment 14, the method of encapsulating an oil, comprises: combining paramylon from Euglena sp. having purity of at least about 70% with the oil to form a mixture, homogenizing the mixture to form a homogenized mixture, spray drying the homogenized mixture, and wherein the molar ratio of paramylon to oil is from about 1:2 to about 1:100 wherein the paramylon comprises granule form, swollen form, elongated form, and/or shell form paramylon, and wherein the microencapsulation efficiency is at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, at least about 99%, or about 100%, thereby encapsulating the oil to form an encapsulated oil.

The method of the above embodiments, wherein the oil is selected from the group consisting a canola oil, a soybean oil, a sunflower oil, an olive oil, a palm oil, a safflower oil, a peanut oil, a sesame oil, a grapeseed oil, a cottonseed oil, an avocado oil, and Euglena derived oil.

The method of the above embodiments, wherein the oil comprises medium-chain triglycerides (MCT), palmitic acid, omega-3 fatty acids eicosapentaenoic acid (EPA) and docosahexaenoic acid (DHA), or oleic acid.

The method of the above embodiments, wherein the homogenizing comprises high pressure homogenizing.

The method of the above embodiments, wherein the encapsulated oil has a peroxide value lower than an unencapsulated oil.

The method of the above embodiments, wherein the encapsulated oil has a peroxide value of less than about 2.5 mEq/Kg, optionally less than about 1 mEq/Kg.

In embodiment 15, the method for preparing a food additive comprises: paramylon from Euglena sp., comprising suspending Euglena biomass with aqueous solution, optionally water, to between 5-15% (w/w) solids, preferred 10% (w/w), optionally adjusting pH to between about 3 and about 10, optionally 4.5, homogenizing the resuspended Euglena biomass, optionally at between about 12 L/h and about 36 L/h, optionally at about 24 L/h, obtaining a homogenate target product comprising paramylon, collecting a second paramylon pellet by centrifugation, and washing the second paramylon pellet with aqueous solution, optionally water or base, by resuspending the second pellet, centrifuging the second pellet, and removing supernatant, optionally adjusted to pH between about 9 and about 11, optionally about 10, wherein the iv) washing is repeated at least five times, thereby forming the food additive.

The method of the above embodiments, wherein the homogenate target product is a paramylon pellet, optionally obtained by centrifugation.

The method of the above embodiments, further comprises after ii), suspending the pellet in aqueous solution, optionally water, equal to between about 75% and about 125%, optionally between about 85% and about 115%, optionally about 100%, of weight of the biomass, with agitation at between about pH 9 and about pH 11, optionally about pH 10, optionally for about 10 minutes to about 1 hour.

In embodiment 16, the method of producing a non-dairy creamer, comprises: combining with water, paramylon from Euglena sp. having purity of at least about 70%, wherein the paramylon is between about 1% and about 20% (w/v), optionally about 1%, about 5%, or about 10% (w/v), of the non-dairy creamer, an oil, optionally a canola oil, a sunflower oil, a MCT, a palm oil, a vegetable oil, a soy oil, a peanut oil, an avocado oil, or a grapeseed oil, wherein the oil is between about 5% and about 20% (w/v), optionally about 10% (w/v), of the non-dairy creamer, and a lecithin, optionally a soy lecithin, a mono-glyceride, a di-glyceride, or a sunflower lecithin, wherein the lecithin is between about 0.1% and about 5% (w/v), optionally about 1% (w/v), of the non-dairy creamer, to form a mixture, homogenizing the mixture, thereby forming the non-dairy creamer.

The method of the above embodiments, wherein the paramylon is in a dried powder or a wet gel form.

The method of the above embodiments, wherein the paramylon was processed by solubilizing in alkali base prior to adjusting using an acid to a pH from about 6 to about 8, optionally about pH 7.

The method of the above embodiments, wherein the alkali base is sodium hydroxide, and wherein the acid is hydrochloric acid.

The method of the above embodiments, wherein the wet gel form paramylon further comprises calcium chloride of between about 0.05% and about 1.5% (w/v).

In embodiment 16, the method of synergistically emulsifying, thickening, increasing viscosity, whitening, increasing water holding capacity, flavor masking, or forming a gelatinous food product, comprises: combining with a food composition, paramylon from Euglena sp. having purity of at least about 70%, and a gum, wherein the paramylon is between about 1% and about 20% (w/v), optionally about 1%, about 5%, or about 10% (w/v), of the food product, thereby forming the food product.

The method of the above embodiments, wherein the gum is selected a group consisting of a carboxymethyl cellulose (CMC), a kappa carrageenan, an iota carrageenan, a lambda carrageenan, a high methoxyl pectin, a low methoxyl pectin, a xanthan gum, a guar gum, a locust bean gum, a konjac gum, a gellan gum, a gum arabic, Xanthan, Methyl cellulose (MC), hydroxypropylmethyl cellulose (HPMC), Gum Arabic, Galactomannans (Guar gum, Locust bean gum and tara gum), Konjac mannan, Gum Tragacanth, Propylene glycol alginate (PGA), Modified starch, Microcrystalline cellulose (MCC), Carrageenan, Konjac glucomannan, Fenugreek gum, Konjac gum, Pectin, Cellulose derivatives, Gelatin, Alginate, and any combination thereof.

The method of the above embodiments, wherein the gum is between about 0.25% and about 5% (w/v), optionally about 0.5%, about 0.75%, or about 1% (w/v), of the food product.

The method of the above embodiments, wherein the paramylon can be in one or more form selected from the group selected from granule form, swollen form, elongated form, shell form, solubilized form, gelled form, milled form, or combination thereof.

In embodiment 17, the method of synergistically emulsifying, thickening, increasing viscosity, whitening, increasing water holding capacity, flavor masking, or forming a gelatinous food product, comprises: combining with a food composition, paramylon from Euglena sp. having purity of at least about 70%, and wherein the paramylon is between about 1% and about 50% (w/v), optionally about 1%, about 5%, or about 10% (w/v), of the food product, thereby forming the food product.

The method of the above embodiments, wherein the paramylon can be in one or more form selected from the group selected from granule form, swollen form, elongated form, shell form, solubilized form, gelled form, milled form, or combination thereof.

In embodiment 18, the method for producing at least one of swollen, elongated, shell, and soluble form paramylon comprises combining a base with the granule form paramylon to form the at least one of swollen, elongated, shell, and soluble form paramylon.

The method of the above embodiments, wherein the base is an alkali hydroxide, optionally sodium hydroxide, potassium hydroxide, or lithium hydroxide.

The method of the above embodiments, wherein the base is between about 0.25M and about 1M, optionally about 0.25M, about 0.33M, about 0.5M, about 0.75M, or about 1M.

The food additive of any one of the above embodiments, wherein the food additive has a taste masking effect.

The food additive of any one of the above embodiments, wherein the food additive has a settling effect on plant proteins.

In any one of the previous embodiments, wherein the Euglena sp. is selected from the group consisting of Euglena gracilis, Euglena sanguinea, Euglena deses, Euglena mutabilis, Euglena acus, Euglena virdis, Euglena anabaena, Euglena geniculata, Euglena oxyuris, Euglena proxima, Euglena tripteris, Euglena chlamydophora, Euglena splendens, Euglena texta, Euglena intermedia, Euglena polymorpha, Euglena ehrenbergii, Euglena adhaerens, Euglena clara, Euglena elongata, Euglena elastica, Euglena oblonga, Euglena pisciformis, Euglena cantabrica, Euglena granulata, Euglena obtusa, Euglena limnophila, Euglena hemichromata, Euglena variabilis, Euglena caudata, Euglena minima, Euglena communis, Euglena magnifica, Euglena terricola, Euglena velata, Euglena repulsans, Euglena clavata, Euglena lata, Euglena tuberculata, Euglena contabrica, Euglena ascusformis, Euglena ostendensis, and combinations thereof.

The following non-limiting Examples are illustrative of the present disclosure. Unless otherwise indicated, the above general methods and instrumental techniques were utilized in the following non-limiting Examples.

### Example 1: Solubilization of Paramylon

### Introduction

This experiment shows impact of temperature and solids loading on the pH at which paramylon is solubilized. Furthermore, it shows effects of pH and NaOH concentration on different transitory states, i.e. swollen form, elongated form, and shells form, on the way to solubilization.

### Materials and Methods

### Growth of Euglena and Isolation of Paramylon

Euglena gracilis cells were grown heterotrophically in media comprised of glucose, yeast extract, potassium phosphate, magnesium phosphate, calcium sulphate, trace metals, ammonium sulphate and the following vitamins: Biotin (B7), Thiamine HCl (B1), B6 and B12. Paramylon was extracted as follows: Euglena biomass was heat inactivated at 40° C. for 1-hour by heating jacket prior to dewatering. Dewatering was conducted using an Alfa Laval disc stack style high speed separator. Alternatively, dewatering can be conducted by any method of cell harvesting known to those skilled in the art, including but not limited to filtration, centrifugation and or settling, or any combination thereof. The harvested biomass was collected at approximately 10% to 30% solids after dewatering. Following dewatering, the solids content is adjusted to 10% solids using water and neutralized to pH 6.5-7.5 using 10% w/v aqueous NaOH, however, other pH values in the range of 2-10 are used optionally and influence the phase separation of the homogenate. The resuspended biomass is homogenized using a high-pressure homogenizer at anywhere from 1,000 psi to 14,000 psi at room temperature, with a preferred condition of 12,500 psi at about 20 to 27° C. Homogenization time is dependent on the volume, i.e. 24 L/h. The collected homogenate is centrifuged at 5,000 rpm for 5 min (or 3,500 rpm for 10 min) at room temperature. The pellet contains a layer of low solubility protein on top of a layer of paramylon. The protein is removed physically by scraping and the paramylon is washed using 3 repeated resuspensions and centrifugations in clean water. Following washing with water, the paramylon is spray dried. Optionally, the washed paramylon is dried using a Labconco freeze dryer.

### Confirmation of Identity and Purity of Paramylon

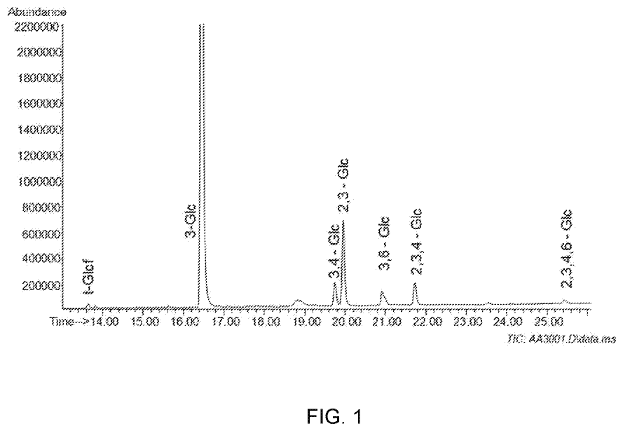

The identity of the product isolated from E. gracilis as paramylon is principally confirmed based upon microscopic investigation. The isolated white sediment which has a gravimetrically determined moisture content between 30-60% and the final white powder are examined by light microscopy, and granules of identical morphology to those seen in whole cells are observed. The isolated paramylon concentrate is made of approximately 88% beta-1,3-glucan, as determined by carbohydrate linkage analysis conducted at The Complex Carbohydrate Research Centre in Athens, Ga., USA (see Table 1 and FIG. 1 for Linkage Analysis Results). In addition, POS Bio-Science in Saskatoon, Saskatchewan a commercial analytical lab, has also analyzed the material for beta-1,3-linked glucan and beta-1,6-linked glucan, and determined the content to be approximately 85% w/w beta-1,3-glucan.

TABLE 1
Glycosyl Linkage Analysis results
from paramylon concentrate sample

| Peak | Area % |
|---|---|
| Terminally linked Glucose residue (t-Glcf) | 0.35 |
| 3 linked Glucopyranosyl residue (3-Glc) | 87.56 |
| 3,4 linked Glucopyranosyl residue (3,4-Glc) | 1.87 |
| 2,3 linked Glucopyranosyl residue (2,3-Glc) | 6.95 |
| 3,6 linked Glucopyranosyl residue (3,6-Glc) | 1.17 |
| 2,3,4 linked Glucopyranosyl residue (2,3,4-Glc) | 1.82 |
| 2,3,4,6 linked Glucopyranosyl residue (2,3,4,6-Glc) | 0.28 |

The purity of paramylon by the method described herein is shown in Table 2. The purity of the paramylon product has been assayed by multiple methods including the Megazyme method for beta-1,3/1,6-linkages in yeast (i.e. Enzymatic Yeast®-Glucan Assay Kit from Megazyme) which has yielded a result of approximately 85% purity. Two other methods have also been used, both of which are used in GRAS Notice No. 698 (ATCC PTA-123017) prepared by Algal Scientific Corporation (ASC). This notice provided three methods for analyzing paramylon purity, which claimed to provide consistent results. The first method is an enzyme assay similar to the Megazyme kit, the second is total dietary fibre, and the third is named the ASC method. The ASC method does not rely on digestion but relies on the removal of cellular components including proteins, oils and other carbohydrates from the paramylon sample.

The ASC method was typically carried out as follows: 1) 0.5 g paramylon sample and a magnetic stir bar were added to an empty centrifuge tube; 2) 25 mL deionized water was added to the tube and the tube was put on a magnetic stirrer for >8 hours at room temperature; 3) stirred sample was sedimented by centrifugation at ˜4,700×g for 10 min whereby the supernatant was removed; 4) 25 mL 2% SDS solution was added to the pellet and the tube was heated at 110° C. (in an oil bath) for 30 min with stirring; 5) stirred sample was sedimented by centrifugation at 4,700×g for 10 min, whereby the supernatant was discarded; 6) steps 4-5 were repeated; 7) 25 mL 70% isopropyl alcohol was added to the pellet and resuspended by vortexed for 15 min; 8) the resuspended pellet was sedimented by centrifugation at 4,700×g for 10 min whereby the supernatant was decanted; 9) 25 mL 95% ethanol was added to the remaining pellet and resuspended by vertexing for 5 min; 10) the stir bar was removed from the tube; 11) the resuspended pellet was sedimented by centrifugation at 4,700×g for 10 min, whereby supernatant was decanted; 12) the pellet was stored at −80° C. and freeze-dried prior to recording the final paramylon weight; 13) purity of paramylon was calculated by dividing the final sample weight by the initial sample weight and multiplying by 100%.

A method similar to the Megazyme method is employed in the present analysis (i.e. in-house Megazyme), of which the principle is as follows: 1,3-beta-glucans are solubilized and hydrated in 2 M potassium hydroxide and the solution is subsequently adjusted to pH 4.0-4.5 with 1.2 M sodium acetate buffer. The slurry is incubated with Glucazyme (trademark) enzyme mixture (Beta-glucanases, beta-glucosidase, and chitinase) for 16 hours at 40° C. After dilution and centrifugation, an aliquot is removed for determination of glucose with GOPOD (The Megazyme Glucose Determination Reagent, glucose oxidase/peroxidase) reagent (forms a coloured product in presence of glucose). A control of yeast beta glucan is also digested, and a standard solution of glucose is used as calibrant.

Without wishing to be bound by theory, the POS kit works the same way, although this procedure refers to the initial solubilization/hydration step in sulfuric acid instead of potassium hydroxide.

Table 2 shows the purity of paramylon isolated by the methods described herein, as analyzed by using the various analytical methods. Methods used were 1) in-house Megazyme method, 2) the POS Bio-Sciences Megazyme method, 3) the ASC method. Another method that Algal Scientific reported was the FCC method, which is similar but not identical to Megazyme, as it uses a slightly different group of enzymes, and carries out sequential, instead of batch digestion.

TABLE 2
Purity of isolated paramylon

| | In-house | POS | POS Total | |
|---|---|---|---|---|
| | Megazyme | Megazyme | Dietary | |
| | (1,3/1,6 | (1,3/1,6 | Fibre | ASC |
| | linkages) | linkages) | (AACC 32-05) | Method |
| Paramylon | 83% | 86% | 87% | 98.6% |
| isolated | | | | |
| from present | | | | |
| method | | | | |

Analysis of paramylon isolated by the method described herein yields 85-95% purity as determined by the total dietary fibre method, whereas analysis with the ASC method yields purities of 98-99%.

### Solubilization

To observe the effects of pH on paramylon granule structure, alkaline solutions of sodium hydroxide (1 M, 0.75 M, 0.5 M, 0.33 M, 0.25 M and 0.125 M) were prepared in distilled water and used to dissolve and suspend different concentrations of paramylon granules (0.01, 0.1, 1, 5 and about 10% w/v paramylon). Each of these treatments (pH and paramylon (w/v)) was done in triplicate, with one set being solubilized at room temperature, one set being solubilized at ˜4° C., and one set being solubilized at 70° C. in a water bath.

Following solubilization and suspension at each concentration, the samples were shaken for approximately 15 minutes before being examined under the microscope. Pictures were then taken at 60× magnification to observe the morphology of the paramylon granules. At this point, the pH of the solutions was also recorded.

Additionally, an attempt was made to freeze-dry a partially solubilized state to see if paramylon granule structure was preserved during the drying process. After freeze drying, the powder was placed in distilled water and viewed under the microscope for visual observation to determine if the form was preserved during the drying process. It was observed that the form (i.e. swollen, elongated or shell) was not preserved during freeze drying. This lack of structural preservation may be due to the slow, gradual removal of water from the sample, but the base, i.e. NaOH, remained when freeze drying the sample. As this freezing occurred, the base and paramylon were concentrated together leading to solubilization of the granules. Alternatively, when the modified granules were spray dried instead of freeze dried, the granule structure was preserved. This could be the result of rapid drying that may not have allowed enough time for interaction of the paramylon in solution with base to destroy the granule structure.

### Results

Tables 3-7 show the results of studies investigating the effect of different sodium hydroxide concentrations and temperature on the solubilization and morphology of paramylon granules. Colder temperatures and higher concentrations of base yielded higher solubilization. Intermediate forms of paramylon, which could be repeatedly generated on the path to solubilization, were observed and can be seen graphically in the tables.

TABLE 3
Results of solubilization of 0.01% (w/v) paramylon solutions
in different concentrations of base at 3 different temperatures.
Temperatures are in parentheses.

| | | | Room | |
|---|---|---|---|---|
| [NaOH] | | 4° C. | Temperature | 70° C. |
| (M) | pH | form | form | form |
| 0.125 | 12.90 (4° C.) | Granules | Granules | Swollen |
| | 12.67 (RT) | | | granules |
| | 10.98 (70° C.) | | | |
| 0.25 | 13.03 (4° C.) | Shells/ | Swollen | Swollen |
| | 12.87 (RT) | mostly | granules | granules |
| | 11.23 (70° C.) | solubilized | | |
| 0.33 | 13.09 (4° C.) | Solubilized | Elongated | Swollen |
| | 12.92 (RT) | | granules | granules |
| | 11.35 (70° C.) | | | |
| 0.5 | 13.10 (4° C.) | Solubilized | Shells/ | Swollen - |
| | 13.05 (RT) | | mostly | elongated |
| | 11.46 (70° C.) | | solubilized | granules |
| 0.75 | 13.17 (4° C.) | Solubilized | Solubilized | Elongated |
| | 13.14 (RT) | | | granules |
| | 11.50 (70° C.) | | | |
| 1 | 13.23 (4° C.) | Solubilized | Solubilized | Shells |
| | 13.17 (RT) | | | |
| | 11.75 (70° C.) | | | |

TABLE 4
Results of solubilization of 0.1% (w/v) paramylon solutions
in different concentrations of base at 3 different
temperatures. Temperatures are in parentheses.

| | | | Room | |
|---|---|---|---|---|
| [NaOH] | | 4° C. | Temperature | 70° C. |
| (M) | pH | form | form | form |
| 0.125 | 12.71 (4° C.) | Granules | Granules | Granules |
| | 12.76 (RT) | | | |
| | 11.00 (70° C.) | | | |
| 0.25 | 12.84 (4° C.) | Elongated | Swollen | Swollen |
| | 12.92 (RT) | granules/ | granules | granules |
| | 11.24 (70° C.) | shells | | |
| 0.33 | 12.93 (4° C.) | Shells/ | Elongated | Swollen/ |
| | 13.03 (RT) | mostly | granules | elongated |
| | 11.34 (70° C.) | solubilized | | granules |
| 0.5 | 13.15 (4° C.) | Solubilized | Shells/ | Swollen/ |
| | 13.10 (RT) | | mostly | elongated |
| | 11.46 (70° C.) | | solubilized | granules |
| 0.75 | 13.20 (4° C.) | Solubilized | Solubilized | Elongated |
| | 13.18 (RT) | | | granules/ |
| | 11.51 (70° C.) | | | shells |
| 1 | 13.21 (4° C.) | Solubilized | Solubilized | Shells/mostly |
| | 13.23 (RT) | | | solubilized |
| | 11.61 (70° C.) | | | |

TABLE 5
Results of solubilization of 1% (w/v) paramylon solutions
in different concentrations of base at 3 different
temperatures. Temperatures are in parentheses.

| | | | Room | |
|---|---|---|---|---|
| [NaOH] | | 4° C. | Temperature | 70° C. |
| (M) | pH | form | form | form |
| 0.125 | 12.776 (4° C.) | Granules | Granules | Granules |
| | 12.62 (RT) | | | |
| | 11.02 (70° C.) | | | |
| 0.25 | 12.929 (4° C.) | Elongated | Swollen | Swollen |
| | 12.83 (RT) | granules | granules | granules |
| | 11.25 (70° C.) | | | |
| 0.33 | 12.948 (4° C.) | Elongated | Elongated | Swollen/ |
| | 12.91 (RT) | granules/ | granules | elongated |
| | 11.32 (70° C.) | shells | | granules |
| 0.5 | 12.971 (4° C.) | Solubilized | Shells/mostly | Swollen/ |
| | 13.02 (RT) | | solubilized | elongated |
| | 11.42 (70° C.) | | | granules |
| 0.75 | 13.018 (4° C.) | Solubilized | Solubilized | Elongated |
| | 13.12 (RT) | | | granules/ |
| | 11.45 (70° C.) | | | shells |
| 1 | 13.080 (4° C.) | Solubilized | Solubilized | Solubilized |
| | 13.18 (RT) | | | |
| | 11.53 (70° C.) | | | |

TABLE 6
Results of solubilization of 5% (w/v) paramylon solutions
in different concentrations of base at 3 different
temperatures. Temperatures are in parentheses.

| | | | Room | |
|---|---|---|---|---|
| [NaOH] | | 4° C. | Temperature | 70° C. |
| (M) | pH | form | form | form |
| 0.125 | 12.721 (4° C.) | Granules | Granules | Granules |
| | 12.514 (RT) | | | |
| | 11.03 (70° C.) | | | |
| 0.25 | 12.807 (4° C.) | Swollen | Swollen | Granules |
| | 12.658 (RT) | granules | granules | |
| | 11.19 (70° C.) | | | |
| 0.33 | 12.796 (4° C.) | Swollen | Swollen | Granules/ |
| | 12.962 (RT) | granules/ | granules/ | swollen |
| | 11.29 (70° C.) | elongated | elongated | granules |
| | | granules | granules | |
| 0.5 | 12.898 (4° C.) | Shells | Elongated | Swollen |
| | 12.816 (RT) | | granules/ | granules/ |
| | 11.38 (70° C.) | | shells | elongated |
| | | | | granules |
| 0.75 | 12.985 (4° C.) | Shells/ | Shells/ | Elongated |
| | 13.147 (RT) | mostly | mostly | granules/ |
| | 11.45 (70° C.) | solubilized | solubilized | shells |
| 1 | 13.019 (4° C.) | Solubilized | Solubilized | Shells/ |
| | 13.018 (RT) | | | mostly |
| | 11.47 (70° C.) | | | solubilized |

TABLE 7
Results of solubilization of 10% (w/v) paramylon solutions
in different concentrations of base at 3 different
temperatures. Temperatures are in parentheses.

| | | | Room | |
|---|---|---|---|---|
| [NaOH] | | 4° C. | Temperature | 70° C. |
| (M) | pH | form | form | form |
| 0.125 | 12.648 (4° C.) | Granules | Granules | Granules/ |
| | 12.490 (RT) | | | Swollen |
| | 11.03 (70° C.) | | | Granules |
| 0.25 | 12.719 (4° C.) | Swollen | Swollen | Swollen |
| | 12.62 (RT) | granules | granules | granules |
| | 11.16 (70° C.) | | | |
| 0.33 | 12.791 (4° C.) | Swollen | Swollen | Swollen |
| | 12.70 (RT) | granules/ | granules/ | granules/ |
| | 11.22 (70° C.) | elongated | elongated | elongated |
| | | granules | granules | granules |
| 0.5 | 12.835 (4° C.) | Swollen | Swollen | Swollen |
| | 12.75 (RT) | granules/ | granules/ | granules/ |
| | 11.29 (70° C.) | elongated | elongated | elongated |
| | | granules | granules | granules |
| 0.75 | 12.911 (4° C.) | Shells | Elongated | Swollen |
| | 12.84 (RT) | | granules/ | granules/ |
| | 11.41 (70° C.) | | shells | elongated |
| | | | | granules |
| 1 | 13.002 (4° C.) | Mostly | Shells/ | Elongated |
| | 12.95 (RT) | solubilized | mostly | granules/ |
| | 11.42 (70° C.) | | solubilized | shells |

### DISCUSSION

While analyzing the dissolution of paramylon granules in alkaline media, four major forms of paramylon were observed depending on the pH of solution. These forms included 1) granules, as normally seen in water, or even within the cells of Euglena directly 2) swollen granules, seen around pH 12.6 (0.25 M NaOH). The swollen form is distinct in that granule expansion has happened along the long and short axis. This may be the result of swollen of the amorphous or the peripheral crystalline regions changing to amorphous forms, thereby increasing in volume. 3) elongated granules, wherein the expansion is dramatically greater along the long axis of the granules, with subsequent narrowing across the short axis. This form may be the result of increased tensile force along the granule, which may be the result of increased negative charge accumulation associated with higher pH, and thus, generation of large repulsive forces leading to granule extension. This chain extension enables beta-glucan increased access to available water and subsequent binding. This form is useful as a water binding agent, by binding to water more easily than the granule form of the paramylon. 4) gel/shell form, which may be disrupted paramylon. Finally, further increasing the pH leads to complete dissolution of the granules, such that no structures are observed using light microscopy.

Without wishing to be bound by theory, the principal force underlying paramylon solubilization appears to be associated with increased solution alkalinity Increasing the pH may lead to deprotonation of OH groups along the backbones of the beta-glucan chains. This leads to accumulation of negative charges along the backbones of the beta-glucan helices causing both intra-chain expansion as well as inter-chain repulsion leading to the dissolution of the granules and ultimately, solvation of the individual beta-glucan chains.

A major finding was that lower temperatures solubilize paramylon granules better than higher temperatures. As can be seen in Tables 3 to 7, at all solid contents (i.e. different percentages of paramylon), transition and solubilization of paramylon granules at 70° C. lagged behind other temperatures at any given pH. This may be due to the inverse relationship between pH and temperature in water. The pKa of paramylon is predicted to be ˜12, suggested by free glucose, its only monomer constituent, having a pKa of approximately 12.3. Additionally, a high degree of buffering capacity for the paramylon is observed in the pH regime around pH 11-13. Because a given concentration of sodium hydroxide at a higher temperature yielded a lower pH, without wishing to be bound by theory, the pH generated by the hot solutions (<12) may not have been sufficient for deprotonation of the alcohol groups to effectively solubilize paramylon granules.

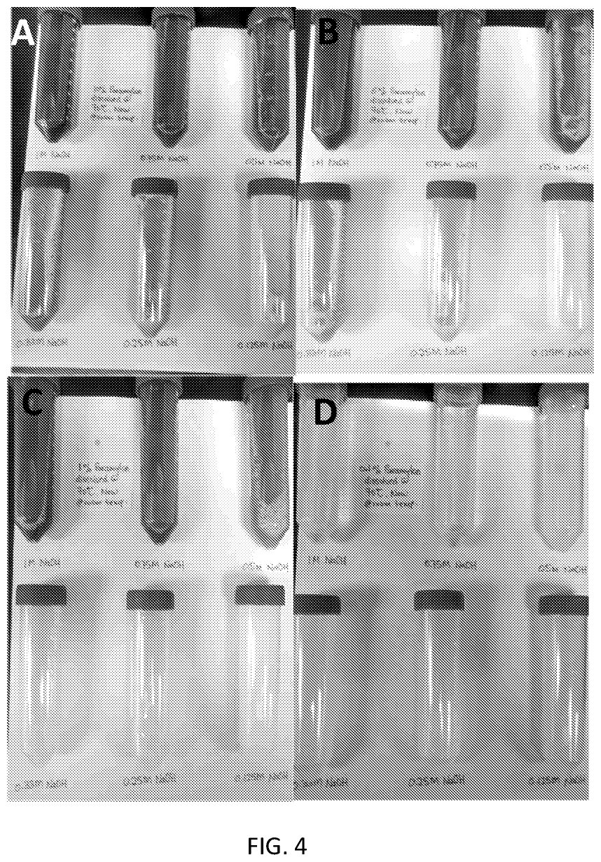

Heating the samples had an additional deleterious effect of discolouration, as seen in FIG. 4. This discolouration was more significant at higher paramylon concentrations, leading to intensely dark colours. Without wishing to be bound by theory, this discolouration may be due to an alkaline peeling type degradation mechanism that has been suggested in curdlan. This decomposition may be temperature and pH dependent, possibly explaining why higher pH samples had more discolouration, e.g. after heating. Interestingly, significant discolouration was not observed for 4° C. samples. At room temperature some colour was observed in the paramylon solutions at above 0.5 M NaOH, and at 5% (w/v) or greater paramylon concentration.

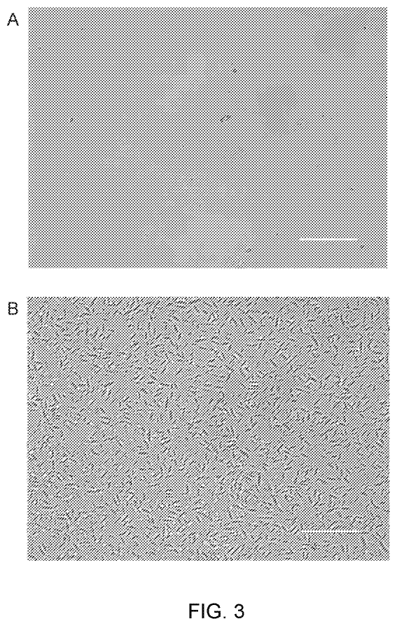

An evaluation was also undertaken to determine whether freeze drying a sample in the elongated granule form (1% (w/v) paramylon, 0.33 M NaOH) would lead to preservation of the granule structure. After drying and resuspension (FIG. 3) significant changes in structure occurred, and the granules appeared to either break or form a smaller crystallized form. Without wishing to be bound by theory, the change in structure may be due to the slow nature of the freeze drying, which may have led to elevated sodium hydroxide concentrations and thus complete dissolution of paramylon granules.

Another clear observation was that higher paramylon concentrations, especially at 10% (w/v), required more base for complete solubilization. However, the 10% (w/v) paramylon sample was not entirely solubilized at any of the pH concentrations tested. Without wishing to be bound by theory, this could be explained by increased release of protons into solution as paramylon solubilizes, leading to lower pH values for a given concentration of base. Even at 4° C., the pH of 1 M NaOH 10% paramylon solution barely surpassed 13. It has been observed that effective total solubilization does not occur until the pH gets above 13.1. Additionally, an unexpected observation was made on the 10% paramylon solution in 0.5 M NaOH. This particular solution became extremely viscous on its own, more viscous than solutions of higher or lower base concentration, resembling a gel. Without wishing to be bound by theory, this solution was the likely result of a high proportion of beta-glucan chains being released into solution, while also having significant amounts of elongated granules present; in effect a hybrid mixture has been created where the granules were suspended in a web of solubilized chains. This hybrid mixture is useful as a gelling or thickening agent. This particular hybrid mixture is also useful in an application where granules need to be kept suspended, such as a creamer.

TABLE 64
The paramylon soluble stage forms and the functionality chart

| Description | a. Granule | b. Swollen | c. Elongated | d. Shell | e. Soluble |
|---|---|---|---|---|---|
| OD at 600 mM | 2.56 ± 0.007 | 2.09 ± 0.013 | 1.66 ± 0.015 | 0.074 ± 0.004 | 0.007 ± 0.0041 |
| Concentration | <0.25M | 0.25M | 0.33M | 0.5M | >0.5 (for 0.75M and |
| of NaOH and | pH: 12.62 | pH: 12.83 | pH: 12.91 | pH: 13 | 1M) |
| pH at RT for | | | | | pH: 13.1 |
| 1% paramylon | | | | | |
| Functionality | Water holding | WHC | WHC | WHC | Soluble fiber |
| | capacity | Fibre | Potential | Thickening | Material for |
| | (WHC) | | emulsification | | thickening or gelling |
| | Whitening | | Fibre | | agent |
| | Fibre e.g. | | | | |
| | bulking | | | | |
| Application | WHC: Bakery | WHC: | WHC: Bakery | Soups, | Functional food, |
| | products, meat | Bakery | products, meat | dressing, | backery,jam, gels, |
| | products to | products, | products to | yogurt, | candies, yogurt, Jell- |
| | maintain | meat | maintain | jellies | O, gelatin desserts, |
| | moisture | products to | moisture | | trifles, aspic, |
| | Whitening: | maintain | | | marshmallows, candy |
| | dairy and non- | moisture | | | corn, gummy bears, |
| | dairy products, | | | | fruit snacks, |
| | confectionery | | | | jellybeans, cream |
| | Fibre e.g. | | | | cheese, margarine, |
| | baked goods, | | | | soup, dumplings. |
| | ready to drink | | | | |
| | beverages | | | | |

Furthermore, an evaluation was undertaken to see the impact of alkali solubilization on the OD and UV visible spectra of paramylon, and to see if any changes happened in the beta glucan structure with respect to solubilization. As can be seen in Table 64, the optical density (OD) of 1% BGI in 0.125M NaOH is highest followed by 0.25 M, and 0.33 M NaOH, respectively. At these pHs the BGI is almost insoluble and the solution is very turbid. However, there is a marked change in turbidity for BGI in 0.5 M NaOH, compared to 0.125 M, 0.25 M and 0.33 M NaOH, indicating that better solubilization of BGI was achieved in 0.5 M NaOH. As stated previously, a further increase in pH, for example to 0.75 M and 1.0M NaOH, has enhanced the solubility of BGI in these solutions, which is evident from the clear dispersions (Table 64) and their low OD value (˜0.007).

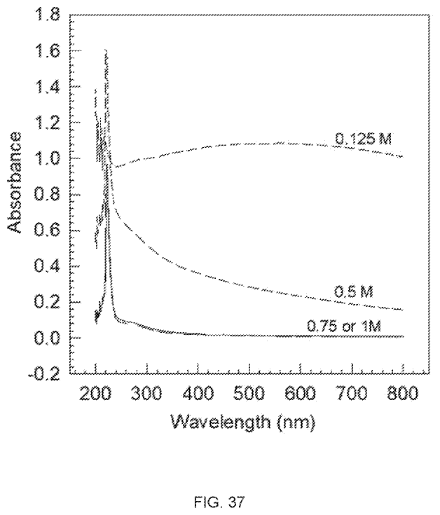

It was found that the OD of 0.125 M. 0.25 M and 0.33 M NaOH did not change after overnight alkalization treatment, indicating that stirring at these concentrations for prolonged time did not alter BGI structure or solubility significantly. Alternatively, for the BGI solution treated using 0.5 M NaOH, there was a ˜0.33% decrease in OD after overnight stirring. This is indicative of a threshold concentration of 0.5 M NaOH for the solubilization of BGI molecules. The very low OD of BGI in 0.75M and 1M NaOH is indicative of their higher solubility compared. to BGI in rest of the concentrations. FIG. 37 shows the impact of NaOH of solubilization on the UV absorption spectrum. Irrespective of the concentration of NaOH used, all soluble BGI samples showed an absorption at 231 inn. However, there was an upward shift in the absorption baseline for 0.125 M NaOH, which is due to insoluble BGI (OD for BGI in 0.125 M NaOH was 2.6). Comparing BGI in 0.5 M NaOH and 1M NaOH. the small shift in the baseline for the former can be explained based on their OD (0.074) compared to the latter which was (0.007), indicating that the latter is 10% more solubilized than the former.

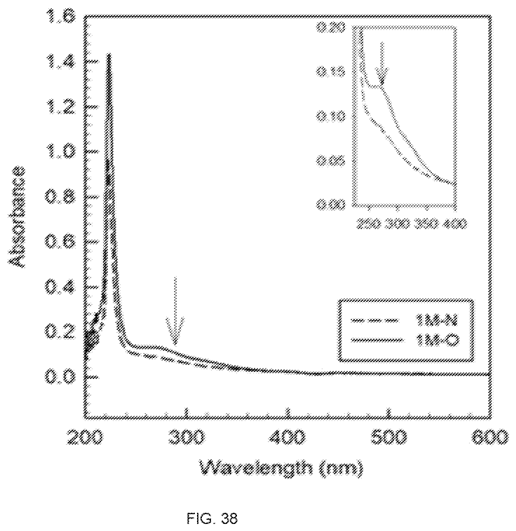

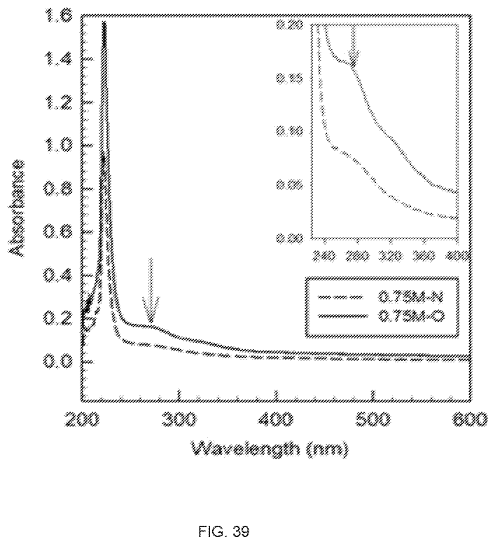

FIG. 38, FIG. 39 and Table 65 shows the effect of time of alkali treatment of 1% BGI (in 0.125M, 0.25M, 0.33M, 0.5M, 0.75M and 1M NOH) on their UV absorption. As seen in FIG. 38 and FIG. 39, the shoulder peak observed at ˜270 nm is due to the absorption of glucose, indicating that prolonged stirring at higher NaOH concentrations cause base-catalyzed β-elimination of the BGI-molecule, Table 65 represents the extent of degradation of the beta-glucan structure based on the concentration of NaOH and time. At lower concentrations ranging from (0.125 M to 0.33 M NaOH), no traces of glucose are found, indicating that no breakage of the glycosidic bond in paramylon is observed. However, as the concentration of NaOH increased to 0.5 M NaOH, glucose concentration raised to ˜0.010 (after 3 h stirring) and 0.014 (after 12 h stirring), indicating breakage of the glycosidic bonds. Note that in this case, the increased amount of glucose liberated with prolonged stirring is comparably lesser compared to other concentrations. The degradation of BGI structure with increased stirring time was significant at NaOH concentrations of 0.75 M and 1 M, indicating that maintaining the BGI in these solutions for prolonged periods of time will rupture the glycosidic linkages of BGI, thus liberating more glucose monomers. Furthermore, the UV absorption intensity of 0.1M-O and 0.75 M-O is higher than 1M-N and 0.75 M-N, indicating the three are more soluble BGI after overnight in the two samples which have very low OD. This is an evidence that gels are formed in 1M-N and 0.75 M-N, and they can be further dissolved after overnight.

TABLE 65
Summary of glucose liberated after the alkalization
of BGI 1% (w/v) samples after 12 h.

| | 1% BGI sample in NaOH | | | | | | |
|---|---|---|---|---|---|---|---|
| | | 0.125M | 0.25M | 0.33M | 0.50M | 0.75M | 1.00M |
| Glucose | After | 0 | 0 | 0 | 0.010 | 0.220 | 0.735 |
| liberat- | 4 h | | | | | | |
| ed (g/L) | | | | | | | |
| | After | 0 | 0 | 0 | 0.014 | 0.276 | 0.975 |
| | 12 h | | | | | | |

As mentioned above, paramylon solubilization can be increased by raising the alkalinity of the solutions with increasing concentrations of NaOH. Such increases in alkalinity may lead to the deprotonation of alcohol groups of the BGI backbone and subsequent dissolution of granules and ultimately, solvation of BGI. Glucose has a pKa of approximately 12.3, and assuming similar values for glucose monomers in the BGI polymer readily explain the physical changes in beta-glucan as pH increases to 12 and beyond. At pH 11.3, it is expected that approximately 10% of the ionizable protons will be released, and at pH 12.3 50%, and by pH 13.3 99% would in theory be ionized. The increased number of negative charges along the polymer backbone with increasing pH and. NaOH concentration infer an increasing charge-charge repulsive force building within the granules as the pH is raised. Furthermore, at an extremely alkaline pH, the added effect of alkaline peeling, which has been reported for curdlan, a similar beta-1,3-glucan must be considered. Alkaline peeling would lead to slow gradual degradation of the chains by releasing monomers over time which would lead to an increase in solubility over nine under highly alkaline conditions.

The solubilization of paramylon proceeds through different forms, whereby the alkali NaOH solution penetrates amorphous regions of beta-glucan, leading to paramylon swelling. The swelling of the solid polymer at the interface increases to a point of chain disentanglement, as a result of the weakened inter and intra-hydrogen bonding via alkali penetration. Thus the chain disentanglement proceeds by breakage of both intra- and inter-molecular hydrogen bonds (phase where molecule swelling increases, elongates etc. depending on the solvent condition) and finally results in solubilization. A lower NaOH concentration a lot of water would be present around the cellulose chains. Thus, at very low NaOH concentrations, hydrated ion pairs may be too large to separate glucan chains thereby preventing breakage of hydrogen bonds. However, as the concentration of NaOH increases, the number of water molecules decreases to form solvated hydrates and decreases their hydrodynamic volume. This will allow alkali ions to penetrate into the paramylon granules/crystal resulting in hydrogen bond breakage, and finally, cause complete dissolution. Another important point is that swelling of paramylon may be heterogeneous as seen with cellulose where the chance of swelling of selected zones of the polymer structure will be high, which is called the ballooning effect. This may also contribute to the elongation of paramylon granules. The possibility of gelling or complexation of paramylon during the NaOH solubilization protocol, when it is swollen, is due to high mobility of the β-glucan chain which diffuses laterally to form an alkali complex. During the solubilization procedure, the organisation and conformation of β-glucan chains varies with respect to the structure of the hydrated ions, the coordination and polarizability of the solvent, which induces reconstruction in the structure of the solvating ions and leads gelling or alkali complexation (varies with the concentration of BGI), and leads into shell like structure before complete solubilization.

The different solubilization pathway and the associated structural changes proposed in the glucan structure were summarized in Table 66

TABLE 66
Solubilized forms of paramylon as a result of NaOH solubilisation.

| Different forms of paramylon during solubilization | Description |
|---|---|
| Granular form | At lower alkali |
| | concentration the |
| | hydrated ions of alkali |
| | cannot diffuse into the |
| | chains of glucan |
| | structure to break the |
| | hydrogen bonding and |
| | hence the solubility is |
| | low. |
| | The forces in this stage |
| | are mainly the intra- |
| | triple helix hydrogen |
| | bonding for forming |
| | crystal. |
| Swollen and elongated form 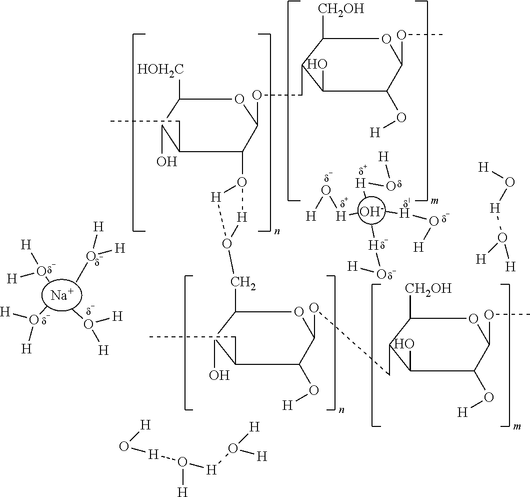 | With the increased NaOH concentration, hydroxyl groups diffuse into the structure with water, causing partial solubilization and swelling. The extent of swelling is dependent upon the degree of alkali penetration. The extent of ballooning effect with negative repulsive force along the length of β-glucan causes the extended swollen granules. Also, may constitute some shell-like structure due to gelling or alkali complexation of BGI. The BGI granules can be elongated by a force or grinding. However, in this case, the elongation will force to build an inter-triple helix hydrogen bonding. The inter-triple helix hydrogen bonding also can trap water to form a swollen/gel material with high viscosity. |
| | Water will also be |
| | possibly brought into a |
| | triple helix structure |
| | with a force. |
| Solubilized form | Fully solubilized |
| | version of paramylon |
| | after the complete |
| | penetration process. |
| | Also may constitute |
| | some shell like structure |
| | due to gelling or alkali |
| | complexation of BGI |
| Breaking of glucan structure at higher NaOH concentration 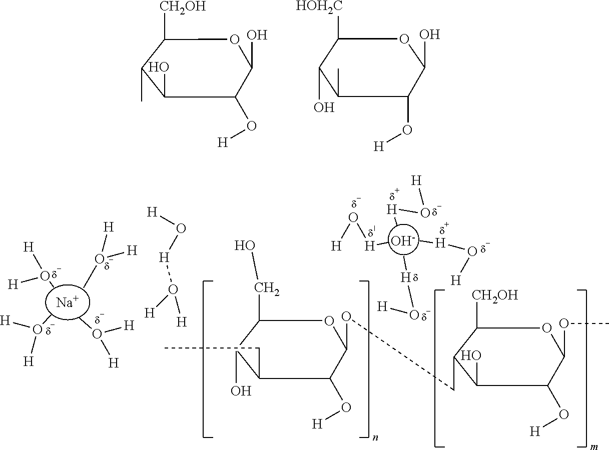 | Further increase in the alkali concentration leads to breakage of glycosidic bonds (beta- elimination) and glucose type monomer liberation. |

### Solubility Effect on Functionality

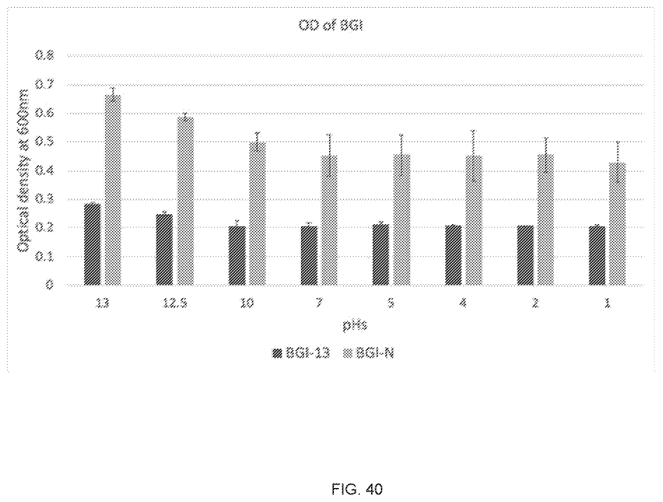

An evaluation was undertaken to see the impact of the enhanced solubilization of BGI in aqueous media on their emulsification properties when mixed with pea protein (PP) and canola oil. The solubilization of BGI and protein was determined by optical density (OD) measurement. The analysis was performed in such a way that both BGI and pea protein were pre-treated at pHs 13 (high alkaline) and 7 (neutral pH) for 12 h prior to BGI-BGI and PP-PP interaction studies and their OD measurements. In detail, method 1—PP or BGI solutions were dispersed in deionized water and kept stirring at neutral pH and room temperature overnight. The dispersed sample obtained by this dissolution method was named as PP(N) or BGI(N). method 2—PP or BGI solutions were dispersed in deionized water and the pH of the resulting solution was raised to pH 13 and kept stirring at pH 13 at room temperature overnight. The dispersed sample obtained by this dissolution method was named PP(13) or BGI(13). For the purpose of comparison, we did the pH treatment in both BGI and PP protein. The OD of both biopolymer solutions at each pH point (from pH 13 to 1.5) at ambient temperature was measured using a UV-visible spectrophotometer at 600 nm. The pHs were controlled throughout the analysis by dropwise addition of NaOH and/or HCl [using 0.1, 0.5N and 2N]. The alkaline pH treatment of BGI samples [BGI(13)] was effective in decreasing OD more than 50% (possibly indicating increased solubility more than 50%) than the neutral treated BGI samples [BGI(N)] at all pHs studied (FIG. 40).

For both BGI(13) and BGI(N), the OD shifted to a lower value with decreasing pHs (from pH13 to pH 10, then remained constant until pH 1 (FIG. 40). This small shift may be associated with a dilution effect while protonation of the suspension or due to the aggregation behaviour of BGI in this range. The pH treatment did not change the colour of dispersion at any pHs indicating a minimal chance of biopolymer cleavage due to β-elimination. Since after BGI treatment no traces of glucose (0 g/L) were observed, alkaline treatment did not rupture the glucan structure.

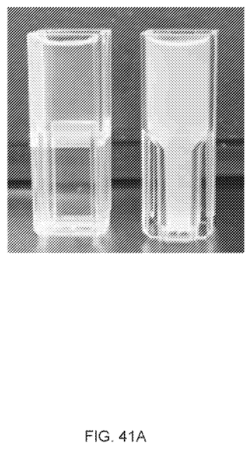

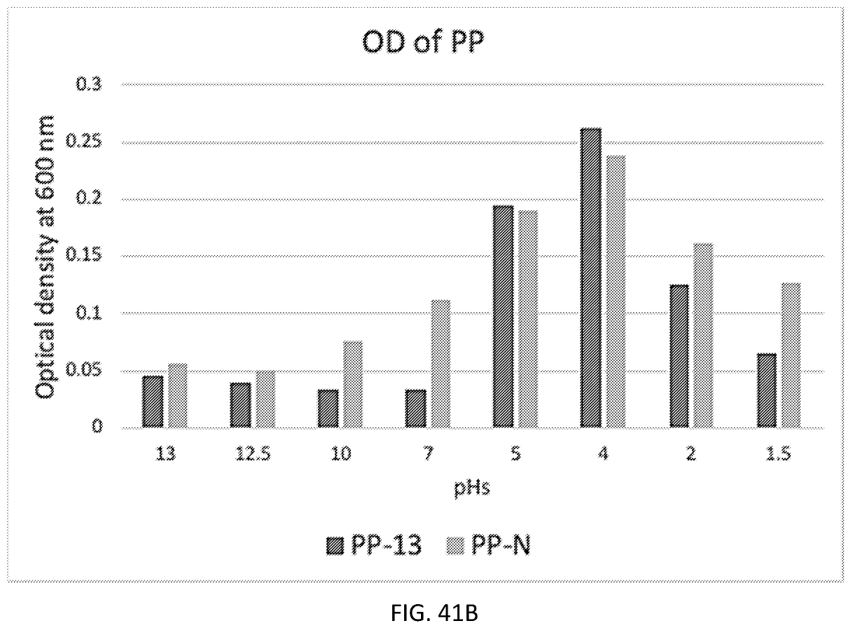

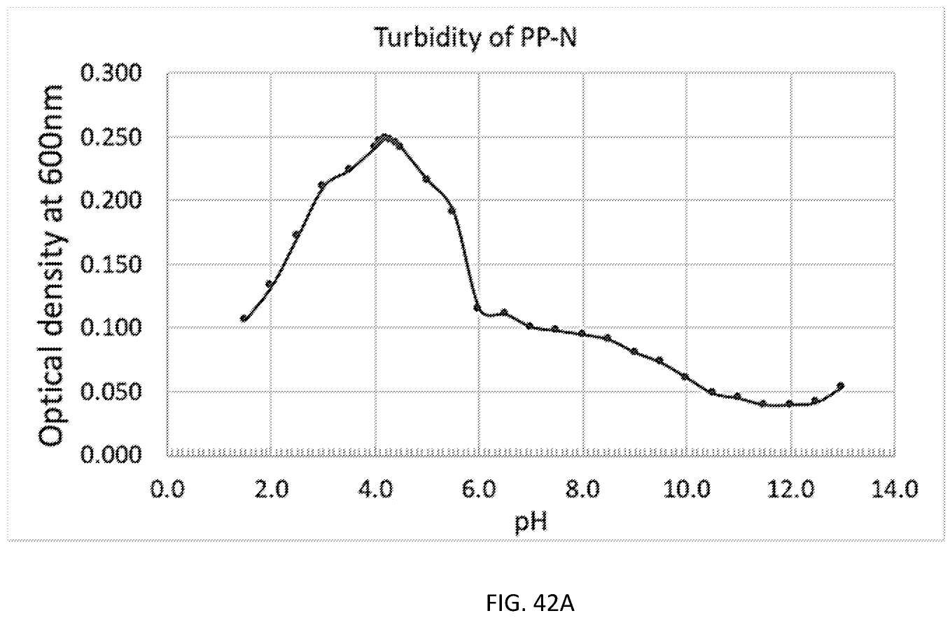

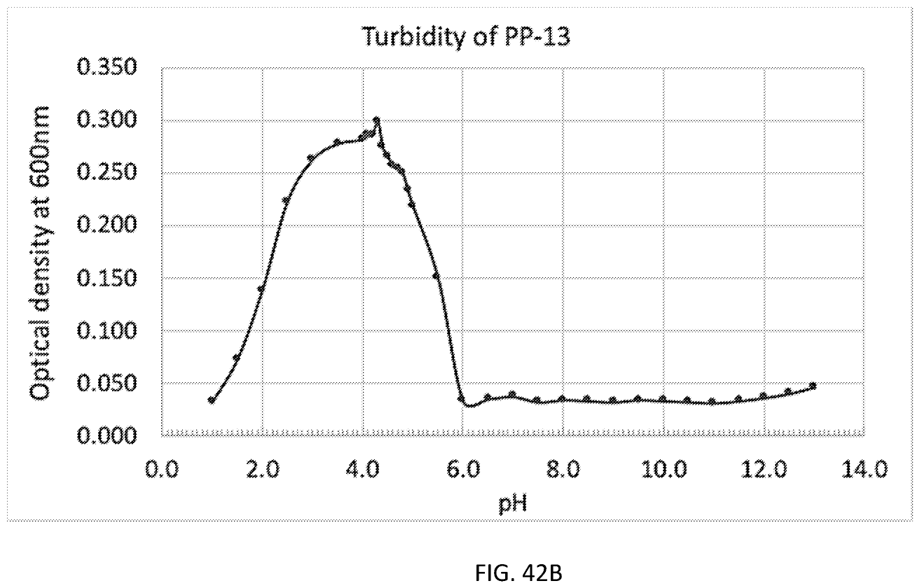

Note that in order to find the optimal form of PP for functionality studies, pH treatments were also investigated in PP. It was found that such treatments were not effective in the PP treatment as considerable protein degradation was observed, Even though there are large differences in turbidity (in terms of transparency) between PP(13) and PP(N), the former may have hydrolyzed at higher alkaline content and produced low molecular weight fragments, compared to PP(N) (from SDS PAGE—data not shown). The two pH treated proteins displayed a different turbidimetric. profile (see FIGS. 41A and 41B for their OD and solution turbidity), which may be due to different aggregation behaviours of protein fractions in solution. FIGS. 42A and 4213 shows the turbidimetric profile of the pH treated. PP, and the resultant critical pHs associated with protein aggregation are displayed in Table 67,

TABLE 67
Critical pH parameters of PP interaction [pH_{c}; initial starting of aggregation;
pH_{φ1}: three dimensional aggregates grow in shape and size and form insoluble
complex with increased the turbidity; pHₒₚₜ: maximum aggregation-close to the isoelectric
point of protein; pH_{φ2}: pH at which dissolution of aggregates occured;
OD: optical density close to the isoelectric point.

| Critical pHs | pH_{c} | pH_{φ1} | pHₒₚₜ | pH_{φ2} | ODₘₐₓ |
|---|---|---|---|---|---|
| PP(13) | 6.05 ± 0.07 | 5.48 ± 0.10 | 4.30 ± 0.0 | 1.50 ± 0.00 | 0.28 ± 0.03 |
| PP(N) | 10.55 ± 0.07 | 6.60 ± 0.30 | 4.35 ± 0.07 | 1.50 ± 0.00 | 0.24 ± 0.01 |

As seen in FIGS. 42A and B, the homogenous PP(13) and PP(N)) system demonstrated different aggregation indicated by a bell shaped turbidity curve as a function of pH, where optical density (OD) began to rise around pH 6.1 for PP(13) and 10.5 for PP(N) due to protein aggregation, and reached a maximum OD (0.2-0.28) between pHs 3.8-4.6 whereby a flattening of the curve occurred; OD declined at pH ˜2. As seen in FIGS. 42 A and B and Table 67, there was an increase in turbidity of PP(N) at pHs ˜10.5 compared to PP(13) (where it occurred at pH ˜6.1). This indicates an early stage aggregation of proteins in the PP(N) system compared to PP(13). This difference in turbidimetric profile and formation of protein aggregates is attributed to different pH treatments of PP solutions prior to the measurement of OD. It was also found from the turbidity diagram that the isoelectric point (pI) of PP is ˜4.4, where maximum protein aggregation was observed. From the turbidity curves, the critical pHs (pH_{c}, pH_{φ1}, pHₒₚₜ, pH_{φ2}, ODₘₐₓ) associated with the aggregation of PP are listed in Table 67. The different aggregation behaviour of PP at these critical pHs can be tuned by the addition of BGI so as to change the functionality of the mixture. From SDS PAGE analysis (data not shown), we have observed a larger fraction of low molecular weight fragments in sample PP(13), which indicates that the high pH treatment induced protein degradation in PP(13) samples. Note that such degradation fragments were absent in PP(N). Thus by considering the alkaline degradation factor and the corresponding changes in the turbidimetric profile, it was confirmed that PP(N) is the optimal candidate for interaction with BGI(13), for emulsification, and for other functionality studies

### Example 2: Additional Studies on Paramylon Forms

Studies are carried out to investigate the individual functionality of the 4 forms of the paramylon (i.e. granule form; swollen form; elongated form; and shell form), and ability of each form to retain its form, for example, whether they are stable to different drying methods. Stability is measured by microscopy to determine if the morphological form is maintained. Particle size is measured, for example, by a particle size analyzer (Beckman Coulter Counter) which uses laser to determine the sizes of the particles in microns pre and post drying. Control includes each form where the paramylon form is not spray dried.

In addition, functional studies are completed to compare the function before drying and after drying. Whitening is compared by measuring the percent whiteness as shown in Examples 27 & 29, as well as the refractive index and colourimetric results. For gelling, the ability to gel by pH adjustment of calcium addition is determined. When a gel forms, its tensile strength is measured by a texture analyzer. Water holding capacity is tested by measuring the amount of water loss in the samples. Emulsification is determined by measuring the amount of emulsion is formed, compared to a lecithin control.

Texture properties are measured by a texture analyzer. Compression is used to determine different characteristics, and a sample is compressed twice to generate the force-time curve. From the force-time curve, the hardness is the height of the first peak in the force-time curve, the springiness is the ratio between the height after the first compression and the original samples height (before compression). To determine adhesiveness, the negative area of the curve when the probe is removed from the sample. The cohesiveness is the ratio between the area under the second peak to the area under the first peak. The gumminess is calculated by multiplying the hardness value, by the cohesiveness value. Chewiness is also calculated similarly by multiplying the gumminess and springiness of the sample. The measurements are repeated several times, for example 3 to 5 measurements.

Food textures are also considered by measuring rheological properties and determined by psychophysical methods. The textual characteristics of food are classified as mechanical, geometric and other properties. Mechanical is based on the hardness, cohesiveness, viscosity, elasticity and adhesiveness of the material. Brittleness, chewiness and gumminess are also additional measurements. Geometrical factors include shape, morphology and orientation of the food material or food particles. Other factors represent moisture, and oiliness of the food product. Oiliness of the product refers to a sample containing a high amount of oil which provides an oily appearance or mouth feel.

To form an emulsion, the test ingredients, i.e. paramylon form, is mixed with an oil, for example, canola, MCT, soybean, sunflower, olive, palm, safflower, peanut, sesame, grapeseed, cottonseed, avocado oil, Euglena derived oil (MCT, palmitic, EPA, DHA, Oleic), and homogenized at 5 min at 13,500 rpm using an OMNI GLH-01 stand homogenizer. The emulsion mixture is then centrifuged at 1,300×g for 5 minutes in a centrifugation tube that can be measured. Emulsion activity is calculated by the following formula based on the layers formed in the centrifugation tube:

Emulsion activity: 100×(height of emulsification layer (in mm)/total height of the mixture in the test tube (in mm)

A higher number indicates a larger emulsion has been formed.

Alternatively after the mixture is homogenized, an aliquot of the sample is diluted with 0.1% sodium Dodecyl sulfate solution and the turbidity of the sample is measured at 500 nm in a spectrophotometer.

Emulsification capacity and emulsion stability are also determined.

Spray drying is compared with freeze drying to determine effects of different methods of drying on structure and functionality. Different structures have unique functionality for gelling, whitening and emulsification. Gelling is impacted by particle size as well as the availability of free-chains vs. colloid like particles. Whitening is related to particle size, which changes the way the material scatters different wavelengths of light. The emulsification ability is impacted by the form of the paramylon due to the change in hydrophobicity/hydrophilicity as the granules change form Scanning electron microscope (SEM) and static/dynamic light scattering are used to evaluate intermediate forms' fine structures.

TABLE 8
Examples of different forms of paramylon for functionality, and food applications.

| Form | Functionality | Food Application |
|---|---|---|
| Granules | Whitening | Whitening: |
| | Water Holding | A dairy product such as: creamer, yogurt, ice |
| | Capacity (WHC) | cream, whipped cream, pudding, a powdered milk |
| | Emulsification | base product, cheese, cream cheese, sour cream, |
| | Bulking agent | low fat dairy product |
| | Sweetener | A dairy substitute product such as: non-dairy |
| | | creamer, non-dairy ice cream, non-dairy yogurt, |
| | | non-dairy whipped cream, non-dairy pudding, non- |
| | | dairy milk base product, non-dairy cream, non- |
| | | dairy sour cream, low fat non-dairy food product |
| | | As a confectionery product such as: |
| | | chocolate with and without a hard coating, hard |
| | | candy, soft gummy candy, marshmallows, icing, |
| | | fondant, jelly beans, a flavoured syrup, chocolate |
| | | syrup |
| | | A drink product such as: protein shake (dairy and |
| | | dairy substitute), meal replacement shake (dairy |
| | | and dairy substitute) |
| | | WHC: |
| | | A bakery product such as: toasted pastry products, |
| | | donuts, muffins, cookies, protein bars, granola |
| | | bars, cake product |
| | | A dairy product such as: creamer, yogurt, ice |
| | | cream, whipped cream, pudding, a powdered milk |
| | | base product, cheese, cream cheese |
| | | A dairy substitute product such as: non-dairy |
| | | creamer, non-dairy ice cream, non-dairy yogurt, |
| | | non-dairy powdered milk base, non-dairy cream |
| | | cheese |
| | | A drink product such as: protein shake (dairy and |
| | | dairy substitute), meal replacement shake (dairy |
| | | and dairy substitute) |
| | | A meat product such as: meat casing, sausages |
| | | (pork, beef, chicken, turkey), patties (beef, |
| | | chicken, pork, turkey), ground meat (beef, chicken, |
| | | pork, turkey) |
| | | A protein substitute product such as: chicken meat |
| | | substitute, beef substitute, pork substitute, turkey |
| | | meat substitute, egg substitute, egg protein |
| | | substitute, soy protein substitute, pea protein |
| | | substitute |
| | | A sauce such as: Salad dressing, mayonnaise, |
| | | ketchup, mustard, tomato pasta sauce, tomato |
| | | sauce, vinaigrettes, marinades, BBQ sauce, gravy |
| | | Emulsification: |
| | | A dairy product such as: creamer, yogurt, whipped |
| | | cream |
| | | A sauce such as: salad dressing, mayonnaise |
| | | Bulking agent: any product that has a neutral |
| | | flavour that increases the bulk (mass) of a product, |
| | | and that does not have a nutrient value: any |
| | | product |
| | | Sweetener: |
| | | A drink mix product such as: drink crystals |
| Swollen | WHC | WHC: |
| | Increased | A bakery product such as: toasted pastry products, |
| | viscosity | donuts, muffins, cookies, protein bars, granola bars |
| | Emulsification | A meat product such as: meat casing, sausages |
| | | (pork, beef, chicken, turkey), patties (beef, |
| | | chicken, pork, turkey), ground meat (beef, chicken, |
| | | pork, turkey) |
| | | A protein substitute product such as: chicken meat |
| | | substitute, beef substitute, pork substitute, turkey |
| | | meat substitute, egg substitute, egg protein |
| | | substitute, soy protein substitute, pea protein |
| | | substitute |
| | | Increased viscosity: |
| | | A sauce such as: Salad dressing, mayonnaise, |
| | | ketchup, mustard, tomato pasta sauce, tomato |
| | | sauce, vinaigrettes, marinades, BBQ sauce, gravy |
| | | Emulsification: |
| | | A dairy product such as: creamer, yogurt, whipped |
| | | cream |
| | | A sauce such as: salad dressing, mayonnaise |
| Elongated | WHC | WHC: |
| | Increased | A bakery product such as: toasted pastry products, |
| | viscosity | donuts, muffins, cookies, protein bars, granola bars |
| | Emulsification | A meat product such as: meat casing, sausages |
| | | (pork, beef, chicken, turkey), patties (beef, |
| | | chicken, pork, turkey), ground meat (beef, chicken, |
| | | pork, turkey) |
| | | A protein substitute product such as: chicken meat |
| | | substitute, beef substitute, pork substitute, turkey |
| | | meat substitute, egg substitute, egg protein |
| | | substitute, soy protein substitute, pea protein |
| | | substitute |
| | | Increased viscosity: |
| | | A sauce such as: Salad dressing, mayonnaise, |
| | | ketchup, mustard, tomato pasta sauce, tomato |
| | | sauce, vinaigrettes, marinades, BBQ sauce, gravy |
| | | Emulsification: |
| | | A dairy product such as: creamer, yogurt, whipped |
| | | cream |
| | | A sauce such as: salad dressing, mayonnaise |
| Shell | WHC | WHC: |
| | Increased | A bakery product such as: toasted pastry products, |
| | viscosity | donuts, muffins, cookies, protein bars, granola bars |
| | Emulsification | A meat product such as: meat casing, sausages |
| | | (pork, beef, chicken, turkey), patties (beef, |
| | | chicken, pork, turkey), ground meat (beef, chicken, |
| | | pork, turkey) |
| | | A protein substitute product such as: chicken meat |
| | | substitute, beef substitute, pork substitute, turkey |
| | | meat substitute, egg substitute, egg protein |
| | | substitute, soy protein substitute, pea protein |
| | | substitute |
| | | Increased viscosity: |
| | | A sauce such as: Salad dressing, mayonnaise, |
| | | ketchup, mustard, tomato pasta sauce, tomato |
| | | sauce, vinaigrettes, marinades, BBQ sauce, gravy |
| | | Emulsification: |
| | | A dairy product such as: creamer, yogurt, whipped |
| | | cream |
| | | A sauce such as: salad dressing, mayonnaise |
| Soluble and | When acidified | Gelatinous material: |
| RTG when | (i.e. HCl, Citric | A spreadable food stuff product such as: jam, jelly, |
| acidified by | acid) or CaCl₂ | nut butters |
| citric acid | addition is a | A confectionery product such as: |
| | gelatinous | Hard candy, gummy (soft) candy, a fruit snack, a |
| | material | fruit gel bar |
| | Increased | A gelatin substitute product |
| | viscosity using | An aspic |
| | gelatinous formed | A dairy product such as: cheese, cream cheese |
| | material | A dairy substitute such as: non-dairy-cream cheese |
| | Sweetener | Increased viscosity using gelatinous formed |
| | | material: |
| | | A confectionery product such as: |
| | | a chocolate syrup, a flavoured syrup |
| | | A dairy product such as: creamer, yogurt, sour |
| | | cream, low fat dairy product |
| | | A dairy substitute such as: non-dairy creamer, non- |
| | | diary yogurt, non-dairy-sour cream, low fat non- |
| | | dairy product |
| | | A drink product such as: protein shake (dairy and |
| | | dairy substitute), meal replacement shake (dairy |
| | | and dairy substitute) |
| | | Sweetener: |
| | | Custard product such as: trifles, custards, pudding |
| Milled | Whitening | Whitening: |
| paramylon | WHC | A dairy product such as: creamer, yogurt, ice |
| | Increased | cream, whipped cream, pudding, a powdered milk |
| | viscosity | base product, cheese, cream cheese, sour cream, |
| | Emulsification | low fat dairy product |
| | | A dairy substitute product such as: non-dairy |
| | | creamer, non-dairy ice cream, non-dairy yogurt, |
| | | non-dairy whipped cream, non-dairy pudding, non- |
| | | dairy milk base product, non-dairy cream, non- |
| | | dairy sour cream, low fat non-dairy food product |
| | | As a confectionery product such as: |
| | | chocolate with and without a hard coating, hard |
| | | candy, soft gummy candy, marshmallows, icing, |
| | | fondant, jelly beans, a flavoured syrup, chocolate |
| | | syrup |
| | | A drink product such as: protein shake (dairy and |
| | | dairy substitute), meal replacement shake (dairy |
| | | and dairy substitute) |
| | | WHC: |
| | | A bakery product such as: toasted pastry products, |
| | | donuts, muffins, cookies, protein bars, granola |
| | | bars, cake product |
| | | A dairy product such as: creamer, yogurt, ice |
| | | cream, whipped cream, pudding, a powdered milk |
| | | base product, cheese, cream cheese |
| | | A dairy substitute product such as: non-dairy |
| | | creamer, non-dairy ice cream, non-dairy yogurt, |
| | | non-dairy powdered milk base, non-dairy cream |
| | | cheese |
| | | A drink product such as: protein shake (dairy and |
| | | dairy substitute), meal replacement shake (dairy |
| | | and dairy substitute) |
| | | A meat product such as: meat casing, sausages |
| | | (pork, beef, chicken, turkey), patties (beef, |
| | | chicken, pork, turkey), ground meat (beef, chicken, |
| | | pork, turkey) |
| | | A protein substitute product such as: chicken meat |
| | | substitute, beef substitute, pork substitute, turkey |
| | | meat substitute, egg substitute, egg protein |
| | | substitute, soy protein substitute, pea protein |
| | | substitute |
| | | A sauce such as: Salad dressing, mayonnaise, |
| | | ketchup, mustard, tomato pasta sauce, tomato |
| | | sauce, vinaigrettes, marinades, BBQ sauce, gravy |
| | | Increased viscosity: |
| | | A sauce such as: Salad dressing, mayonnaise, |
| | | ketchup, mustard, tomato pasta sauce, tomato |
| | | sauce, vinaigrettes, marinades, BBQ sauce, gravy |
| | | A spreadable food stuff product such as: jam, jelly, |
| | | nut butters |
| | | A confectionery product such as: |
| | | Hard candy, gummy (soft) candy, a fruit snack, a |
| | | fruit gel bar |
| | | A gelatin substitute product |
| | | An aspic |
| | | A dairy product such as: cheese, cream cheese |
| | | A dairy substitute such as: non-dairy-cream cheese |
| | | Increased viscosity using gelatinous formed |
| | | material: |
| | | A confectionery product such as: |
| | | a chocolate syrup, a flavoured syrup |
| | | A dairy product such as: creamer, yogurt, sour |
| | | cream, low fat dairy product |
| | | A dairy substitute such as: non-dairy creamer, non- |
| | | diary yogurt, non-dairy-sour cream, low fat non- |
| | | dairy product |
| | | A drink product such as: protein shake (dairy and |
| | | dairy substitute), meal replacement shake (dairy |
| | | and dairy substitute) |
| | | Emulsification: |
| | | A dairy product such as: creamer, yogurt, whipped |
| | | cream |
| | | A sauce such as: salad dressing, mayonnaise |

### Example 3: Gelation of Paramylon

### Introduction

This study tested the basic parameters of gelation of paramylon through pH adjustment (for example, at which pH it gels). Additionally, during gelation, the effect of temperature and paramylon concentration on gelation was tested. Finally, the effect of CaCl₂ was tested to see if it aided in the formation of gels at different pHs and concentration levels.

### Materials and Methods:

In this study, Gel score was assigned to indicate gel strength observed from 1 to 3, where 1 means weak gel, 2 means medium strength gel, and 3 means firm gel. The experiment was performed according to the matrix shown in Table 9.

TABLE 9
Experimental matrix of gelation study

| | | | |
|---|---|---|---|
| Paramylon (w/v): | 0.1% | 1% | 5% |

| | | | | | | |
|---|---|---|---|---|---|---|
| Low Temp: | 4° | C. | 4° | C. | 4° | C. |
| Room Temp: | 22-25° | C. | 22-25° | C. | 22-25° | C. |
| High Temp: | 70° | C. | 70° | C. | 70° | C. |

### Gelation at Various pH Levels

200 mL of 0.1%, 1% and 5% (w/v) paramylon was freshly made by dissolving 0.2 g, 2 g or 10 g of paramylon powder in 1M NaOH solution (pH >13), pH was adjusted using HCl to around 1. In addition, other acids can be used, for example citric acid, lactic acid, nitric acid, sulphuric acid. Two samples were taken every 1 unit of pH.

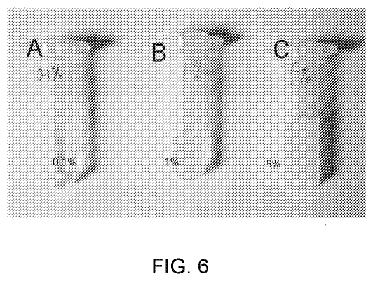

After preparing initial samples, pH was measured to ensure it was >13, and pictures were taken with the aid of a microscope to confirm solubilization of paramylon. Samples were taken at every 1 unit of pH in duplicate, and observations at pH 10 are shown below. Results are summarized in Table 10 and images are shown in FIG. 6.

TABLE 10
Results from room temperature gelation of solubilized
paramylon. 0.1% (w/v) paramylon was unable to gel at
any pH. 1% (w/v) paramylon formed a weak gel around pH
10 while 5% (w/v) paramylon forms a firm gel at pH 10.2.

| Paramylon solution (w/v) | Gelling pH (1-13) |
|---|---|
| 0.1% | No gelling |
| 1% | at pH 10.036 a weak gel (gel score 1) |
| 5% | firm gel (gel score 3) formed at pH 10.242 |

### Chilling and Heat Treatment

One set of samples was kept at 4° C. overnight, the other was incubated at 70° C. in a water bath for 2 hours, to observe if the gel is stable.

### Chilling Treatment

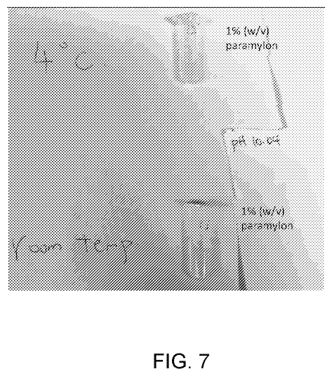

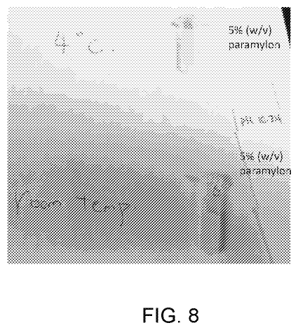

For 0.1% (w/v) paramylon, no difference was seen between the two sets after 4° C. treatment overnight. For 1% (w/v) paramylon, at the initial pH change to 10.04, the sample did not gel. However, after exposing the same sample to 4° C. or room temperature overnight, a weak gel was formed (gel score 0.5, shown in FIG. 7). The results for 5% paramylon are shown in Table 11 and in FIG. 8.

TABLE 11
4° C. and room temperature overnight treatment of 5% paramylon
gel. Observations at different pH for both treatments, see also FIG. 8.

| | 4° C. overnight | Room temperature overnight |
|---|---|---|
| pH 13.014 | Solution is still clear | Solution became yellow from |
| | | clear (original) |
| pH 12.240 | Solution is still clear | Solution became light yellow |
| | | from clear (original) |
| pH 11.209 | Solution is clear | Solution is clear |
| pH 10.242 | Firm gel (gel score 3) with | Lesser firm gel (gel score 2) |
| | higher opacity | with lesser opacity compared to |
| | | 4° C. treatment |

For 0.1% (w/v) paramylon, no difference was seen between the two sets after 4° C. treatment overnight. For 1% (w/v) paramylon, the sample did not form a gel when pH was adjusted to 10.036 or below, however after exposure to 4° C. or room temperature overnight, a weak gel was formed at 4° C. (gel score 0.5, shown in FIG. 7), while no gel was observed at room temperature. The results for 5% paramylon are shown in Table 11 and in FIG. 8.

### Heat Treatment

Results of heat treatment on varying concentration of paramylon are summarized below in Table 12.

TABLE 12
0.1% (w/v) paramylon gel colour change after
heat treatment at 70° C. for 2 hours

| | Sample Colour before | Sample Colour after |
|---|---|---|
| pH of sample | treatment | treatment |
| Above 3.845 | Clear | Clear |
| 3.845 and below | Clear | Bottom part formed weak gel |
| | | (score 0.5), upper part is |
| | | clear |

TABLE 13
1% (w/v) paramylon gel colour change after
heat treatment at 70° C. for 2 hours.

| | Sample Colour before | Sample Colour after |
|---|---|---|
| pH of sample | treatment | treatment |
| 13.161 | Clear | Dark yellow |
| 12.070 | Clear | Dark yellow |
| 11.210 | Clear | Light yellow |
| 10.036 and below | Clear | Bottom part formed weak gel |
| | | (score 0.5), upper part is |
| | | clear |

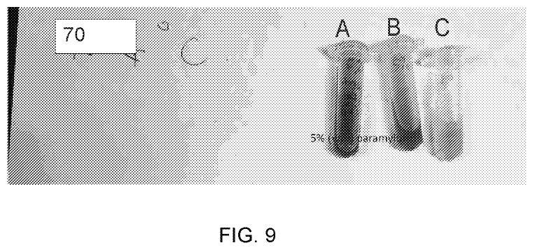

TABLE 14
5% (w/v) paramylon gel colour change after heat treatment
at 70° C. for 2 hours (see also FIG. 9):

| | Sample Colour before | Sample Colour after |
|---|---|---|
| pH of sample | treatment | treatment |
| 13.014 | Light yellow | Dark yellow |
| 12.240 | Light yellow | Dark yellow |
| 11.209 | Clear | Light yellow |

### Effects of CaCl₂) on Gelation at Various pH Levels

25 μL 5% CaCl₂ was added to each 1 mL sample to see if different pH values and concentrations of CaCl₂ affect gel formation. After overnight treatment at 4° C., 1 mL paramylon samples provided with 25 ul of 5% CaCl₂ and observations were recorded after 10 minutes. Effects of CaCl₂ are summarized in Tables 69-71.

TABLE 69
Observations of 0.1% (w/v) paramylon with 25
μl of 5% CaCl₂ added to 1 mL samples and
the pH lowered to see the effect of on gelation.

| pH of sample | Observation |
|---|---|
| 13.013 | formed weak gel (gel score 1) |
| 11.889 and below | Clear thick solution |

TABLE 70
Observations of 1% (w/v) paramylon with 25 μl of 5%
CaCl₂ added to 1 mL samples and the effect of lowering pH on gelation.

| pH of sample | Observation |
|---|---|
| 13.161 | formed clear firm gel (gel score 3) |
| 12.070 | formed opaque firm gel (gel score 2.5) |
| 11.210 | formed weak opaque gel (gel score 1) |
| 10.702 and below | formed clear thick solution |

TABLE 71
Observations of 5% (w/v) paramylon with 25 μl of 5%
CaCl₂ added to 1 mL samples and the effect of lowering pH on gelation.

| pH of sample | Observation |
|---|---|
| 13.014 | formed clear firm gel (gel score 3) |
| 12.240 | formed weak gel (gel score 1) |
| 11.219 | formed weak gel (gel score 1) |

Freezing Treatment on 1% (w/v) Paramylon Gel

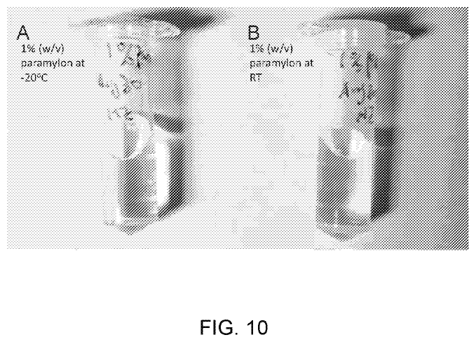

200 mL of 1% (w/v) paramylon was made fresh by dissolving 2 g of paramylon powder in 1 M NaOH solution (pH >13). pH was adjusted using HCl to around 1, at every 2 units of pH, 2 samples were taken. One set of samples was placed at −20° C. overnight, the other set was kept at room temperature as a control. 1% (w/v) paramylon solution at varying pH levels were kept at −20° C. overnight, and no difference was observed between this cold treatment and room temperature (control) (see FIG. 10).

### Results

Gel score was assigned to indicate gel strength observed from 1 to 3, where 1 means weak gel, 2 means medium strength gel, and 3 means firm gel.

### Chilling Treatment

For 0.1% (w/v) paramylon, no difference was seen between the two sets after 4° C. treatment overnight. For 1% (w/v) paramylon, the sample did not form a gel when pH was adjusted to 10.036 or below, however after exposure to 4° C. or room temperature overnight, a weak gel was formed at 4° C. (gel score 0.5, shown in FIG. 7), while no gel was observed at room temperature. The results for 5% paramylon are shown in Table 11 and in FIG. 8.

### Effects of CaCl₂) on Gelation at Various pH Levels

After overnight treatment at 4° C., 1 mL paramylon samples provided with 25 μl of 5% CaCl₂ and observations were recorded after 10 minutes. Results of the effects of CaCl₂ are summarized below in Tables 15-17.

TABLE 15
Observations of 0.1% (w/v) paramylon with 25
μl of 5% CaCl₂ added to 1 mL samples and
the pH lowered to see the effect of on gelation.

| pH of sample | Observation |
|---|---|
| 13.013 | formed weak gel (gel score 1) |
| 11.889 and below | Clear thick solution |

TABLE 16
Observations of 1% (w/v) paramylon with 25 μl of
5% CaCl₂ added to 1 mL samples and the pH lowered
to see the effect of on gelation.

| pH of sample | Observation |
|---|---|
| 13.161 | formed clear firm gel (gel score 3) |
| 12.070 | formed opaque firm gel (gel score 2.5) |
| 11.210 | formed weak opaque gel (gel score 1) |
| 10.702 and below | formed clear thick solution |

TABLE 17
Observations of 5% (w/v) paramylon with 25 μl of
5% CaCl₂ added to 1 mL samples and the pH lowered
to see the effect of on gelation.

| pH of sample | Observation |
|---|---|
| 13.014 | formed clear firm gel (gel score 3) |
| 12.240 | formed weak gel (gel score 1) |
| 11.219 | formed weak gel (gel score 1) |

Cold Treatment on 1% (w/v) Paramylon Solution

1% (w/v) paramylon solution at varying pH levels were kept at −20° C. for overnight, and no difference was observed between this cold treatment and room temperature (control) (see FIG. 10).

### Discussion and Conclusion

As shown in this Example, paramylon is useful as a gelling agent under varying pH, temperatures, and concentrations. Without wishing to be bound by theory, pH, temperature, presence of cations, and concentration of a gelling agent may affect the functionality of gelling agent in a food matrix. Here it was shown that a desired gel strength can be achieved by using a combination of specific treatments within a food matrix. For example, for paramylon as a gelling agent in yogurt (i.e, traditional yogurt, live yogurt, stirred yogurt, set yogurt, and Greek yogurt, of different flavours), the gel strength can be controlled such that the texture is semi-solid and soft but not completely firm, so that the resulting yogurt has a good mouth feel. The pH can be from pH 1-12, temperature can be from −20° C. to 100° C., and concentration of paramylon can range from 0.01% to 10% (w/v) of yogurt.

### Gelation at Various pH Levels

Concentration of paramylon affected gel formation. It was shown in this Example that higher concentrations of paramylon resulted in firmer gels. Without wishing to be bound by theory, higher firmness may be due to more molecules available to form networks in a given space. This characteristic is also seen in other commercially available gels such as pectin or gelatin.

Furthermore, the higher the concentration of paramylon, the higher the pH at which initial gel formation occurred. For example, 0.1% (w/v) paramylon solution did not form a gel even at pH 1, whereas a gel was formed at around pH 10.0 from 1% (w/v) paramylon solution and a gel was formed with 5% (w/v) paramylon solution above pH 10.24.

As the concentration of paramylon increased, the strength of gel also increased, i.e. from no gelling at 0.1% paramylon, to weak gelling (gelling score 1) at 1% (w/v) paramylon, to firm gelling (gelling score 3) at 5% (w/v) paramylon.

### Chilling and Heat Treatment

Chilling and heat treatments were done on gels at varying pH to test effects of temperature on gel strength.

It is shown in this example that treatment at 4° C. helped in the formation of a gel. For example, with 1% (w/v) paramylon a weak gel (gel score 0.5) was formed at 4° C., while the original solution was clear and had no gel formation after the pH was adjusted; however, an increased viscosity was observed at 4° C. Cooling of 5% (w/v) paramylon, from room temperature (i.e. 20-25° C.) to 4° C., resulted in gel with more opacity than 5% paramylon gel that was kept at room temperature, and an increased gel firmness score of 3.5 compared to 3. Additionally, treatment at 4° C. prevented the solution from changing colours (yellowing), as observed with 5% paramylon at pH 13.014 and pH 12.240. Without wishing to be bound by theory, this may be the result of cooler temperatures slowing down the degradation of paramylon.

Heat treatment likely increased the degradation of paramylon solution, as the 5% paramylon solution changed from clear to yellow. Additionally, heat treatment resulted in gelling at the bottom of solutions at lower pH ranges, as observed with 0.1% and 1% (w/v) paramylon solutions. Without wishing to be bound by theory, this phenomenon may be the results of higher temperature increasing the kinetics of paramylon molecules, which facilitated an inter-molecular network via hydrogen bond formation, such that gel, albeit weak, was formed.

### Effects of CaCl₂) on Gelation at Various pH Levels

Results from this study show that CaCl₂ facilitated gel formation at higher pH ranges. Without wishing to be bound by theory, cations have been suggested to affect gel formation. For example, calcium may help gel formation by cross-linking polymers through ionic bonds, and it is used to increase gel strength of some commercial gelling agents.

As shown in this study, at pH 13.0 for the 0.1% paramylon solution, a weak gel was immediately formed after addition of CaCl₂ (final concentration ˜0.12%). Similar effects were observed with 1% and 5% (w/v) paramylon solution. As pH decreased, the effect of CaCl₂ was less pronounced on gel formation. Without wishing to be bound by theory, this may be due to a lack of available ionic functional groups, such as —OH groups, to form cross-link networks. For example, with 5% (w/v) paramylon solution at pH 13.0, it formed a firm gel but at pH 12.2, only a weak gel was formed.

Freezing Treatment on 1% (w/v) Paramylon Gel

In the freezing treatment on 1% (w/v) paramylon, the gel showed no difference in appearance of observed gel score compared to the −20° C. treatment and the room temperature control. For 1 freeze thaw cycle, the 1% (w/v) paramylon treatment has freeze thaw stability.

### Example 4: Calcium Gelation of Paramylon

### Introduction

This study evaluated gel formation of paramylon solutions using CaCl₂. Without wishing to be bound by theory, calcium ions may create bridges between deprotonated hydroxyl groups of paramylons in basic solutions.

### Materials and Methods

### Solubilization of Paramylon

Paramylon was dissolved in 1 N solutions of sodium hydroxide at 0.01, 0.1, 1, 5 and about 10% (w/v), by stirring for approximately 30 minutes at room temperature until no solids were observed.

### Preparation of Calcium Chloride

CaCl₂ solutions were prepared at 0.5, 1.5 and 5% (w/v) in deionized water.

### Preparation and Evaluation of Paramylon Gels

Work was conducted by mixing small volumes of paramylon with CaCl₂ solutions. It was shown that 0.01 and 0.1% (w/v) solutions of paramylon did not gel upon any addition of CaCl₂. 40 mL of each paramylon solution (1, 5, 10% (w/v)) were aliquoted into 50 mL centrifuge tubes in three sets of triplicates. Each set was treated with 1 mL of each CaCl₂ concentration (0.5, 1.5, 5% (w/v)). One set of triplicates was stored overnight in an oven (70° C.), one set was left at room temperature, and one set was frozen (−20° C.) overnight and then allowed to thaw for 2 hours. The strength of the gels was then scored on a scale of 0-3, with 3 being a gel state in which the tube could be inverted without the gel falling apart, 2 being a gel that was mostly semi-solid and inversion caused some pieces to fall apart, 1 being a solution was that was visibly thickened, but still flowed like a liquid, and 0 being no obvious increase in viscosity. A gel score of 2.5 is an intermediate gel strength between 3 and 2 where only a few pieces of the gel fall down the tube with inversion. 1.5 is an intermediate gel strength between 2 and 1 where the gel was slightly semi-solid. 0.5 is an intermediate gel strength between 1 and 0 where the solution is slightly thicker than water.

### Control for Calcium Addition to 1 M NaOH

A control experiment was conducted by adding CaCl₂ directly to 1 N NaOH to determine what would be observed in the absence of any paramylon. 10 mL aliquots of 1 N NaOH were added to 50 mL tubes and 0.5 mL additions of 0.5, 1.5 and 5% (w/v) CaCl₂ solutions were added to them and the effects observed.

### Results

### Control for Calcium Addition to 1 M NaOH

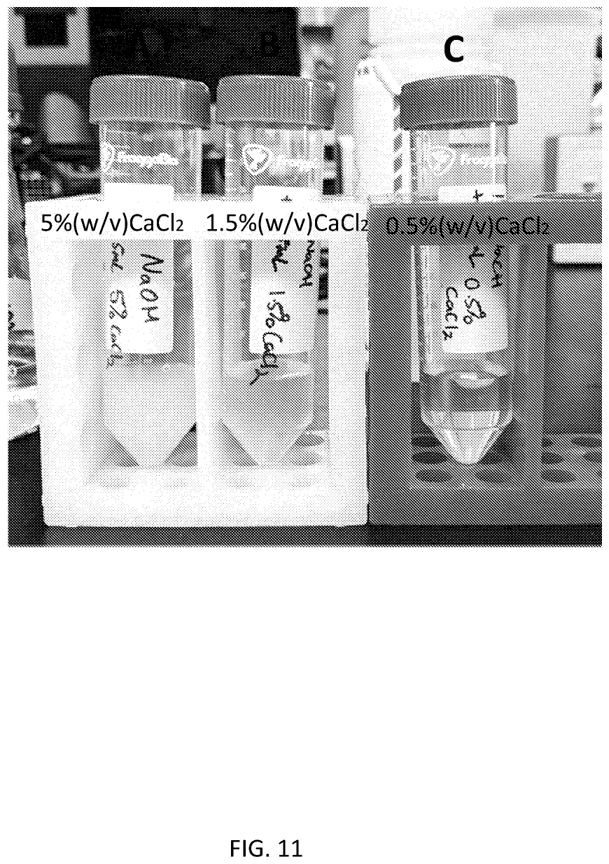

Results of CaCl₂ addition showed that a white precipitate was observed when CaCl₂ came into contact with 1 N NaOH (FIG. 11). This was only very pronounced at the addition of 0.5 mL 5% (w/v) CaCl₂ to 10 mL 1 N NaOH.

### Room Temperature Gelling

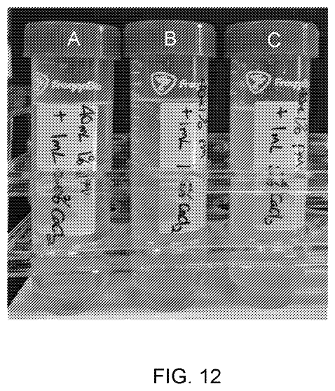

At 1% (w/v) inclusion of paramylon, the addition of 0.5% CaCl₂ solution yielded a thickened solution, but not a true gel (gel score 1; FIG. 12). The addition of 1.5% CaCl₂ solution yielded a gel that still deformed upon inversion but did not break (gel score 2; FIG. 12). Finally, the 1% (w/v) paramylon inclusion with the addition of 5% CaCl₂ yielded a firm, stable gel (gel score 3; FIG. 12).

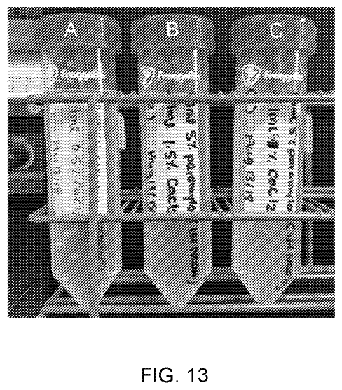

At 5% (w/v) inclusion of paramylon, similar to 1% (w/v) inclusion, the addition of 0.5% CaCl₂ solution yielded a thickened solution, but not a true gel (gel score 1.5; FIG. 13). The addition of 1.5% CaCl₂ solution yielded a gel that still deformed upon inversion, but did not break (gel score 2.5; FIG. 13). Finally, 1% (w/v) paramylon inclusion with the addition of 5% CaCl₂ yielded a firm, stable gel (gel score 3; FIG. 13).

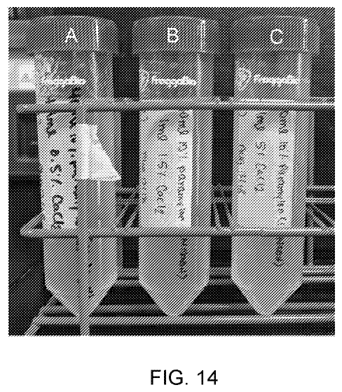

At 10% paramylon inclusion, the results were slightly different. The gels were all stronger than their lower inclusion counterparts. The 10% gel with 0.5% CaCl₂ was a very thick liquid with a small amount of breakage/flow (gel score 2; FIG. 14). Whereas, the 10% gels with 1.5% and 5% CaCl₂ were both firm gels that withstood inversion (gel score 3; FIG. 14). It was also observed that at 10% (w/v) paramylon inclusion there was yellowing of the paramylon solution. The 10% paramylon gel with 5% CaCl₂ also had a pH of approximately 12.8, to ensure that calcium was causing the gelling, not a pH shift due to the addition of the salt.

TABLE 18
Gel Strength scores of paramylon solutions (1%,
5% and about 10% (w/v)) kept at room temperature.

| | 1% (w/v) | 5% (w/v) | 10% (w/v) |
|---|---|---|---|
| | Paramylon | Paramylon | Paramylon |
| 1 mL 0.5% | 1 | 1.5 | 2 |
| Calcium Chloride | | | |
| 1 mL 1.5% | 2 | 2.5 | 3 |
| Calcium Chloride | | | |
| 1 mL 5% Calcium | 3 | 3 | 3 |
| Chloride | | | |

### Thermal Stability of Gels

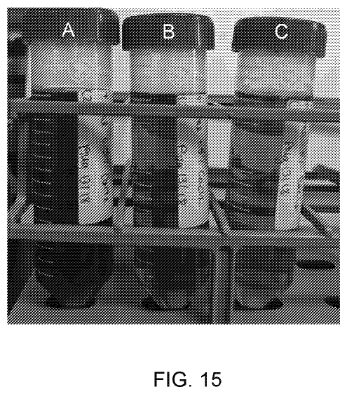

Colour change and gel stability was observed upon heat treatment in an oven overnight (˜16 hours) at 70° C., as exemplified by the 1% (w/v) paramylon shown in FIG. 15. The colour being most intense/darkest with the lowest CaCl₂ inclusion. All three inclusions of CaCl₂ with 1% (w/v) paramylon were melted and thus all received gel scores of 0, with no changes observed upon allowing solutions to return to room temperature.

The results of heating 5% (w/v) paramylon gels were different from 1% (w/v) paramylon gels (Table 19). For example, more darkening was observed at 5% paramylon inclusion than at lower paramylon inclusion. Furthermore, some syneresis was observed in these gels. An asterisk on the gel score was used to denote that there was a gel in the middle of the tube but the outer fringes of the tube remained liquid. The 5% (w/v) gel with 0.5% CaCl₂ received a gel score of 1.5, the 5% (w/v) gel with 1.5% CaCl₂ also received a gel score of 1.5 and the 5% (w/v) gel with 5% CaCl₂ received a gel score of 2.5.

The results of the 10% paramylon gels were similar to the 5% paramylon gels. The 10% gel with 0.5% (w/v) paramylon received a gel score of 2, the 1.5% CaCl₂ gel received a score of 2.5, the 5% (w/v) paramylon gel received a score of 3, notably, the entire solution remained gelled, with no obvious syneresis.

TABLE 19
Gel Strength scores of paramylon solutions (1%, 5%
and about 10%) tested for thermal stability at 70°
C. overnight (asterisk indicates syneresis observed)

| | 1% (w/v) | 5% (w/v) | 10% (w/v) |
|---|---|---|---|
| | Paramylon | Paramylon | Paramylon |
| 1 mL 0.5% | 0 | 1.5* | 2* |
| Calcium Chloride | | | |
| 1 mL 1.5% | 0 | 1.5* | 2.5* |
| Calcium Chloride | | | |
| 1 mL 5% Calcium | 0 | 2.5* | 3 |
| Chloride | | | |

### Freeze/Thaw Stability of Gels

The set of replicates for freeze thaw stability was evaluated after storage at −20° C. overnight and then being allowed to come to room temperature over ˜4 hours before evaluating their scores. For the 1% (w/v) gels of paramylon, significant degradation of gel stability was observed. The 0.5% and 1.5% CaCl₂ samples received a gel score of 0 whereas the 5% CaCl₂ gel received a score of 2.

The 5% paramylon gels showed similar loss of stability due to the freeze thaw cycle. For the 0.5% CaCl₂ sample, the thawed gel received a score of 0 whereas the 1.5% and 5% CaCl₂ samples received a score of 1 and 2, respectively.

The 10% paramylon gels showed slightly more resistance to freeze thaw than 5% gels. At 10% paramylon inclusion, the 0.5% CaCl₂ gel received a score of 1 whereas the 1.5% and 5% CaCl₂ gel received a score of 1.5 and 3, respectively.

TABLE 20
Gel Strength scores of paramylon solutions (1%,
5% and about 10% (w/v)) tested for freeze thaw
stability at −20° C. overnight.

| | 1% (w/v) | 5% (w/v) | 10% (w/v) |
|---|---|---|---|
| | Paramylon | Paramylon | Paramylon |
| 1 mL 0.5% | 0 | 0 | 1 |
| Calcium Chloride | | | |
| 1 mL 1.5% | 0 | 1 | 1.5 |
| Calcium Chloride | | | |
| 1 mL 5% Calcium | 2 | 2 | 3 |
| Chloride | | | |

### Discussion

Calcium is known to initiate gelling in some carbohydrate/hydrocolloid systems such as alginates and pectins. Without wishing to be bound by theory, the mechanism is thought to rely on the coordination of calcium by multiple hydroxyl groups along the carbohydrate backbones, especially in their deprotonated states, due to the divalent nature of calcium ions. This coordination may lead to extended three-dimensional networks of structured carbohydrate chains which ensnare water leading to the formation of a gel. Here, it was tested whether alkaline solubilized paramylon chains can form coordinated gel networks in the presence of calcium ions.

The results of the control (FIG. 11), where CaCl₂ was added directly to the 1 N NaOH used to solubilize paramylon, showed that at high pH calcium may be precipitating as calcium hydroxide. Calcium hydroxide is known to be poorly soluble. Furthermore, the precipitate observed in the control may explain part of the opacity of some of the gels prepared with high calcium concentrations. Without wishing to be bound by theory, one further problem due to this precipitation may be the production of calcium hydroxide upon drying of the gels.

Here, it was shown that room temperature gelation of paramylon solutions with CaCl₂ is a promising avenue for the food industry. There is a proportional relationship between calcium concentration and gel strength observed across all samples in this experiment. The same proportional relationship is seen with paramylon concentration and gel strength. This offers the opportunity for food formulators to tailor the amount of calcium or paramylon added to yield a gel of desired consistency.

Many gelling agents such as gelatins and pectins may require heating before gel set. It may be desirable in certain formulations with ingredients that undergo undesirable colour change upon heating to find a simple, robust gelling agent that works at ambient temperatures. Furthermore, some nutrients are thermally unstable, and preparation of nutritionally enhanced gummies may be easier using paramylon than conventional alternatives.

On the other hand, the results of this particular experiment imply that paramylon/calcium gels may not be desirable for applications where heating is necessary. The discolouration observed under heating is undesirable. Some heat induced syneresis of the gels was also observed which may create a challenge in some formulations. The 10% paramylon gel with addition of 5% CaCl₂ did not undergo any syneresis or melting but still had a dark colour. Unexpectedly, higher calcium concentrations inhibit the discolouration reaction, which can most clearly be seen in the 1% (w/v) paramylon gels of FIG. 15.

Freezing and thawing are also important factors for gels in the food industry, for applications such as ice cream. Although the act of freezing on these calcium gels appeared to decrease the overall gel strength upon thawing, thickening and viscosity enhancement were clearly retained, indicating uses of these gels in frozen confectioneries.

To summarize, it is concluded that use of calcium in conjunction with paramylon works to generate gels which are useful in food applications. The increased viscosity induced by even partially gelled paramylon is useful to increase formulation stability by preventing syneresis of the sample by slowing particle migration in the food matrix. Syneresis would be where water leaves the paramylon gel, which would be undesirable in food applications as it changes the properties of the item. The schematic representation of the different gel structures formed, via ionic interaction and/or carboxyl interaction and/or hydrogen bond cross-links, from CaCl₂, citric acid (as seen below in Example 7A) and HCl addition to paramylon solubilized in NaOH are presented in Scheme 1A, 1B and 1C in Table 72 below.

TABLE 72
Schematic representation of the different gel
structures of the beta-glucan chains generated by
CaCl₂ (1A), Citric Acid (1B) and HCl (1C).

| | | |
|---|---|---|
| Scheme 1A: CaCl₂-Gel | Scheme 1B: Citric-Gel | Scheme 1C HCl-gel |

### Example 5: Effects of Urea on Gelation of Paramylon

### Introduction

This study evaluated the effect of a chaotropic agent (urea) on paramylon gel formation by acid and CaCl₂. Without wishing to be bound by theory, urea may interfere with hydrogen bonding thereby affecting gel formation, in particular in the case of acid-facilitated gel formation. Here, it was determined whether urea affects paramylon gel formation with respect to gel strength, as well as whether urea affects CaCl₂ or acid-facilitated gel formation.

### Materials and Methods

Solutions of urea were prepared by dissolving urea in 1 M NaOH to final urea concentrations of 8 M, 7 M, 6 M, 5 M, 4 M, 3 M, 2 M, and 1 M. In each of these solutions, 5% (w/v) paramylon was dissolved. Each solution was split into equal volumes with 40 mL of each solution being added to one set of tubes for acid gel formation, and another 40 mL being added to another series of tubes for calcium gelation (as prepared in Example 4). In addition, a 40 mL control solution for each gel type was prepared (i.e. no addition of urea). To each solution in the acid set, 10 mL of 4 M HCl was added (enough acid to neutralize the NaOH), followed by vigorous shaking for 10 seconds, which was then allowed to set. In the parallel calcium set, 5 mL of 5% (w/v) CaCl₂ solution in water was added instead of the acid. The CaCl₂ solutions are neutral. When calcium is added to the paramylon in 1 M NaOH, the pH remains about the same as the original paramylon solution (˜13). As for the acid gels, the pH of the final gel is near neutral.

### Results and Discussion

Unexpectedly, a gel was formed under all circumstances. In particular, the acid gels formed almost immediately upon shaking. For the calcium gels, lower urea concentrations led to quicker gelation than higher urea concentrations (i.e. 6-8 M urea). For instance, the 8 M urea solution was initially viscous but formed the characteristic firm gel after about 30 minutes. This study shows that, surprisingly, urea does not have a significant impact on gel formation by either mechanism.

These results are in contrast to the strong effect of urea on curdlan gelling. The inclusion of urea in a curdlan suspension lowers the temperature needed to induce gelling and it is directly correlated with urea concentration, suggesting that the higher the urea concentration, the lower the temperature needed for gelation. Without wishing to be bound by theory, the effects of urea on curdlan gelling may be due to urea disrupting the initial crystalline regions' hydrogen bonding to allow reformation of the hydrogen bond network in an annealing type effect. As such, from 4-8 M urea, the gel strength declined, with no gel being formed in 8 M urea.

Paramylon gelling mechanisms are still poorly understood. Without wishing to be bound by theory, the use of strong base for solubilization may counteract the effectiveness of urea at disrupting hydrogen bonding. Additionally, urea is known to hydrolyze in base, and therefore, in addition to dilution from acid or calcium chloride, may affect final urea concentration.

Base catalyzed hydrolysis of urea: (NH₂)₂CO→CNO⁻+NH₄⁺ Eq. 1

The results of this study were unexpected. Results described herein showed that the gelation mechanism of paramylon is different than curdlan. Without wishing to be bound by theory, it may be that because urea is incorporated into the unit cell of the crystallite, in the same way water can be incorporated, which may increase the strength of the crystallites.

### Example 6: Drying and Reconstitution of Intermediate Paramylon States

### Introduction

This study evaluated whether the intermediate states of paramylon granules during alkaline solubilization (i.e. swollen, elongated, shell, solubilized) could be dried into powders that could then be rehydrated to yield the same structure. This work is relevant for preparing products derived from paramylon for tailored functionality in food applications. Our studies had shown that freeze drying is not effective in preserving the elongated structure. Here, it was tested whether spray drying may better preserve structure due to rapid drying.

### Materials and Methods

200 mL of 1% (w/v) paramylon solutions were prepared in various concentrations of sodium hydroxide to yield the desired intermediate forms of partially solubilized granules (i.e. 0.25 M NaOH for swollen granules, 0.33 M for elongated granules, 0.5 M for shells and 1 M NaOH for total solubilization). These suspensions were allowed to equilibrate with gentle inversion for approximately 1 hour before evaluation by light microscopy to confirm the particle structure.

After confirming that the desired forms of paramylon were obtained, the solutions were split into two 100 mL fractions. One 100 mL fraction was freeze dried, and the other was spray dried via co-current flow with a two-fluid atomiser, using an inlet temperature of 160° C., a flow rate of approximately 10 mL/min and an air pressure of 10 psi. After drying, samples were re-hydrated in 1 mL water to return them to their original concentrations of paramylon and sodium hydroxide (assuming the final powder had the same ratio of paramylon to sodium hydroxide as in the initial samples). These re-hydrated samples were then again evaluated by light microscopy to see if structural characteristics were preserved.

### Results

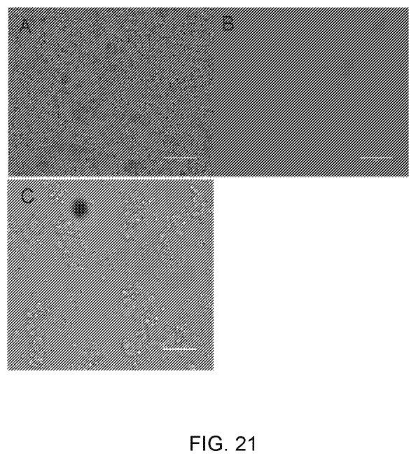

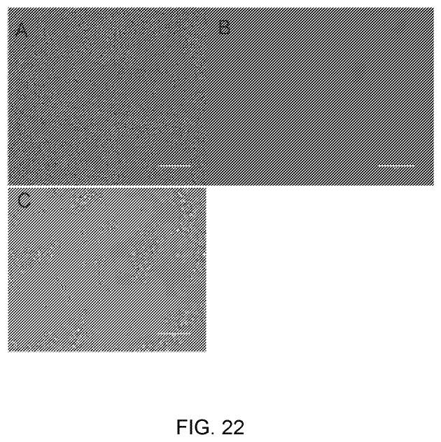

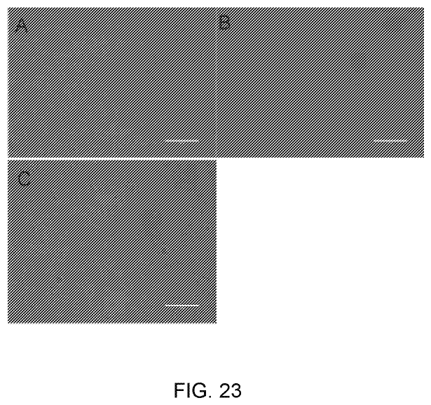

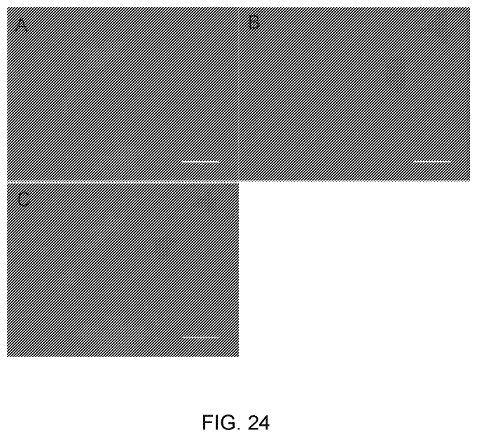

FIGS. 21-24 show the results of both drying methods on the structure of paramylon. In all concentrations of NaOH, the freeze-dried resuspension appeared as if it was solubilized. All concentrations of NaOH when spray dried yielded structures similar to the source material. The suspensions of spray dried powder had more of a grey gel-like appearance after settling, when compared to the initial solutions.

### Example 7A: Reconstitution of Organic Acid Gels—Preparation of a “Ready to Gel” Powder by Drying with Co-Solutes

### Purpose

A gel-ready powder is desired that can be dried and sold directly to customers, so all they are required to do is add water to obtain their desired amount of thickening/gelation.

### Materials and Methods

Solutions of paramylon (0.5%, 1%, 5% w/v) were prepared by dissolving appropriate amounts of paramylon in three separate 250 mL samples of 1 M NaOH. For example, dissolving 1.25 g in 250 mL of 1 M NaOH for 0.5% w/v, 2.5 g (w/v) for 1% (w/v), and 12.5 g for a 5% (w/v) solution. From these 250 mL solutions, nine 20 mL aliquots were distributed into 50 mL centrifuge tubes. Four gels were prepared by additions of various amounts of 4 M HCl (2 mL, 5 mL, 10 mL), 375 g/kg citric acid (2 mL, 5 mL, 10 mL), 600 g/kg citric acid (2 mL, 5 mL, 10 mL), or 5% w/v CaCl₂ solution (0.1 mL, 0.3 mL, 1 mL). Gels were prepared by pulse addition of the solutions whereby the entire volume was added all at once as opposed to dropwise. Following preparation of the gels by shaking in the tubes, the gels were immediately freeze-dried. The powder obtained was then ground with a mortar and pestle followed by addition of 20 mL of distilled water to each, ultimately yielding a standardized final paramylon concentration of 0.5%, 1% or 5% w/v. Following addition of water, the tubes were shaken, and the resultant “gels” were qualitatively evaluated as to whether they were representative of the gel/thickener obtained before freeze drying.

### Results

The results of the reconstitution experiments are summarized in Tables 21-25.

TABLE 21
Reconstitution of 0.5% paramylon samples

| | pH | pH | Quality |
|---|---|---|---|
| Treatment | before FD | after FD | after FD |
| 375 g/kg citric acid - 2 mL | 13.09 | 13.26 | N/A |
| 375 g/kg citric acid - 5 mL | 10.75 | 4.63 | Thickening |
| 375 g/kg citric acid - 10 mL | 3.44 | 3.51 | N/A |
| 600 g/kg citric acid - 2 mL | 5.30 | 5.41 | N/A |
| 600 g/kg citric acid - 5 mL | 3.39 | 3.34 | Thickening |
| 600 g/kg citric acid - 10 mL | 2.59 | 2.55 | Thickening |
| 4M HCl - 2 mL | 13.30 | 13.35 | N/A |
| 4M HCl - 5 mL | 10.75 | 9.79 | N/A |
| 4M HCl - 10 mL | 0.09 | 1.19 | N/A |
| 5% CaCl₂ - 0.1 mL | 13.43 | 13.47 | Thickening |
| 5% CaCl₂ - 0.3 mL | 13.41 | 13.42 | Thickening |
| 5% CaCl₂ - 1 mL | 13.41 | 13.41 | N/A |

FD = freeze drying

TABLE 22
Reconstitution of 1% paramylon samples

| | pH | pH | Quality |
|---|---|---|---|
| Treatment | before FD | after FD | after FD |
| 375 g/kg citric acid - 2 mL | 13.07 | 13.15 | N/A |
| 375 g/kg citric acid - 5 mL | 4.61 | 4.65 | Thickening |
| 375 g/kg citric acid - 10 mL | 3.53 | 3.54 | Thickening |
| 600 g/kg citric acid - 2 mL | 5.24 | 5.22 | Thickening |
| 600 g/kg citric acid - 5 mL | 3.52 | 3.34 | Thickening |
| 600 g/kg citric acid - 10 mL | 2.59 | 2.62 | Thickening |
| 4M HCl - 2 mL | 13.24 | 13.24 | N/A |
| 4M HCl - 5 mL | 7.54 | 7.28 | N/A |
| 4M HCl - 10 mL | 0.01 | 1.41 | N/A |
| 5% CaCl₂ - 0.1 mL | 13.25 | 13.36 | Thickening |
| 5% CaCl₂ - 0.3 mL | 13.26 | 13.32 | Thickening |
| 5% CaCl₂ - 1 mL | 13.32 | 13.32 | Thickening |

TABLE 23
Reconstitution of 5% paramylon samples

| | pH | pH | Quality |
|---|---|---|---|
| Treatment | before FD | after FD | after FD |
| 375 g/kg citric acid - 2 mL | 12.89 | 12.96 | Thickening |
| 375 g/kg citric acid - 5 mL | 4.65 | 4.53 | Gel |
| 375 g/kg citric acid - 10 mL | 3.51 | 3.47 | Gel |
| 600 g/kg citric acid - 2 mL | 5.23 | 5.06 | Gel |
| 600 g/kg citric acid - 5 mL | 3.33 | 3.37 | Gel |
| 600 g/kg citric acid - 10 mL | 2.45 | 2.51 | Gel |
| 4M HCl - 2 mL | 13.08 | 13.04 | N/A |
| 4M HCl - 5 mL | 1.64 | 2.24 | Thickening |
| 4M HCl - 10 mL | 0.46 | 1.29 | N/A |
| 5% CaCl₂ - 0.1 mL | 12.96 | 13.36 | Thickening |
| 5% CaCl₂ - 0.3 mL | 13.04 | 13.34 | Thickening |
| 5% CaCl₂ - 1 mL | 13.00 | 13.21 | Thickening |

The experiment was repeated as outlined in the materials and methods above, with the following changes: dropwise addition compared to pulse addition of citric acid was compared to change the pH of the resulting gel. Only 5% (w/v) paramylon was tested. For 4 M HCl and 5% (w/v) CaCl₂, only one sample was tested. In addition, a negative control containing no addition of co-solute was added to the experiment. The quality of the gels was scored before and after freeze drying. Results from the experiment are shown below in Table 24.

TABLE 24
Repeat of 5% paramylon gel reconstitution,
including before freeze drying gel scores.

| | Amount added | pH | | Gel Score | |
|---|---|---|---|---|---|
| | to solubilized | Before | After | Before | After |
| | PM (mL) | drying | drying | drying | drying |
| Citric Acid (375 | 2 | 12.91 | 12.95 | 1 | 1 |
| g/kg) (pulse | 5 | 4.52 | 4.61 | 3 | 3 |
| addition) | 10 | 3.43 | 3.57 | 3 | 3 |
| Citric acid (333 | 2.1 | 8.51 | 7.79 | 3 | 1 |
| g/kg) (dropwise | 2.4 | 5.76 | 5.88 | 3 | 1 |
| addition) | 2.5 | 7.11 | 6.89 | 3 | 1 |
| Citric acid (500 | 2.1 | 6.21 | 6.11 | 3 | 3 |
| g/kg) (dropwise | 2.5 | 5.29 | 5.19 | 3 | 3 |
| addition) | | | | | |
| 4M HCl | 5 | 7.55 | 8.35 | 3 | 1.5 |
| 5% CaCl₂ | 1 | 13.58 | 13.20 | 1.0 | 1.0 |
| Control | N/A | 13.59 | 13.29 | 0.5 | 0.5 |

### Discussion

The most dramatic observation in this set of experiments was the ability of citric acid induced gels to be reconstituted as gels, instead of only thickeners. This result shows that under appropriate balance of citric acid and paramylon, and appropriate reconstitution volume, a powder that is slightly acidic can form a fully ensnared 3D gel network when water is added. This result is highly desirable in terms of being able to supply a water dispersible powder which could be incorporated directly into food formulations, leading to thickening and gelling, without affecting the food pH dramatically.

Calcium gels were able to exhibit some amount of rheological influence over reconstituted samples as well, in a less dramatic way. Samples that were gels prior to drying wound up as thickeners, with no dramatic trend associated with calcium or paramylon concentrations. Ultimately, since the pH was still quite high on the reconstituted calcium gels, the apparent thickening after rehydration may simply be the consequence of paramylon remaining in a soluble form, which in itself imparts a significant amount of viscosity to the solution.

The gels prepared from HCl showed almost no effective reconstitution. However, when these samples were rehydrated an opaque, jelly-like mass was usually observed at the bottom of the tube, indicating some amount of water interaction but reduced ability to form a dispersion. This lack of dispersibility likely hindered gel formation.

Since HCl and citric acid are presumably forming gels via the same mechanism, one might expect them to be equally equipped for reconstitution, however this was clearly not observed. Without wishing to be bound by theory, a potential explanation is an alteration of the paramylon fibril structure obtained by drying in the presence of citric acid. Citric acid may have co-crystallized with the beta-glucan chains making a material which was overall less crystalline in nature than that produced by HCl. Without wishing to be bound by theory, it is reasonable to assume that citrate may intercalate between beta-glucan microfibrils due to some affinity between citrate and the beta-glucan backbone that was not observed with the chloride ions. The resulting citrate containing powder could then be more readily dispersed in water due to reduced hydrogen bonding between beta-glucan chains and ultimately the ability to form a new hydrogen bonding network including water. The HCl powders appeared to hydrate but not completely disperse, thus not forming an extended hydrogen bonding network with water, but mostly among the beta-glucan chains themselves.

A repeat of the samples which worked based on the first trials was conducted to ensure reproducibility (Table 24). The samples which were treated with dropwise citric acid to specifically target neutrality did not reconstitute as well as those which were prepared by pulse addition, however the citric acid solution used was also of a slightly lower concentration and may have influenced the difference observed between these methods.

When the repeat experiment was performed, a control was additionally included, wherein no acid or other gelling agent was added to the solubilized paramylon. This demonstrated that the solubilized material, which has some thickening property, remained in a similar, soluble form following freeze drying, thus maintaining the slight increase in thickness observed from dissolved paramylon.

### Example 7B: Additional Studies on Reconstitution of Organic Acid Gels

Materials and methods are as described in Example 7A. Studies are undertaken to determine the ratio of citric acid to paramylon that is useful to prepare paramylon powder, to determine useful variations in combining the two ingredients, drying conditions, and resuspension volumes and conditions.

The effects of presence of other potential crystallinity interrupting materials is also determined, by adding to paramylon gels prior to drying to generate more reconstitutable powders, for example the addition of urea prior to gel formation and freeze drying may yield a powder which is amorphous enough to readily disperse and form a gel upon rehydration.

The difference between dropwise and pulse addition was discovered to influence the outcomes of reconstitution significantly. Studies are carried out to figure out the exact volumes needed to reach neutrality and compare whether these additions done dropwise or by pulse addition influence the final powder behaviour. Furthermore, the concentration of the citric acid solution is investigated to see if this impacts the final reconstitution results.

Once the ratio of citric acid to paramylon and drying conditions are optimized this “gel-ready” powder is investigated in different food matrices such as deserts (custard, fillings, etc) or fruit jellies, or other food matrices, especially those which can tolerate or even require a small amount of acidity.

### Example 8: Additional Studies on Milling of Spray Dried Samples

Studies are carried out to investigate the effects of milling of the spray dried paramylon samples on particle size and whiteness of the samples. Spray dried material is milled, by which the aggregate spheres formed from spray drying are broken apart into smaller particles. A particle is discreet solid material that is suspended in the liquid phase. Spray dried particles tend to be aggregates of smaller sub particles, where the sub-particles are granules that have been stuck together. When the particles are broken into sub particles (i.e. granules), the whiteness of the spray dried paramylon is increased. The experimental condition would be the taking the spray dried paramylon, from the granule, swollen, elongated, and shell form and milling it to break the aggregation. This is then put into solution, such as water or base and suspended. The controls are the non milled, spray dried paramylon of the granules, swollen form, elongated form, and shell form that is also put into water or base and suspended. The difference between the treatment and the control shows the effect of milling on the properties on paramylon form. Another control that is used is the non spray dried paramylon granules, swollen form, elongated form, and shell form in water or base. By comparing the treatment to this control it shows if the treatment also has the same properties that the non-spray dried (before drying) material has. The particle sizes of the non spray dried control, non milled control, and milled treatment is measured on an EVOS microscope under light illumination. The sub particle size and the non spray dried control particle size is 1-5 μm, the aggregates in the spray dried material is 10-100 μm and the milled material has particle sizes 1-50 μm.

### Example 9A: Gelling Fruit Examples

### Introduction

This study was carried out to test gelation property of paramylon by using a simplified version of fruit jelly and fruit gummies. In the fruit gummy example, glucose was used instead of real fruit juice to simplify the food matrix. Sucrose and fruit flavoring were used in the fruit jelly example to simplify the food matrix.

### Materials and Methods

### Fruit Gummies

The granule form of paramylon was isolated as described in Example 1. 3 g paramylon was solubilized into 100 mL of 1M NaOH solution (pH >13). 10 g glucose was added to the paramylon solution. pH of the solution was adjusted to <3 by 1M HCl. The solution was poured into jelly mounds during pH adjustment at ˜pH 10 or ˜pH 3, and kept overnight at 4° C. The solution reaching pH 1.5 was not poured into the jelly mould. Pictures were taken to tracked gel formation.

### Fruit Jelly

The granule form of paramylon was isolated as described in Example 1. 3 g paramylon was solubilized into 100 mL of 1M NaOH solution (pH >13). Sugar (sucrose) and strawberry flavor (Lorann Gourmet) was added to the paramylon solution for a final concentration of 20% sucrose and 0.1% flavor, as seen in Table 25. Using a 50% citric acid solution, pH of the solution was brought down until a jelly-like gel was formed. The final pH was measured at pH 4.

TABLE 25
Paramylon fruit jelly mixture, the solvent
for NaOH and Citric is dH₂O.

| Reagent used to generate | Percentage of |
|---|---|
| paramylon fruit jelly | reagent (%) |
| Paramylon granules | 1.8 |
| 1M NaOH | 58.1 |
| Sugar | 20 |
| Citric Acid (50%) | 20 |
| Strawberry flavour | 0.1 |
| Total Volume | 100 |

### Results

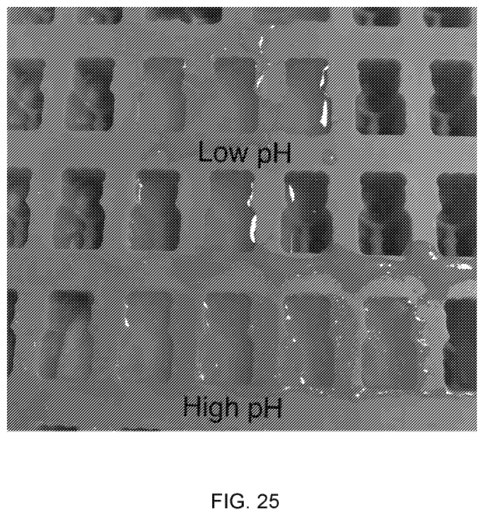

Gel score was assigned to indicate gel strength observed from 1 to 3, where 1 means weak gel, 2 means medium strength gel, and 3 means firm gel. pH of solution dropped initially from 13.079 to a final pH of 1.5. During adjustment, when the pH was 10.2 (high pH) and 3.3 (low pH) the solution was poured into a jelly bear mould. A weak gel was observed (gel score 0.5) at pH 10.2 (FIG. 25), indicating gelation occurred in this fruit gummies version of jelly candy. When a lower pH, i.e. 3.3 was reached, the solution did not gel, which was unexpected.

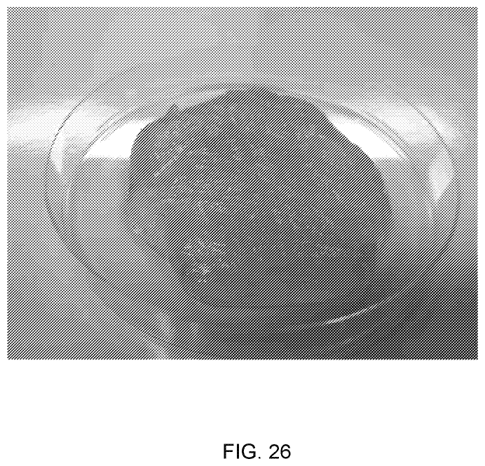

The fruit jelly that was made was a medium strength gel (i.e. gel score 2; FIG. 26).

### Discussion and Conclusion

This study has shown that paramylon is useful in food application, in particular, to facilitate gel formation in the making of jelly candy such as fruit gummies. Above experiment supported such conclusion. However, the jelly was not firm enough to retain its shape when removed from the mould.

Unexpectedly, the lower pH jelly (3.3) did not form even a weak jelly, although a gel was formed at a lower pH when making pH adjusted gels. When making pH adjusted gels, even at a lower pH, a gel is still formed, whereas the higher pH gel did form. Without wishing to be bound by theory, the lower pH introduces more protons into the solution, and these protons may be able to interact with the alcohol group of glucose, protonating it and making the glucose units more positive. At a more basic pH, it is likely that the glucose and paramylon are interacting by hydrogen bonding. At the more acidic pH, the positive charge on the glucose molecules may repulse the paramylon molecules, making it difficult to form a matrix and therefore, a gel.

The fruit jelly experiment showed the gelation capability of paramylon to form a jelly product using an organic acid which is a safe and commonly used acidulant in food production and is specifically used in the industrial production of fruit jellies. Additional examples of the fruit jelly are outlined below.

### Example 10: Additional Studies on Application of Paramylon in Idly Candy Making

Studies are carried out to determine the ability of paramylon in facilitating gel formation in a jelly candy model. These studies use varying concentration of paramylon, from 3%, 4%, 5%, to as high as 10%, varying pH, from pH 1 to as high as 12, with HCl, citric acid, lactic acid or any organic acid and varying calcium chloride concentration, from 0.001% to 5% (w/v) calcium chloride. The firmness of gels is measured as follows. The firmness of the gels is measured by a texture analyzer. Material is applied to a cup and the piston applies a set amount of pressure, then the amount of deformation of the gel there is measured, and then the machine keeps applied more pressure, measuring the force applied and the deformation of the gel. The strength of the gel is 1-3000 g/cm². Higher concentrations of paramylon form firmer gels. Since a stronger gel would help the jelly hold its shape, the higher concentration paramylon forms a stronger jelly. As well, with the higher paramylon concentration, a stronger gel at a lower pH at 6-7 form a gel in the jelly mould.

In addition, studies are carried out to determine the effects of flavour additive in paramylon-mediated gel formation in the jelly candy model. Fruit juice, flavour extract or flavourings is combined with solubilized paramylon, from pH solubilization. In another method, heat treatment at greater than 150° C. in a microwave is able to disrupt the paramylon structure. Without wishing to be bound by theory, the heat treated suspensions of disrupted granules may be induced to gel upon cooling.

### Example 11: Emulsion Capability and Water Holding Capacity of Spray Dried and Wet Gel in Cookies

### Introduction

This study evaluated emulsification capabilities of paramylon in spray dried gel and wet gel format, as compared with egg, when baked into a cookie. Additionally, observation was made on water holding capacity of paramylon in cookies.

### Materials and Methods

Compositions for making cookies using egg (i.e. control), wet paramylon, and spray dried paramylon are shown in Tables 26-28. The composition for the control group is also shown in https://www.seriouseats.com/recipe s/2015/12/print/soft-and-chewy-sugar-cookie-recipe.html.

TABLE 26
Control cookie recipe using egg.

| Ingredient | % | Weight (g) |
|---|---|---|
| Unsalted butter | 24.7 | 112.5 |
| Sugar | 30.7 | 140 |
| Salt | 0.5 | 2.5 |
| Egg | 6.1 | 28 |
| Vanilla extract | 1.6 | 7.5 |
| All purpose flour | 35.1 | 160 |
| Baking powder | 1.1 | 5 |

TABLE 27
Wet paramylon gel replacing the egg in the cookie recipe.

| Ingredient | % | Weight (g) |
|---|---|---|
| Unsalted butter | 24.7 | 112.5 |
| Sugar | 30.7 | 140 |
| Salt | 0.5 | 2.5 |
| 13% paramylon gel, | 6.1 | 28 |
| pH formed | | |
| Vanilla extract | 1.6 | 7.5 |
| All purpose flour | 35.1 | 160 |
| Baking powder | 1.1 | 5 |

TABLE 28
Spray dried paramylon gel replacing the egg in the cookie recipe.

| Ingredient | % | Weight (g) |
|---|---|---|
| Unsalted butter | 24.7 | 112.5 |
| Sugar | 30.7 | 140 |
| Salt | 0.5 | 2.5 |
| Spray dried paramylon granules | 0.79 | 3.64 |
| (egg protein replacement) | | |
| Vegetable oil (egg fat | 0.67 | 3.08 |
| replacement) | | |
| Filtered water (egg moisture | 4.63 | 21.28 |
| replacement) | | |
| Vanilla extract | 1.6 | 7.5 |
| All purpose flour | 35.1 | 160 |
| Baking powder | 1.1 | 5 |

The cookies were made as follows.

Cookies Made with Egg (Control)

Control was made in accordance to the recipe as shown in Table 26. Cookie batter was divided into 26 one ounce portions by rolling 1 ounce of batter into a ball and placed onto an aluminum baking sheet. Cookies were baked at 350° F. for 15 minutes.

Cookies Made with Paramylon Wet Gel

Wet 13% paramylon acid gel was prepared by solubilizing 13% paramylon in 1M NaOH, stirred and acidified pH to neutral by HCl. Gel was then finely mashed with a fork in a bowl prior to adding it to the dough to ensure even distribution of gel particles. Negative control was also made in accordance to the recipe but omitting the egg or paramylon.

Cookies with Spray Dried Paramylon Gel Powder

Cookies were prepared according to recipe as shown in Table 28. Spray dried 2% Paramylon acid gel, vegetable oil and filtered water were used to replace whole egg used in the control cookies. Ingredients were whisked in non-plastic bowl for 2 min until uniformly dissolved. pH strip was used to test the pH of the mixture (˜6 pH). Mixture was stored in a 4° C. refrigerator for 10 minutes. Egg replacement mixture was whisked again for one min before adding it to the cookie dough recipe.

For both cookies with dry paramylon or wet gel, rise and spread of cookies were measured within 1 hour of cooling down of cookies and observed visually in the following two days.

### Results and Discussion

In order to evaluate the appearance of the cookie, the rise and spread were measured. The rise and spread are not a measurement of the emulsification or water holding capacity of the cookie, but show how the cookies with paramylon compare to the positive control cookies in terms of the cookie appearance. Two control batches were made and the rise and spread were fairly consistent between the two. The negative control (no eggs nor paramylon), dried paramylon and wet paramylon were compared to the positive control in terms of rise and spread.

Cookies with Dry Paramylon

The spray dried gel cookie (Table 31) had less rise and similar spread compared to negative control cookies (no eggs nor paramylon; Table 30). Compared with positive control (with eggs; Table 29), the cookies had less rise and spread overall, making the structure smaller than the positive control. The break of the cookie was only slightly more with the experimental as compared with the control (i.e. made with egg), as the break was hardly noticeable because they were both soft, although the crumb was larger than the control. For the negative control (no egg nor paramylon), the rise was similar to the positive control (with egg), however it did not spread as much (see Table 29 vs Table 30). Taste, colour and appearance were the most noticeably differences between the two cookies. The taste in the experimental had a tang or slight sourness to it. The colour was lighter, whiter than the golden/honey colour of the control. As well, the surface of the experimental cookie was uneven and pitted in comparison to the control which was smoother and had tiny air pockets on the surface.

TABLE 29
Rise and spread of the positive control cookies in
the 2 control batches, control 1 and control 2. Each
batch has 6 trials and the average was given.

| | 1 | 2 | 3 | 4 | 5 | 6 | Average |
|---|---|---|---|---|---|---|---|
| Positive | | | | | | | |
| Control 1 | | | | | | | |
| 17/8/18 | | | | | | | |
| Rise | 10.87 | 9.96 | 10.41 | 9.86 | 9.97 | 9.56 | 10.11 |
| (mm) | | | | | | | |
| Spread | 56.25 | 62.16 | 57.9 | 55.62 | 57.26 | 62.55 | 58.62 |
| (mm) | | | | | | | |
| Positive | | | | | | | |
| Control 2 | | | | | | | |
| 28/8/18 | | | | | | | |
| Rise | 10.33 | 10.11 | 10.11 | 9.93 | 9.74 | 10.44 | 10.11 |
| (mm) | | | | | | | |
| Spread | 60.49 | 65.4 | 58.33 | 59.08 | 60.45 | 55.78 | 59.92 |
| (mm) | | | | | | | |

TABLE 30
Negative control cookie rise and spread results

| Negative | | | | | | | |
|---|---|---|---|---|---|---|---|
| Control | | | | | | | |
| 28/8/18 | 1 | 2 | 3 | 4 | 5 | 6 | Average |
| Rise | 11.45 | 9.89 | 11.96 | 10.08 | 11.16 | 11 | 10.92 |
| (mm) | | | | | | | |
| Spread | 55.52 | 54.27 | 57.73 | 55.91 | 55.95 | 54.7 | 55.68 |
| (mm) | | | | | | | |

TABLE 31
Rise and spread of the spray dried paramylon eel in the cookies

| Spray | | | | | | | |
|---|---|---|---|---|---|---|---|
| dried | | | | | | | |
| paramylon gel | | | | | | | |
| 17/8/18 | 1 | 2 | 3 | 4 | 5 | 6 | Average |
| Rise | 8.01 | 8.59 | 8.88 | 8.38 | 8.87 | 8.83 | 8.59 |
| (mm) | | | | | | | |
| Spread | 57.88 | 55.08 | 54.77 | 54.3 | 57.16 | 54.23 | 55.57 |
| (mm) | | | | | | | |

### Water Holding Capacity

Immediately after baking, the cookies (with egg, paramylon or negative control without egg and paramylon) all maintained good moisture. Visual inspection after 2 days showed that cookies with dry paramylon have similar moisture texture with the control (with egg), and it contained slightly more moisture than the negative control (without paramylon or egg). This indicated some water holding capacity of dry paramylon.

### Emulsion Capacity

The three treatments (with egg, paramylon, or negative control without egg and paramylon) all maintained good moisture in both dough stage and final cookies, which suggested that there is limited additional water emulsion capacity.

Cookies with Wet Gel Paramylon

Both wet gel paramylon and negative control cookies, upon removal from the oven, were dome shaped before they cooled. Once they cooled their appearance was ridged and pitted. This is likely due to the lack of egg within the cookies, as the ridging and pitting was noticed on the cookies lacking the egg. Wet gel paramylon experimental cookies have the appearance of the above “dry” paramylon experimental cookie in colour and texture and they were soft to the break with a slight oil residue left on the fingers. The wet gel cookie (Table 32) had similar spread compared to negative control cookies (Table 30) and the spray dried paramylon gel (Table 31). Compared with positive control (Table 29), the cookies had similar rise, however spread less. The taste was sweet and no noticeable tang or sourness, although it seemed to be lacking the eggy richness of the control. The mouth feel was also very different between the positive control and the wet gel paramylon cookie in that the control had a smoother mouth crumb than the larger less uniform mouth crumb of the experimental. The wet gel paramylon cookie crumb was different, in that it had the appearance of the gel paramylon within it. Also the center of the cookie seems under baked, so much so a small dough ball can be formed. Without wishing to be bound by theory, a possible cause of this is that the gel is locking in the moisture within the center of the cookie matrix.

TABLE 32
Wet paramylon eel cookie rise and spread result.
6 trials were done and the average was given.

| Wet | | | | | | | |
|---|---|---|---|---|---|---|---|
| Paramylon gel | | | | | | | |
| 28/8/18 | 1 | 2 | 3 | 4 | 5 | 6 | Average |
| Rise | 11.02 | 10.9 | 9.94 | 11.54 | 10.28 | 10.62 | 10.72 |
| (mm) | | | | | | | |
| Spread | 54.82 | 53.47 | 55.38 | 52.92 | 53.41 | 55.31 | 54.22 |
| (mm) | | | | | | | |

### Water Holding Capacity

In terms of the moisture level in the wet paramylon gel cookie, it was comparable to the negative control and not the positive control. As the negative control lacked eggs, in particular the egg white which gave the moisture to the cookie.

### Emulsion Capacity

Limited emulsion capacity was observed as when preparing the cookie dough, wet gel paramylon was not easily emulsifying the oil and water.

As a general conclusion, both dry and wet gel paramylon had some water holding capacity in cookie application while wet gel paramylon showed limited water holding capacity. Both dry and wet gel paramylon had limited emulsion capacity.

### Example 12: Additional Studies on Effects of Paramylon on Cookies

The cookies are visually inspected at various time points from 2 days to 1 month and beyond. In order to determine the water holding capacity, the weight after baking and after set days i.e., 24 hours, 48 hours, 72 hours, 1 week, 2 weeks and 1 month at room temperature to see the effects of water holding. The difference between the positive control and negative control is egg in the positive control and no egg in the negative control. Negative control has the most moisture loss over time and quicker than the positive control and the treatment conditions (paramylon cookies). Positive control and paramylon cookies have more weight measured over time, as more water is retained or held. Results are reported as grams of water held per gram of cookie to analyze the water holding capacity in extended period of time.

Studies are carried out to determine water loss over time. A positive control where there is egg in the cookie is used as the reference for water loss over time. A negative control cookie containing no egg is compared as a low moisture control. The experimental cookies contain spray dried paramylon gel, from both a calcium chloride form gel and a pH adjusted gel. The wet paramylon gel cookie and the cookie that has dried paramylon spray dried gel retains more water, such as lower percentage of weight loss over time stored at room temperature over time than the negative control cookie based on weight measurements. A water activity meter, such as the Novasina labtouch-AW from ThermoFisher Scientific can be used to measure the water availability inside the cookie. Alternatively, the weight on the initial day cookie is compared to the weight at the end of the experiment, cookies that have a higher moisture at the end of the experiment have higher water holding capacity. Higher water holding capacity is preferred in order to prevent staleness in the cookie.

### Example 13: Effects of Dialysis on Paramylon Solution and Gel

### Introduction

This study evaluated the effects of dialysis on pH, salt contents and concentration of paramylon solutions and gels. Removal of sodium can bring the paramylon gels into food application.

### Materials and Methods

Paramylon solution was prepared by dissolving paramylon in 1M NaOH solution at a final concentration of 0.1%, 1%, 2%, 3% and 5% (w/v) paramylon. Paramylon gel was prepared by adding 1 mL 5% calcium chloride in 40 mL paramylon solution or by adjusting pH to ˜3.3 using 4M HCl solution.

5 mL paramylon solution was put into a dialysis tube (10,000 Da tubing), and then the dialysis tube was dialyzed against 500 mL water. Water phase samples were taken at 0 min, 10 min, 24 hours and 48 hours for analyses of pH, sodium content, calcium content, colour, and gelation ability.

Sodium and calcium ions were measured by analytical lab SGS Canada using ICP-MS. Briefly, the sample was digested in concentrated acid and then ionized through high temperature plasma. The ionized mixture was then put through a magnetic field to separate the ions. The results were compared to a standard of sodium or calcium solution and was then quantified.

### Results

### Dialysis of Paramylon Solution

pH value: 0.1%, 1% and 5% (w/v) paramylon solutions in 1M NaOH solution were dialyzed using the method described above. The pH value and volume variations are shown in Table 33. As seen, the pH in water phase was significantly increased even after 10 min, and the pH value was equilibrated in paramylon solution phase and water phase after 24 hr dialysis, regardless of the concentration of paramylon.

TABLE 33
pH and volume variation of paramylon solution after washing.

| | pH | | | | | Volume (mL) | |
|---|---|---|---|---|---|---|---|
| Sample | pHi | 10 min | 24 hr | 48 hr | pHf | Vi | Vf |
| 0.1% | 13.24 | 10.37 | 11.69 | — | 11.83 | 5 mL | 4 mL |
| 1% | 13.33 | 11.503 | 11.72 | | 11.58 | 5 mL | 4.5 mL |
| 2% (gel) | 3 | 6.23 | 5.98 | 5.81 | 5.98 | 5 mL | 5 mL |
| 5% | 13.04 | 8.04 | 11.69 | | 11.86 | 5 mL | 7 mL |

pHi is the initial pH in paramylon phase; pHf is the final pH in paramylon phase; 10 min, 24 hr and 48 hr are the pH in water phase at the stated times. Volume is the paramylon volume; Vi is the initial volume of paramylon volume; Vf is the final volume of paramylon volume. The colour of paramylon in 0.1%, 1% and 2%: those initial colour was white, is not visibly changed; the colour of paramylon in 5%, its initial colour was yellow, becomes white.

Volume change: The volume of the paramylon solution in dialysis tube decreased in lower concentrations of paramylon (0.1% and 1% (w/v)), but increased in higher concentration (5% (w/v)).

Colour: The yellow colour in 5% (w/v) paramylon solution was turned into white during dialysis. This is because the lower molecular-weight molecules were removed from the paramylon solution. Without wishing to be bound by theory, the lower molecular weight molecules may be products of alkaline degradation of the beta-glucan.

### Gel Formation of Dialyzed Paramylon Solution by Adding 5% CaCl₂

5% calcium chloride was added to dialyzed paramylon solution to investigate the gelation behavior. Results are shown in Table 34 It is clear that the dialysis highly influences gel formation of paramylon solution. Without wishing to be bound by theory, effects on gel formation may be due to changes in concentration of paramylon and pH, especially pH (decreased to ˜12), were changed.

TABLE 34
Gelation behavior of dialyzed paramylon solution

| | | Gelation | Gels behaviors after 2 |
|---|---|---|---|
| Samples | | behavior | days at −20° C. |
| 0.1% | Before | Gel formed | |
| | dialysis | | |
| | After dialysis | No Gel formed | Phase separation |
| 1% | Before | Gel formed | |
| | dialysis | | |
| | After dialysis | Loose solution | Phase separation |
| 5% | Before | Yellow; gelling | |
| | dialysis | immediately | |
| | After dialysis | Clear gelling slowly | No phase separation |

### Dialysis of Paramylon Gels Prepared Using Calcium Chloride

pH: The pH value and volume variations are shown in Table 35. As seen, the pH in water phase was increased after 10 min. However, water cannot readily penetrate a paramylon gel when compared to a paramylon solution. This changes the volume of water that can enter the dialysis tube, where larger volume can enter the paramylon solution dialysis tube compared to the paramylon gel dialysis tube.

TABLE 35
pH and volume variation of CaCl₂ paramylon gels after dialysis.

| | pH | | | | Volume (mL) | | Sodium | | Calcium | |
|---|---|---|---|---|---|---|---|---|---|---|
| Sample | pHi | 10 min | 24 hr | pHf | Vi | Vf | BD | AD | BD | AD |
| 1% | 13.302 | 9.516 | 10.385 | 12.326 | 5 | 4.5 | 20000 | 720 | 300 | 300 |
| 3% | 13.232 | 9.155 | 10.937 | 12.079 | 5 | 5.1 | 19000 | 650 | 300 | 260 |
| 5% | 13.180 | 7.135 | 10.525 | 11.926 | 5 | 5.5 | 19000 | 760 | 290 | 240 |

pHi is the initial pH in paramylon phase;
pHf is the final pH in paramylon phase;
10 min, 24 hr and 48 hr mean the pH in water phase at the stated times from the beginning of dialysis. pHi is the initial pH, pHf the final pH. Volume is the paramylon solution volume;
Vi is the initial volume of paramylon solution;
Vf is the final volume of paramylon solution;
BD: before dialysis (mg/L);
AD: after dialysis (mg/L)

Volume change: The volume of the paramylon gel in dialysis tube decreased in lower concentrations (1% (w/v) paramylon), but increased in higher concentration (3% and 5% (w/v) paramylon). To give a clear conclusion, more samples with varied concentrations should be tested.

Sodium and Calcium ion content: Sodium ion content of paramylon phase of the paramylon gels was decreased after dialysis. Without wising to be bound by theory, this may be due to pH of the paramylon gels before and after dialysis was not equilibrated yet, such that water had not fully penetrated the gels in the dialysis tubes. Without wishing to be bound by theory, the sodium content can be diluted by the ratio of paramylon gel volume and the water volume, meaning in a ratio with a small amount of paramylon gel to a large amount of water used for dialysis to give enough dialysis (volume) time to allow pH in both gel phase and water phase to reach to an equilibration, thereby raising the pH of the paramylon gel and lowering the sodium ion amount in the gel. In addition, since there was a decrease in the sodium ions in the paramylon gels, a liquid paramylon solution may have a larger amount of sodium ions removed from the solution than the gels as there is an increased diffusion of the water and salt ions between two liquids, as compared to the case where the diffusion is between a gel and a liquid.

The results show that calcium ion content in the paramylon phase remains relatively stable following dialysis. Without wishing to be bound by theory, any slight decrease of calcium contents may be due to changes of paramylon solution volume during dialysis. Further, the lack of calcium ions diffusing from the paramylon phase to the water phase indicates strong bonding of calcium ions with paramylon gel.

### Dialysis of Acidic Paramylon Gels Prepared Using Calcium Chloride

2% acidic paramylon gels were prepared and dialyzed using the methods described above.

pH: pH value and volume variations are shown in Table 36. As seen, the pH in water phase was decreased after 10 min, and pH value was equilibrated in paramylon gel and water phase after 24-hour dialysis.

TABLE 36
pH and volume variation of acidic paramylon gel after washing.

| | pH | | | | | Volume (mL) | |
|---|---|---|---|---|---|---|---|
| Sample | pHi | 10 min | 24 hr | 48 hr | pHf | Vi | Vf |
| 2%(gel) | 3 | 6.23 | 5.98 | 5.81 | 5.98 | 5 mL | 5 mL |

pHi is the initial pH in paramylon phase; pHf is the final pH in paramylon phase; 10 min, 24 hr and 48 hr mean the pH in water phase at the stated time from the beginning of dialysis. Volume is the paramylon phase (gel) volume; Vi is the initial volume of paramylon volume; Vf is the final volume of paramylon volume.

Volume change: The volume of the paramylon gel in dialysis tube did not change.

Sodium contents: The effect of dialysis on sodium content was evaluated. The sodium contents before and after dialysis are shown in Table 37. 5 mL acidic 2% (w/v) paramylon gel was dialyzed against 500 mL water. After the equilibration between gel phase and water phase has been reached, the sodium content decreased by 100 times, meaning that the gel and dialysis tube did not hinder the diffusion of sodium.

TABLE 37
Sodium contents in acidic 2% (w/v) paramylon gel

Sodium Content (mg/L)

| Samples | Before Dialysis | After Dialysis |
|---|---|---|
| Acidic 2% (w/v) | 17000 | 170 |
| paramylon gel | | |

### Conclusions

This study tested the dialysis behaviors of paramylon solution in 1 M NaOH, gels prepared using CaCl₂ and HCl with respect to pH, sodium concentration and volume of sample. This study evaluated dialysis as a potential way to achieve desired functionality in food applications for paramylon solution and gels in a cost effective way.

Evidently, dialysis of both paramylon solution and gel has significant effect on their pH value. The pH of paramylon solution can be equilibrated with water phase after 24 hours as the final pH's were similar to the 24 hour pH reading. The change was from ˜13.2 to ˜11.8. Acidic paramylon gel also equilibrated with water phase after 24 hours, pH of the 2% (w/v) gel changes from 3.3 to ˜5.9. However, the CaCl₂ paramylon gels hinder pH equilibration with water phase. After 24 hours of dialysis, the pH of CaCl₂ paramylon gel is ˜12.0 (comparing with 13.2, the initial value), but the pH of water phase is between 10.3 and about 10.9.

The volume of paramylon solution and gel is changed during dialysis because of water exchange between paramylon phase and water phase. Due to the equilibrium between the paramylon and water phase, the direction of water movement is dependent on the concentration differential across the dialysis membrane. Generally, compared with pH variation, the volume variation is not a primary effect factor.

During the dialysis of 5% (w/v) paramylon solution, the colour changed from yellow to white. Without wishing to be bound by theory, this may be due to removal of hydrolyzed by-products from paramylon phase. This shows that dialysis is useful in providing a clearer or whiter paramylon solution.

The sodium content was equilibrated following dialysis and was diluted by 100 times when 5 mL paramylon gel was dialyzed using 500 mL deionized water (see for example, results from acidic paramylon gel as shown in Table 37).

As shown in this study, dialysis is a practical way to remove sodium from paramylon gel.

### Example 14: Additional Studies on Dialysis

Studies are carried out to investigate the effects of dialysis on pH, salt and ions contents, colour change of paramylon gels and solutions. Dialysis procedure is carried out as described in Example 13. Various paramylon solution/gel concentrations are tested, including 0.5%, 1%, 1.5%, 2%, 3%, 4%, 5%, 6%, 7%, 8%, 9% and about 10%. Paramylon contents in paramylon solution/gels before and after dialysis are measured. Properties of paramylon gels, including density, absorption, viscosity and phase situation are tested. These tests are carried out to confirm that the gel does not change in terms physical properties during dialysis. Parameters of the gel before dialysis are compared to the parameters after dialysis. For density of a gel, it can be determined by measuring the weight of a specific volume of a gel (g/mL). A gel with a higher concentration can yield a higher gel strength, for example a 5% gel compared to a 1% gel. The gel strength is determined by texture analyzer to give the tensile strength in g/cm². Tensile strength would be in the range of 1-3000 g/cm². Absorption analysis provides information on the colour of gels, which is measured by UV spectrophotometer between 300-600 nm. Every compound has an extinction coefficient which correlates its absorption to its concentration according to the beer lambert law: A=εbc where A is absorbance, ε is the extinction coefficient and b is the path length and c is the concentration. Viscosity is measured by rheometer, and the higher the number the more viscous the solution is. The viscosity is in the range 1-2000 mPa·s. Phase separation of the gel is determined visually. A phase separation occurs when liquid goes to upper part of solution while lower part is a gel or vice versa. Paramylon gel is phase separated during any treatment.

### Example 15: Desalting Paramylon Gel Through Water Washing

### Introduction

This study evaluated if the saltiness of the pH-treated gel could be reduced by water-washing treatment.

### Materials and Methods

Water-washing was carried as follows: 1) A 2% (w/v) paramylon solution in 1 M NaOH was made (pH=13.2). 2) pH was brought down to neutral using 4 M HCl, and a gel was obtained. 3) The gel was centrifuged at 3,000 rpm for 5 min. The result of the centrifugation was a pellet (a denser gel than the initial gel) and a clear supernatant in each centrifuge tubes. 4) The supernatants in each tube were decanted and deionized water in the exact same amount of decanted water (was added to the pellets in each tube. This is done to minimize changing the initial concentration of paramylon. 5) Using a spatula, the pelleted gel in each tube was broken down, mixed with the added water, and the tubes were vortexed vigorously for 1 min. 6) The tubes were centrifuged again at 3000 rpm for 5 min and the steps 3-6 was repeated for 2 more times. 7) The gel after the above washes was tested against a control gel before the washes.

### Results

The consecutive washing of beta-glucan gel was able to noticeably reduce the sodium content, lowering it from 13500 mg/100 g (dry weight) to 2400 mg/100 g (dry weight), or approximately 82% reduction.

### Discussion and Conclusion

The sodium that was generated in the preparation of beta-glucan pH-treated gels was soluble in the water portion of the gel. Upon centrifugation of the gel, the water portion of the gel separated and formed a clear supernatant. Each round of washing reduces the salt content. Theoretically, enough consecutive rounds of washing can be undertaken to completely remove all sodium present in the supernatant.

### Example 16: Additional Studies on Desalting Paramylon Gel Through Water Washing

Studies are carried out to quantify the amount of salt that is removed and to determine an acceptable salt level. The amounts of ions present in the gel prior to washing, in each wash, and in the final gel product, are measured. The sodium ions are measured by a by ICP-MS as described in Example 13 As the number of washes increases, the amount of sodium ions remaining is lowered.

Studies are carried out to investigate the ability of dialysis to remove residual sodium in the gel and dried powders. Residual sodium may be undesirable in food. Studies are carried out to investigate the effects of dialysis against calcium chloride solutions. When calcium is added in bursts it can form droplets of gel, similar to alginate. When solubilized paramylon is dialyzed against calcium chloride, the addition of calcium ions to the paramylon solution would be slower. This slower addition generates a gel within the dialysis tubing, and that this gel has a higher tensile strength when measured by a texture analyzer. Furthermore, other methods of addition of the calcium are investigated, such as other calcium salts, or at different rates (i.e. dropwise vs. burst) to determine the effect on gel mechanical properties including tensile strength and compressibility, as well as optical properties including opacity and refractive index.

Use of a viscometer, texture analyzer or rheometer is as described in the above for viscometer, at least Examples 2, 10, 14, and 18 for texture analyzer and rheometer in Example 14. Higher concentration of paramylon yields higher viscosity measurement. Putting quantitative values on tensile strength, viscosity, deformability, springiness as described above examples. Paramylon gel near 1% (w/v) has tensile gels strengths of approximately 1000 g/cm², whereas 5% paramylon gels approach or exceed tensile strengths of 3000 g/cm².

### Example 17: Water Holding Capacity

### Introduction

This study evaluated water holding capacity (WHC) of paramylon isolated from Euglena. This study shows that the insoluble paramylon has water holding capacity which is useful in different food applications, i.e. meat, protein substitute, or bakery application.

The WHC of foods can be defined as the ability to hold their own and added water during the application of forces, pressing, centrifugation, or heating. Other definitions describe WHC as a physical property, the ability of a food structure to prevent water from being released from the three-dimensional structure of the protein gel.

### Materials and Methods

WHC quantification was carried out as follows. 1) 0.6 gram of paramylon isolate, and 0.6 grams of elongated paramylon powder that was freeze dried, pH-treated (pH 3) paramylon gel (spray dried powder), CaCl₂-treated paramylon gel (freeze dried powder), glass beads (as a negative control with no WHC), desiccant, and pectin (as positive control with high WHC) were weighted in small centrifuge tubes. 2) 4 mL distilled water was added to each tube. 3) The tubes were vortexed for 1 min. 4) The tubes were incubated at room temperature for 2 hours. 5) The tubes were centrifuged at 3,000 rpm for 30 min. 6) The supernatants were removed using transfer pipets. 7) The tubes with precipitates were placed in the oven at 50° C. for 25 min to evaporate the residual free water at the surfaces of the precipitate. 8) The tubes were weighted. 9) The WHC was calculated as gram of water held by gram of sample (the experiment was replicated 2 times and the numbers were averaged). 10) To take into account for any errors, the WHC obtained in step 9 for each ingredient was subtracted from the WHC obtained for negative control (glass beads, Sigma-Aldrich, 0.5 mm Z250465-1PAK) and the corrected WHC values (i.e. g water held by g sample against the negative control (glass beads)) were summarized in the Table 38.

The percentage water loss of 144 hours is calculated as follows:

% water loss at time X=100*(1−[Mass remaining after 144 hours (g)−mass of initial sample (g)]/Mass water (and any additives i.e. HCl) in sample (g))

### Results

Table 38 summarizes the average WHC values (2 replicates). Table 39 demonstrates water loss of wet paramylon granules and their derivatives.

TABLE 38
Water holding capacity (WHC) of different paramylon forms,
as well as the positive controls of desiccant and pectin.

| | Corrected WHC values (g water held by g sample) |
|---|---|
| | against the negative control (glass beads) |
| Paramylon Isolate | 0.74 |
| pH-treated Gel | 0.79 |
| (dried powder) | |
| Desiccant | 1.37 |
| (positive control) | |
| Pectin (positive | 6.06 |
| control) | |

Elongated form and CaCl₂-treated paramylon gel (dried powder) was tested for WHC, but as they fully or partially solubilize upon addition of water, at the stage of decanting some of the total solid is lost, which affects the weights and poses an error of underestimation of the results.

TABLE 39
Measurements of water retention of paramylon granules and its derivative states in
their wet forms in an oven at 50° C. to 144 hours. PM is short form for paramylon.

| | | | | | | | 1% PM |
|---|---|---|---|---|---|---|---|
| | | | | | | | in 1M |
| | | | | | | 1% PM in | NaOH + |
| | | 1% PM | 1% PM | 1% PM | 1% PM | 1M NaOH + | 0.5 mL |
| | 1% PM | in 0.25M | in 0.33M | in 0.5M | in 1M | 2.5 mL | 5% CaCl₂ |
| | in water | NaOH | NaOH | NaOH | NaOH | 4M HCl | (calcium |
| | (granule) | (swollen) | (elongated) | (shells) | (solubilized) | (acid gel) | gel) |
| Water in | 9.975 | 9.986 | 10.041 | 10.113 | 10.324 | 10.298 + | 10.313 + |
| sample | | | | | | (2.753 g | 0.517 g |
| added (g) | | | | | | 4M HCl) | 5% CaCl₂ |
| Mass PM | 0.108 | 0.109 | 0.110 | 0.106 | 0.106 | 0.111 | 0.105 |
| initial (g) | | | | | | | |
| Mass | 0.100 | 0.366 | 0.403 | 0.697 | 1.121 | 0.897 | 0.885 |
| remaining | | | | | | | |
| after 144 | | | | | | | |
| hours (g) | | | | | | | |
| % water | >100% | 97.4% | 97.1% | 94.1% | 90.2% | 94.0% | 92.7% |
| loss over | | | | | | | |
| 144 hours | | | | | | | |

### Discussion and Conclusion

As shown in Table 38, paramylon isolate (insoluble) and the dried matter of pH-treated paramylon gel have good water holding capacity. The pH treatment did not affect the WHC of the paramylon. In comparison, pectin (positive control) immediately absorbs all the water and thereby forming a gel, as expected.

An attempt was made to determine whether the wet forms of the paramylon granules and modified forms (i.e. swollen, elongated, shell and solubilized) had an effect on water loss or retention over time. However, the results of this experiment are inconclusive. In the samples dissolved in base some of the remaining mass at the end could also have been due to dried sodium hydroxide, artificially lowering the % water loss at 144 hours. The swollen, elongated, shells, solubilized, and gel forms showed slightly lower water loss over 144 hours than the paramylon granules, with the solubilized paramylon showing the least amount of water loss.

### Example 18: Additional Studies on Water Holding Capacities

Studies are carried out to determine binding capacity of paramylon. The common insoluble fiber oat fiber, is used in industry as a water binder, and is used for comparison of water binding capability. Out of three intermediate paramylon forms (swollen, elongated, shells) the elongated and shell forms have higher water holding/binding capacity. Without wishing to be bound by theory, this may be due to the beta-glucan chains being more exposed to the water molecules than the swollen and granule form. By being more accessible to the water, there is an increase the probability of water being able to bind to the beta-glucan molecules. Exposing more surface area of the beta-glucan chains, and the corresponding alcohol functional groups provides more area for water to adhere to by hydrogen bonding interactions. In addition, as a food application, for example in bakery, incorporation of paramylon may increase the time required for the bread to dry out and go stale, this would lead to the bread remaining moister or chewier for longer. Chewiness can be approximated by performing a complete texture profile analysis using a texture analyzer directly on the final food product. As well, the paramylon maintains the moisture, chewiness, and mouthfeel of meat analogues. The elongated and shell forms have the highest chewiness and moisture holding ability. The elongated and shell forms are useful in preventing ice crystal formation, which is undesirable as it leads to freezer burn, or an unsmooth ice cream texture. The smoothness is evaluated using a triangle test such as UNI ISO 4120 and an ice cream prepared with 1% inclusion of the paramylon in its modified forms has statistically significant increase in reported smoothness from a panel when compared to an ice cream lacking paramylon.

This experiment is carried out on the spray dried and wet forms of the intermediate granule forms (swollen, elongated, shells). The water holding capacity results are measured as describe above in Example 17. The positive control is the pectin as it has strong water holding capacity, while the glass beads are used as the negative control and the correction factor. The same experimental conditions are used for the spray dried and wet paramylon forms (swollen, elongated, and shells). For the wet paramylon conditions, the dried paramylon experimental conditions are followed, with the wet paramylon sample substituting in for the dried paramylon sample.

### Example 19: Water Holding Capacity Experiment to Prevent Syneresis

### Introduction

WHC are of key importance in many food manufacturing processes. WHC plays a major role in the formation and maintaining the desirable food texture for a wide range of food products, including comminuted meat products, meat analogues, baked doughs, protein substitute products, and dairy products. WHC is a determining factor in the shelf life of food products in terms of physical stability such as resistance to syneresis.

Gels are created from a three-dimensional network of large molecules which are cross-linked with each other to such an extent that they trap water and hold it in place. Syneresis which is the liquid oozing out from a gel structure over time has been always a serious issue in a large number of gel-based food products foods such as jams, jellies, sauces, yogurts and pie fillings as well as meat products, protein substitute products, and soybean products.

### Materials and Methods

Euglena paramylon granules can decrease and delay the syneresis that happens in the gel-type products due to its shown WHC. Prototypes of yogurts with different protein sources are formulated with the inclusion of 0 (control), 1, 2, 3, and 4% isolated Euglena paramylon granules (Table 40). As positive control, non-dairy yogurt prototypes with 0.7% pectin or 1% gelatin as the water holding agent instead of the paramylon granules (Table 41) are prepared. For all the above formulations, plant-based milks (soy, coconut, and almond milk) with protein content of 3% are inoculated with 6-10% non-dairy yogurt that contains live microorganism for the fermentation (starter culture). The live microorganism is either Lactobacillus bulgaricus or Streptococcus thermophilus. The prototypes are stored at optimum temperature for the starter culture microorganisms (37-45° C.) for 10 hours. Then the prototypes are stored in the fridge (4° C.) for about 4 hours. From then, the percentage of syneresis is determined at time intervals of initial (after the 4 hours in fridge), 1 day, 3 days, 7 days, 15 days, and 30 days.

Percentage of syneresis is calculated as follows: The initial weight of the sample in grams is measured after the 4 hours in the fridge. At each time interval (1 day, 3 days, 7 days, 15 days, 30 days) the weight of the water that has separated from the gel sample is measured.

Percentage of syneresis=(weight (g) of the separated water from the gel at time point X/the weight (g) of the initial gel sample taken at removal of the fridge)×100%

Where the initial gel weight of the sample is measured after removal from the fridge and the weight of the water that is separated from the gel at the individual time points. The higher the number for percentage of syneresis, the more syneresis or water separation from the gel. A higher syneresis indicates a lower water holding capacity. A low number indicates a high water holding capacity. The percentages of syneresis are compared to the control prototypes (both negative and positive) at the same time points. The higher the amount of beta-glucan included, the lower the percentage of syneresis. A lower syneresis indicates a higher water holding capacity as less water is leaving the gel.

TABLE 40
The yogurt prototypes with Euglena B-Glucan Isolate
(BGI) as the gel water holding capacity agent.

| Yogurt | Euglena Beta-glucan | | | | |
|---|---|---|---|---|---|
| Prototypes | Isolate (%) | | | | |
| 3% Soy protein | 0 | 1 | 2 | 3 | 4 |
| 3% Coconut protein | 0 | 1 | 2 | 3 | 4 |
| 3% Almond | 0 | 1 | 2 | 3 | 4 |
| protein | | | | | |

TABLE 41
Formulation for positive control yogurt prototype with pectin
or gelatin as the gel water holding capacity agent.

| Positive Control Yogurt | Pectin | Positive Control Yogurt | Gelatin |
|---|---|---|---|
| prototype with Pectin | (%) | prototype with Agar | (%) |
| 3% Soy protein | 0.7 | 3% Soy protein | 1 |
| 3% Coconut protein | 0.7 | 3% Coconut protein | 1 |
| 3% Almond protein | 0.7 | 3% Almond protein | 1 |

### Example 20: Paramylon as an Emulsifier

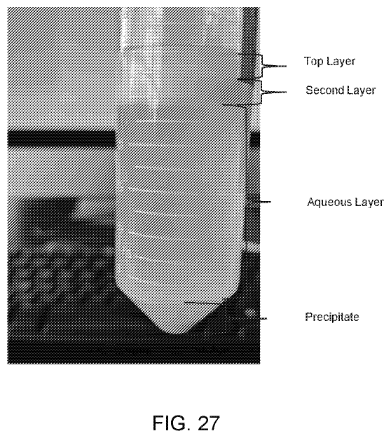

This study investigated the ability of paramylon and its derivative to act as an emulsifier in oil in water emulsion systems. To directly test this effect emulsification activity of paramylon and its derivatives was tested. However, challenges were identified with this method. After the emulsions were formed by use of a stand homogenizer, separation was either allowed to happen naturally, or induced by centrifugation. In both instances the same challenge arose of how to classify each layer of the system. The original method relies on a simple two phase mixture being observed, not the complicated multiphase mixture that is observed when paramylon is used. For example, when the granular form was used at least four distinct layers were observed. Furthermore, as shown in FIG. 27, a buoyant layer of beta-glucan granules is observed, which normally in either purely aqueous or pure oil system would all sediment, indicating at least adsorption of oil to the granule surface in the emulsion generating buoyancy.

Surprisingly, the pH 3 acid-gelled paramylon produced 2 obvious layers, one being an apparent cream, or gel, and the other appearing to be clear water. In addition, the gel layer took on a bright white colour consistent of an oil in water emulsion, as opposed to the cloudy/semi-transparent colour of a normal acid-gel. This particular sample also showed no further phase separation over the course of more than a week, indicating the gel phase was able to form a type of stable emulsion.

### Example 21A: Emulsification Effects of Paramylon as a Creamer

### Introduction

This creamer study was carried out to show three different principles of paramylon as a functional food ingredient: a whitening agent to improve the colour of the creamer, an emulsifying agent to allow oil to be dispersed in the creamer, and a thickening agent to allow the viscosity of the creamer to mimic dairy-based creamers.

This study was carried out to determine the Emulsifying Activity (EA) of paramylon isolate (made from freeze dried powder), a pH-treated paramylon gel (pH 3; made from spray dried powder), 5% CaCl₂-treated paramylon gel (made from freeze dried powder) and elongated paramylon powder (made from freeze dried powder).

### Materials and Methods

Emulsion Activity (EA) of the ingredients mentioned above is determined as follows: 1) Oil in water emulsions comprising canola oil were made (see the formulations in Table 42 using an OMNI GLH-01 stand homogenizer at 13,500 rpm for 5 min. Positive control is 1% lecithin and no paramylon, and negative control is no lecithin and no paramylon; 2) Aliquots of emulsions were centrifuged in 15 mL graduated centrifuge tubes at 1,200 g for 5 min; and 3) The volume of the emulsified layer left after centrifugation was measured with a ruler. The emulsion layer shows a cream coloured layer below the top oil layer and above the water layer. The EA was calculated by dividing the volume of the emulsified layer to the total volume.

TABLE 42
Emulsion formulations for positive control, negative control
and emulsification tests E1-E8 using different forms of paramylon
i.e. paramylon isolate, pH treated paramylon, CaCl₂
treated paramylon and elongated paramylon.
Emulsification Experiment

| | Positive | Negative | | | | | | | | |
|---|---|---|---|---|---|---|---|---|---|---|
| | Control | Control | E1 | E2 | E3 | E4 | E5 | E6 | E7 | E8 |
| | % | | | | | | | | | |
| Water | 89 | 90 | 89 | 85 | 89 | 85 | 89 | 85 | 89 | 85 |
| Oil | 10 | 10 | 10 | 10 | 10 | 10 | 10 | 10 | 10 | 10 |
| Lecithin | 1 | 0 | 0 | 0 | 0 | 0 | 0 | 0 | 0 | 0 |
| Paramylon | 0 | 0 | 1 | 5 | 0 | 0 | 0 | 0 | 0 | 0 |
| Isolate | | | | | | | | | | |
| pH-treated | 0 | 0 | 0 | 0 | 1 | 5 | 0 | 0 | 0 | 0 |
| paramylon | | | | | | | | | | |
| CaCl₂- | 0 | 0 | 0 | 0 | 0 | 0 | 1 | 5 | 0 | 0 |
| treated | | | | | | | | | | |
| paramylon | | | | | | | | | | |
| Elongated | 0 | 0 | 0 | 0 | 0 | 0 | 0 | 0 | 1 | 5 |
| paramylon | | | | | | | | | | |
| Total | 100 | 100 | 100 | 100 | 100 | 100 | 100 | 100 | 100 | 100 |

### Results

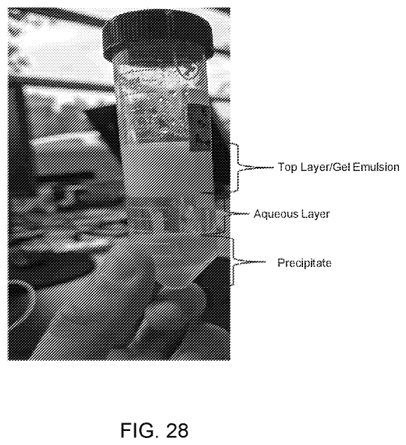

Visual observations showed that paramylon samples had an effect on the oil-water interface (FIG. 27 and FIG. 28). FIG. 27 shows emulsification activity assay with untreated paramylon granules. The second layer has a white, gritty appearance, appearing to indicate that the paramylon granules have collected in this second layer in the emulsion system, where most of the granules have appeared to collect in this emulsion system. FIG. 28 shows results of emulsification activity using an acid-gel of paramylon. The aqueous phase is transparent, and the gel emulsion phase, i.e. the mixture oil and gel, shows white colour.

Water resuspension of the freeze-dried powder of CaCl₂-treated paramylon gel and freeze-dried powder of elongated paramylon show that most of the powder would clump into big chunks upon addition of the water, even with immediate vigorous vortexing. The resuspended material was also heated in the water bath to 60° C. and also left in the room temperature overnight in attempt for the clumps to open up and hydrate, but none of those procedures helped. Therefore, estimate on how much of the powder plays a role as the emulsifier could not be determined. Also, when those resuspensions were heated, their colour turned to a dark colour. This has been seen before with high pH paramylon suspensions as there is alkaline peeling and production of by products that introduce colour to the solution.

TABLE 43
Summary of the emulsifying activity
of the above-mentioned ingredient.

| | Emulsifying Activity |
|---|---|
| Positive control 1% lecithin | 0.83 |
| 1% Paramylon Isolate | 0 |
| 5% Paramylon Isolate | 0 |
| 1% pH-treated paramylon | 0 |
| 5% pH-treated paramylon | 0 |
| CaCl₂ treated paramylon | — |
| Elongated paramylon | — |

### Discussion and Conclusion

Under the tested conditions, the paramylon isolate (both at 1 and 5% (w/v) level) and the dried matter of pH-treated paramylon gel (both at 1 and 5% (w/v) level) showed no measurable emulsifying activity as a creamer

### Example 21B: Emulsification Effects of Spray Dried Paramylon

Studies are undertaken to determine the effects of spray drying of different paramylon forms (i.e. granules, swollen, elongated, and shell form) on emulsification ability of paramylon. As the different forms have different structures, their emulsification activities differ. For example, the swollen, elongated and shell forms have more beta-glucan strands exposed than the granular form, with elongated and shells having a higher exposure than the swollen form. Negative and positive are the same as in the Example 21A.

### Example 22: Additional Studies on Emulsification of Paramylon—Creamer

Studies are carried out to quantify the strength of paramylon and its derivatives as an emulsifier and stabilizer. Stabilizer properties are measured using shelf life studies. This varies from formulation to formulation. For example, in the creamer, by measuring how long it takes to visibly see a separate oil phase to be observed. The samples are stored in sealed containers at 4° C. This may be conducted by accelerated methods, such as heating or centrifugation. The Emulsion activity (EA) is determined as described in Example 21A.

In addition, to measure the stability of the emulsion, the emulsion activity is measured over a set period of time and compared. The smaller the change between the initial emulsion activity to the stability time point, the more stable the mixture is. Emulsion activity is measured at time 0 minutes, 5, 10, 20, 30, 40, 60 minutes and overnight. Longer stability can be determined at 1 day, 2 days, 3 days, 5 days and 1 week after emulsification. The samples are compared to a creamer mixture that does not have paramylon present but does have a known stabilizer, such as lecithin (positive control in Table 44). The oil is evenly distributed across the layers, and co-distribute with the paramylon, this results in a higher calculated emulsifying activity for samples containing paramylon,

### Example 23: Ice Cream Matrix or Anti-Freezer

Paramylon granules when added to an ice cream matrix can disrupt the ice crystal formation of the water by exclusion and water holding capacity. This prevents ice formation in the ice cream which is associated with a gritty, undesirable texture. In an ice cream matrix, at the time of preparation, the average ice crystal size can be measured microscopically by a light microscope (EVOS by life technologies) and then over time, such as keeping it in the −20° C. freezer for 1 day, 3 days, 5 days, 7 days 14 days, 21 days, 28 days, 3 months and 6 months to determine the size of the ice crystal over time. Ice crystal size in ice cream ranges from 1 micron to 150 microns, with average tending to be 25 microns. Microns smaller than 50 microns are desirable because these are reported as maintaining a smooth texture, whereas if significant amounts of crystals larger than 50 microns are present the texture is gritty.

### Example 24: Additional Studies on Paramylon Emulsification Activity

Studies are carried out to determine emulsification activity of paramylon. A dispersible dried matter of CaCl₂)-treated paramylon gel and elongated paramylon are created. In Example 6, it is shown that spray dried elongated form of paramylon is able to keep its shape, therefore when the spray dried form of the elongated form is used, calcium chloride gel and pH treated gel would disperse better in the liquid. Since elongated paramylon form disperses in liquid, this form possesses emulsification activity and is available in solution to form an emulsion.

A more sensitive quantification of the emulsifying activity of paramylon is also used. Tensiometry is used to determine the surface activity of surfactants/emulsifiers and in turn their emulsifying activity. The oil/water interfacial tension is determined as follows.

Without wishing to be bound by theory, using drop shape tensiometer, a syringe needle containing oil is immersed in a glass cuvette containing 5 mL of a solution with known concentration of the ingredients including, granular paramylon, swollen paramylon, elongated paramylon and the shell form of paramylon, which are being measured for emulsifying activity. An oil droplet is formed at the tip of the needle and while the droplet's volume is consistently controlled using a volume control regulation program, the shape of the droplet is recorded by a Charge-Coupled Device (CCD) camera connected to a computer. Interfacial tension is automatically determined by analyzing the recorded oil drop's shape profile according to the Yong-Laplace equation. A water solution of a known emulsifier is used as a positive control and “water with no emulsifier” is used as negative control. Different concentrations of paramylon at different forms are tested and their surface tension are compared to the surface tension between positive and negative control. The lower the surface tension generated by an ingredient/emulsifier, the higher its emulsifying activity. Without wishing to be bound by theory, the presence of paramylon reduces the surface tension of the oil/water interface. This is useful for forming an emulsion, since the high surface tension of an oil water interface in the absence of an emulsifier causes oil droplets to coalesce and separate into discrete phases, to minimize the energy of the system.

### Example 25: Thickening Effects of Paramylon as a Non-Dairy Creamer

### Introduction

This study determined the thickening effect of pH treated paramylon gel (dried powder) and CaCl₂) treated paramylon gel (dried powder) emulsified to add thickness to a non-dairy creamer. In this example thickening effect was measured in a non-dairy creamer experiment.

### Materials and Methods

Thickening effects of paramylon were determined as follows. 1) Oil in water emulsions using canola oil were made (see the formulations in Table 44) using an OMNI GLH-01 stand homogenizer at 13,500 rpm for 5 min. Positive control was 1% Gum (mixture of Gum Acacia and Gellan Gum-Ticaloid Pro 181 AG) and negative control is no Gum; 2) Gum was dissolved in the water portions of their formulations and left in the water bath of 60-70° C. for an hour to hydrate; 3) A 2% pH-treated paramylon gel that was prepared by solubilizing paramylon in 1 M NaOH solution and bringing the pH down to neutral pH using 4 M HCl. This gel in its wet form was used in the T5 sample in an amount in which the total concentration of paramylon in T5 was 1% (w/v).

TABLE 44
Thickening formulations for positive control, negative control and
thickening tests T1-T5 using different forms of Paramylon i.e. paramylon
isolate, pH treated paramylon, CaCl₂ treated paramylon, elongated
paramylon and the wet gel form of pH treated paramylon gel.

| | Positive | Negative | | | | | |
|---|---|---|---|---|---|---|---|
| | Control | Control | T1 | T2 | T3 | T4 | |
| % | | | | | | | T5 |
| Water | 88 | 89 | 88 | 84 | 88 | 84 | 88 |
| Oil (canola oil) | 10 | 10 | 10 | 10 | 10 | 10 | 10 |
| Lecithin | 1 | 1 | 1 | 1 | 1 | 1 | 1 |
| Gum | 1 | 0 | 0 | 0 | 0 | 0 | 0 |
| pH treated | 0 | 0 | 1 | 5 | 0 | 0 | 0 |
| paramylon | | | | | | | |
| (dried powder) | | | | | | | |
| CaCl2 treated | 0 | 0 | 0 | 0 | 1 | 5 | 0 |
| paramylon | | | | | | | |
| (dried powder) | | | | | | | |
| pH treated | 0 | 0 | 0 | 0 | 0 | 0 | 1 |
| paramylon | | | | | | | |
| (wet gel form) | | | | | | | |
| Total | 100 | 100 | 100 | 100 | 100 | 100 | 100 |

It is noted that in the CaCl₂-treated paramylon gel (dried powder), upon addition of water, most of the powder clumped up to big chunks, although it was well shaken immediately after water addition and vortexed vigorously for 20 min. The suspension was added to the oil phase and left out over night for rehydration, and then emulsions were observed.

Observation by eye was used to estimate the thickness of the emulsions. The thickness of the emulsions was measured by utilizing the volume gradation on the sides of the tubes which the emulsions are prepared in.

### Results

Results of this study are summarized as follows.

1. The positive control with 1% Gum was noticeably thicker than the negative control.

2. No significant differences between the viscosity of negative control (no gum) and the emulsions containing 1 and 5% pH-treated paramylon gel (spray dried powder) was observed.

3. Replacement of 1% Gum with 1% of “paramylon in the wet gel form” imparts a comparable thickness to the emulsion (T5) as the control.

4. A prototype with both 1% Gum and 1% of “paramylon in the wet gel form” was also made. A thicker consistency of the sample with both 1% Gum and 1% of “paramylon in the wet gel form” was observed comparing to prototypes only with 1% gum or 1% “paramylon in the wet gel form”.

5. The emulsion containing 5% of CaCl₂-treated paramylon gel (dried powder) showed noticeable thickness, comparable to the consistency/thickness of the emulsion containing 1% Gum (positive control). However, after overnight sitting of all samples, an extensive phase separation was observed in the emulsions containing 1 and 5% CaCl₂-treated paramylon gel (spray dried powder) while the emulsion with the gum showed no phase separation. The negative control (emulsion with no gum) and the emulsions with 1 and 5% (w/v) pH treated paramylon gel (dried powder) showed some comparable phase separation.

### Discussion and Conclusions

The results showed thickening properties of the paramylon pH-treated gel indicating replacing gum with it in a one-to-one ratio. Also, a thickening effect of paramylon gel on the gum was observed which shows paramylon gel has the ability to be combined with other thickening/gelling agents strengthening the functional properties of the mixture.

The freeze-dried powder of the pH-treated gel of paramylon did not show thickening effect in the emulsion application.

Without wishing to be bound by theory, it is probable that upon water removal in drying process, due to the high linearity of paramylon chains, it is easy for some chains to interact back together through hydrogen bonds. The dried pH-treated gel of paramylon when resuspended is partly soluble in water which shows that the tight crystalline structure (granule shape) before pH treatment has not returned. Without wishing to be bound by theory, however, probably the interactions of some of the chains back together take away from the interactions of paramylon chains with water that had created the thickening effect of pH-treated paramylon before drying.

As for the freeze-dried powder of the CaCl₂-treated gel, some thickening effect at higher concentration was observed which are important in terms of the mouthfeel, or texture of the creamer.

The extensive phase separation started by the inclusion of the dried powder of the CaCl₂-treated gel is an issue and shows that this powder did not hold the emulsification over time, as compared to traditional gums which provides stability over time more readily.

Another issue with CaCl₂)-treated gel was the darker colour of the emulsions including due to the discolouration of their water suspension upon heating. This was due to the high pH used for solubilization of the paramylon granules. In order to prevent this from happening, a different solubilization technique is used (see Example 26 using high heat by microwave induction).

### Example 26: Additional Studies on Paramylon as a Thickener

Studies are carried out to determine viscosity of the emulsions or beverage applications using a viscometer that detects subtle changes in the viscosity. The viscosity of the creamer with the wet form of the paramylon gel, either calcium or pH adjusted from either the base or heat solubilization has a higher viscosity than the dried gel form or any powdered form of paramylon.

The strength of paramylon and its derivatives as an emulsifier and stabilizer is determined. Emulsification studies are carried out in the presence of a lipid dye. When the oils in the sample are dyed it becomes apparent what the composition of each layer is after centrifugation of the simulated emulsion systems. Knowing the composition of each layer provides a better understanding of how much emulsion is formed and stable, and whether it is a water-in-oil or an oil-in-water emulsion. Alternatively, techniques such as tensiometry are used to objectively and reproducibly quantify paramylon's ability to act as an emulsifier or stabilizer. Emulsification activity over time is a measure on stability of emulsification. The emulsification activity is measured as described in Example 21A at set time intervals after emulsification. The initial value measured after centrifugation is the starting emulsion activity value. Measurements are taken 1 hour, 24 hours, 48 hours 5 days, 7 days 14 days and 21 days after emulsification and the activity values are compared to the initial value. The smaller the deviation from the initial value, the more stable the emulsion was over time.

As described in this disclosure, studies on isolation of various states of paramylon granules at intermediate degrees of solubilization show their varying degrees of ability to act as emulsifiers. Without wishing to be bound by theory, the different paramylon structural forms of paramylon changes the structure of the microfibrils and the orientation of individual beta-glucan molecules within them, which are changing in the differing treatments with base. These modified forms have more or less accessible hydrophobic vs. hydrophilic surface characteristics which ultimately impact their ability to act as emulsifiers.

Studies are carried out using microwave to provide heat above 170° C. to solubilize the paramylon. When the treatment is done in water, then the pH of the solubilized paramylon is around neutral and alkaline degradation is hindered. The discolouration of the paramylon does not occur when the samples are heated to disrupt the paramylon structure. In order to prevent the clumping, the gels are ground to fine particles, i.e. mortar and pestle, or a fine mill grinder before spray drying, being dried longer helps with the reconstitution in water. As well, after spray drying the powder are grinded again to ensure the smallest particles. The extra grinding makes the particles smaller, and the smaller particles is easier to disperse in the liquid, preventing the clumping. After the emulsion, the thickness are measured by measuring the viscosity by a viscometer. Both the freeze-dried pH gel and the freeze-dried calcium chloride-treated paramylon gel are able to thicken the solution more than the negative control which contained no gum. In addition, the different forms of paramylon, untreated granules, swollen, elongated, shells and solubilized paramylon are tested for emulsification capacity. The elongated form and the shell form have the best emulsification and thickening properties of the different forms as they have more organized structure than the solubilized form, however, these forms do not have the high crystallinity and inaccessible beta-glucan strands that the granules and swollen paramylon forms have.

### Example 27: Paramylon as a Whitening Agent and Replacement for TiO₂

### Introduction

The current leading whitening agent for food grade materials is synthetically produced titanium dioxide (TiO₂) which has several beneficial qualities, such as resistant to heat, pH and light stability. The use of titanium dioxide has a broad range of food applications, which can be divided into four main categories: i) dairy products; ii) bakery and confectionery; iii) sauces and iv) savory products.

A more detailed list of titanium dioxide used as a whitening agent includes: gum, hard candy, chocolate with a hard coating/shell, chocolate without a hard coating/shell, creamers, instant breakfast shakes, coffee flavouring agents, pudding, powdered milk based products, marshmallows, chocolate syrup, low-fat dairy products, mayonnaise, whipped cream, salad dressing, icing, drink crystals, donuts, pop tarts, ice cream, meat casings, sauces. As such, there is a broad market in which titanium dioxide is used as a whitening agent in today's market.

Even though titanium dioxide has unique properties that make it a suitable whitener, one salient drawback is that it adds no nutritional value to the food product. As well, manufacturers are limited by the amount they can add because there are health concerns over titanium dioxide, in particular at the nanoparticle size, which reports suggesting that it is a carcinogen, and a factor leading to type 2 diabetes. France has banned the use of titanium dioxide as a food additive as of the end of 2018. This raises the question on what to use to replace this leading whitening agent.

To date, there is only one natural product on the market as a replacer to titanium dioxide: Avalanche by Sensient Technologies Corporation. Sensient offers the Avalanche suite of products as a natural whitening material that has good heat, pH and light stability, similar to the desirable characteristics from titanium dioxide. Avalanche is comprised of a natural starch and minerals. A comparable whitening agent would share similar functionality of both titanium dioxide and this naturally derived whitening product.

This study was carried out to determine whether paramylon non-modified granules as a suitable replacement to titanium dioxide, and comparable to the naturally derived Avalanche product as a whitening agent. In this regard, paramylon must whiten the product, as well as be heat, pH and light stable. Paramylon granules is a pure white powder that has a high crystallinity at approximately 90%. The non-modified paramylon granules are water insoluble granules that are 1-2 μm in size. Both the high crystallinity and the particle size influence the refractive index, which affects how the molecules act a white light scatter.

In terms of heat stability, several different temperature ranges were tested in this disclosure to illustrate that the paramylon granules remain insoluble in water even after heat treatment. Upper range tested was 121° C. for 20 minutes, which still yielded insoluble paramylon granules. As well, the higher crystallinity offers the paramylon an increase in the refractive index.

In regard to pH stability, paramylon granules remain insoluble (in crystalline form) from pH's 1-11. Due to paramylon high crystallinity and network of hydrogen bonding, in order to solubilize or break allow the network of hydrogen bonds, a strong pH (12+) is needed. This shows that the paramylon also has a large pH range at which it is stable for food applications.

### Buttercream Icing

This part tested if incorporation of paramylon dry powder (0.1%, 1% and 5% (w/w)) has whitening effect in buttercream icing.

### Materials and Methods

Buttercream icing was prepared according to the following procedure. Two commercial whiteners (TiO₂ and Avalanche) was used to compare with products and ingredients shown in Table 45-47. These comparison groups were mixed directly in with the icing. For 0.1%, 1%, and 5% (w/w) paramylon, buttercream icing was made with dried paramylon granules that were extracted from Euglena. A 5% paramylon gel at pH 3 was generated by solubilized in 1M NaOH then decreased the pH 3. The gel was then sprayed dried into a powder to be used in the buttercream. For the negative control no whitener inclusions were added.

TABLE 45
Negative control and titanium dioxide
masses used for the butter cream icing

| | | 0.1% Titanium | 1% Titanium |
|---|---|---|---|
| | Control | Dioxide | Dioxide |
| Ingredients | (g) | (g) | (g) |
| Unsalted Butter cold butter | 62.5 | 62.5 | 62.5 |
| Icing sugar | 156.25 | 156.25 | 156.25 |
| 2% Milk | 10 | 10 | 10 |
| Vanilla Bean paste | 2.5 | 2.5 | 2.5 |
| Titanium Dioxide | N/A | 0.5 | 2.5 |

TABLE 46
Avalanche buttercream icing recipe

| | 0.1% | 1% | 5% |
|---|---|---|---|
| | avalanche | avalanche | avalanche |
| Ingredient | (g) | (g) | (g) |
| Unsalted Butter cold butter | 62.5 | 62.5 | 62.5 |
| Icing sugar | 156.25 | 156.25 | 156.25 |
| 2% Milk | 10 | 10 | 10 |
| Vanilla Bean paste | 2.5 | 2.5 | 2.5 |
| Avalanche | 0.5 | 2.5 | 12.5 |

TABLE 47
Paramylon buttercream icing recipe

| | | | | 5% |
|---|---|---|---|---|
| | | | | Paramylon |
| | 0.1% | 1% | 5% | spray dried |
| | Paramylon | paramylon | Paramylon | gel, pH 3 |
| Ingredients | (g) | (g) | (g) | (g) |
| Unsalted Butter cold | 62.5 | 62.5 | 62.5 | 62.5 |
| butter | | | | |
| Icing sugar | 156.25 | 156.25 | 156.25 | 156.25 |
| 2% Milk | 10 | 10 | 10 | 10 |
| Vanilla Bean paste | 2.5 | 2.5 | 2.5 | 2.5 |
| Paramylon granules | 0.5 | 2.5 | 12.5 | 12.5 |

The whiteness was both analyzed by visual inspection and by computer software. For software analysis, icings were put into 6 deep well plates and scanned under consistent conditions (including light) Xerox 7845 scanner using the colour setting, and degree of whiteness was analyzed from image obtained and whiteness score (% whiteness) was given by software.

In non-plastic mixing bowl, whip butter was made using a Kitchenaid hand mixer on high speed for 4-5 min until butter was uniformly whipped. To the milk, the whitening agent being tested was mixed in. The icing sugar, vanilla paste and milk were mixed together and then added to the whipped butter and mixed for 5 min on high speed, setting 5 of the KitchenAid 5-Speed Ultra Power Hand mixer. The resultant buttercream icing mix is stored in a resealable sandwich bag and labeled.

### Results and Discussion

### Visual Inspection

Effect of 0.1% and 1% paramylon powder has some whiteness effect compared to negative control, however, the effect is not strong and not comparable to titanium dioxide 0.1 or 1% powder. The 5% paramylon powder resulted in significant whiteness and the whiteness is comparable to 5% avalanche product by visual inspection.

### Software Analysis

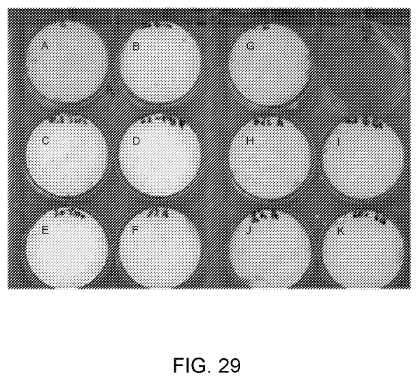

Source images are shown in FIG. 29, and results from software analysis are shown in Table 48. Briefly, a custom program was developed that takes a sample of a scanned image and converts the image to grayscale. The program then counts the number of white pixels within the sample area. After that the whiteness percent value is calculated. The whiteness percentage is the percent of white pixels contained within the sampled area. The sampled area was same for all samples. The skilled person can readily recognize that alternative approaches using ImageJ software by NIH (https://imagej.nih.gov/ij/) which is a known open software for image processing and analysis. In addition, a Hunterlab colorimeter or spectrophotometer (HunterLab) can measure a samples colour or colour differences to give numerical values to samples. Its EasyMatch QC software gives colour data and the spectral data and could be used to measure the whiteness of the samples as the method described herein. If using ImageJ, scanning of 6-well plates is carried out the same way as described herein, and a TIFF (i.e. image file) of a scanned image is opened in ImageJ, and this software can covert the image to grayscale. The selection tool is used to, for example to draw a rectangle encompassing a region of interest for a sample. The skilled person understands that a region of interest (ROI) should just contain the sample to be measured and should be the same size for all the samples. A smaller region of interest can be drawn in order to have multiple readings on the sample in different spots. Average grey pixels in the ROI are measured by the software. The higher the number, the whiter the sample is. Multiple measurement replications can be undertaken, for example, at least 3 of a sample, in order to carry out statistical analysis of the measurement. As well, multiple regions of interest, for example, at least 2, can be used to have an average per replicate.

The results from software analysis are consistent with visual inspection. Use of TiO₂ at 1% has the highest whiteness score, while the control (without whitener) showed the lowest whiteness score. 0.1% of TiO₂ was slightly lower than 1% TiO₂, 86% compared to 88.7%, respectively. The 5% (w/w) paramylon derived from pH 3 gel showed the highest whiteness score at 87.8% after 1% TiO₂. As well, the whiteness of 0.1% and 1% (w/w) paramylon was comparable to the same concentrations of Avalanche. The 5% paramylon granules show slightly lower whiteness compared to the 5% avalanche sample (82.5% compared to 85.2%), however, the difference could not be determined by eye. As well, as the concentration of paramylon and avalanche increases, the whiteness score increases. These results show that paramylon is incorporated into buttercream icing and is useful in increasing the whiteness of the icing. Both qualitatively observed by eye and quantitatively measured by software analysis, the effects of paramylon in whitening the icing was comparable to commercially available alternative to TiO₂, Avalanche.

When the gel form of paramylon was incorporated into the buttercream icing, the whiteness was higher than the comparable percentage in granular form and was almost as white as the 1% TiO₂. Without wishing to be bound by theory, it may be that the gel particles when spray dried ended up whiter than the native granules due to a change in particle size. If the particle size ended up smaller than the initial granules, for instance, they may be closer in size to the wavelengths of visible light, leading to more effective scattering. Furthermore, less uniformity due to a random distribution of sizes may lead to better overall scattering of the different wavelengths of light, compared to the relatively uniform paramylon granules. As shown in Examples 1 and 3, when the acid neutralized gels are formed, they do take on a relatively white and opaque colour even before drying, especially when compared to gels made by addition of calcium chloride, which are much more translucent, indicating that they are scattering less light.

TABLE 48
Computer software analysis on whiteness of the different
samples 0.1%, 1% or 5% of paramylon, avalanche, or TiO2.

| Sample Name | Whiteness % |
|---|---|
| Plate A-0.1%_TiO2 | 86.0 |
| Plate A - 1.0%_TiO2 | 88.7 |
| Plate A - 5%_Avalanche | 85.2 |
| Plate A - 5%_Paramylon | 82.5 |
| Plate A - 5%_pH 3 Paramylon gel | 87.8 |
| Plate A - Control (without whitener) | 74.3 |
| Plate B - 0.1%_Avalanche | 77.9 |
| Plate B - 0.1%_paramylon | 78.6 |
| Plate B - 1%_Avalanche | 78.8 |
| Plate B - 1%_paramylon | 78.7 |
| Plate B - Control (without whitener) | 74.7 |

### Example 28: Paramylon as a Whitening Agent in Buttercream Icing

Studies are carried out to determine the use of paramylon as a whitening agent in buttercream icing. These studies use a lower inclusion rate, including 1.5%, 2%, 3%, and 4% paramylon that has been spray dried compared to freeze dried paramylon. The spray drying changes the particle size of the paramylon granules. The sub particle size and the non-spray dried control particle size is 1-5 um, the aggregates in the spray dried material is 10-100 um and the milled material has particle sizes 1-50 um. Since spray dried paramylon granules are smaller, they have an increased refractory property, allowing the sample to appear whiter with smaller amounts of paramylon. The 2% spray dried paramylon is compared to 2% freeze dried paramylon to determine their differences in whitening effect. As well, a 2% avalanche sample is also generated to determine if the paramylon samples are comparable to this product. As a positive control, 1% titanium dioxide is used, and the negative control is buttercream icing with no whitening agent added. The whitening effects of paramylon are comparable to the Avalanche product. As well, the positive control has high whiteness score while the negative control has the lowest, the 2% paramylon that has been spray dried has a higher whiteness score than the non-spray dried sample.

### Example 29: Whitening Effect of Paramylon in Coffee Creamer

### Introduction

This study determined the whitening effect of paramylon isolate from Euglena in a coffee creamer prototype. As the insoluble paramylon has a whitening effect as shown in Example 27, it is useful as a whitening agent in different food products, for example, icing and non-dairy creamer.

### Materials and Methods

A creamer prototype formulation was developed to investigate the whitening effect of paramylon isolate. The formulations are shown in Table 49.

TABLE 49
Whitening effect in coffee creamer: percentages of components
used to generate sample creamer. Two concentrations of paramylon
were investigated, W1 with 5% paramylon granules and W2 with 10%
paramylon granules. A negative control with no paramylon and a
positive control of dairy half and half (Neilson's) was
used for comparison purposes.
Whitening Experiment

| | Negative | W1 5% | W2 10% |
|---|---|---|---|
| | Control | Paramylon | Paramylon |
| | % (w/v) | | |
| Water | 93 | 88 | 83 |
| Canola Oil | 6 | 6 | 6 |
| Lecithin | 1 | 1 | 1 |
| Paramylon Isolate | 0 | 5 | 10 |
| Total | 100 | 100 | 100 |

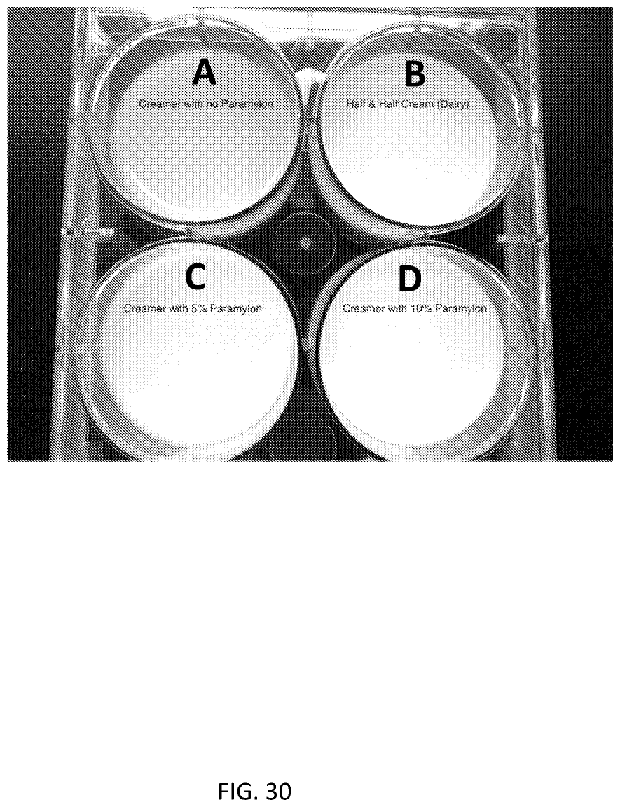

The control has no paramylon, and the W1 and W2 samples have 5% and 10% (w/v) paramylon isolate. Lecithin was added to the oil phase; the mixture was vortexed and then incubated in a water bath at 50° C. for about 30 min for a better solubilization. Paramylon isolate was added to water and the mixtures were vortexed, then the suspension was added to oil phase. The mixture was vortexed for 1 min and then pre-homogenized for 5 min at 13,500 rpm using an OMNI GLH-01 stand homogenizer. A picture comparing Neilson's half & half cream, the presently described creamer prototype with 0, 5, and about 10% (w/v) paramylon isolate were taken by a phone camera (FIG. 30).

### Results

### Visual Observation

FIG. 30 the paramylon creamers compared to the negative control (A) and positive control (B). The creamers that contained the paramylon appear white, and they appear whiter than the negative control. There also seems to be a direct correlation between the amount of paramylon and whiteness of the creamer, the higher the concentration of paramylon, the higher the whiteness percentage was. The whiteness of the creamer with 10% paramylon seems very close to the whiteness of the half and half cream which was the positive control.

### Scanning and Software Analysis of the Whiteness

The results from software analysis were shown in Table 50. The results are consistent with the visual observation as follows. The creamers containing 5 and about 10% (w/v) paramylon showed a higher whiteness % than the creamer with no paramylon. Also, the whiteness % of the creamer containing 10% (w/v) paramylon is higher than the one with 5% (w/v), which confirms a direct correlation between whiteness of the creamer and paramylon inclusion level.

TABLE 50
Computer software analysis of whiteness of the creamers.
Positive control: half & half creamer, Negative
control: No paramylon, W1: Creamer with 5% paramylon
and W2: Creamer with 10% paramylon.

| Sample Name | Whiteness % |
|---|---|
| Half & Half Creamer | 91.6 |
| Negative Control (creamer with no Paramylon) | 67.9 |
| W1 - Creamer with 5% Paramylon | 84.0 |
| W2- Creamer with 10% Paramylon | 87.8 |

### Discussion and Conclusion

These results show that inclusion of paramylon at 5% and 10% (w/v) in creamer formulation has whitening effect and there is a direct correlation between whiteness of the creamer and paramylon inclusion level. Therefore, paramylon isolate is useful as a whitener in non-dairy creamer application where plant-based proteins (such as pea, almond, and coconut) and soy lecithin (dark brown coloured) are common inclusions (as an emulsifier) and produce some yellow or grey colour in the product.

### Example 30A: Paramylon Powder Whiteness Index

Colorimetry measures light reflection of a given sample and is one of the most commonly accepted food industry practices for various color additives. In this Example, a Hunterlab colorimeter (spectrophotometer) ColorFlex EZ with the 65/10 L. a. b. setting is used to measure the whiteness of paramylon (beta-glucan isolate (BGI)) granules compared to its purity as determined by the ASC method described in Example 1 as well as compared to other powdered whitening agents on the market. 4 samples of beta-glucan isolate (BGI, purity range 87-98%) granules were measured with a Hunterlab colorimeter. As a comparison, the whitening agent Avalanche (XTRA NBS (590111020) by Sensient) powder, and two different samples of TiO₂ powder (from Venator Hombitan and Pantia Chemical PTR-620) were also measured for the L, a and b values. All measurements were done in triplicate and the average whiteness index number is reported. Whiteness index was measured by the following formula:

WI=100−(√((100−L²)+a²+b²))

Where L is the lightness variable, which represents the degree of greyness and thus corresponds to brightness as well. A high L indicates a high whiteness or high brightness. a and b are chromaticity coordinates. a represents the red-green axis, and b represents the blue-yellow axis. A negative value of a indicates greenness whereas a positive value indicates redness. A negative value of b indicates blueness whereas a positive value of b indicates yellowness.

TABLE 51
Whiteness index and measurement values
from a Hunterlab colorimeter.

| | | | | Whiteness |
|---|---|---|---|---|
| Sample | L | a | b | Index |
| BGI 8AUG 271 (87%) | 92.3 | 0.2 | 4.0 | 91.3 |
| BGI 8DEC 11-1-153 (98.0%) | 94.9 | −0.1 | 0.6 | 94.9 |
| BGI 8DEC13-1-84 (93.5%) | 94.7 | −0.1 | 4.1 | 93.3 |
| BGI 8DEC-17-1 (93.50%) | 95.0 | −0.5 | 4.9 | 93.0 |
| Avalanche | 95.1 | −0.3 | 1.3 | 94.9 |
| TiO2 food grade Venator Hombitan | 94.1 | −0.6 | 1.5 | 93.9 |
| TiO2 Pantia Chemical PTR-620 | 92.1 | −0.4 | 3.6 | 91.3 |

Bracket percentage values refer to purity of paramylon,

Results in Table 51 show that the higher the purity of beta-glucan isolate (BGI), the higher the whiteness index. All samples of beta-glucan isolate were comparable to either the avalanche whitening agent or TiO₂. Similarly, 5% BGI, 5% Avalanche, and 0.1% TiO₂ in butter cream icing led to a comparable whitening effect.

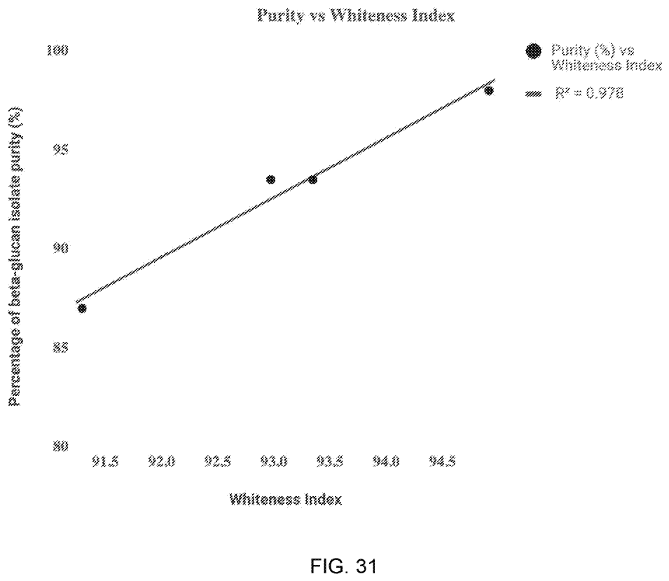

In addition, when the purity of paramylon isolate was compared to the whiteness index, there was a strong linear relationship between the purity and whiteness index (R² value=0.978) (FIG. 31).

### Example 30B: Paramylon for Whitening Non-Dairy Creamer

Non-dairy creamer samples containing paramylon granules (98.0% purity based on ASC method described in Example 1) are measured by a Hunterlab spectrophotometer. As a comparison, non-dairy creamer made with Avalanche product (XTRA NBS (590111020) by Sensient) or TiO₂ (Venator Hombitan Food Grade) were also measured. Formulations of the non-dairy creamer are shown in Table 93. A negative control was included without whitening agent. For positive controls, 4 commercially available non-dairy creamers (Silk Coconut Milk, Silk Soy for Coffee, Silk Coconut for coffee and Califia half and half for coffee) were measured for their whiteness index, as well as 2 samples of dairy creamer (Natrel 2% cow milk and Natrel half and half creamer). Whiteness index was calculated by the following formula:

WI=100−(√((100−L²)+a²+b²))

L is the lightness variable, which represents the degree of greyness and thus corresponds to brightness as well. A high L indicates a high whiteness or high brightness. a and b are chromaticity coordinates. a represents the red-green axis, and b represents the blue-yellow axis. A negative value of a indicates greenness whereas a positive value indicates redness. A negative value of b indicates blueness whereas a positive value of b indicates yellowness.

All samples were measured in replicate. The standard deviation is reported for the whiteness index as a ±after the whiteness index. Measurements were taken on a ColorFlex EZ Spectrophotometer from Hunterlab was used with the 65/10 L.a.b. setting.

TABLE 52
Non-dairy creamer formulations with paramylon granules (B-
Glucan isolate), Avalanche, or TiO₂ as the whitening agent.

| | | Oil | | | | |
|---|---|---|---|---|---|---|
| | | (Crisco | Sunflower | B-Glucan | | |
| Creamer | Water % | Canola) % | lecithin % | Isolate % | Avalanche % | TiO2 % |
| formulation | (w/v) | (w/v) | (w/v) | (w/v) | (w/v) | (w/v) |
| Control | 89.5 | 10 | 0.5 | 0 | 0 | 0 |
| B-Glucan | 88.5 | 10 | 0.5 | 1 | 0 | 0 |
| Isolate 1% | | | | | | |
| B-Glucan | 86.5 | 10 | 0.5 | 3 | 0 | 0 |
| Isolate 3% | | | | | | |
| B-Glucan | 84.5 | 10 | 0.5 | 5 | 0 | 0 |
| Isolate 5% | | | | | | |
| Avalanche 1% | 88.5 | 10 | 0.5 | 0 | 1 | 0 |
| Avalanche 3% | 86.5 | 10 | 0.5 | 0 | 3 | 0 |
| Avalanche 5% | 84.5 | 10 | 0.5 | 0 | 5 | 0 |
| TiO2 1% | 88.5 | 10 | 0.5 | 0 | 0 | 1 |
| TiO2 3% | 86.5 | 10 | 0.5 | 0 | 0 | 3 |
| TiO2 5% | 84.5 | 10 | 0.5 | 0 | 0 | 5 |

In the non-diary creamer formulations, paramylon products achieved similar whiteness level as Avalanche but less than TiO₂ (Table 53). Non-dairy creamers made of paramylon falls within the range of typical milk/creamer products on the market, as well with most non-dairy creamer products. The higher the inclusion of paramylon, the higher the whiteness index.

TABLE 53
Whiteness index results for non-dairy creamer formulations, as well
as positive control samples. L, a, and b are coordinates measurement
from colorimeter. All measurements are in triplicate, and average
of triplicate experiment with standard deviation (SD) reported.

| | | | | Whiteness |
|---|---|---|---|---|
| Sample Name | L | a | b | index ± SD |
| Control (non-dairy creamer with no | 87.66 | −0.02 | 8.96 | 84.7 ± 0.05 |
| beta glucan) | | | | |
| BGI153 Beta glucan creamer 1 | 88.40 | −0.23 | 7.69 | 86.1 ± 0.09 |
| (w/v %) | | | | |
| Beta glucan creamer 3 (w/v %) | 89.09 | 0.08 | 8.00 | 86.5 ± 0.16 |
| Beta glucan creamer 5 (w/v %) | 90.07 | −0.05 | 6.91 | 87.9 ± 0.13 |
| Avalanche “creamer” 1 (w/v %) | 88.61 | −0.04 | 8.80 | 85.6 ± 0.03 |
| Avalanche “creamer” 3 (w/v %) | 90.83 | −0.02 | 7.19 | 88.3 ± 0.01 |
| Avalanche “creamer” 5 (w/v %) | 90.99 | −0.03 | 6.91 | 88.6 ± 0.02 |
| TiO2 “Creamer” 1 (w/v %) | 91.52 | 0.16 | 7.35 | 88.8 ± 0.04 |
| TiO2 “Creamer” 3 (w/v %) | 92.35 | −0.33 | 5.54 | 90.6 ± 0.20 |
| TiO2 “Creamer” 5 (w/v %) | 93.13 | −0.37 | 4.01 | 92.0 ± 0.04 |
| Silk Coconut milk | 83.50 | −1.97 | 9.30 | 81.0 ± 0.02 |
| Silk Soy for Coffee BB: March 14/19 | 89.85 | −0.08 | 10.89 | 85.1 ± 0.00 |
| Silk Coconut for coffee BB: March | 91.55 | −0.49 | 3.71 | 90.8 ± 0.01 |
| 20/19 | | | | |
| Califia creamer half and half coconut | 73.25 | 2.56 | 10.77 | 71.0 ± 0.05 |
| cream & almond | | | | |
| Natrel 2% cow milk | 92.05 | −2.69 | 9.54 | 87.3 ± 0.01 |
| Natrel 10% half & half creamer cows | 94.17 | −0.74 | 9.69 | 88.7 ± 0.03 |
| milk | | | | |

### Example 30C: Studies on Light Stability of Paramylon

Studies are carried out to determine light stability of different forms of paramylon, including the granule and gel forms. Light stability for whiteness is where the whiteness value from the whiteness percentage test, refractive index and or Hunter lab measurements do not change significantly over time. Paramylon samples are exposed to light for an extended period of time, such as 1 hour, 24 hours, 48 hours, 5 days, 7 days, 14 days, 21 days, and 28 days. Avalanche and titanium dioxide are also tested to see how the paramylon sample compares as positive controls that are known to be light stable. Negative control with no whitening ingredient is also measured. Measurements of the whiteness at each time point are measured by the whiteness percentage, refractive index and/or the Hunterlab colorimeters described in above examples. The paramylon samples have high light stability, meaning that the whiteness or refractive index does not change significantly over time. This is compared to the positive control of titanium dioxide, which is known to have a high light stability. The paramylon samples do not have a decreased whiteness, as the granules in the paramylon icing have a high crystallinity. A high crystallinity means that it is difficult to disrupt the structure, a lot of energy is needed in order to break the hydrogen bonds and change the structure. A changed structure would result in a reduction of the whiteness, or refractive index. Without wishing to be bound by theory, while light is energy, paramylon granules have great light stability.

### Example 31: Additional Studies on Paramylon as a Whitening Agent in a Creamer

Studies are carried out to determine the effects of high pressure homogenization on emulsification with paramylon to prevent phase separation of the oil and aqueous components of the system, including a pre-homogenization step, using an OMNI GLH-01 stand homogenizer at 13,500 rpm for 1-5 min, followed by a second round of homogenization for 5 minutes. High pressure homogenization makes the droplets in the emulsion smaller, thereby increases their whitening capacity. This is due to the total whiteness of the smaller oil droplets with the paramylon present in the sample. The whiteness of the smaller drops has a higher whiteness score compared to a sample that has not gone through high pressure homogenization. Whiteness can be measured through the method as described herein (see Example 27).

Further, studies are carried out which vary the amount of paramylon, including 6%, 7%, 8%, 9%, 10%, 12.5%, 15%, 20%, and 25% (w/v), such as increasing it to determine how much paramylon can be added until no change in whiteness can be observed by measurements of percent whiteness and the refractive index measurements from the refractometer. Increasing the amount of paramylon would increase the amount of whiteness of the creamer. As well, the amount of lecithin is concurrently decreased, down to zero to determine if paramylon itself is suitable as a thickener or stabilizer by texture analyzer, as described in Example 18, in the creamer application, alongside its whitening ability.

Furthermore, refractive index, whiteness percentage and Hunterlab colorimeter measurements of creamer before and after paramylon addition are determined as described in Example 27. The refractive index of creamer is higher than negative control after paramylon addition. The refractive index of creamer increases as the particle size of the paramylon powder decreases.

### Example 32: Paramylon Hydrolysis to Release Glucose Using Megazyme Enzymatic Beta-Glucan Kit

### Introduction

Paramylon are glucose polymers. This study was designed to test if paramylon can be hydrolyzed to release glucose, which possesses moderate sweetness and thus is useful as food sweetener.

### Materials and Methods

Samples: Paramylon isolate, and Sigma 1,3-beta glucan isolate from E. gracilis.

This study was carried out as follows. 1) 100 mg from each sample was weighed and dissolved in 5 mL 2 M KOH with stirring for 2 h; 2) Digest paramylon into individual glucose following instructions from commercial kit (Megazyme K-EBHLGO2/17, USA); and 3) measure glucose released by YSI analyzer, an analytical instrument that compares the amount of glucose in a sample to a glucose standard to determine concentration of the glucose.

### Results

Results in Table 54 show that the Megazyme kit is able to break down the beta-glucan into individual glucose molecules. As well, digestion of paramylon extracted using the method described herein resulted in similar values of glucose released to the commercially available product.

TABLE 54
Glucose readings after digestion of paramylon with Megazyme
kit. Digestion of paramylon extracted from Euglena gracilis
using the method described herein was compared to commercially
available beta-glucan from Sigma Aldrich (89862).

| Sample | YSI glucose (g/L) |
|---|---|
| Paramylon isolate rep 1 | 0.698 |
| Paramylon isolate rep 2 | 0.687 |
| Sigma beta-glucan rep 1 | 0.69 |
| Sigma beta-glucan rep 2 | 0.712 |

### Discussion

This study shows that paramylon is useful as a food sweetener. Glucose is released through digestion of paramylon. This experiment shows that in a hybrid application, the same source of paramylon can provide an effect, such as thickener or whitening, as well as being able to sweeten a product and release glucose under specific conditions.

### Example 33: Additional Studies on Paramylon Solubilization

Studies are carried out to investigate different means of paramylon solubilization, including techniques of heating to determine how the solubilization and functionality of paramylon is impacted by microwave heating. Without wishing to be bound by theory, microwave pre-treatment of paramylon disrupts granule and may increase enzyme hydrolysis activity of beta-glucan. Solvents, such as dimethyl sulphoxide, have been reported to solubilize paramylon and other related beta-glucans, however, these methods are likely less applicable to the food industry, due to concerns of solvent residue in final food products. Other bases are investigated for solubilization such as other alkali hydroxides (i.e. potassium hydroxide, lithium hydroxide), but these bases have challenges of cost and residual bitter flavor.

### Example 34: Retention of Functional Properties of Paramylon

### Introduction

Of direct interest to paramylon applicability in the food industry is whether the product can be shipped in a ready to gel powder that can be dissolved in water directly, yielding desirable functional properties such as gelling, whitening, or emulsification. The solubilized material can be dried and reconstituted from a powder to yield these properties without further acid or base treatment. This ease of use is greatly desirable in food applications. Studies are carried out to determine retention of functional properties.

### Materials and Methods

Preparation of Amorphous Beta-Glucan from Paramylon Granules

In this approach, inventors convert paramylon, which is highly crystalline in its natural state, to a material more similar to curdlan, another beta-glucan, which can form heat-set gels upon dispersion in water. Without wishing to be bound by theory, curdlan is thought to be able to form heat-set gels due to its lack of crystallinity making it initially easier to disrupt the normal hydrogen bonding network to shift and begin to incorporate water into a 3D network structure through newly formed hydrogen bond interactions. The initial disruption of the hydrogen bonding network of paramylon has proven impossible under mild heat-treatment conditions in aqueous media (<100 degree Celsius). However, without wishing to be bound theory, paramylon in a pressurized vessel in a microwave reactor to temperatures above 180° C. may yield conversion of the highly crystalline granules to a new form. This new form is likely to be amorphous beta-glucan, which can be determined using melt point and DSC techniques. When significant amounts of this material is generated, an appropriate concentration dispersion readily recognized by the person skilled in art can yield a gel by heat treatment similar to curdlan at temperatures achievable in non-pressurized aqueous systems (e.g. 80° C.).

### Preparation of a Water Soluble “Paramylate” Salt

Without wishing to be bound by theory, once paramylon is solubilized one or more alcohol groups along the backbone of the beta-glucan molecules are deprotonated to form an alkoxide anion. This alkoxide may potentially be precipitated by addition of an appropriate concentration of a suitable cation.

Inventors have shown that when significant amounts of calcium chloride are added to a solution of paramylon in sodium hydroxide, a precipitate forms (see Example 4). This precipitate is unlikely to be either sodium chloride or sodium hydroxide since the concentration of sodium required to exceed the Kₛₚ for either of those materials was not reached before the precipitate was observed. Without wishing to be bound by theory, this precipitate however could potentially be explained as a salted-out product, as opposed to a true salt though. When a sodium salt of paramylon is formed and isolated, upon dispersion in water, the alkoxide ions extract protons from water because the pH of water is well below the pKa suspected/observed (>12) and this re-protonated paramylon forms a random network of hydrogen bonding that would incorporate water, in the same way inventors has shown in acid-induced gelation from solution (see Example 3). Furthermore, this isolated sodium salt (or another cation) of paramylon is added gradually into a solution of calcium chloride, forming a calcium bridged gel instead. Thus, a salt like this is preparable and isolable and is easily shipped in a powdered form that could be readily adopted into industrial formulations.

### Before and After Drying

Studies are also carried out to investigate the functionality of each paramylon form (granule, swollen, elongated and shells) before and after drying. Disruption of the spheres obtained by spray drying are performed by methods such as vortexing, sonication, and heating to determine structures reverting back into the original discrete paramylon particles of varying morphology. The functionality of the dried forms post disruption resembles the functionality of the original wet preparations. The elongated and shell forms have higher water holding capacity but lower whiteness as they have less crystallinity. The undisrupted dried material has limited functional application, aside from potential encapsulation. 0.1%, 0.5%, 1% w/v paramylon in the granule, swollen, elongated and shell forms, each containing 10% w/v high oleic Euglena oil, or linoleic, or MCT or palm. The material is spray dried to yield an encapsulated oil product. The encapsulated oil is compared to an unencapsulated oil dispersion in water. The initial peroxide values are determined on each preparation, and monitored at 1, 5, 15, and 30 days after storage at ambient conditions. The encapsulated oil yields lower peroxide values over time than the unencapsulated oil, which indicates that encapsulated oil are protected from oxidation, relative to unencapsulated oil.

### Hydrogen Bond Interrupters

Other hydrogen bond interrupters (which remain debatable whether it is the true effect of chaotropic agents) are evaluated, including guanidinium chloride, to determine if they have an effect on gel formation and functionality. In particular, as guanidinium chloride is a hydrogen bond interrupter, studies are carried out to determine the effects of guanidinium chloride on gel strength. Gel strength is measured by a texture analyzer, i.e. to measure the tensile strength. Guanidinium chloride disrupts the hydrogen bonds, resulting in paramylon gels having a weaker gel strength. Guanidinium chloride addition leads to paramylon gels having a lower tensile strength than the control only paramylon gels. Concentrations of paramylon gels form by both HCl addition and calcium chloride addition (0.1-5%) range from 1% to 10% paramylon gel for both the control (no guanidinium chloride) and guanidinium chloride tests in a range of 0.1 M-5 M. The experiment is conducted at room temperature, and the results are observed after 10-30 minutes. Tensile strength is measured by a tensiometer. The Guanidinium chloride experiments have lower tensile strength measurements than the control paramylon gels in the range of 0-3000 g/cm². In addition, if the gel is dried, it acts like curdlan when water is added back and heated, a gel is more likely to form as the hydrogen bond network have been weakened compared to the original granular paramylon, making it easier to form a matrix after heating. Incorporation of guanidinium chloride reduces the crystallinity of the final dried product, yielding a material more similar to the limited crystallinity of curdlan (30% crystallinity) which ultimately causes the material to become a heat set gel at conditions between 50 and about 100 degree Celsius.

### Example 35: Additional Studies on Gelation of Paramylon

Studies are carried out to investigate gelation of paramylon, as detailed hereinabove in Example 3. NaOH concentration range for gelation is from 0.01% to 10%. Temperature range for gelation is from −20° C. up to 200° C., from an hour to 2, 3, 4, 5, 7, 14, and up to 28 days. In particular, gel gelation is undertaken in temperature range from 65° C. up to 200° C., from an hour to 1 day, and up to 2 days. The degradation of paramylon solution under heat treatment are examined. The degradation can be visually observed microscopically, as well as measured by a texture analyzer as described in at least Examples 2, 10, 14, and 18. For cation treatment, other cations besides calcium, for example magnesium, are also tested. Experiments are carried out on a wide range of paramylon concentrations, including 0.5%, 1.5%, 2%, 3%, 4%, and 7.5% (w/v) in a range of 0.001-5% calcium chloride or 0.001-5% magnesium chloride. The strength of the gel is determined by texture analyzer as described in Examples 2, 10, 14, and 18 as well as the viscosity of the gel as described in Example 14. Gel strength determines differences or similarities between calcium and magnesium for the gel strength. The viscosity is a measurement of the flow of the gel that relates to the thickness of the gel.

### Example 36: Additional Studies on Calcium Gelation of Paramylon

Studies are carried out to investigate the lowest pH point at which gels are formed and the paramylon is still soluble before addition of the calcium. Other calcium salts which yield a slightly more acidic solution, such as calcium nitrate, are tested. Calcium hydroxide is also used instead of sodium hydroxide during solubilization which removes the sodium ions from the paramylon solution. If the solubilization occurs at a lower pH, the final gel pH will be lowered and closer to neutral, which is desired in food formulations.

### Example 37: Synergism Between Paramylon and Hydrocolloids

Hydrocolloids are long chain polymers of either carbohydrates (polysaccharides) or proteins that form a viscous solution or gel in water. This is due to the high number of hydroxyl groups allowing for increased binding to water. As Euglena's beta-glucan molecules are long chains of carbohydrate molecules that can form viscous solutions, the synergistic interaction between Euglena's beta-glucan and other hydrocolloid molecules is investigated.

### Example 38: Paramylon in Plant-Based Protein Drink Product

### Introduction

This study investigated whether Euglena paramylon granules prevent or delay settlement of the protein powder in the plant protein shake drink.

### Methods and Materials

An unsweetened plant based protein shake which has acacia gum in the formulation, spray dried paramylon granules, and deionized water were used to prepare protein drinks in the absence (control) and presence of paramylon isolate at different concentrations.

The plant protein shake powder and paramylon granule are mixed together prior to addition of water. The amount of each powder is seen below:

According to the powders' label instruction, one scoop of the powder (39 g) must be mixed with 1.5 cups of water (12 fl.oz.). This is approximately 10% of the powder in the drink, making a total solids of 10% (w/v).

2 sets of prototypes were made both including 0, 1, 3, and 5% paramylon granules in the formulations.

Variable total solids (1st set): 0, 1, 3, and 5% (w/v) paramylon was included in addition to 10% powder, therefore the final total solid content became 10, 11, 13, and 15% (formulations are shown in Table 55).

Constant total solids (2nd set): the total solid content was kept at 10%, therefore 0, 1, 3, and 5% of plant protein powder was substituted with paramylon (formulations are shown in Table 56).

After vigorously shaking each of the prototypes, pictures were taken at time 0, 5, 10, 20, 30, 60 min and after overnight storage to investigate the effect of paramylon inclusion in the settlement of the plant protein powder in the drink.

TABLE 55
Formulation of plant protein drink containing 0, 1, 3,
and 5% in addition to plant protein powder.
Variable Total Solid

| | Control | 1% | 3% | 5% |
|---|---|---|---|---|
| | (0%) | Paramylon | Paramylon | Paramylon |
| | % | % | % | % |
| Water | 90 | 89 | 87 | 85 |
| Plant Protein Powder | 10 | 10 | 10 | 10 |
| Paramylon granules | 0 | 1 | 3 | 5 |
| Total | 100 | 100 | 100 | 100 |

TABLE 56
Formulation of plant protein drink containing 0, 1, 3,
and 5% in substitution for plant protein powder.
Constant Total Solid

| | Control | 1% | 3% | 5% |
|---|---|---|---|---|
| | (0%) | Paramylon | Paramylon | Paramylon |
| | % | % | % | % |
| Water | 90 | 90 | 90 | 90 |
| Plant Protein Powder | 10 | 9 | 7 | 5 |
| Paramylon granules | 0 | 1 | 3 | 5 |
| Total | 100 | 100 | 100 | 100 |

### Results

The results showed the following:

When paramylon was added in addition to the 10% protein powder especially at high paramylon concentration such as 5%, the presence of paramylon delayed the settlement of the protein powder for about 10-20 min (which could be within the timeline many people finish their drink), and even after 20 min, up until one hour, less settlement was observed in the presence of paramylon (especially at higher paramylon concentrations).

When the total content was kept constant (10%), paramylon especially at higher concentrations delayed the protein settlement for the first 5-10 min but lesser of the “settlement prevention” effect was observed compare to when paramylon was added on top of the 10% protein powder.

Regardless of the total solid being constant or variable, paramylon concentration has a direct positive effect on delaying the settlement of the protein powder in the drink (more paramylon delays the plant powder settlement more).

Regardless of the total solid being constant or variable inclusion of paramylon showed a whitening effect on the plant protein drink which again was in a direct relationship with the paramylon concentration.

In all prototypes, the presence of paramylon did not adversely affect the sensory profile of the prototypes, in fact paramylon seemed to mask the earthy taste of plant based protein drink.

The delayed settling of the powder showed an effect between the paramylon and the protein powder. In order to determine if it is a synergistic effect with the acacia gum (gum arabic) present in protein powder with Euglena's paramylon, an interaction experiment is performed in the example below.

The viscosity synergism index is used to determine if there is a synergistic effect or not. The equation is below:

Viscosity Synergism Index (Iv)=nⱼ₊ᵢ/(nⱼ)+(nᵢ)

Where nᵢ and nⱼ are the measured viscosity of the individual hydrocolloids, and nⱼ₊ᵢ is the measured viscosity of the hydrocolloid blend. If the index number is greater than 1, than there is a synergistic effect. If the number is 1, there is an additive effect. If the number is less than 1 then there is an inhibitory effect. The measured viscosity is in cp/min at 20° C.

In addition, the sedimentation rate is measured to determine the rate of which the particles fall out of solution. The formula is as follows:

Sedimentation rate (%)=100−((Height of the sedimentation (in mm)/Total height of the liquid (in mm))×100)

Where the height of the sedimentation is measured in mm and the total height of the solution is measured in mm. Sedimentation refers to the particles in the solution, in these examples they are the plant-based protein shake, as well as the paramylon granules. A lower number indicates that the particles stay suspended in the solution, while the higher number indicates that the particles fell out of the solution.

TABLE 57
Sedimentation rate of variable total solid solutions
containing plant protein drink and paramylon granules
Variable total solids (set 1)
Percentage inclusion of paramylon granules

| Time | 0% | 1% | 3% | 5% |
|---|---|---|---|---|
| (min) | (control) | paramylon | paramylon | paramylon |
| 0 | 0 | 0 | 0 | 0 |
| 5 | 62.5 | 30.4 | Not | Not |
| | | | clear | clear, |
| | | | | close |
| | | | | to 0 |
| 10 | 62.5 | 43.5 | 8.7 | 2.2 |
| 20 | 61.5 | 52.0 | 16.0 | 4.0 |
| 30 | 64.0 | 54.2 | 25.0 | 8.3 |
| 60 | 66.7 | 58.3 | 37.5 | 12.5 |
| Overnight | 62.5 | 60.9 | 54.3 | 39.1 |

In Table 57, the sedimentation values for the variable total solid samples (from Table 55) are reported. The control showed the highest sedimentation of particles over all time points where as the highest inclusion of paramylon showed the lowest amount of sedimentation. Both the 3% and 5% inclusion rate of paramylon showed a decrease in the sedimentation in comparison to the control, the 1% inclusion showed a slight decrease in the sedimentation rate. A not clear label indicates that there was not a clear distinction of the sedimentation line in order to make a measurement.

TABLE 58
Sedimentation rate of constant total solid solutions
containing plant protein drink and paramylon granules
Constant total solids (set 2)
Percentage inclusion of paramylon granules

| Time | 0% | 1% | 3% | 5% |
|---|---|---|---|---|
| (min) | (control) | paramylon | paramylon | paramylon |
| 0 | 0 | 0 | 0 | 0 |
| 5 | Not | not | 13.0 | 8.7 |
| | clear | clear | | |
| 10 | 60.9 | 47.8 | 21.7 | 19.6 |
| 20 | 60.9 | 56.5 | 34.8 | 34.8 |
| 30 | 60.9 | 56.5 | 43.5 | 41.7 |
| 60 | 60.9 | 56.5 | 52.2 | 47.8 |
| Overnight | 62.5 | 60.9 | 60.9 | 60.9 |

In Table 58, the control had the highest sedimentation rate at all time points, where as the 5% inclusion of paramylon had the lowest overall sedimentation rate. 3% and 5% paramylon inclusion had the largest effect on settlement of the protein powder, where as the 1% inclusion had a slight improvement of the sedimentation rate. A not clear label indicates that there was not a clear distinction of the sedimentation line in order to make a measurement.

### Discussion

The results above showed that inclusion of paramylon can help with delaying the protein powder settlement in plant based protein shake. Paramylon also whitens the drink which mellows its original darker murky green colour to a lighter, less turbid or less green colour. Also, the bitter taste of the original drink can be perceptually less in the presence of paramylon which could be of preference to some consumers.

In terms of the masking the earthy/plant like taste in the drink, the main protein source in the drink is from peas. Peas are known to have an earthy/plant-like off flavour and bitterness. Without wishing to be bound by theory, in terms of the off flavour, hexanal is one of the major compounds responsible for grass smell in frozen peas, and saponin is responsible for bitterness taste in pea. Without wishing to be bound by theory, both hexanal and saponin can be removed by porous activated carbon adsorbent effectively. Activated carbon adsorbent is often used to remove volatile compounds and is used in food manufacturing.

Cellulose, which is beta 1,4 linked insoluble fiber that in its natural form has some adsorption capacity due to the hydroxyl groups, however chemically modified cellulose has an increased adsorption ability. Cellulose is able to absorb water, metal ions, dyes and organic substances and is used as a pre treatment for activated carbon.

Without wishing to be bound by theory, curdlan gel made with activated carbon may act as adsorbent material. Curdlan gel when dried is porous with a surface composed of hydroxyl groups. In activated carbon in a curdlan gel, the curdlan was also an adsorbent due to its porous nature and the hydroxyl groups on the surface.

Paramylon is a beta 1,3-glucan that is porous molecule that would also have hydroxyl groups available for binding materials. Without wishing to be bound by theory, paramylon is able to adsorb the undesirable flavour compounds in a similar way that cellulose and curdlan are able to act as adsorbents.

Lower plant protein powder concentration in the 2^{nd} set of prototypes (prototypes with constant total solid) makes one expect the prevention of the powder settlement by paramylon would be easier and more in those prototypes while the opposite results were obtained when comparing the 2^{nd} set to the 1^{st} set (where paramylon was added on top of the 10% powder). Without wishing to be bound by theory, this can be attributed to the effect of higher total solid in the 1^{st} set which could be helping with an increased viscosity of the drink and less settlement of the powder in return. More experiments are conducted where protein drinks with total solid of 11, 13, and 15 is made using only plant protein powder with 0% paramylon inclusion.

Gum acacia is present in both the creamer example above, and as a part of the plant protein shake. In the creamer example with the gum and paramylon, there was an observed increased thickness in the creamer compared to the gum and paramylon only control, showing a positive interaction between the gum and paramylon. In this drink example, the addition of paramylon granules prolonged the settling of the drink mixture. To determine if the positive effect with the addition of the paramylon is with the acacia gum in the protein drink, synergistic experiment is carried out to test if this positive interaction is synergistic.

### Example 39: Effects of BGI on Plant Proteins with Considering the Solubility of Protein

### Introduction

This study was to further confirm that BGI could delay the settling of plant-based protein in water, and to give a better understanding of the effect of BGI on the properties of plant protein when the solubility of protein was considered. Settling of BGI was also measured as a control. Additionally, the effect of BGI on the solubility and water hold capacity (WHC) of plant protein were also evaluated.

### Materials and Methods

WHC of plant based protein were measured, the weight loss of the plant based protein when a WHC test was considered as the solubility of plant based protein. Briefly, the mixture of BGI and plant-based protein beverage with water after settling study was transferred into a 50 mL centrifuge tube and centrifuged for 25 min under 1600 g force. The supernatant was decanted, and the precipitate was further dried at 50° C. with a 15-degree angle mouth-down to remove free water, and then the samples were freeze dried. DW (dry Weight) was given by the weight of the dry samples. WHC was given by the ratio of absorbed water weight and initial solid weight (or DW for cor.WHC))”

The settling study was determined as the following procedure. 5 g plant based protein powder, BGI and their mixtures as seen in Table 110 were poured in 45 mL water in 4 oz jar, and hand shaking violently in 20 seconds, and then let the mixtures be kept still. The height of the solid was measured at 0, 5, 10, 15, 30, 60, 90, 120 and 270 min to determine the settling volume. The initial height (at 0 min) was 2.7 cm.

TABLE 110
Inclusion levels of Beta-Glucan Isolate
(BGI) and plant-based protein beverage

| | Amount of sample (g) | | | | | |
|---|---|---|---|---|---|---|
| Sample number | 1 | 2 | 3 | 4 | 5 | 6 |
| Plant based protein beverage | 5 | 4.5 | 4 | 3 | 2.5 | 0 |
| BGI | 0 | 0.5 | 1 | 2 | 2.5 | 5 |
| Plant % | 100 | 90 | 80 | 60 | 50 | 0 |

### Results:

### General Information

The weight variation of the samples was listed in Table 110. As well-known, BGI(here Paramylon Granules) is a water-insoluble material. Before and after the experiment, the weight loss of the BGI was considered as transferring loss, being used to calculate the transfer loss rate (TLR). The dry solid weight after experiment (DW) was determined using the WHC method. The mixture of BGI and plant-based protein beverage with water after settling study was transferred into a 50 mL centrifuge tube and centrifuged for 25 min under 1600 g force. The supernatant was decanted, and the precipitate was further dried at 50° C. with a 15-degree angle mouth-down to remove free water, and then the samples were freeze dried. DW was given by the weight of the dry samples. Dry BGI weight (DWb) was given by the initial BGI weight in samples multiplied by the transfer rate (4.677/5=93.5%). The dry solid plant-based protein beverage weight after experiment (DWp) was given by the difference between DW and DWb. The dry solid plant-based protein beverage percentage (Dp %) was given by the ratio of DWp and DW. The results of the parameters were seen in Table 111.

TABLE 111
weight variation of the samples before and after experiment IW:
initial weight of samples; DW: dry solid weight after experiment;
DWp: Dry Weight of insoluble plant-based protein beverage after
experiment; DWb: Dry weight of BGI after experiment corrected by
TLR (Transferring loss rate) (here 4.677/5 = 93.5%). Dp %:
the dry solid plant-based protein beverage percentage after experiment.

| Sample | Protein % | IW | DW | DWb | DWp | Dp % |
|---|---|---|---|---|---|---|
| 1 | 100 | 5 | 3.296 | 0 | 3.296 | 100 |
| 2 | 90 | 5 | 3.421 | 0.468 | 2.956 | 86.3 |
| 3 | 80 | 5 | 3.554 | 0.935 | 2.619 | 73.7 |
| 4 | 60 | 5 | 3.837 | 1.87 | 1.967 | 51.3 |
| 5 | 50 | 5 | 3.986 | 2.34 | 1.646 | 41.3 |
| 6 | 0 | 5 | 4.677 | 4.677 | 0 | 0 |

### Solubility of the Plant-Based Protein Beverage

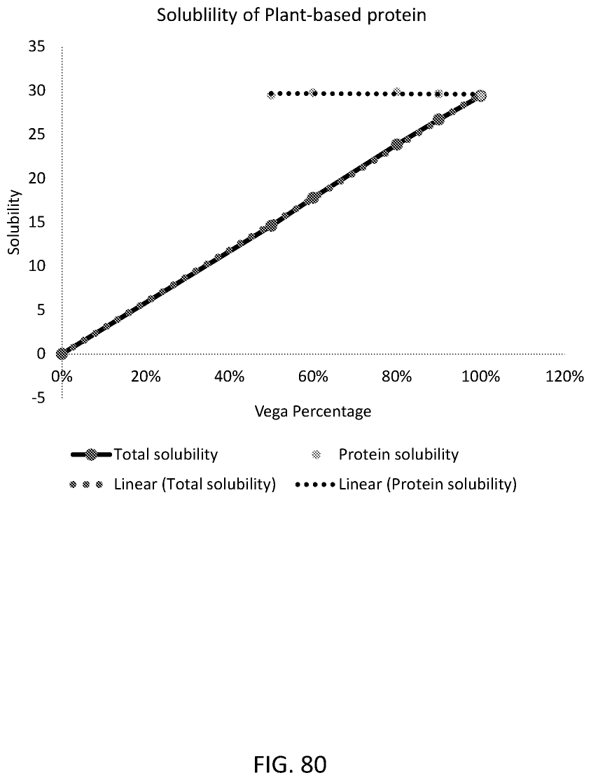

Because BGI was considered as non-water-soluble materials, the soluble materials in this study was considered as plant-based protein only. The transfer rate was also considered when a soluble plant based protein beverage percentage was given. The results are in Table 112. The total soluble percent was given by the ratio of the weight loss compared to initial weight (here 4.677 g was used because of TLR) and the initial weight (4.677 g). The total plant based Soluble percentage was given by the ratio of the weight loss and the DWp. As seen in FIG. 80, the soluble amount of the plant-based protein beverage linearly increased with the plant-based protein beverage ratio increased, and up to ˜30% when 100% plant-based protein was used in sample 1. If considering the true weight of plant protein in each sample as seen the organ in FIG. 80, BGI does not affect the solubility of protein.

TABLE 112
Solubility of protein. Dp %: the dry solid plant based protein percentage
after experiment; Total soluble %: the ratio of the weight loss comparing
to initial weight (here 4.677 g was used because of the transfer rate)
and the initial weight (4.677 g); Total Protein Soluble %: the ratio
of the weight loss and the Initial Protein Weight*TLR.

| | Protein % | | Total | Total protein |
|---|---|---|---|---|
| Sample | (Initial) | Dp % | soluble (%) | soluble % |
| 1 | 100 | 100 | 29.3 | 29.4 |
| 2 | 90 | 86.3 | 26.7 | 29.6 |
| 3 | 80 | 73.7 | 23.8 | 29.9 |
| 4 | 60 | 51.3 | 17.8 | 29.8 |
| 5 | 50 | 41.3 | 14.6 | 29.5 |
| 6 | 0 | 0 | 0 | 0 |

### Water Hold Capacity

In this study, WHC was given by considering TLR, too. It was a ratio of absorbed water and initial weight multiplied by TLR. Corrected WHC (Cor.WHC) was given by considering the weight loss of each samples. It was the ratio of the absorbed water and DW. A theoretic WHC (Th WHC) was given by Th WHC=Protein %*WHC1+BGI %*WHC2. There, WHC1 is protein WHC (1.73 g/g) and WHC2 is BGI WHC (1.13 g/g). A correction theoretic WHC (cor. Th WHC) was given by Th Cor. WHC=protein %*Th cor. WHC1+BGI %*Th cor.WHC2) Here, Th WHC1 is 2.45 g/g and Th WHC2 is WHC, 1.13 g/g.

TABLE 113
Water Holding capacities based on concertation of protein:
WHC was given by considering TLR, too. It was a ratio of
absorbed water and initial weight multiplied by TLR. Corrected
WHC (Cor. WHC) was given by considering the weight loss of
each samples. It was the ratio of the absorbed water and
DW. A theoretic WHC (Th WHC) was given by Th WHC = Protein
%* WHC1 + BGI % *WHC2. There, WHC1 is protein WHC (1.73
g/g) and WHC2 is BGI WHC (1.13 g/g). A correction theoretic
WHC (cor. Th WHC) was given by Th Cor. WHC = protein
% *Th cor. WHC1 + BGI % *Th cor. WHC2) Here, Th WHC1
is 2.45 g/g and Th WHC2 is WHC, 1.13 g/g

| | Protein | Dp % | WHC | Cor. WHC | Th WHC | Th Cor. WHC |
|---|---|---|---|---|---|---|
| 1 | 100% | 100 | 1.73 | 2.45 | 1.73 | 2.45 |
| 2 | 90% | 86.3 | 1.49 | 2.04 | 1.67 | 2.27 |
| 3 | 80% | 73.7 | 1.45 | 1.91 | 1.61 | 2.11 |
| 4 | 60% | 51.3 | 1.29 | 1.57 | 1.49 | 1.80 |
| 5 | 50% | 41.3 | 1.24 | 1.45 | 1.43 | 1.67 |
| 6 | 0 | 0 | 1.13 | 1.13 | 1.13 | 1.13 |

Not surprisingly, WHC increases with the increase of Protein % because protein has a higher WHC than BGI. Interestingly, the Th WHC and Th Cor. WHC is higher than WHC and Cor. WHC, respectively, by increasing around 10%. This suggests that BGI lowered down the WHC of Protein.

### Settling Study

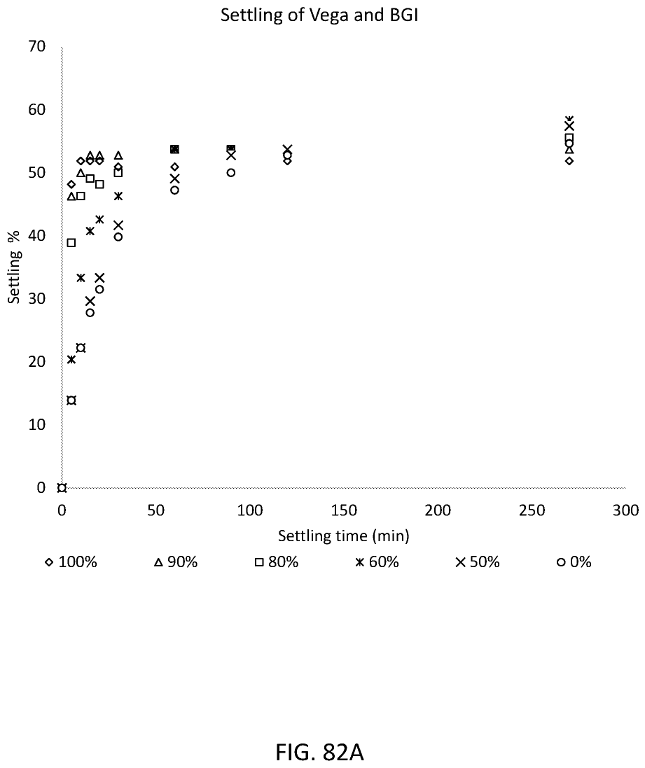

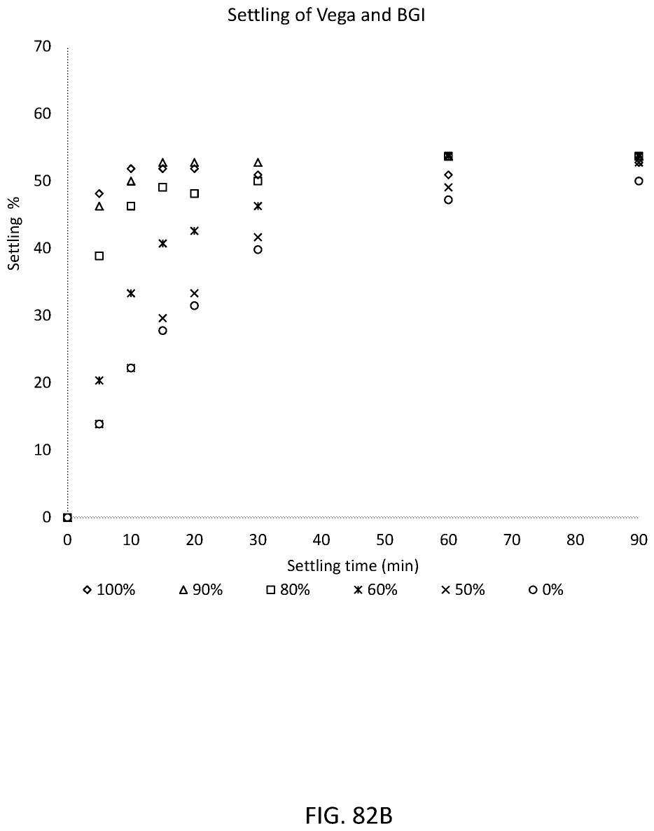

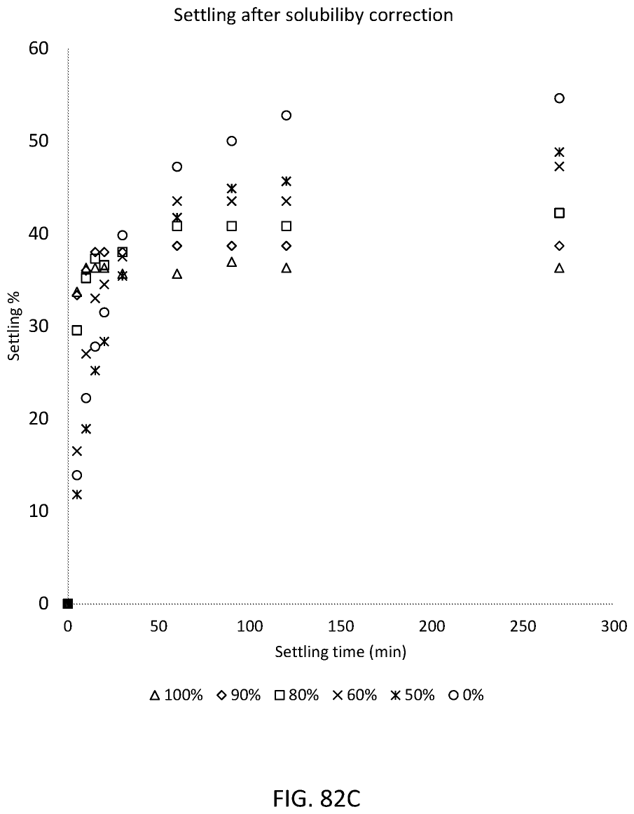

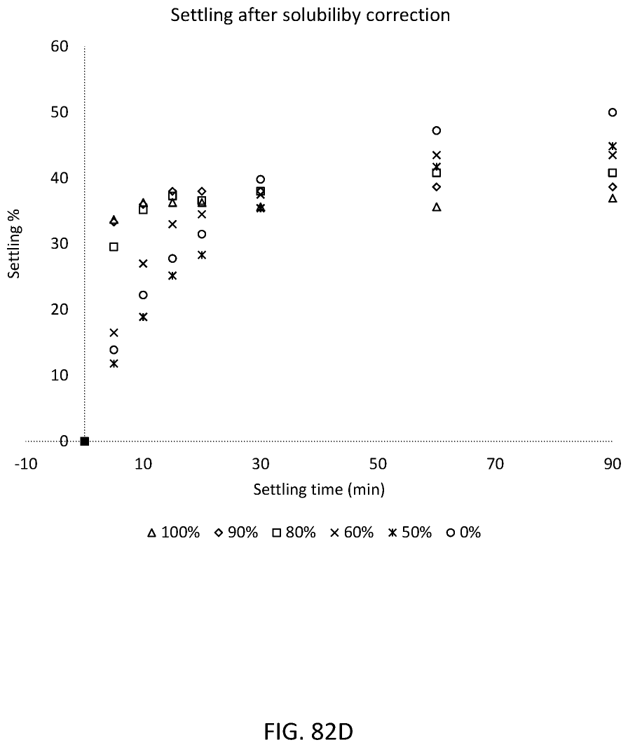

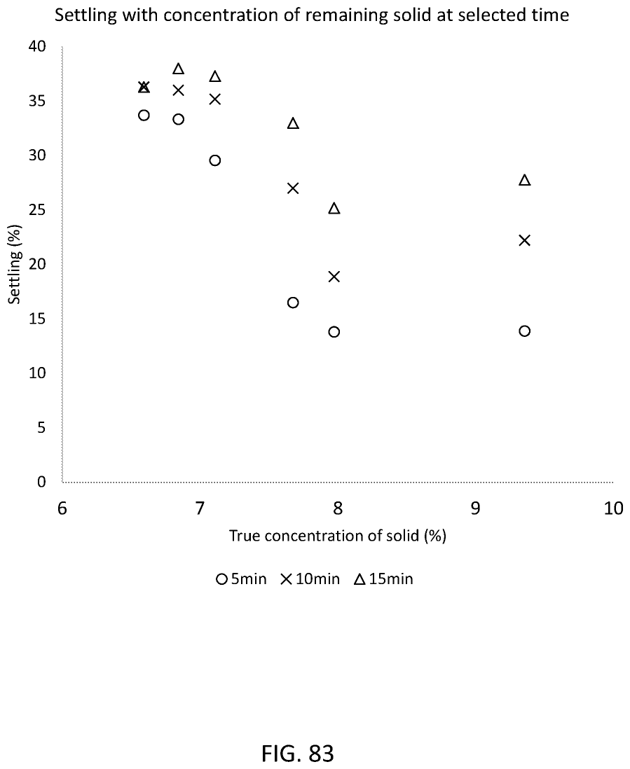

The settling study was carried out using the method above. The settling % was given by the clear supernatant height divided by initial height (2.7 cm in this study). The settling % were shown in FIG. 82 A through D. BGI was settling more slowly than Protein in the first 30 mins, but eternally, BGI showed more settling than protein. When BGI content was up to 20%, the mixture of BGI and protein started to give a slower settling compared to 100% protein. When BGI content was up to 50%, its settling was similar at the settling of 100% BGI. The results seemed to suggest that BGI delays protein settling in the first 30 min when BGI content was up to 20%. It should be noticed that the settling of BGI and plant based protein mixture was faster than 100% BGI. It should be noted, as seen in FIG. 83, that the total solid content decreased with the increase of plant based protein content in mixtures. The settling % with the solid content was presented in FIG. 83. One can see that the settling % linearly increased with decrease of solid content in this study. A study on the settling of 100% protein and 100% BGI at different concentration would give a better understanding of interaction between protein and BGI.

### Conclusions

In this study, the effect of BGI on plant-based protein properties was studied. The properties included solubility, water holding capacity (WHC), and settling behaviours. The total initial solid content was 10% which is suggested by the instruction of plant-based protein beverage products. WHC was measured using our SOP. Solubility was measured by the solid weight loss before and after the experiment. Settling behaviours were measured by the settling volume with time (0 to 300 mins). The results showed that BGI did not affect the solubility of plant-based protein, but affect on WHC, decreased by 10%. The settling study showed that 100% the protein settled faster than 100% BGI in the first 30 to 60 min, although eternally, 100% BGI had more final settling. The study seems to suggest that BGI could delay the protein settling in the first 30 min when BGI content was up to 20%. A study on the settling of 100% plant-based protein and 100% BGI at different concentration would give a better understanding of interaction between plant-based protein and BGI.

### Example 40: Synergistic Effect of Paramylon

### Purpose

To determine if there is a synergistic effect between the hydrocolloid gum in the plant protein drink, and simplified version of the experiment performed in Example 38 is conducted. In this experiment, only pea protein (Caldic, pea protein 80%) and 1, 3 and 6% of gum acacia represent the plant protein powder.

### Materials and Methods

The experiment is as outlined in Example 38, Table 56 and Example 39 38 is repeated here, with the plant protein powder consisting of 9, 7, and 4% pea protein and 1, 3, and 6% gum acacia to make a 10% total solids solution. Paramylon granules are added at a 1%, 3% and 5% inclusion rate, with both varying total solids concentrations (11%, 13% and 15%) as well as by keeping the total solids content the same at 10%. To test the effect of the paramylon granules with the pea protein only, a set of sample with just the pea protein and paramylon granules at both the varying total solids concentrations (11%, 13%, 15% with 1% 3% and 5% inclusion of paramylon granules) as well as the fixed total solids at 10% as seen in Table 59. The same set of samples is generated for the gum acacia, replacing the pea protein in the above sentence. Viscosity synergism index as well sedimentation rate measurements are taken for each solution.

TABLE 59
Synergistic interaction test between pea protein, acacia gum and
paramylon on preventing the settlement of protein in a beverage.

| | Pea | Acacia | | Total |
|---|---|---|---|---|
| | protein | gum | Paramylon | solids |
| Sample Number | (%) | (%) | (%) | (%) |
| Pea control | 10 | 0 | 0 | 10 |
| Acacia 1% control | 0 | 1 | 0 | 1 |
| Acacia 3% control | 0 | 3 | 0 | 3 |
| Acacia 6% control | 0 | 6 | 0 | 6 |
| Paramylon 1% control | 0 | 0 | 1 | 1 |
| Paramylon 3% control | 0 | 0 | 3 | 3 |
| Paramylon 5% control | 0 | 0 | 5 | 5 |
| Variable solids high | 9 | 1 | 1 | 11 |
| protein 1 | | | | |
| Variable solids high | 9 | 1 | 3 | 13 |
| protein 2 | | | | |
| Variable solids high | 9 | 1 | 5 | 15 |
| protein 3 | | | | |
| Variable solids high | 9 | 3 | 1 | 13 |
| protein 4 | | | | |
| Variable solids high | 9 | 3 | 3 | 15 |
| protein 5 | | | | |
| Variable solids high | 9 | 3 | 5 | 17 |
| protein 6 | | | | |
| Variable solids high | 9 | 6 | 1 | 16 |
| protein 7 | | | | |
| Variable solids high | 9 | 6 | 3 | 18 |
| protein 8 | | | | |
| Variable solids high | 9 | 6 | 5 | 20 |
| protein 9 | | | | |
| Variable solids med | 7 | 1 | 1 | 9 |
| protein 1 | | | | |
| Variable solids med | 7 | 1 | 3 | 11 |
| protein 2 | | | | |
| Variable solids med | 7 | 1 | 5 | 13 |
| protein 3 | | | | |
| Variable solids med | 7 | 3 | 1 | 11 |
| protein 4 | | | | |
| Variable solids med | 7 | 3 | 3 | 13 |
| protein 5 | | | | |
| Variable solids med | 7 | 3 | 5 | 15 |
| protein 6 | | | | |
| Variable solids med | 7 | 6 | 1 | 14 |
| protein 7 | | | | |
| Variable solids med | 7 | 6 | 3 | 16 |
| protein 8 | | | | |
| Variable solids med | 7 | 6 | 5 | 28 |
| protein 9 | | | | |
| Variable solids low | 4 | 1 | 1 | 6 |
| protein 1 | | | | |
| Variable solids low | 4 | 1 | 3 | 8 |
| protein 2 | | | | |
| Variable solids low | 4 | 1 | 5 | 10 |
| protein 3 | | | | |
| Variable solids low | 4 | 3 | 1 | 8 |
| protein 4 | | | | |
| Variable solids low | 4 | 3 | 3 | 10 |
| protein 5 | | | | |
| Variable solids low | 4 | 3 | 5 | 12 |
| protein 6 | | | | |
| Variable solids low | 4 | 6 | 1 | 11 |
| protein 7 | | | | |
| Variable solids low | 4 | 6 | 3 | 13 |
| protein 8 | | | | |
| Variable solids low | 4 | 6 | 5 | 15 |
| protein 9 | | | | |
| Constant solids low | 8 | 1 | 1 | 10 |
| gum 1 | | | | |
| Constant solids low | 6 | 1 | 3 | 10 |
| gum 2 | | | | |
| Constant solids low | 4 | 1 | 5 | 10 |
| gum 3 | | | | |
| Constant solids med | 6 | 3 | 1 | 10 |
| gum 4 | | | | |
| Constant solids med | 4 | 3 | 3 | 10 |
| gum 5 | | | | |
| Constant solids med | 2 | 3 | 5 | 10 |
| gum 6 | | | | |
| Acacia and paramylon | 0 | 1 | 1 | 2 |
| control 1 | | | | |
| Acacia and paramylon | 0 | 1 | 3 | 4 |
| control 2 | | | | |
| Acacia and paramylon | 0 | 1 | 5 | 6 |
| control 3 | | | | |
| Acacia and paramylon | 0 | 3 | 1 | 4 |
| control 4 | | | | |
| Acacia and paramylon | 0 | 3 | 3 | 6 |
| control 5 | | | | |
| Acacia and paramylon | 0 | 3 | 5 | 8 |
| control 6 | | | | |
| Acacia and paramylon | 0 | 6 | 1 | 7 |
| control 7 | | | | |
| Acacia and paramylon | 0 | 6 | 3 | 8 |
| control 8 | | | | |
| Acacia and paramylon | 0 | 6 | 5 | 11 |
| control 8 | | | | |

If there is a positive effect between the paramylon granules and the hydrocolloid gum, then the sedimentation rate is the lowest in those samples. If it is synergistic, then the viscosity synergistic index is greater than 1. Solutions that contain both the gum and paramylon have a lower sedimentation rate than the pea protein alone or pea protein and gum alone. The higher the inclusion of paramylon, the lower the sedimentation rate is.

### Example 41: Synergistic Matrix Involving Paramylon

### Introduction

Beta-glucan is a hydrocolloid, and hydrocolloids are known to have interactions with each other, both positively and negatively. Positive interactions have an additive and or a synergistic effect whereas negative interactions have inhibitory effects. Euglena's beta-glucan is used in combinations of other hydrocolloids, known as gums. The synergistic effect is measured in terms of the viscosity of the solution to determine a synergistic increase in thickness and or gelation strength.

### Materials and Method

2 different preparation methods are used.

In the first, powdered gums and paramylon granules are added to 50 mL of 1 M NaOH in order to solubilize the paramylon granules. Then, 1 M HCl, or 50% citric acid is added dropwise while stirring until pH 2. Alternatively, organic acids can be used to lower the pH. At each unit of pH i.e. 11, 10, 9, 8, 7, 6, 5, 4, 3 and 2, a sample of the solution is taken for viscosity measurements described below. The viscosity index is used to determine if the interaction is positive or negative, and if the positive interaction is synergistic.

In the second method, first, the 1% and 2% paramylon gel is made by solubilizing the paramylon in 1 M NaOH, then 50% citric acid is added to gel the solution. Alternatively, organic acids can be used to lower the pH. The gel is then freeze dried as explained above. In brief, the gel is placed into the −80 degree Celsius freezer for 30 minutes up to overnight. The frozen sample is then placed in a Labconco freeze dryer for 24-48 hours. Once the sample is fully dry, it is ground with a mortar and pestle into a fine powder. This fine powder is then mixed with the different amounts of gums as seen in Table 60 and 61 Water is then added and the solution's viscosity is measured as previously described. The synergistic effect is then determined by the viscosity index value.

All thickening and gelation are performed at room temperature unless otherwise stated. Locust bean gum is heated to above 74° C. to solubilize the gum. Gellan gum is heated to above 75° C. if using high acyl gellan or 100° C. if using low acyl gellan. High and low methoxyl pectin is heated to above 80° C.

Ions are needed for certain gums in order to gel, such as the Carrageenan family of Kappa and Iota. Iota has the strongest gel with calcium ions, however can also gel with potassium ions or ammonium ions. Whereas Kappa forms a firm brittle gel with potassium ions. In addition, the carrageenan mixture with paramylon are heated to above 80° C., then 2% (w/v) KCl or CaCl₂ is added to the heated solutions for gelling.

TABLE 60
Control hydrocolloid mixtures for synergism experiment

| | Low | Medium | High |
|---|---|---|---|
| | Concen- | Concen- | Concen- |
| | tration % | tration % | tration % |
| Control mixture: | (w/w) | (w/w) | (w/w) |
| Paramylon Granules or | 1 | 2 | 5 |
| freeze dried citric acid gel | | | |
| Carboxymethyl Cellulose | 0.3 | 0.5 | 1 |
| (CMC) | | | |
| Carrageenan (Kappa) | 0.5 | 0.75 | 1 |
| Carrageenan (Iota) | 0.5 | 0.75 | 1 |
| Carrageenan (Lambda) | 0.5 | 0.75 | 1 |
| Pectin (High Methoxyl) | 0.5 | 0.75 | 1 |
| Pectin (Low Methoxyl) | 0.5 | 0.75 | 1 |
| Xanthan Gum | 0.5 | 0.75 | 1 |
| Guar Gum | 0.5 | 0.75 | 1 |
| Locust bean gum | 0.5 | 0.75 | 1 |
| Konjac Gum | 0.5 | 0.75 | 1 |
| Gum arabic | 0.5 | 0.75 | 1 |
| Sodium alginate | 0.5 | 0.75 | 1 |
| Microcrystalline cellulose | 0.5 | 0.75 | 1 |
| Gellan | 0.50 | 0.75 | 1 |

TABLE 61
Hydrocolloid and paramylon granule or freeze dried citric acid
gel paramylon concentration used in synergism experiments

| Hydrocolloid gum: | Paramylon concentration % (w/w) | | |
|---|---|---|---|
| Carboxymethyl Cellulose | 1.00% | 2.00% | 5.00% |
| (CMC) 0.3% (w/w) | | | |
| Carboxymethyl Cellulose | 1.00% | 2.00% | 5.00% |
| (CMC) 0.5% (w/w) | | | |
| Carboxymethyl Cellulose | 1.00% | 2.00% | 5.00% |
| (CMC) 1.0% (w/w) | | | |
| Carrageenan (Kappa) 0.5% | 1.00% | 2.00% | 5.00% |
| (w/w) | | | |
| Carrageenan (Kappa) 0.75% | 1.00% | 2.00% | 5.00% |
| (w/w) | | | |
| Carrageenan (Kappa) 1.0% | 1.00% | 2.00% | 5.00% |
| (w/w) | | | |
| Carrageenan (Iota) 0.5% | 1.00% | 2.00% | 5.00% |
| (w/w) | | | |
| Carrageenan (Iota) 0.75% | 1.00% | 2.00% | 5.00% |
| (w/w) | | | |
| Carrageenan (Iota) 1.0% | 1.00% | 2.00% | 5.00% |
| (w/w) | | | |
| Carrageenan (Lambda) 0.5% | 1.00% | 2.00% | 5.00% |
| (w/w) | | | |
| Carrageenan (Lambda) 0.75% | 1.00% | 2.00% | 5.00% |
| (w/w) | | | |
| Carrageenan (Lambda) 1.0% | 1.00% | 2.00% | 5.00% |
| (w/w) | | | |
| Pectin (High Methoxyl) 0.5% | 1.00% | 2.00% | 5.00% |
| (w/w) | | | |
| Pectin (High Methoxyl) | 1.00% | 2.00% | 5.00% |
| 0.75% (w/w) | | | |
| Pectin (High Methoxyl) 1.0% | 1.00% | 2.00% | 5.00% |
| (w/w) | | | |
| Pectin (Low Methoxyl) 0.5% | 1.00% | 2.00% | 5.00% |
| (w/w) | | | |
| Pectin (Low Methoxyl) 0.75% | 1.00% | 2.00% | 5.00% |
| (w/w) | | | |
| Pectin (Low Methoxyl) 1.0% | 1.00% | 2.00% | 5.00% |
| (w/w) | | | |
| Guar Gum 0.5% (w/w) | 1.00% | 2.00% | 5.00% |
| Guar Gum 0.75% (w/w) | 1.00% | 2.00% | 5.00% |
| Guar Gum 1.0% (w/w) | 1.00% | 2.00% | 5.00% |
| Locust bean gum 0.5% (w/w) | 1.00% | 2.00% | 5.00% |
| Locust bean gum 0.75% (w/w) | 1.00% | 2.00% | 5.00% |
| Locust bean gum 1.0% (w/w) | 1.00% | 2.00% | 5.00% |
| Konjac Gum 0.5% (w/w) | 1.00% | 2.00% | 5.00% |
| Konjac Gum 0.75% (w/w) | 1.00% | 2.00% | 5.00% |
| Konjac Gum 1.0% (w/w) | 1.00% | 2.00% | 5.00% |
| Gum arabic 0.5% (w/w) | 1.00% | 2.00% | 5.00% |
| Gum arabic 0.75% (w/w) | 1.00% | 2.00% | 5.00% |
| Gum arabic 1.0% (w/w) | 1.00% | 2.00% | 5.00% |
| Sodium alginate 0.5% (w/w) | 1.00% | 2.00% | 5.00% |
| Sodium alginate 0.75% (w/w) | 1.00% | 2.00% | 5.00% |
| Sodium alginate 1.0% (w/w) | 1.00% | 2.00% | 5.00% |
| Microcrystalline cellulose | 1.00% | 2.00% | 5.00% |
| 0.5% (w/w) | | | |
| Microcrystalline cellulose | 1.00% | 2.00% | 5.00% |
| 0.75% (w/w) | | | |
| Microcrystalline cellulose | 1.00% | 2.00% | 5.00% |
| 1.0% (w/w) | | | |
| Gellan 0.5% (w/w) | 1.00% | 2.00% | 5.00% |
| Gellan 0.75% (w/w) | 1.00% | 2.00% | 5.00% |
| Gellan 1.0% (w/w) | 1.00% | 2.00% | 5.00% |

As gums can be polysaccharides, several factors affect the properties of the gum, such as the size (molecular weight), the type, if any of the side chains, how those side chains are placed as well as the backbone. Molecular weight of the molecule refers to the chain length, the longer or bigger the molecule is, the more likely it is to interact with other molecule in solution. More interaction affect the flow of the solution or its viscosity, which in turn relates to the thickness of a solution.

The backbone also influences the gum's properties in a solution, such as the pH stability, ability to thicken and or gel.

In terms of whether the gum is a thickening or gelling agent, the type of side chains can influence the gum's properties. One is by the size of the side groups, ranging from none, to large sugar molecules. The groups determine how the gum interacts with other molecule, the more junctions that can be made, the more likely the hydrocolloid will form a gel. In addition, the number and placement of side groups affects the solubility such as cold solubility, gelling ability, and synergistic effects with other gums. The side groups are either evenly distributed or unevenly, with areas that contain none or clusters. Side groups play an important role in water solubility as they have weaker intermolecular bonding, allowing water to interact easier.

As Euglena beta-glucan has no side chains on its backbone it is able to form strong gels with other hydrocolloids as it forms more junctions than a branched or heavily side chained hydrocolloid would.

### Example 42: Microencapsulation of Oil by Paramylon as an Encapsulation Agent

As shown in FIGS. 21-24, the results of spray drying point to preservation of structures. In all cases, the powder generated preserved a resemblance to the starting material. The spray drying formed sphere like particles made up of a film of the paramylon around a core of air. This particle characteristic is observed in the spray drying process and is part of the reason spray drying can be used for microencapsulation work, when the concentrations of the material to be encapsulated and the encapsulant are controlled. This is useful in the food industry because encapsulation may increase stability or water solubility of the encapsulated material. The solubility is the constant variable while the ease and time to become soluble is dependent on the pre-treatment or preparation conditions. For example material that has an increase surface area would solubilize more quickly. An example to test encapsulation is to take an oil, for example oleic oil, MCT oil, canola oil, soybean oil, linoleic oil, Euglena derived oil (MCT, palmitic, EPA, DHA, Oleic) and homogenize it using an OMNI GLH-01 stand homogenizer at 13,500 rpm for 5 min at room temperature with a 1% (w/v) solutions of paramylon granules, or swollen form, or elongated form or shell form.

To encapsulate the oil, the homogenized mixture is spray dried, as described above. Spray drying generates aggregates that have sphere space on the inside of the particles. In microencapsulation, the oil is in the sphere, with the paramylon encapsulating the oil. One positive control for encapsulation would be using alginate, which has encapsulation activity. The negative control would be oil and water, which would not form a stable encapsulation. The encapsulation of the oil by paramylon can be measured by the oxidative stability. This is defined as how much oxygen is exposed to the oil, as oxygen causes oxidization of the oil. The tubes with solution are closed and the amount of oxygen is what is present in the micro-centrifuge tubes, which are left at room temperature. Measurements are taken at day 1, 2, 5, 7, and 14 days after encapsulation. To measure oxidation, peroxide value measuring oxidation in oils is determined. Higher numbers means the oil is more oxygenated. Peroxide values are determined by analytical laboratory POS

Biosciences. Lipids are extracted from the microencapsulated samples and controls, and peroxide values are determined by colourimeteric method by measuring the iron thiocyanate at 500 nm. The peroxide values are in the range 0.1-30 mEq/Kg.

In addition, the efficiency of microencapsulation is measured. Microencapsulation efficiency is measured by the surface oil method known in the art and the following formula is used:

Microencapsulation efficiency (%)=((Total oil (g)−Surface oil (g))/Total oil(g)×100

Where the total oil is the total available oil added. The total available oil is assumed to be the same as the initial amount of oil added. The surface oil is the oil that is not encapsulated and/or the oil that is leaked from a poor encapsulation. When the microencapsulation holds the oil and does not leak or let the oil out of the encapsulation, then the surface oil number is low. When the microencapsulation is not as well formed, then the oil leaks out of the encapsulation, and the surface oil value is higher. In order to test the leakage, the encapsulated material is placed in a solvent (hydrophobic and hydrophilic) which does not dissolve the product.

In contrast, it can clearly be seen that freeze drying does not preserve any of the initial structures observed during solubilization (aside from the solubilized sample in 1 M sodium hydroxide). Without wishing to be bound by theory, this phenomena may be due to the freeze drying process being a slow gradual process that slowly concentrates the base and paramylon as both the freezing and drying processes occur. As this slow transition is occurring, the paramylon ends up experiencing the effects of a higher concentration of sodium hydroxide and is ultimately turned into its solubilized form in all cases, whether starting from swollen granules, elongated granules, or shells.

Preservation of the functionality of each granule morphology is of high interest for commercialization of paramylon as a food ingredient. This would allow tailoring of forms of paramylon that could be made more economically and be conveniently shipped to customers who could then simply add water to obtain the functional product. It is apparent than some of the whiteness of the intermediate forms appears to be lost in the drying process, perhaps due to the change from mostly discrete particles to clustered aggregates forming the spheres.

Studies are carried out to investigate the capability of paramylon gels to be dried into a powder, either by spray drying or freeze drying and then reconstitute the gel by addition of water. Alternative methods of drying, such as drum drying or vacuum oven drying could be used, however the high heat and increased exposure time to high temperature of these processes might lead to degradation and discolouration of the product. In addition, the dried powder of solubilized paramylon is blended with calcium salts in the dry state to yield a mixture which gels upon addition of water.

A path of experiments that is conducted in is to determine whether an even higher calcium concentration of calcium generates even firmer gels. The range that is investigated is from 0 g/L CaCl2.2H2O to 5 g/L CaCl2.2H₂O. The optimal ratio of calcium ions is reached when paramylon gel strength reaches 3000 g/cm².

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### Example 43: FTIR of Glucans

Fourier Transform Infrared Spectroscopy (FTIR) is a vibrational spectroscopy that relies on the absorbance, transmittance or reflectance of infrared light (4000 cm⁻¹−400 cm⁻¹) by materials. The infrared light is absorbed in different amounts corresponding to the vibrational frequencies of the bonds in a sample, such as stretching or bending. FTIR spectroscopy is more sensitive to hetero-nuclear functional group. The FTIR spectrum can be divided into two regions: Functional group region (4000 cm⁻¹-1500 cm⁻¹) and fingerprint region (below 1500 cm⁻¹). The motions related to functional group region, generally stretching vibration, are more characteristic of the typical functional groups found in organic molecules.

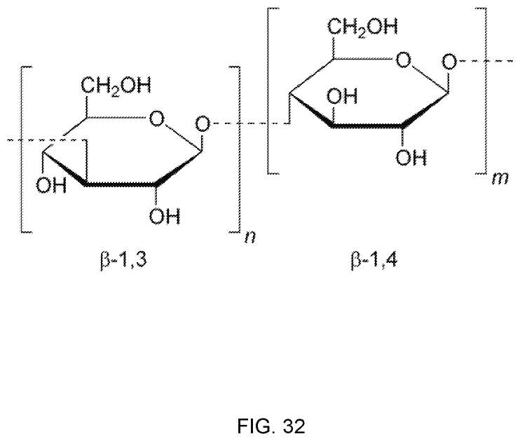

An example of beta-glucan is shown in FIG. 32. Normally, functional groups are represented by characteristic bands that appear at defined wavelengths. For example, free or hydrogen bonding O—H stretching vibrations are present at 3600-3200 cm⁻¹, C—H stretching bands at 3000 cm⁻¹-2800 cm⁻¹, CH₂ (scissoring, wagging and twisting) and COOH vibrations at 1500-1200 cm⁻¹ (such as 1375 cm⁻¹; C—H bending; 1335 cm⁻¹, O—H in-plane bending; 1315 cm⁻¹, CH₂ wagging; 1277 cm⁻¹, C—H bending; and 1225 cm⁻¹, O—H in-plane bending, C—O—C or C—C vibrations at 1200-950 cm⁻¹). C—OH groups related to C—O stretching or O—H bending are present at 1160-1110 cm⁻¹. Fingerprints or the anomeric region are present at 950-700 cm⁻¹. The detailed assignment of bands of a polysaccharide are summarized in Table 62.

TABLE 62
The Assignment of FTIR for glucans

| Frequency (cm⁻¹) | Assignment | Comments |
|---|---|---|
| 3415 | vOH | |
| 2922 | vCH | |
| 1730 | v(C═O) | Uronic acid protonated form |
| 1651 | Amide I:v(C═O) | Chitin, acetamide |
| 1620 | v(C═O) | Chitin, acetamide |
| 1600 | v(as)(COO—) | Carboxymethyl |
| 1556 | Amide II:vNH | Chitin |
| 1540 | Amide II:vNH | |
| 1421 | v(s) (COO—) | Carboxymethyl |
| 1375 | | Chitin |
| 1328 | | Carboxymethyl |
| 1316 | AmideIII (CN) | Chitin |
| 1161 | v(COC), (CC) | Beta Glc |
| 1153 | v(COC), (CC) | Alpha -Glc |
| 1078 | v(CO), (CC) | Beta Glc |
| 1047 | v(CO), (CC) | Carboxymethyl |
| 1038 | v(CO), (CC) | Beta Glc |
| 1023 | | alpha -Glc |
| 930 | | Ring |
| 890 | CH | C-1-H, beta -Glc |
| 850 | CH | C-1-H, alpha -Glc |
| 783 | CH | C-1-H, beta -Glc |
| 765 | CH | C-1-H, alpha -Glc |

The characteristic band at 1420 cm is assigned to scissoring motion, suggesting that changes of intensity or location are related to the environment of C6, such as the formation/breaking of an intramolecular hydrogen bond on O6. The bands at 1163-1100 cm⁻¹ correspond to C—O stretching or O—H bending of the C—OH functional group, and the band at ˜1110 cm⁻¹ is for primary and secondary alcohols. The bands at 900-880 cm⁻¹ are for vibrations involving C1 and its four connecting atoms. This is expected to reflect changes in molecular conformation due to rotation about the C1-O—C4 (glycosidic) linkage.

Previous studies, suggested that peaks at 1025 and 1150 cm⁻¹ are due to 1,4-linkages, and the peak at 850 cm⁻¹ is typical of alpha-glucans. Interestingly, Previous studies used bands at 1160, 1078, 1041, and 889 cm⁻¹ to represent beta (1,3)-/(1,6)-linked glucans, and those at 1155,1023, 930, 850 and 765 cm-1 for alpha (1,4;1,6-). They used the intensity ratios at 1160/115, 1041/1023, 1160/1023 and 889/930, 889/765 for ratio determination of alpha- and beta-linkages.

Previous studies believed that FTIR is possible to assign characteristic bands of alpha and beta anomers. Due to the deformation mode of the anomeric C—H linkage, an axial hydrogen at C-1 in the alpha conformation is closer to that on C-5 than an equivalent beta form. This leads to an increase of Van der Waals forces, and hence an increase in frequency. In monosaccharides, the beta-anomers are present at 915, 874 and/or 767 cm⁻¹, while alpha anomers are present at 921, 890 and/or 774 cm⁻¹. It was also identified that alpha 1,4-linkages are indicated by bands at ˜930 and/or 758 cm⁻¹, and 1,6-linkages at 917 and/or 768 cm⁻¹. However, previous studies reported that bands at 1160, 1078, 1041, and 889 cm⁻¹ represent beta (1,3)-/(1,6)-linked glucans, and those at 1155,1023, 930, 850 and 765 cm⁻¹ represent alpha (1,4;1,6-)-linked glucans. They used intensity ratios at 1160/115, 1041/1023, 1160/1023 cm⁻¹ and 889/930, 889/765 cm⁻¹ to determine the ratio of alpha- and beta-linkages. Previous studies also reported characteristic peaks for (1,3)- and/or (1,6)-linked beta-glucan in laminarin are at 1160, 1078, 1041, and 889 cm⁻¹. While those from P. sajor-caju are at 1152, 1078, 1042 and 892 cm⁻¹. The peak at 892 or 889 cm⁻¹ is specific for the beta-glycosidic bond. The peaks at 1152 (1160), 1078, and 1042 (1041) cm⁻¹ (pyranose ring) are from the corresponding sugar residues such as glucose. Therefore, both bands at ˜1160 and at ˜1153 cm⁻¹ are possible for beta-glucan.

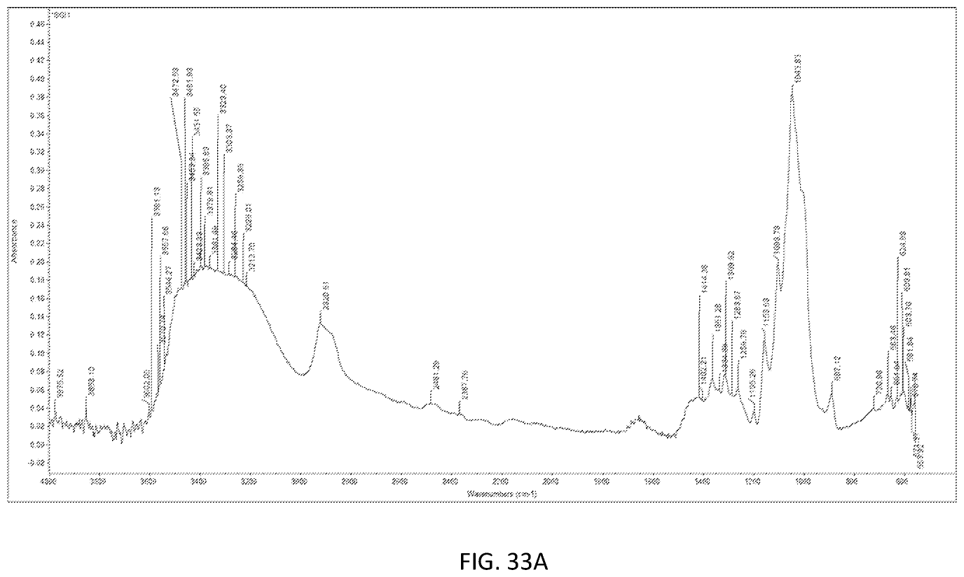

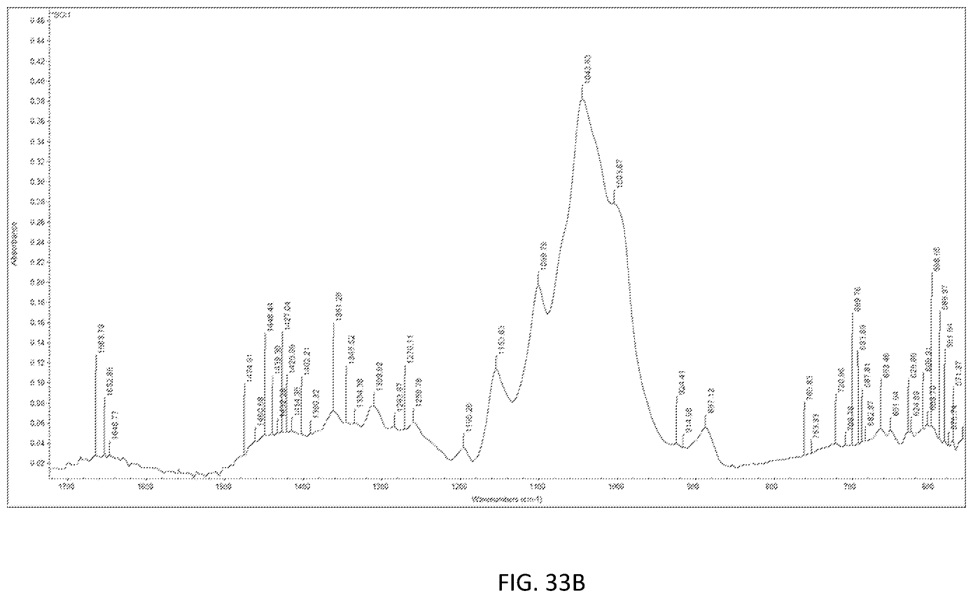

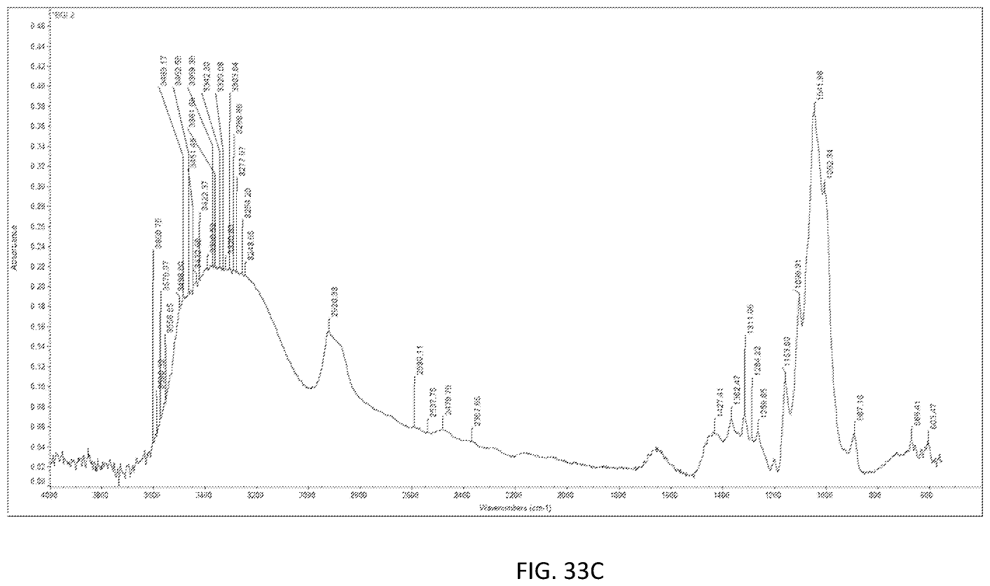

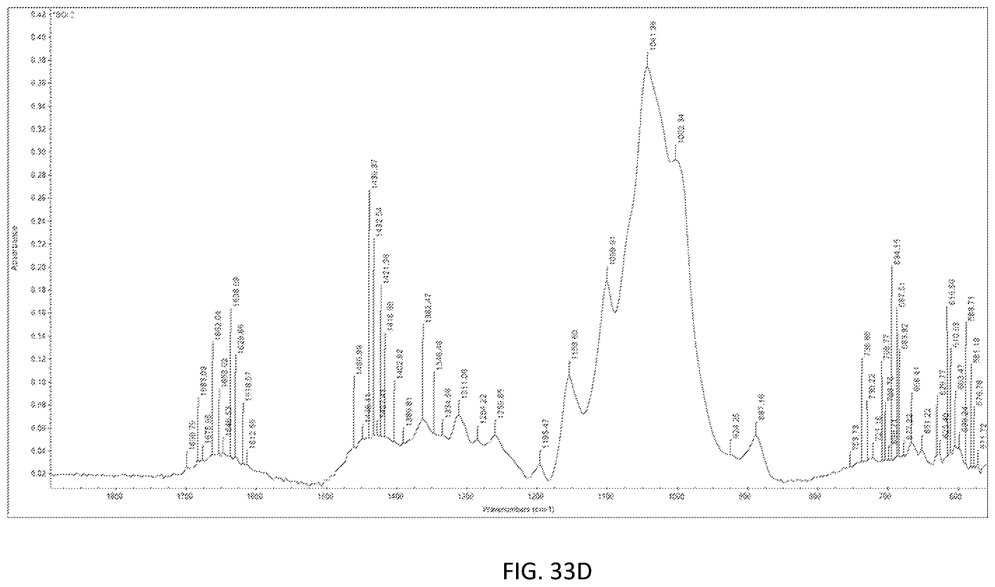

In this study, FTIR spectra of paramylon products were recorded on a Thermo Scientific Nicolet IS50 FTIR spectrophotometer, equipped with an ATR accessory, at 4000-500 cm⁻¹; 32 scans were performed with a resolution of 4 cm⁻¹. The spectra were analyzed using EZ Ominz software. They are shown in FIG. 33 A-D BGI (1) and BGI (2) came from different batches.

As seen FIG. 33 A-D, functional groups of paramylons were detected. Free or hydrogen bonding OH stretching vibrations are present at 3200-3500 cm⁻¹, C—H stretching bands at 2850-2920 cm⁻¹, C-6 related CH. scissoring motions present at ˜1420 cm⁻¹; C—H betiding (at 1350 and 1260 cm⁻¹), O—H in-plane bending (1334 cm⁻¹ and 1200 cm⁻¹), and CH₂ wagging (1260 cm⁻¹) are also detected. The glucose structure was confirmed by the bend at 1160-950 cm⁻¹, related to the C—O—C (1153 cm⁻¹), C—O (1041 cm⁻¹, 1002 cm⁻¹), OH (1099 cm⁻¹) and C—C (1153 cm⁻¹) stretching or bending in glucose. C-1 related motions specific to glucose were present at 887 cm⁻¹. The bands at 1153 cm⁻¹ and 887 cm⁻¹ confirm the existence of beta glucan. The absence or very small peak at ˜930,850 or 760 cm⁻¹ suggests no or very small quantities of alpha glucan. The high similarity of BGI (1) and BGI (2) suggests that BGIs coming from different batches are chemically the same. it should be noted that the band at ˜1600 cm⁻¹ comes from glucose-hydrogen bonded H₂O.

### Example 44: SEM and Size

In this study, the samples were mounted onto SEM stubs with double sized carbon tape. Paramylon granules were then placed in the chamber of Polaron Model E5100 sputter coaster and approximately 25 nm of gold was deposited onto stubs, and then were viewed in a Tescan Vega II LUS scanning electron microscope.

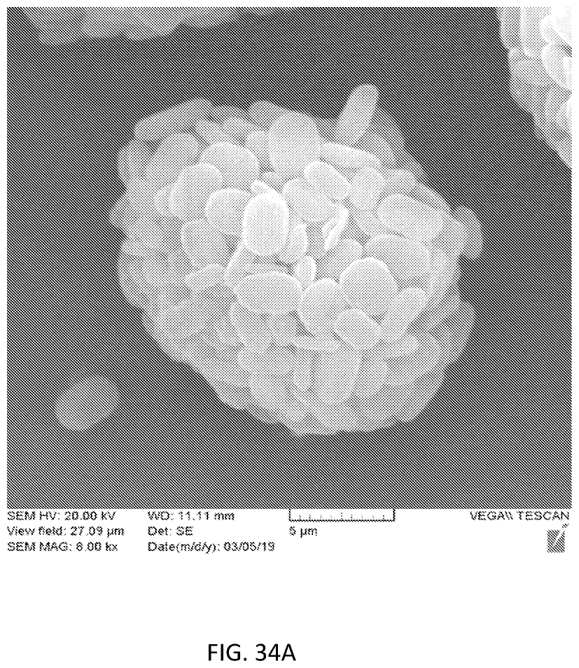

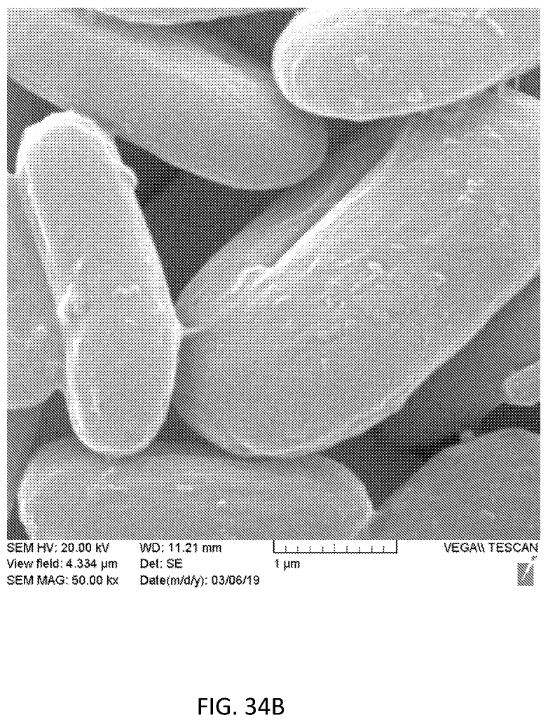

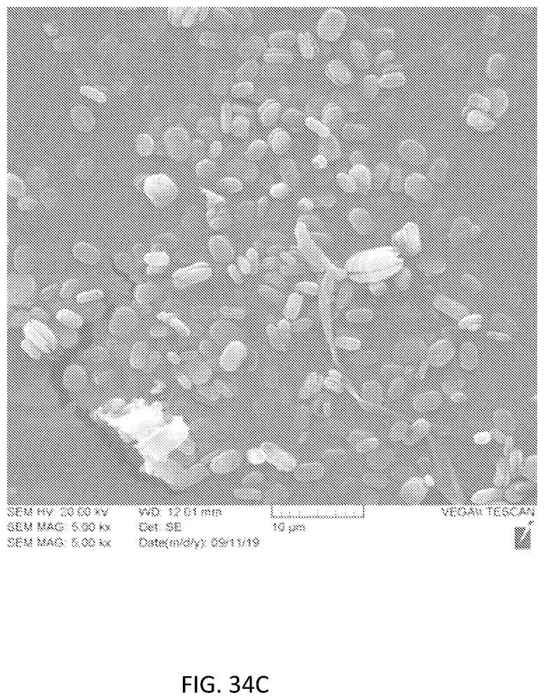

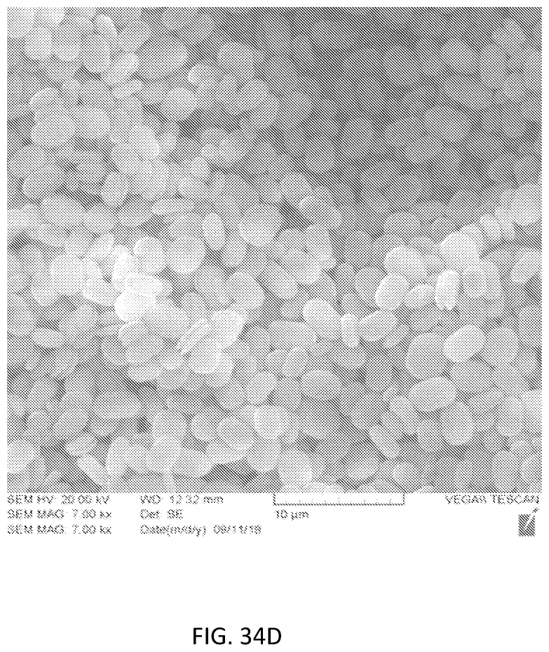

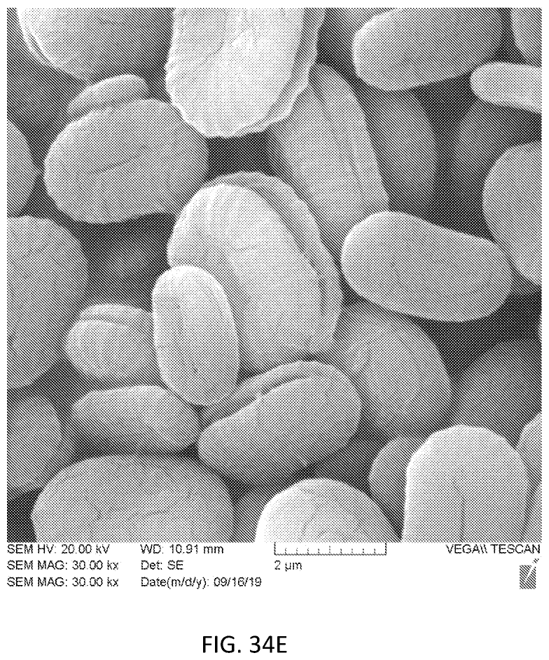

Three paramylon granule forms were observed by SEM, as seen in FIG. 34. Spray dried and freeze-dried paramylon granules were achieved using the methods in disclosed in the General Methods and Instrumental Techniques section. Wet BGI saturated with waters prepared using the method of Water Holding Capacity. Briefly, the spray dried paramylon was soaked in water for 2 hours, whereby solid granules were collected by centrifugation at 1600×g for 25 min.

The spray dried BGI granules aggregated in large clusters with a 15 to 20 nm diameter but freeze dried and wet BGI remained as individual granules around 2-3 nm in size. The amplified picture of spray dried BGI (FIG. 34 B), paramylon in its original form, showed oval-shaped granules with a relatively smooth surface. Whereas, freeze dried BGI granules appear swollen from being saturated with water. There also appears to be debris, potentially from split granules, accumulating amongst the granules. The wet BGI granules also appeared swollen but less so compared to freeze-dried water saturated BGI. Their surface is also smoother in appearance and less debris is present. This suggests that the drying methods of BIG has an effect on granules structures which could result in unique BGI functionalities or properties.

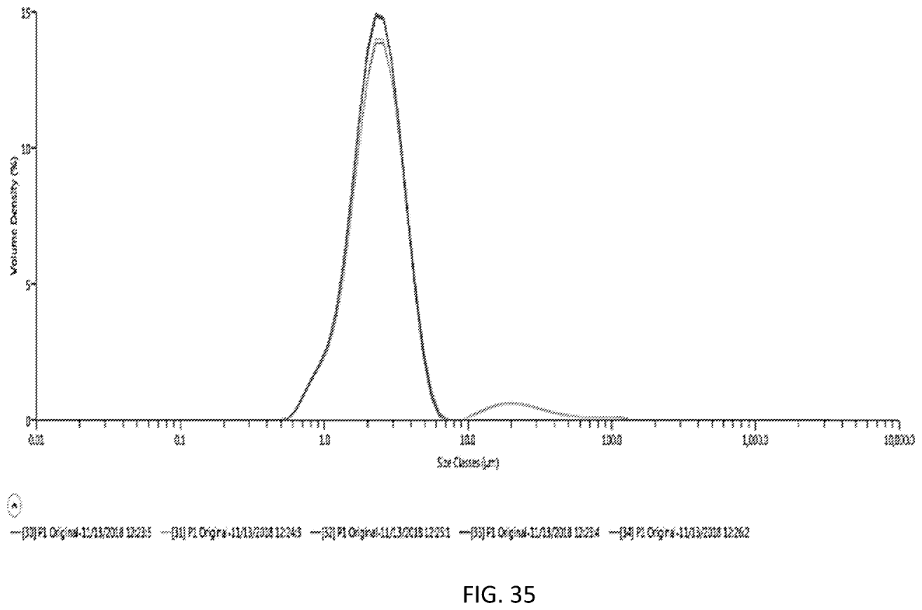

The particle size distribution of spray dried paramylon granules was measured on MALVERN Mastersizer 3000 particle size analyzer and the results are shown in FIG. 35. The average size of the granules was around 2.5 μm, suggesting ultrasonication can break the aggregated particles that were observed by SEM.

### Example 45: Molecular Weight

The absolute molar mass distributions of the samples were measured using size exclusion chromatography (SEC) with multi-angle light scattering (MALS) detection. The samples were dissolved in dimethyl sulfoxide (DMSO) at a nominal concentration of 9.5 mg/mL. Each preparation was heated to approximately 70° C. for 90 minutes in a water bath. At the end of the treatment, samples appeared visibly clear.

TABLE 63
The molecular weight information measured by SEC.

| Samples | Mn | Mw | Mw/Mn | Mass recovery (%) |
|---|---|---|---|---|
| BGI | 102,000 | 166000 | 1.64 | 99.8 |

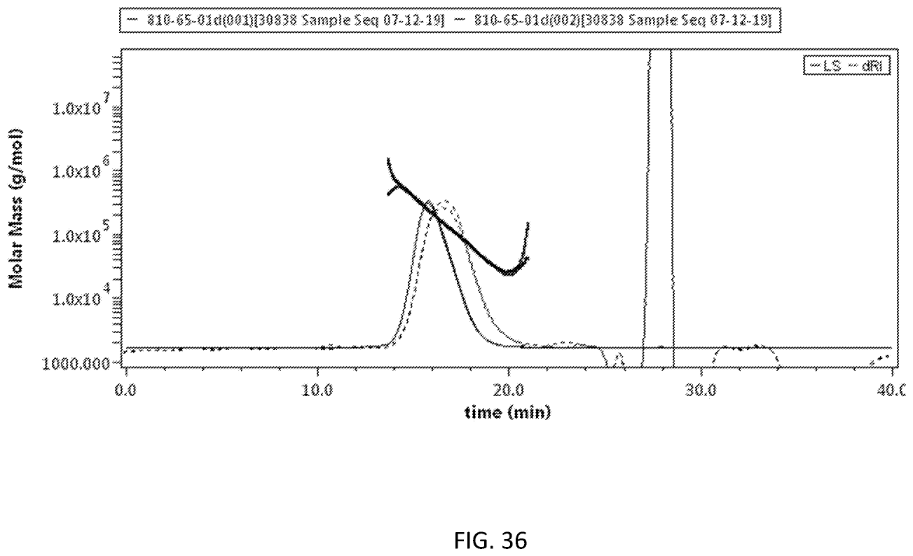

As seen in FIG. 36. and Table 63, the molecular weight of BGI granules was 166 kDa with sharrow PDI 1.64. This is less than the 633 kDa value reported by previous studies and could be due to differences in the Euglena strain; culture conditions or processing steps, suggesting that the molecular weight of BGI can be controlled, although the granule size did not change.

### Example 46: Density

The bulk density and true density of BGI granules were measured. The bulk density was measured by weighing approximately 0.5 g of BGI and measuring the volume in a 10 mL graduated cylinder. The bulk density was calculated using the formula: Bulk density=Mass (g)/Volume (mL). A true density was measured by using a graduated cylinder containing 0.5 g BGI and adding 3 mL deionized water, then calculated with the formula: True density=Mass (g)/(volume added-Initial volume (mL)). This measurement is based on an assumption that BGI has zero solubility in water.

In this study, the bulk density was calculated as 0.5 g/mL which varies slightly from the literature, whereas the true density was calculated as 2.5 g/ml, which agrees with reported values.

### Example 47: Emulsion

Emulsion stability (ES) indicates the strength of an oil-in-water emulsions to resist their gravitational phase separation, which occurs as a result of droplet coalescence and creaming. For oil-in-water emulsions, the amphiphilicity of proteins, the charge density of polysaccharide, molecular weight and conformation of biopolymers etc., are crucial factors determining their emulsion stability. The stabilization occurs by the rapid diffusion of protein/biopolymer mixture at the oil-water interface or due to their adsorption, or by their rearrangement to form an elastic film, which lowers the surface tension and strengthens the emulsified droplets. The ability of proteins to adsorb and rearrange at the oil-water interface is greatly affected by their interaction with polysaccharides present in the system, and the continuous phase viscosity.

A comparison of emulsification properties of PP(N)-BGI(13), PP(N)-BGI(N) and PP(N) alone were done to evaluate the effect of pH treatment on emulsion stability. The high alkaline treated BGI [BGI(13)] displayed better emulsion stability than BGI(N) when emulsified with PPI(N). Note that BGI(13) displayed 50% more solubility than BGI(N) [see FIG. 40], which indicates that the increase in BGI solubility had an effect on the functional properties of PP-BGI admixtures as well as PP alone. Table 68 lists the ES of 50% oil in water emulsions prepared using 5:1 PP-BGI admixture. The emulsion prepared using PP and BGI (13) displayed an ES of 94% after 4 h, compared to 83% by PP-BGI(N) and 82% PP alone. This corroborates that the high alkaline pH treatment of BGI has an effect on the functional property of BGI-PP admixtures. The presumed high solubility (quantified from OD measurement), better emulsion stability offered by alkaline pH treated BGI, indicates that such a treatment is highly significant prior to the BGI-PP interaction study and their detailed functional property assessment. The study confirms that PP(N) and BGI(13) mixtures are the correct choice for complexing under different solvent conditions to yield preferred functional and physicochemical characteristics that makes it probable for food product development.

TABLE 68
Emulsion stability of PP-BGI admixtures at pH 7

Emulsion Stability (%)
Time (min)

| Sample | 30 | 60 | 180 | 240 |
|---|---|---|---|---|
| PP(N) | 100 | 95 | 90 | 82 |
| PP(N)-BGI(N) | 99 | 91 | 85 | 83 |
| PP(N)-BGI (13) | 100 | 100 | 95 | 94 |

### Example 48: Interaction with Pea Protein and the Suspension Properties

In this disclosure, we have evaluated how critical pHs and biopolymer ratio associated with complexation of BGI and PP impacted BGI-PP suspension stability. As part of this investigation, we have evaluated the interaction of BGI and PP at pHs [8-1.5] within a region viable for food ingredient applications at different mixing ratios [1:1, 2:1, 4:1, 8:1 and 10:1 of PP and BGI, respectively]. Note that we have maximized the solubility of BGI via their pH treatment, mentioned in the previous section for BGI, to establish an optimal mixing conditions that gives better physicochemical and functional properties. The different critical structure forming events, which are defined by the formation of soluble complexes (at pHc) near the isoelectric point (pI) of the protein, the soluble complexes grow in size and number to form insoluble complexes at pH_{φ1}, followed by the electrical neutrality point, where maximum complexation pHₒₚₜ occurs. The complete dissolution of these complexes occurs at pH_{φ2}. The interaction of BGI and PP due to electrostatic, hydrophobic or hydrogen bonding may impact these parameters and hence the physicochemical properties of the mixtures.

The critical pHs were determined by the pH turbidimetric analysis, where the aqueous biopolymer mixtures containing PP and BGI were prepared at a total biopolymer concentration of 0.05% (w/v). The pH was adjusted to 8.0 by adding 1 M HCl, and was gradually lowered to 1.5 by dropwise addition of HCl (a gradient of 0.1, 0.5 and 1N HCl). Turbidity measurements were performed by measuring OD of the solution at each pH (0.5 units) at ambient temperature as a function of pH (pH 8.0-1.5) and biopolymer ratio (PP:BGI; 1:1, 2:1, 4:1, 8:1 and 10:1) using a UV-visible spectrophotometer (Genesys 10 UV/Vis, Thermo Scientific, Waltham, Mass., USA) at 600 nm. OD of homogenous PP (0.05% w/w) and BGI (0.05% w/w) solutions were also determined for comparison purposes. Critical pH values of complex formation were graphically determined as described in Liu et al. (2009). All measurements were carried out in triplicate.

### Effect of pHs on the Turbidimetric Profile of PP-BGI Admixtures

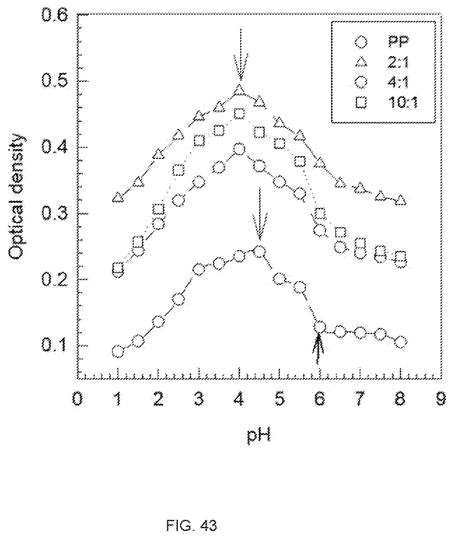

The turbidity curves, from pH 8.0-1.5, of PP-BGI mixtures as a function of biopolymer mixing ratio (PP: BGI; 1:1, 2:1, 4:1, 8:1, and 10:1) along with the homogenous PP are shown in FIGS. 42 A and B. The homogenous PP system demonstrated a bell-shaped turbidity curve as a function of pH, where OD began to rise around pH 6.1 due to protein aggregation and reached a maximum OD (0.21) between pHs 3.8-4.8 where a flattening occurred; OD declined at pH 1.7. Note that homogenous BGI showed the same OD ˜0.20 over the pH range of 7-1 indicating no differences in their measurable OD at different pH (see FIG. 40). This is contrary to other polysaccharides such as pectin, gum arabic (GA) etc., which have no measurable OD when in a homogenous state. This indicates the possibility of BGI aggregation due to a lack of water solubility compared to the remaining polysaccharides. Apart from that, these polysaccharides were structurally different. For example, BGI possessed a lot of weakly ionizable hydroxyl groups compared to pectin and gum arabic which have easily ionizable carboxylate groups on their backbone. These carboxylate anions are responsible for high electrostatic interaction in the above-mentioned food hydrocolloids when they interacted with proteins. There is only a small difference between the turbidimetry profile of PP-BGI admixtures and PP alone (FIG. 43). However, even though there may be a small ionization interaction, from the turbidimetry data, we could confirm that more non-specific interactions such as hydrogen bonding or hydrophobic bonding are prevalent in PP-BGI admixtures than electrostatic interactions. From the turbidity curves, the critical pHs associated with complex formation (pH_{c}, pH_{φ1}, pHₒₚₜ and pH_{φ2}) were determined (Table 115).

Unlike the homogenous PP, the formation of soluble complexes for PP-BGI admixtures occurred above the pI of PP (4.5 in this study), when PP possessed net negative charges. The soluble complexation (pHc) for all the mixtures were observed at pH˜7 (at pH>pI). Further acidification resulted in the second critical pH parameter, the formation of insoluble complexes (pH_{ϕ1}) at pH 5.5. The addition of BGI to PP (for all biopolymer mixtures) had shifted the optimal pHs (pHopt) from pH 4.5 to a lower pH (pH 3.8 to 4). The increased turbidity is either due to the minimal electrostatic complexation and maximum hydrogen bonding and hydrophobic interaction or the formation of PP-PP aggregates. The tendency of aggregation increases with increased protein content of the mixture. The complete dissolution of all the complexes occurred at pH ˜2.

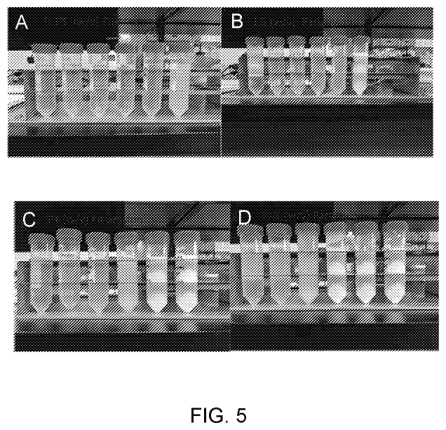

TABLE 115
Critical pH parameters of PP-BGI interaction

| | Critical pHs | | | | |
|---|---|---|---|---|---|
| PP:BGI | pH_{c} | pH_{φ1} | pHₒₚₜ | pH_{φ2} | ODₘₐₓ |
| 1:1 | 6.9 | 5.5 | 3.9 | 1.5 | 0.497 |
| 2:1 | 6.8 | 5.6 | 3.9 | 1.5 | 0.486 |
| 4:1 | 6.9 | 5.6 | 4.0 | 1.5 | 0.387 |
| 8:1 | 7.0 | 5.8 | 4.0 | 1.5 | 0.397 |
| 10:1 | 7.2 | 5.8 | 4.0 | 1.5 | 0.451 |
| PP | 6.1 | 5.4 | 4.4 | 1.5 | 0.245 |

| | |
|---|---|
| BGI | Displayed an OD of ~0.21 in the pH |
| | range pH8-1.5 (see FIG. 5) |

### Effect of Biopolymer Mixing Condition

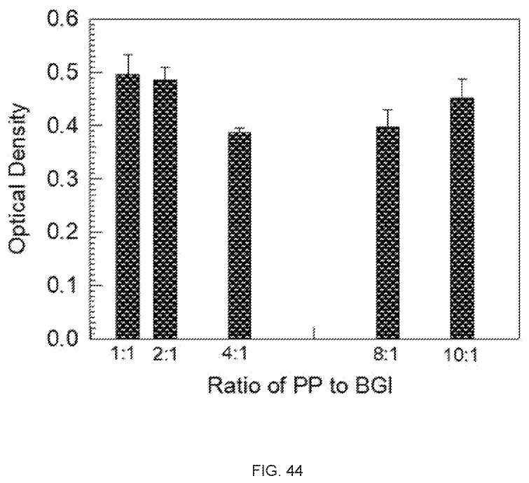

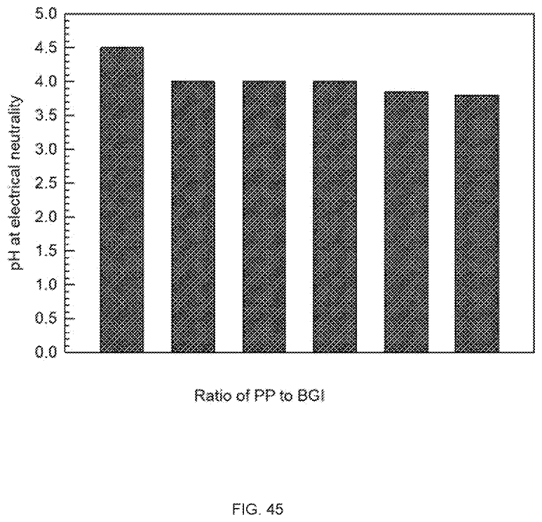

FIG. 44 displayed the maximum optical density of PP-BGI admixtures. The PP complexed with BGI, at 1:1 and 2:1 ratio, displayed a maximum OD ˜0.49 at pH opt ˜3.9, which is the critical pH corresponding to their optimal interaction. However, PP complexed with BGI, at 4:1 and 8:1 ratio, displayed the lowest OD ˜0.39 at pH opt 4.0. This indicates that differences in BGI and PP concentration, and the subsequent aggregation or complexation of the two biopolymers, have substantial impact on deciding the coacervate yield and OD. Considering the turbidity diagram, the maximum OD is attributed either to protein aggregation or hydrogen bonding or hydrophobic interaction of PP and BGI. Thus, based on the OD value we could choose 2:1 (since there is no significant difference between 1:1 and 2:1), 4:1 (since there is no significant difference between 4:1 and 8:1) and 10:1 PP: BGI admixtures for further studies. As seen in FIG. 45, the optimal pH of PP has shifted from pH ˜4.4 to pH ˜3.9 after interaction with BGI, indicating the existence of minor ionic interactions along with hydrogen bonding/hydrophobic interaction.

### Suspension Stability at Critical pHs and Optimal Mixing Conditions

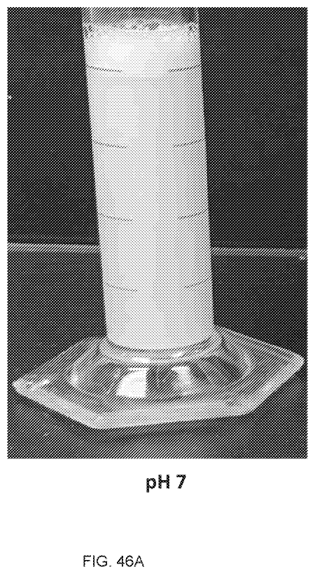

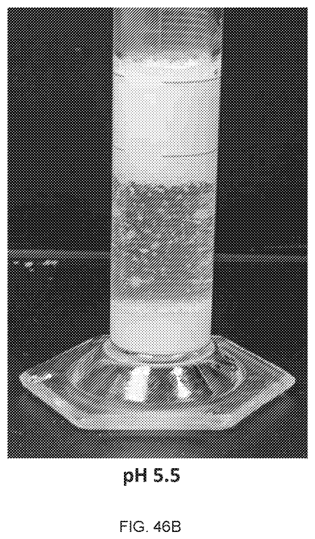

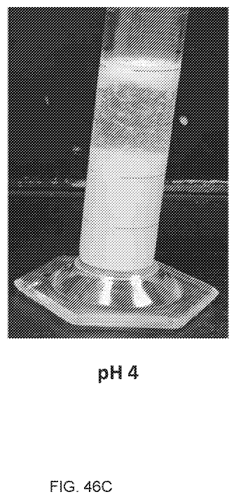

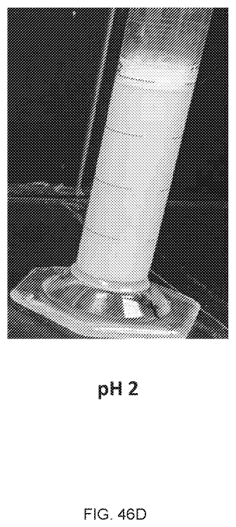

The PP-BGI based suspensions were made at different critical pHs and optimal mixing conditions. The admixtures of PP and BGI were made at different critical pHs (pH_{c}, pH_{ϕ1} and pH_{ϕ2}) at a total biopolymer concentration of 1.0% (w/v), and 20 mL of the solution is transferred into a 100 mL beaker and is homogenized (Omni International, Inc., Marietta, Ga., USA) for 2 min at speed 4. The homogenized solution was transferred into a 25 mL graduated cylinder and monitored for phase separation at time intervals (5, 10, 20, 30- and 1440-min). Measurements were done in duplicate, and results were reported as the mean±one standard deviation (n=2). Irrespective of the ratio, it was found that suspensions were very stable and stayed without phase separation at pH 7 and pH 2 (FIG. 46 A through D). However, at pH 4 and 5.5, the suspensions got destabilized within ˜4 min. The enhanced phase stability of suspensions up to 24 h is due to increased solubility of PP at pH 7 and 2. At pH 5.5, the insoluble complexation begins and at pH 4 maximum complexation was observed. In the case of PPI-BGI admixtures, the increased OD at pH 5.5 and 4 are due to protein aggregation resulting in faster phase separation, and hence, destabilization of suspensions. This study indicates that pH2 and pH7 are best suited for utilization of PP and BGI in the making of beverages or protein shakes. Through ratio analysis, 10:1 was optimal followed by 4:1 for making suspensions at pH 7 and 2. For 10:1 PP:BGI based suspensions, we didn't observe any sedimentation for 20 min, however after 30 min ˜0.1 mL sedimentation occurred, though it stayed constant from 30 min to 24 h. In the case of PP: BGI 4:1, 0.5 to 0.8 mL sedimentation occurred after 10 min and then remained stable until 30 min. Unlike the other two ratios, PP: BGI as 2:1 resulted in 2.5 to 3 mL sedimentation in the first two min, indicating that increasing the BGI content favors more sedimentation. Contrasting to pH 7, the rate of sedimentation was much slower at pH 2 indicating protein solubility is higher at pH 2 compared to pH 7, and hence better phase stability for the suspension. Thus the suspension stability was greater for 10:1 of PP-BGI mixed systems compared to the remaining at pHs 7 and 2, indicating better suitability of BGI for making protein shakes.

### Example 49: Effects of Dialysis on Paramylon Solution and Gel

### Introduction

This study evaluated the effects of dialysis on pH, salt content and concentration of paramylon solutions and gels. Removal of sodium can bring paramylon gels into the food application space.

### Materials and Methods

Paramylon solution was prepared by dissolving paramylon in 1 M NaOH solution at a final concentration of 0.1%, 1%, 2%, 3% and 5% (w/v). Paramylon gel was prepared by adding 1 mL 5% CaCl₂ in 40 mL paramylon solution or by adjusting pH to ˜3.3 using 4 M HCl solution.

5 mL paramylon solution was dialyzed (10,000 Da tubing) against 500 mL water. Water phase samples were taken at 0 min, 10 min, 24 hours and 48 hours for analyses of pH, sodium content, calcium content, colour, and gelation ability.

Sodium and calcium ions were measured by SGS Canada using ICP-MS. Briefly, the sample was digested in concentrated acid and then ionized through high temperature plasma. The ionized mixture was then put through a magnetic field to separate the ions. The results were compared to a standard of sodium or calcium solution and was then quantified.

### Results

### Dialysis of Paramylon Solution

pH value: 0.1%, 1% and 5% (w/v) paramylon solutions in 1 M NaOH solution were dialyzed using the method described above. The pH value and volume variations are shown in Table 73. As indicated, the pH in water phase was significantly increased even after 10 min, and the pH value was equilibrated in paramylon solution phase and water phase after 24 hr of dialysis, regardless of the concentration of paramylon.

TABLE 73
pH and volume variation of paramylon solution after washing.

| | pH | | | | | Volume (mL) | |
|---|---|---|---|---|---|---|---|
| Sample | pHi | 10 min | 24 hr | 48 hr | pHf | Vi | Vf |
| 0.1% | 13.24 | 10.37 | 11.69 | — | 11.83 | 5 mL | 4 mL |
| 1% | 13.33 | 11.503 | 11.72 | | 11.58 | 5 mL | 4.5 mL |
| 2% (gel) | 3 | 6.23 | 5.98 | 5.81 | 5.98 | 5 mL | 5 mL |
| 5% | 13.04 | 8.04 | 11.69 | | 11.86 | 5 mL | 7 mL |

pHi is the initial pH in paramylon phase; pHf is the final pH in paramylon phase; 10 min, 24 hr and 48 hr are the pH in water phase at the stated times. Volume is the paramylon volume; Vi is the initial volume of paramylon volume; Vf is the final volume of paramylon volume. The colour of paramylon in 0.1%, 1% and 2%: those initial colour was white, is not visibly changed; the colour of paramylon in 5%, its initial colour was yellow, becomes white.

Volume change: The volume of the paramylon solution in the dialysis tube decreased for lower concentrations of paramylon (0.1% and 1% (w/v)) but increased for higher concentration (5% (w/v)).

Colour: The yellow colour in 5% (w/v) paramylon solution turned white during dialysis. This is likely due to lower molecular-weight molecules being removed from the paramylon solution. Without wishing to be bound by theory, the lower molecular weight molecules may be products of alkaline degradation of beta-glucan.

### Gel Formation of Dialyzed Paramylon Solution by Adding 5% CaCl₂

5% CaCl₂ was added to dialyzed paramylon solution to investigate gelation behavior. Results are shown in Table 74. It is clear that dialysis highly influences gel formation of paramylon solutions. Without wishing to be bound by theory, effects on gel formation may be due to changes in paramylon concentration and pH.

TABLE 74
Gelation behavior of dialyzed paramylon solution

| | | | Gels behaviors |
|---|---|---|---|
| | | | after 2 days |
| Samples | | Gelation behavior | at −20° C. |
| 0.1% | Before dialysis | Gel formed | |
| | After dialysis | No Gel formed | Phase separation |
| 1% | Before dialysis | Gel formed | |
| | After dialysis | Loose solution | Phase separation |
| 5% | Before dialysis | Yellow; gelling | |
| | | immediately | |
| | After dialysis | Clear gelling slowly | No phase separation |

### Dialysis of Paramylon Gels Prepared Using Calcium Chloride

pH: The pH value and volume variations are shown in Table 75. The pH in water phase increased after 10 min; however, water cannot readily penetrate a paramylon gel when compared to a paramylon solution. This changes the volume of water that can enter the dialysis tubing, where a larger volume can enter the dialysis tubing containing paramylon solution compared to dialysis tubing containing paramylon gel.

TABLE 75
pH and volume variation of CaCl₂ paramylon gels after dialysis.

| | pH | | | | Volume (mL) | | Sodium | | Calcium | |
|---|---|---|---|---|---|---|---|---|---|---|
| Sample | pHi | 10 min | 24 hr | pHf | Vi | Vf | BD | AD | BD | AD |
| 1% | 13.302 | 9.516 | 10.385 | 12.326 | 5 | 4.5 | 20000 | 720 | 300 | 300 |
| 3% | 13.232 | 9.155 | 10.937 | 12.079 | 5 | 5.1 | 19000 | 650 | 300 | 260 |
| 5% | 13.180 | 7.135 | 10.525 | 11.926 | 5 | 5.5 | 19000 | 760 | 290 | 240 |

pHi is the initial pH in paramylon phase;
pHf is the final pH in paramylon phase;
10 min, 24 hr and 48 hr mean the pH in water phase at the stated times from the beginning of dialysis. pHi is the initial pH, pHf the final pH. Volume is the paramylon solution volume;
Vi is the initial volume of paramylon solution;
Vf is the final volume of paramylon solution;
BD: before dialysis (mg/L);
AD: after dialysis (mg/L)

Volume change: The volume of the paramylon gel in dialysis tube decreased for lower concentrations (1% (w/v) paramylon) but increased for higher concentration (3% and 5% (w/v) paramylon). To give a clear conclusion, more samples with varied concentrations should be tested.

Sodium and calcium ion content: Sodium ion content of paramylon phase of the paramylon gels decreased after dialysis. Without wishing to be bound by theory, this may be due to the pH of paramylon gels, before and after dialysis, not yet being equilibrated, such that water had not fully penetrated the gels in the dialysis tubes. Without wishing to be bound by theory, the sodium content can be diluted by the ratio of paramylon gel volume and the water volume, meaning in a ratio with a small amount of paramylon gel to a large amount of water used for dialysis to give enough dialysis (volume) time to allow pH in both gel phase and water phase to reach to an equilibration, thereby raising the pH of the paramylon gel and lowering the sodium ion amount in the gel. In addition, since there was a decrease in the sodium ions in the paramylon gels, a liquid paramylon solution may have a larger amount of sodium ions removed from the solution than the gels as there is an increased diffusion of the water and salt ions between two liquids, as compared to the case where the diffusion is between a gel and a liquid.

The results show that calcium ion content in the paramylon phase remains relatively stable following dialysis. Without wishing to be bound by theory, any slight decrease of calcium content may be due to changes of paramylon solution volume during dialysis. Furthermore, the lack of calcium ions diffusing from the paramylon phase to the water phase indicates strong bonding of calcium ions with paramylon gel.

Dialysis of Acidic Paramylon Gels Prepared Using Calcium Chloride

2% acidic paramylon gels were prepared and dialyzed using the methods described above.

pH: pH value and volume variations are shown in Table 76. The pH in water phase decreased after 10 min, whereas the pH equilibrated in paramylon gel and water phase after 24 hours of dialysis.

TABLE 76
pH and volume variation of acidic paramylon gel after washing.

| | pH | | | | | Volume (mL) | |
|---|---|---|---|---|---|---|---|
| Sample | pHi | 10 min | 24 hr | 48 hr | pHf | Vi | Vf |
| 2% (gel) | 3 | 6.23 | 5.98 | 5.81 | 5.98 | 5 mL | 5 mL |

pHi is the initial pH in paramylon phase; pHf is the final pH in paramylon phase; 10 min, 24 hr and 48 hr mean the pH in water phase at the stated time from the beginning of dialysis. Volume is the paramylon phase (gel) volume; Vi is the initial volume of paramylon volume; Vf is the final volume of paramylon volume.

Volume change: The volume of the paramylon gel in the dialysis tube did not change.

Sodium contents: The sodium contents before and after dialysis are shown in Table 77. 5 mL acidic 2% (w/v) paramylon gel was dialyzed against 500 mL water. After equilibration between gel phase and water phase has been reached unexpectedly 44% BGI granules at 40 C showed as shearing-thickening behaviour when shearing rate below 6 l/s, the sodium content decreased by 100 times, meaning the gel and dialysis tube did not hinder the diffusion of sodium.

TABLE 77
Sodium contents in acidic 2% (w/v) paramylon gel

Sodium Content (mg/L)

| Samples | Before Dialysis | After Dialysis |
|---|---|---|
| Acidic 2% (w/v) | 17000 | 170 |
| paramylon gel | | |

### Conclusions

This study tested the dialysis behaviors of paramylon solution in 1 M NaOH gels prepared using CaCl₂ and HCl with respect to pH, sodium concentration and sample volume. This study evaluated dialysis as a potential way to achieve desired functionality in food applications for paramylon solution and gels in a cost-effective way.

Evidently, dialysis of both the paramylon solution and paramylon gel has a significant effect on pH. The pH of the paramylon solution can be equilibrated with the water phase after 24 hours as the final pHs were similar to that at 24 hours (˜13.2 to ˜11.8). Acidic paramylon gel also equilibrated with water phase after 24 hours whereby the pH of the 2% (w/v) gel changes from 3.3 to ˜5.9. However, CaCl₂ paramylon gels hinder pH equilibration with water phase. After 24 hours of dialysis, the pH of the CaCl₂ paramylon gel is ˜12.0 (compared to the initial value of 13.2), but the pH of water phase is between 10.3 and about 10.9.

The volume of paramylon solution and paramylon gel changes during dialysis due to water exchange between paramylon and water phases. Due to the equilibrium between the paramylon and water phases, the direction of water movement is dependent on the concentration differential across the dialysis membrane. Generally, compared with pH variation, the volume variation is not a primary factor.

During the dialysis of 5% (w/v) paramylon solution, the colour changed from yellow to white. Without wishing to be bound by theory, this may be due to removal of hydrolyzed by-products from the paramylon phase. This shows that dialysis is useful for clarifying or whitening a paramylon solution.

The sodium content was equilibrated following dialysis and was diluted by 100× when 5 mL paramylon gel was dialyzed using 500 mL deionized water (see for example, results from acidic paramylon gel as shown in Table 77).

As shown in this study, dialysis is a practical way to remove sodium from paramylon gel.

### Example 50: Ready to Gel (RTC)

Creating a water dispersible powder that produces thickening/gelling properties upon rehydration and can be incorporated into food formulations without affecting the taste profile can be a valuable product. Citric acid induced gels of solubilized paramylon have shown the ability to reconstitute into gels after being dried and, compared to other studied paramylon gels, possess superior characteristics. As a result, we have started to refer to reconstitutable citric acid powder as RTG powder; as it can be used for the above-mentioned properties in food formulations.

### Drying Method

Spray drying works under the principle of maximizing surface area to rapidly evaporate a carrier solvent through injecting a liquid slurry with the desired product suspended in a solvent as a mist into a heated chamber wherein the high surface area and heat cause near instantaneous evaporation of the solvent. Because of the high surface area to volume ratio the effects of evaporative cooling become pronounced and also serve to prevent the suspended phase from experiencing the potentially destructive high temperatures associated with other thermal drying techniques. As the mist evaporates its liquid phase, solid particles remain suspended in the carrier gas, which in the case of this experiment is air. The carrier gas is forced through the system by action of a blower, in a co-current configuration where the gas flows from the atomization nozzle where the slurry is injected into the drying chamber towards a cyclone separator which captures the particles by virtue of their greater density than air. The moist air formed after evaporation is removed immediately above the cyclone separator. However, the spray drying efficiency of citric acid gels has been shown to be very low. One possible explanation could be that the 3D gel network that is created in a citric acid gel could be hindering the ability of the spray dryer to instantaneously evaporate the water trapped within the particles. This would affect the moisture of the particles and their ability to be carried through the system to the cyclone. A potentially simpler explanation could be that the gel network is causing problems at the atomization nozzle; not allowing the proper mist to be formed and consequently affecting the evaporation. Both instances would explain the large portion of material that encompasses the main chamber at the end of drying runs. Comparatively, freeze drying is a more efficient process and there is no difficulty in completely removing the moisture from the gels. Freeze dried RTG can easily be ground into powder and produces a viscous gel solution when reconstituted at concentrations ˜10%.

### SEM of RTG

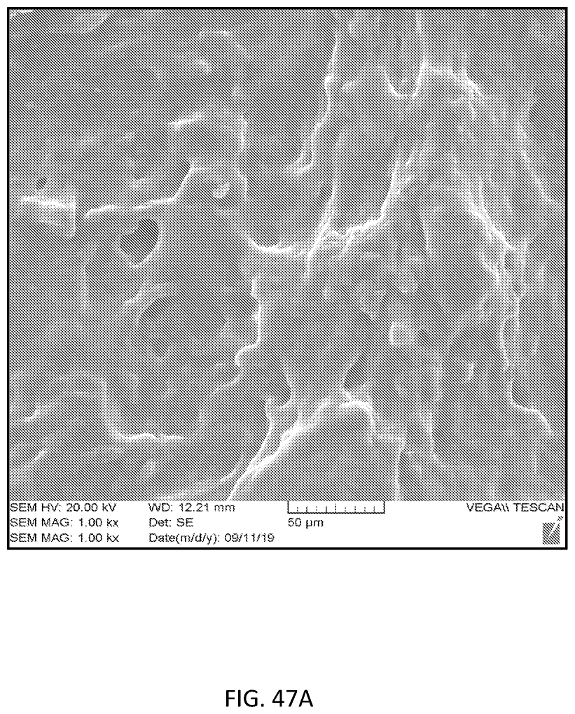

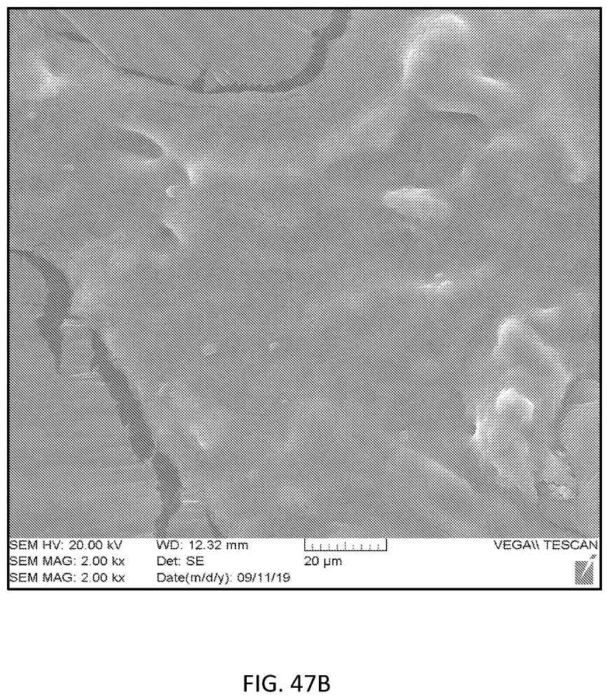

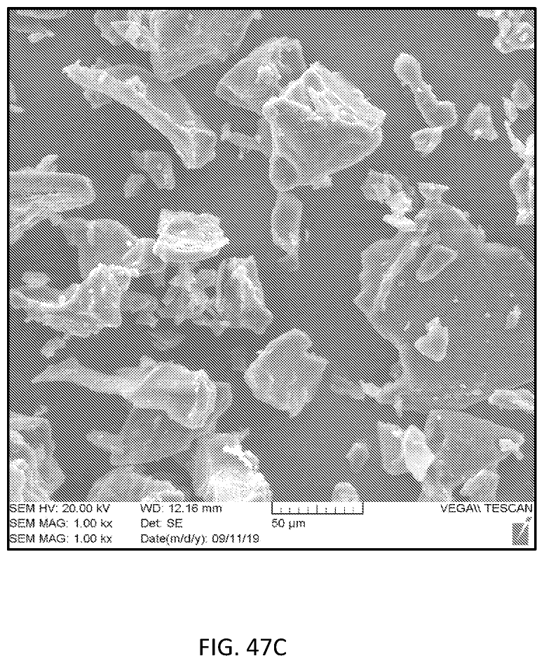

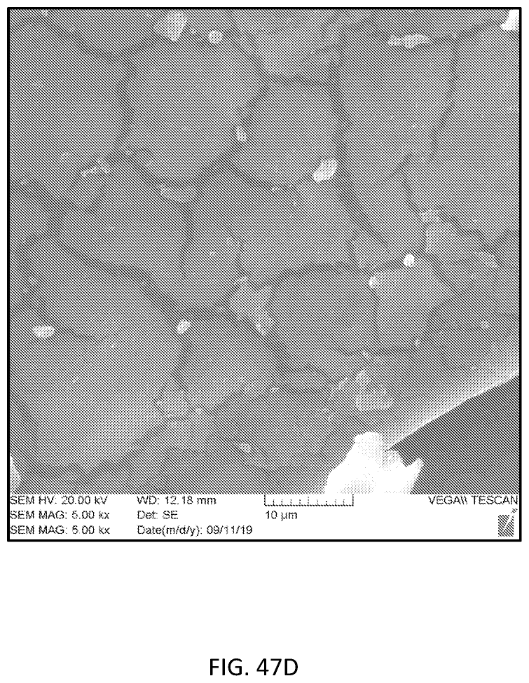

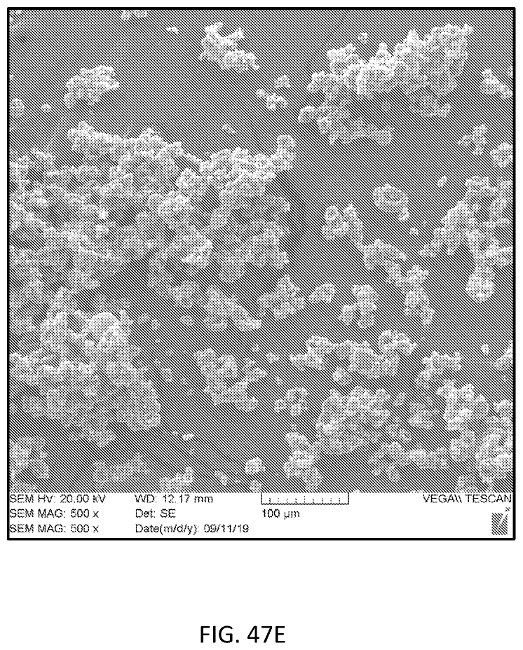

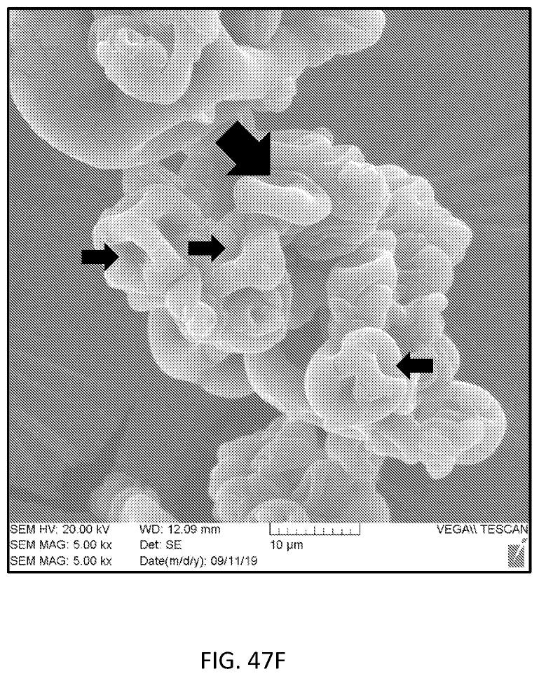

Three forms of RTG were observed as seen in FIG. 47 A through F. It can be seen that no paramylon granules are present in wet RTG samples. Its surface contains many cavities and pockets due to the increased surface, although overall it is still smooth and contains few loose particles. The wet RTG can resemble freeze-dried RTG much more than spray dried RTG. Freeze dried samples resemble fractured glass and have a predominantly smooth surface that contains some small attached particles, but granules are no longer present.

Spray drying resulted in clumping of the material. Individual particles have a consistent multi-concave shape to them, almost resembling red blood cells. This likely occurs from the contact of air molecules and the beta-glucan, which is malleable from the increase in temperature as it is being sprayed at high pressure; causing the concave sides that can be seen on most particles (arrows).

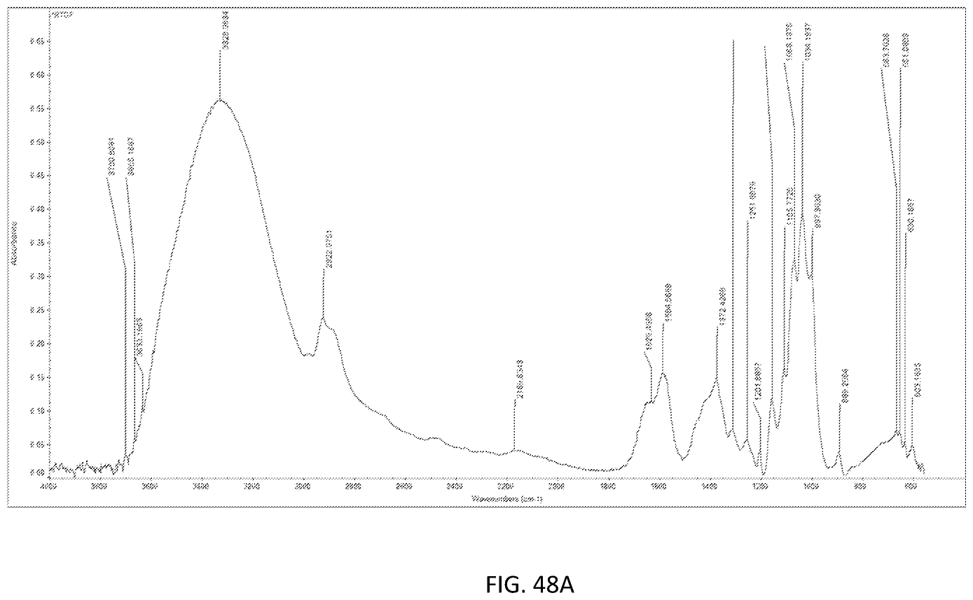

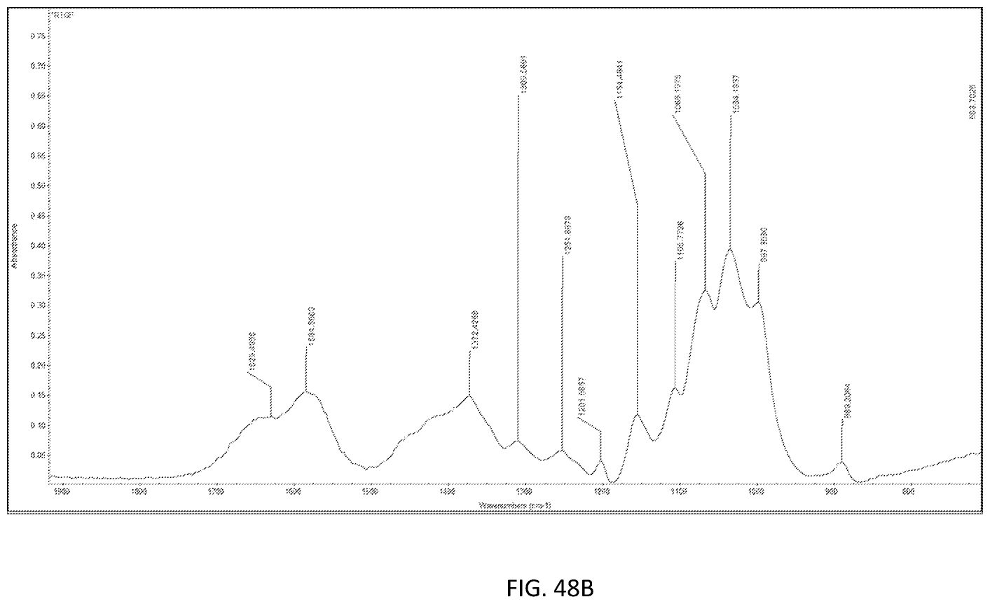

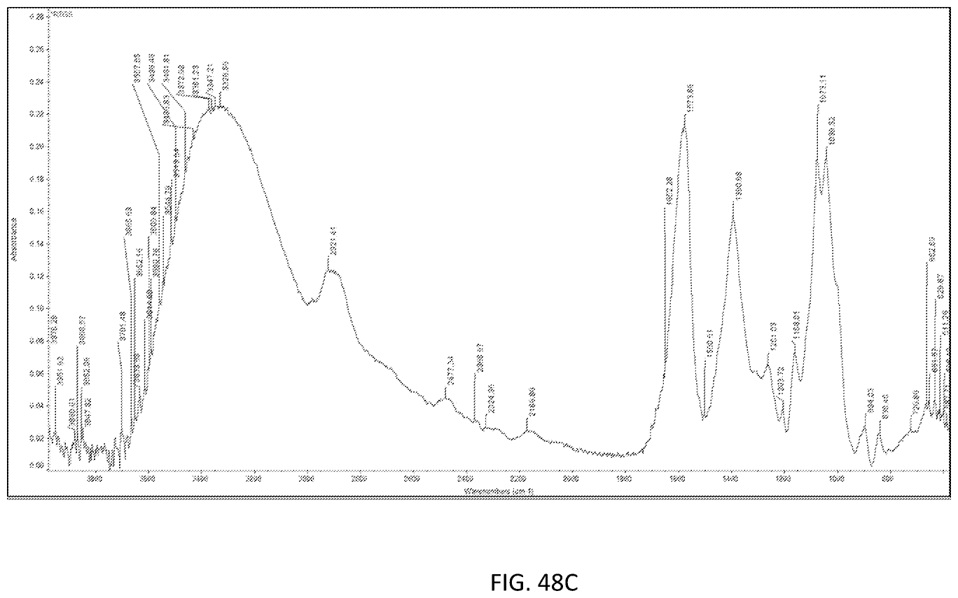

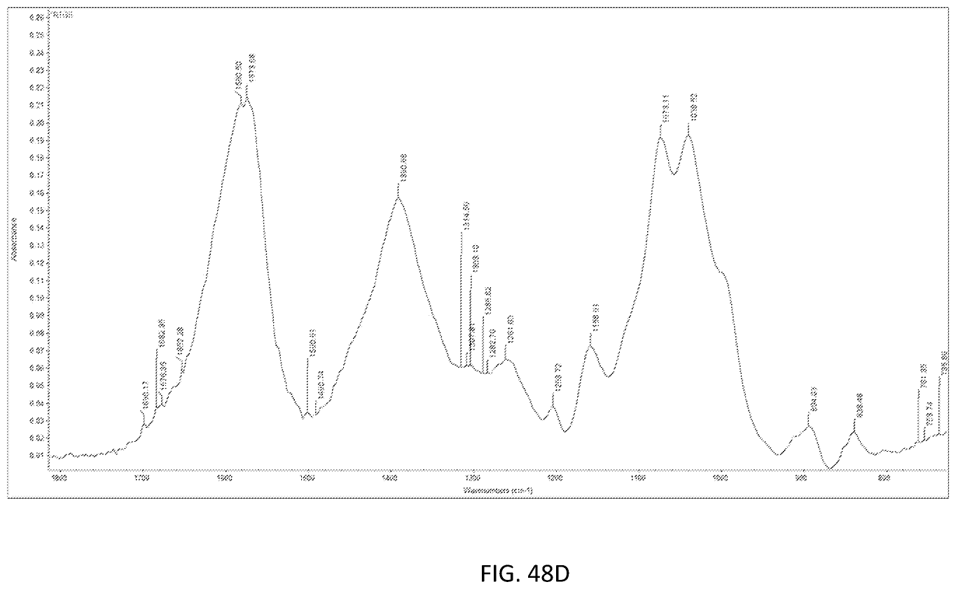

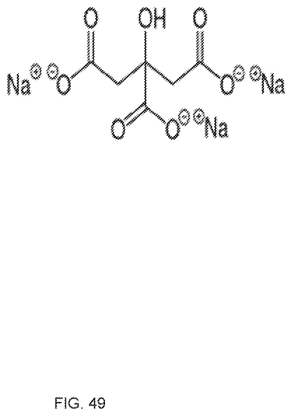

The structure of the sodium citrate is shown in FIG. 49, and the FTIR spectrum is seen in FIG. 48 A through D. Not surprisingly, RTG contains sodium citrate factors into its FTIR spectra. The intense lines at 2880 and 2922 cm⁻¹ are attributed to the out of phase and in phase CH₂ stretching vibrations. The corresponding deformation mode is to be found in the region 1270-1304 cm⁻¹. The bands at 1387 and 1580 cm⁻¹ are due to asymmetric and symmetric oscillations of the carboxylate ion. The deformation vibration of this group manifests itself as two medium bands at 842 and 893 cm⁻¹. The bands between 1300 and 1070 cm⁻¹ are ascribed to the oscillations of the C—OH group.

For the freeze drying RTG, the factors of citrate were clearly shown on its FTIR. The band at 1600 cm⁻¹ can be evidence of ester groups formed between citrate and glucose functioning as a cross-tinker,

Compared to freeze dried RTG, spray dried RTG gave stronger citrate factors and weaker glucan factors. This is evidence that there is more citrate in spray drying RTG. This matches what we found in the thermal study.

Overall, the treatments of paramylon change the chemistry of the glucan or its environment. This leads to variations in the FUR spectra of RTGs.

### Example 51: Milled Paramylon

This study is to investigate the effect of physical modification on the properties of BGI. Milling was done on a small scale in-house and on a larger scale (so-called CMC-milling method) by a contractor, CMC-milling co.

### Small Lab Scale

### Preparation

The milling was done in a 15 mL metal cylinder using 5 mm metal beads by a ball miller. 1 g of BGI and with/without 4% NaCl or sugars was grinded for 5 min and then cold down in 5 min, repeated the procedure until the accumulated time to 1 hours. The milling progress was detected using microscopy. When a dry sample was used, it was referred to as dry milling. When a wet sample was used, it was referred to as wet milling samples that were generated by using the 1 g dry sample, but at a concentration of 20-25% in dH₂O.

### Effects of Milling Conditions

### Effect of the Density of Metal Beads

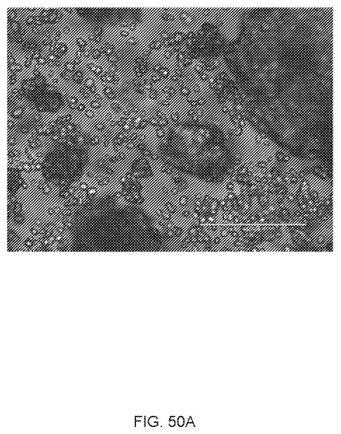

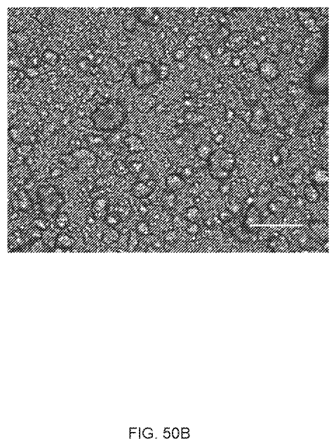

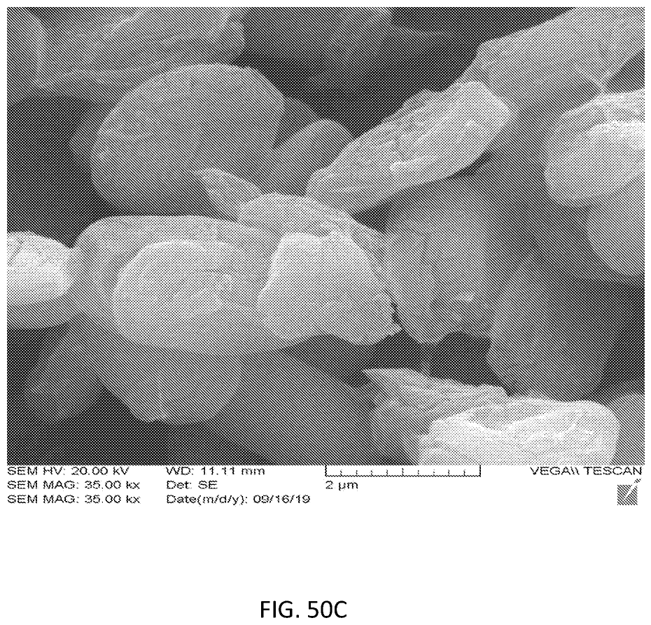

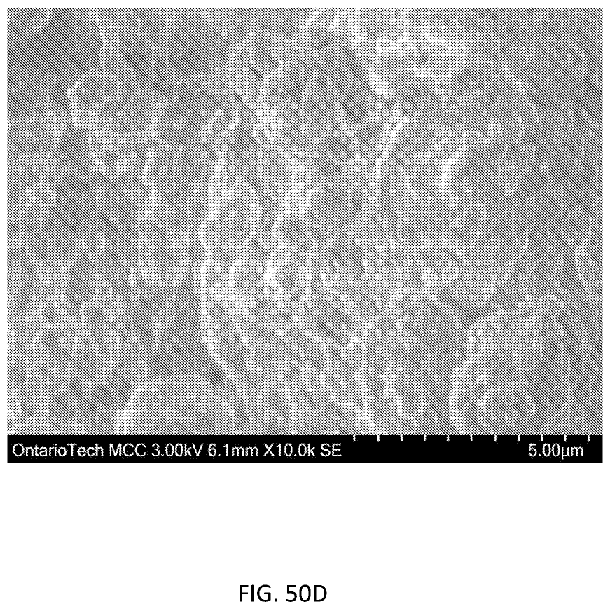

5, 20 and 40, 5 mm metal balls in 15 mL metal holders were used to evaluate dry milling efficacy. The milling progress was evaluated using microscopy. FIGS. 50 A-D are representative images of the milling results.

As seen in FIG. 50 A through D, when 5 or 20 metal beads were used, paramylon granules were relatively intact with partially broken structures observed with SEM. Alternatively, when 40 metal beads were used, paramylon granules were completely broken. These results indicate that particle size is hard to control with milling alone as they were either completely broken (40 beads) or relatively intact (5 or 20 beads).

### Dry Milling Vs Wet Milling

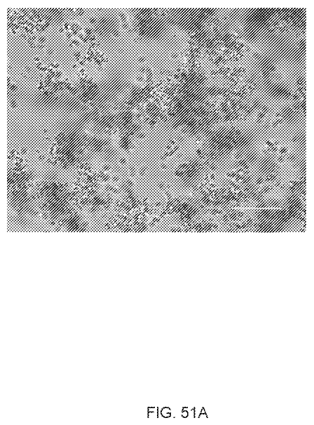

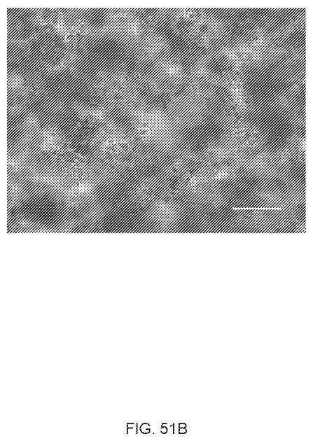

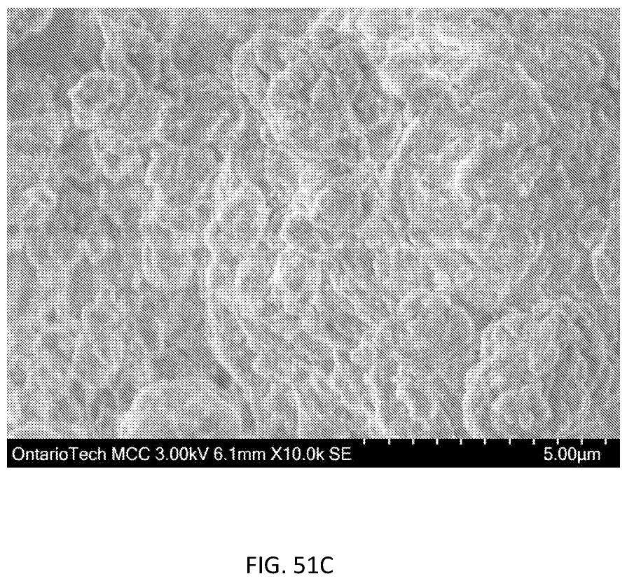

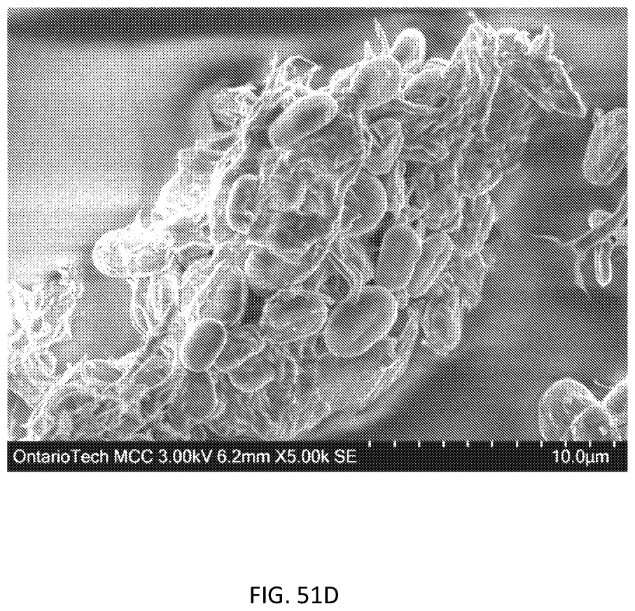

The same procedure was utilized for wet samples with a BGI concentration of 20 or 25% in water. In general, viscosity increased with increased milling time (FIGS. 51 A-D. Due to the build-up of high viscosity during milling, milling was hindered and could not be completed (FIGS. 51 A-D. However, the milling degree increased with a reduction of the concentration of BGI in the milling process.

As known, the forces in the BGI granules are mainly intra-triple helix hydrogen bonding to form crystal. With the grinding forces, BGI granules were elongated (clearly seen in FIG. 51 D) and are forced to build inter-triple helix hydrogen bonds. Lower solubility of MP in DMSO compared to BGI is one of the evidences for the exist of the inter-triple helix hydrogen bonds. When water was applied during milling, water can be trapped into the inter-triple helix hydrogen bonding to form a swollen/gel material with high viscosity. As well, water can also be possibly brought into a triple helix structure with this grinding force.

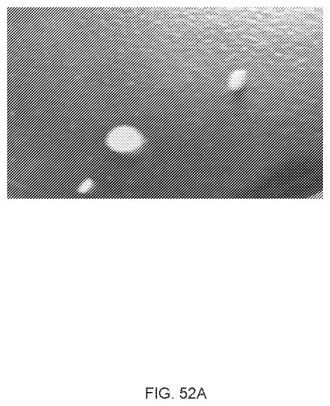

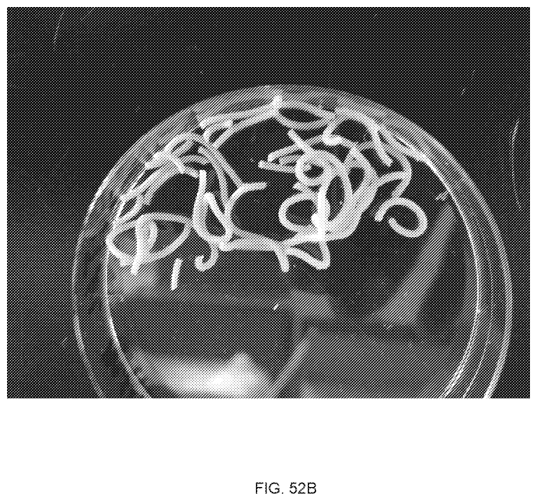

It is very interesting that the wet milled BGI gave fibre-like materials and granules. This material can be shaped into a very hard sphere/pellet, or a relatively stiff rod-like object (FIGS. 52 A and B. Polysaccharide fibres have been reported as drug delivery agents and for regenerative engineering devices. Linear fibrous paramylon structures have also been used for chronic wound healing. Taken together, our milled paramylon could be a good candidate for drug delivery/regenerative medicine applications.

Dry Milling and then Wet Milling

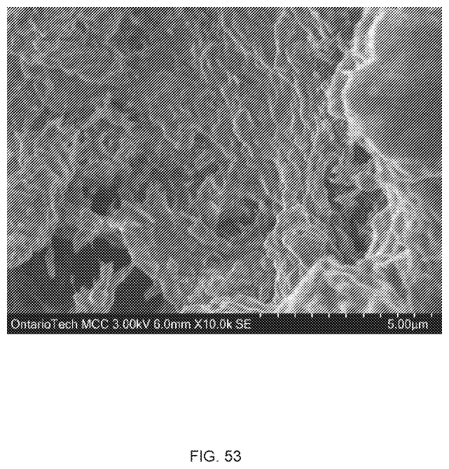

BGI was also milled using the following protocol: dry milling with 40 beads in a 15 mL milling vessel for 1 hour to break down all paramylon granules followed by wet milling in the same vessel using 4 mL water for 1 hour. The SEM is shown in FIG. 53 and as can be seen that the milled BGI gave a continuous structure.

### Co-Milling

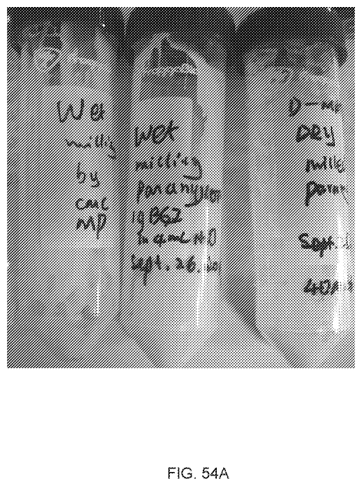

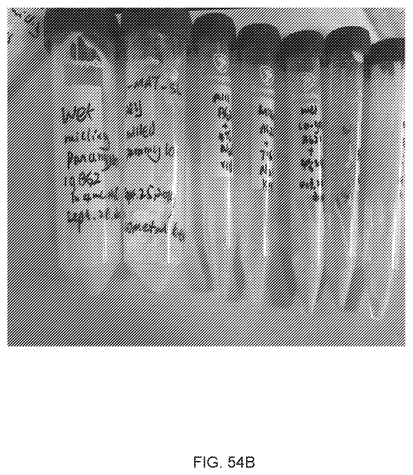

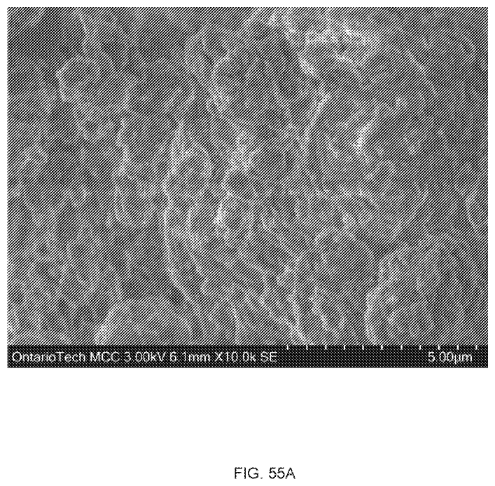

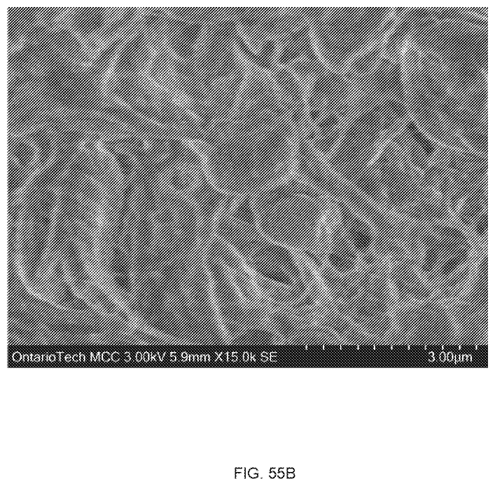

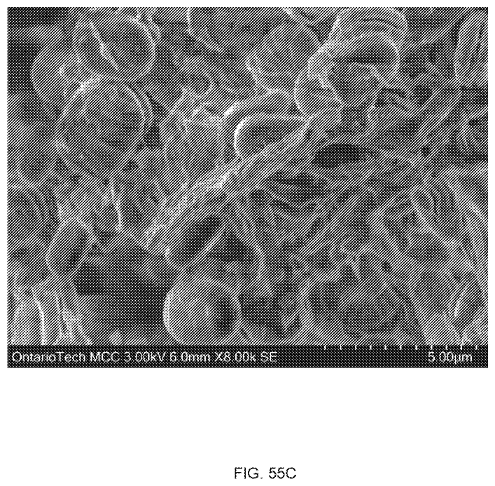

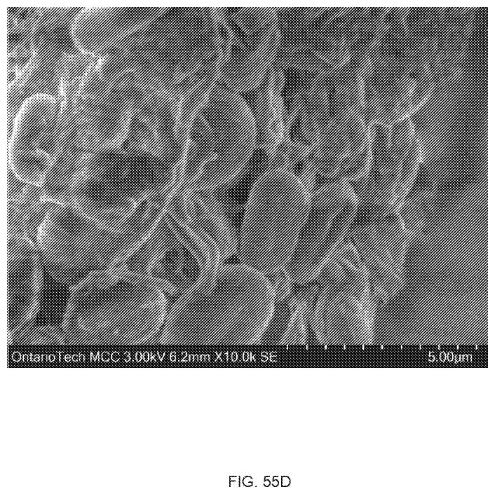

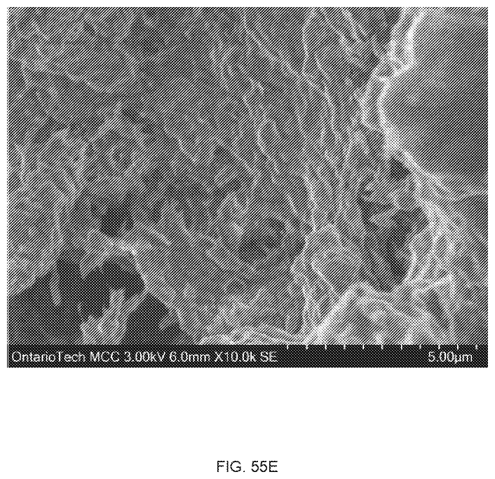

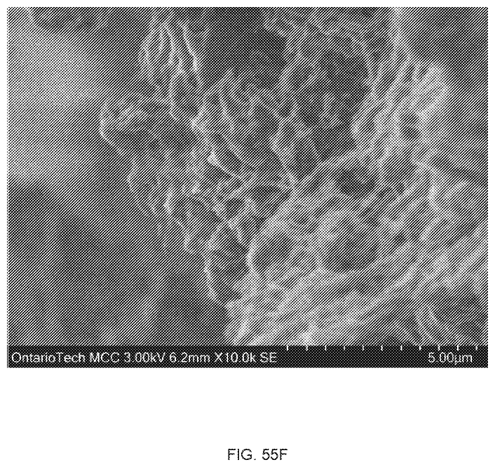

We also milled BGI with NaCl and Sucrose and the appearance of co-milling samples is shown in FIGS. 54 A and B with representative SEMs in FIG. 55 A through F. In general, the co-milled paramylon products were similar to milled-BGI itself. Whereas dry milling can break the granules completely, wet milling partially elongates the granules as single fibers. Interestingly, the co-milling with sucrose increases the whiteness of BGI.

### FTIR

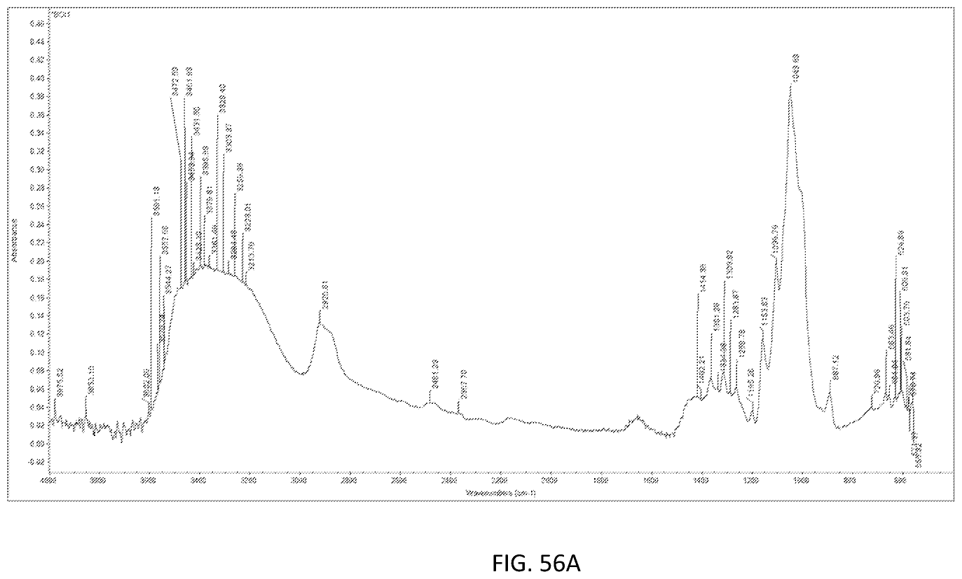

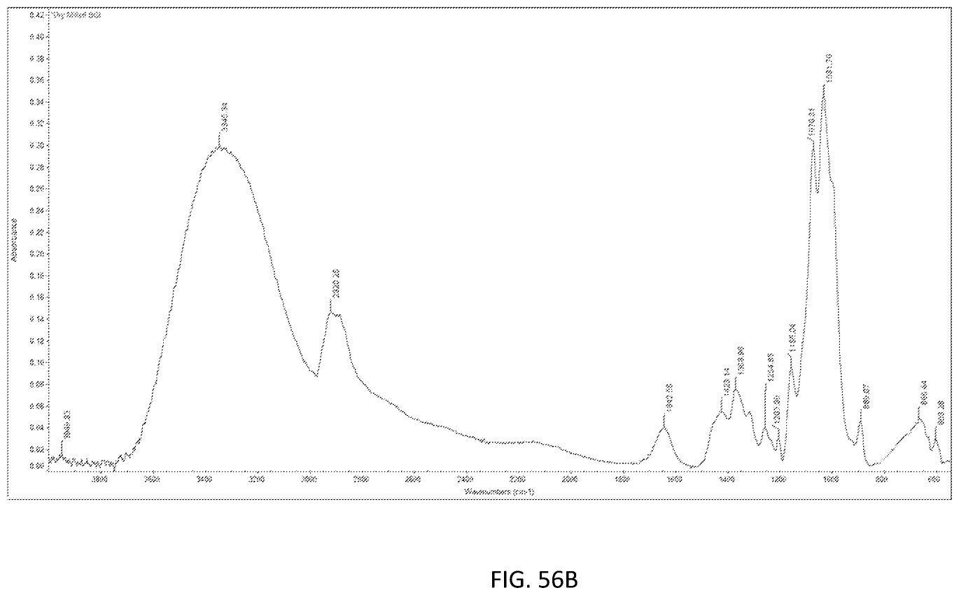

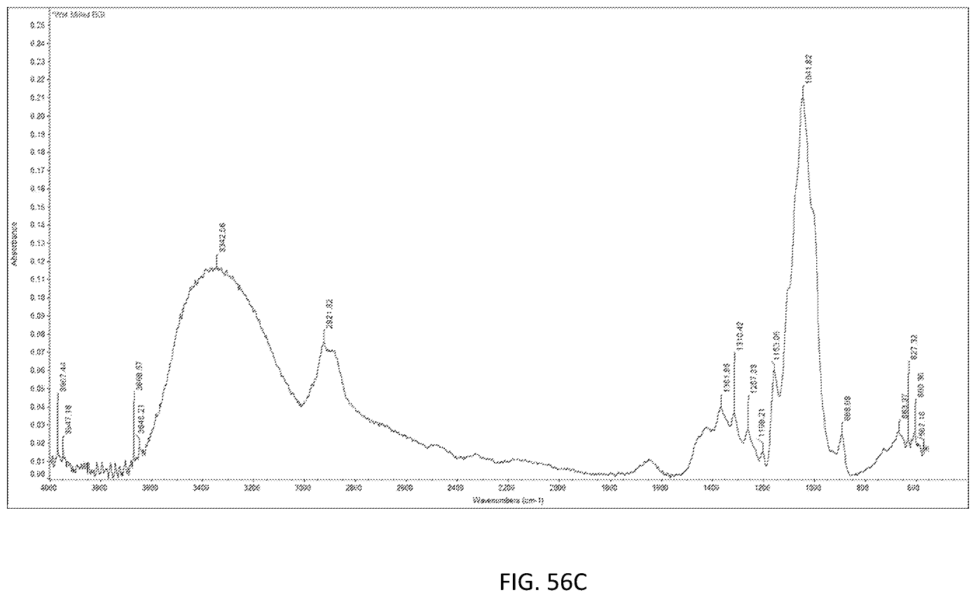

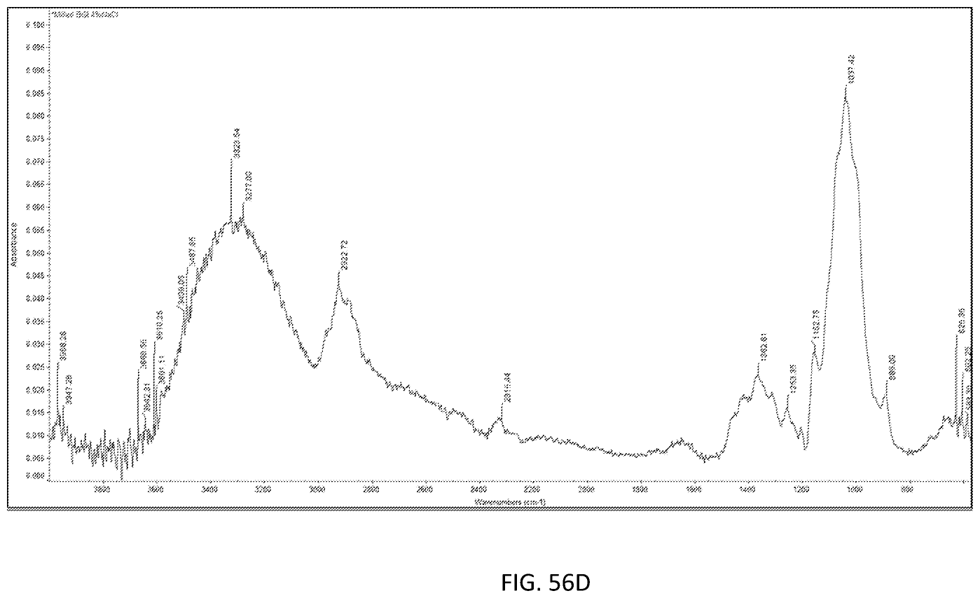

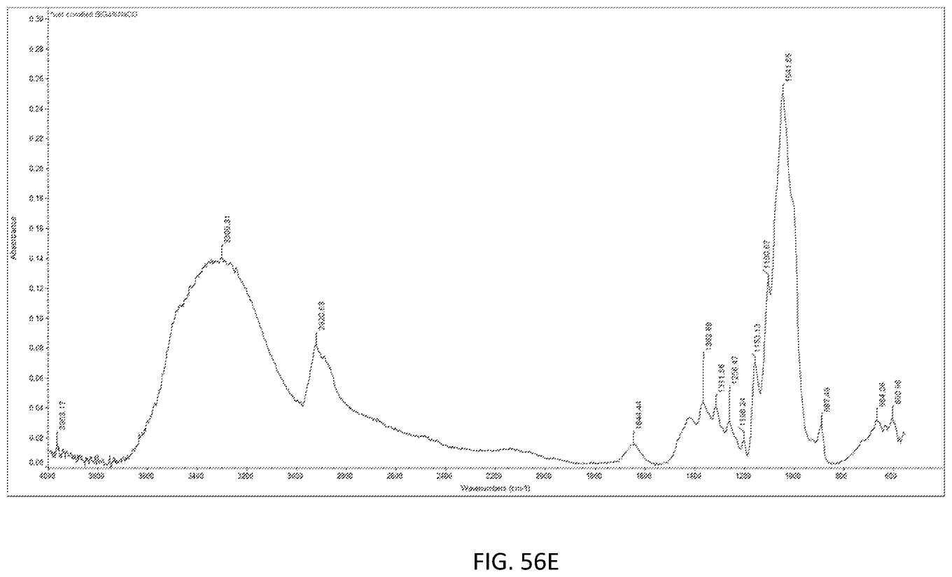

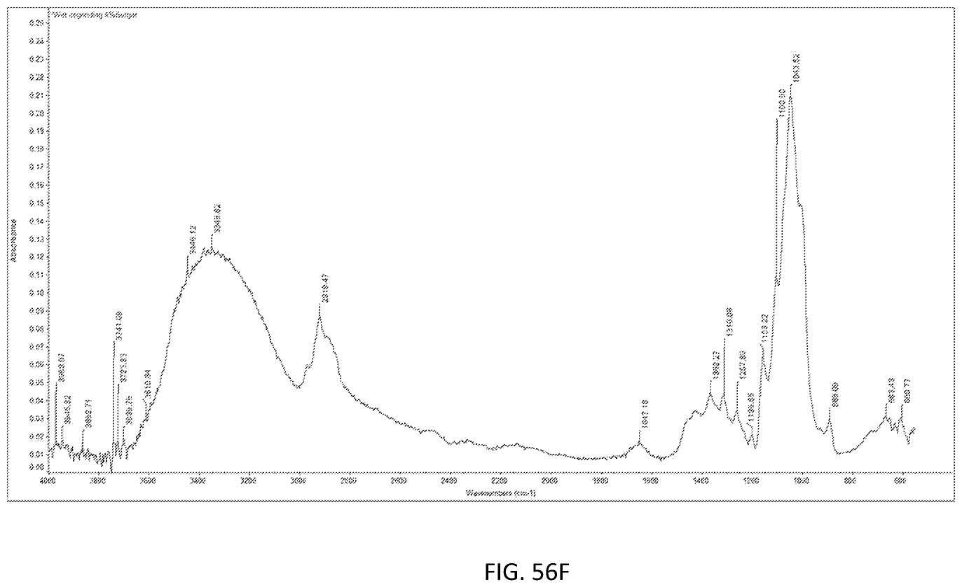

FTIR is a powerful tool for understanding the structure of polysaccharides like starch, cellulose, chitin etc. It is particularly useful to identify functional groups and molecular configurations. It is sensitive to changes in structure at the molecular level, for example, chain conformation, helicity, crystallinity, and retrogradation processes. Paramylon FTIR has been reported above. Briefly, in BGI, free or hydrogen bonding —OH stretching vibration present at 3200-3500 cm⁻¹, C—H stretching band at 2850-2920 cm⁻¹, C-6 related CH₂ scissoring motion present at 1420 cm⁻¹; the C—H bending (at 1350 and 1260 cm⁻¹), O—H in-plane bending (1334 and 1200 cm⁻¹), and CH₂ wagging (1260 cm⁻¹) are also detected. The sugar structure was confirmed by the bend at 1160-950 cm⁻¹, related to the C—O—C(1153 cm⁻¹), C—O (1041 and 1002 cm⁻¹), —OH (1099 cm⁻¹) and C—C (1153 cm⁻¹) stretching or bending in sugar body. C-1 related motions present at 887 cm⁻¹. The bands at 1153 cm⁻¹ and 887 cm⁻¹ also confirm the existence of beta-glucan. The absence/very small peak at ˜930, 850 or 760 cm⁻¹ suggests no or very low quantities of alpha-glucan. No structural change was observed during milling (FIG. 56 A through F).

### Settling Study

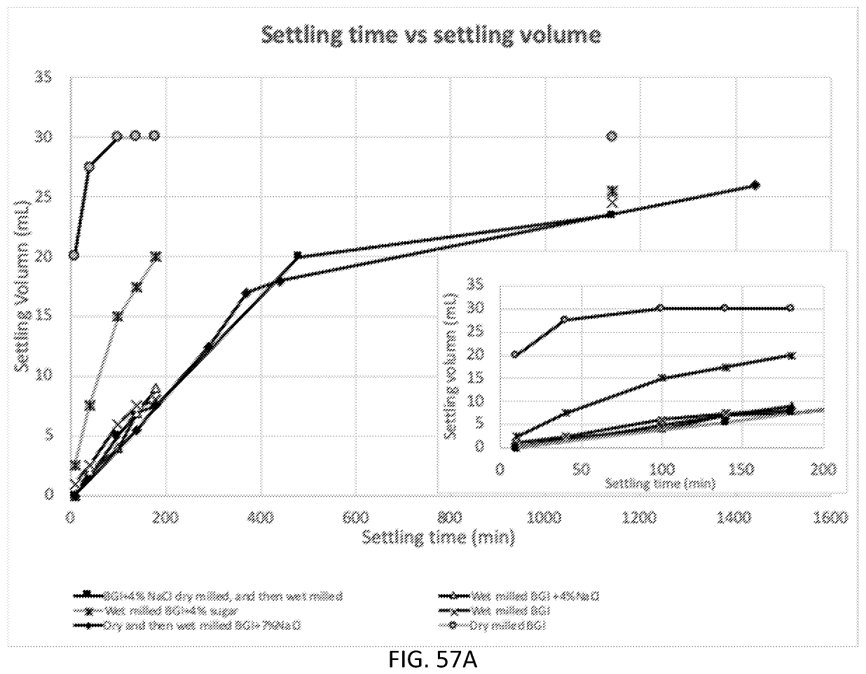

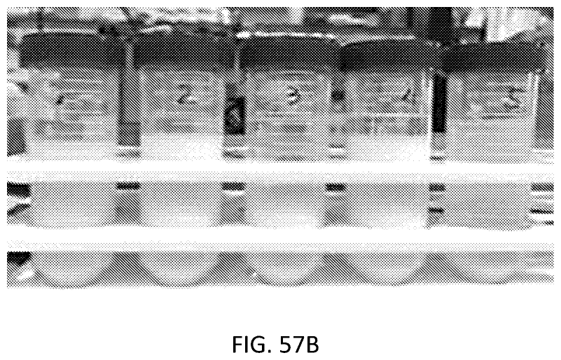

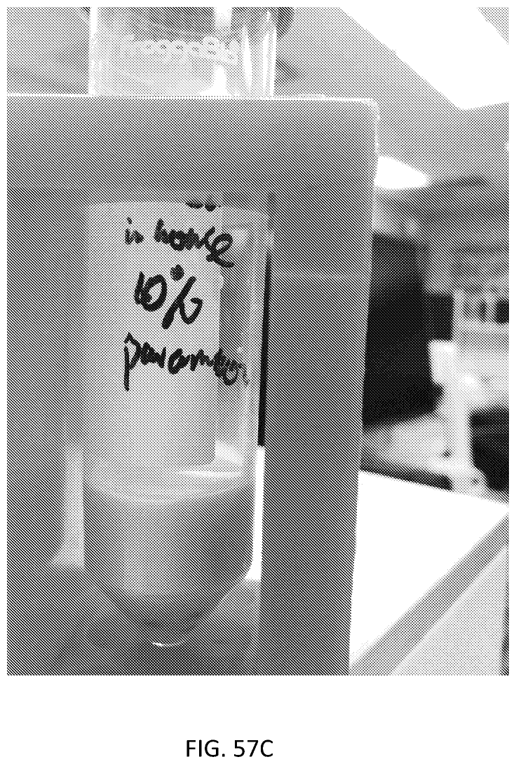

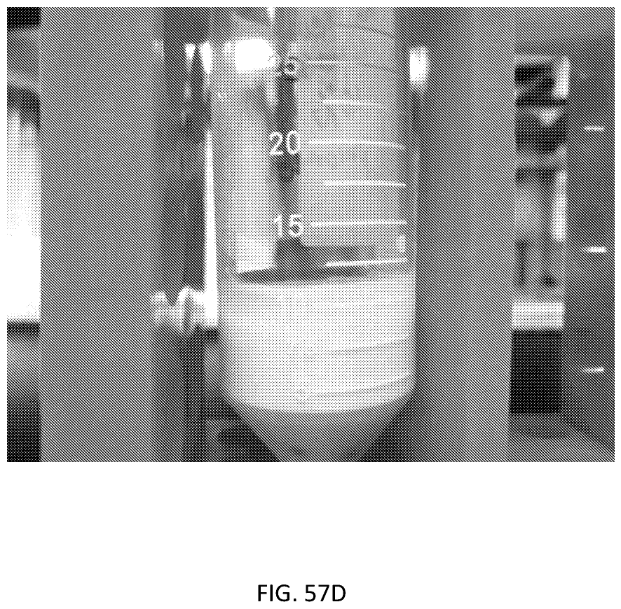

1 g milled BGI was washed into a 50 mL test tube and diluted into 40 mL using dH₂O. The settling volume was recorded at different times. The results are shown in FIG. 57 A through D.

One can see that the settling time highly depends on milling method. Dry milled BGI settled faster than BGI itself (result now shown) and much faster than wet milled BGI. Interestingly, co-milling with sucrose gave the fastest settling time. It should be noted that the final settling volume did not depend on co-milling method or co-milling agents. They were all settled from 40 mL down to 11 mL (˜72.5% settling) compared to BGI which was settled from 40 mL down to 4 mL (˜90% settling).

### Milling of Paramylon Biomass

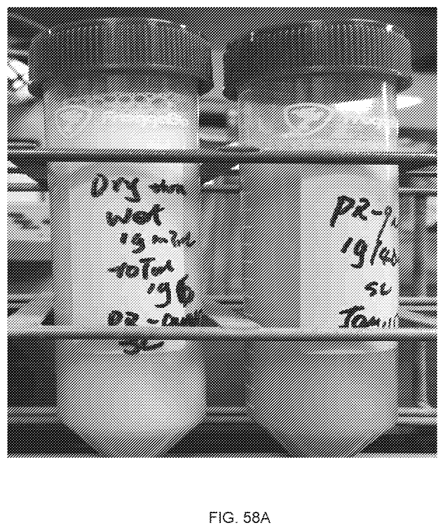

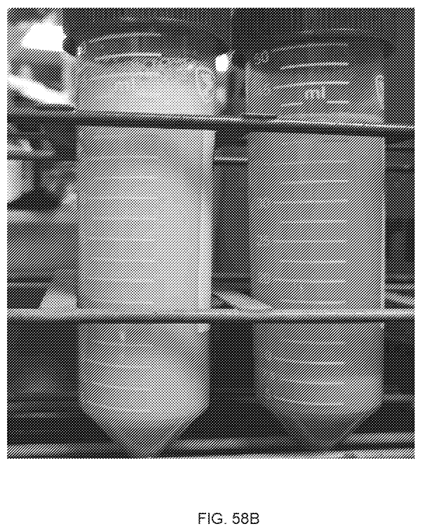

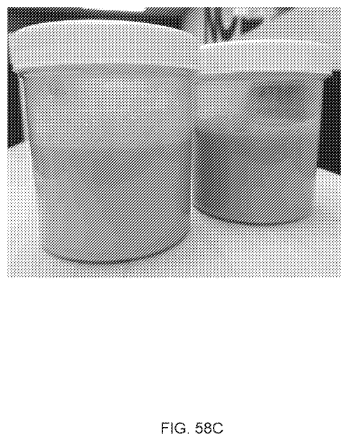

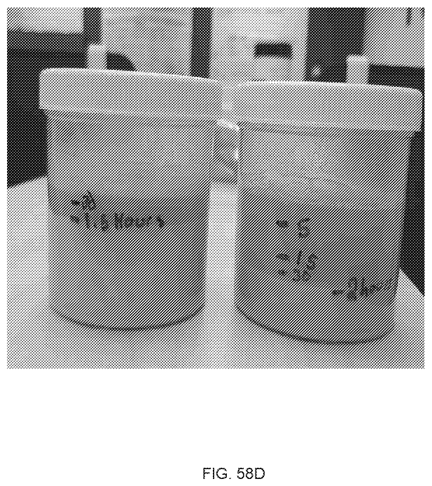

The milling process was also applied on Euglena biomass. A biomass flour produced by Noblegen was used. Two sets of the milling vessels were used for biomass. a, 1 g in a 15 mL milling vessel with 40 metal beads was employed for dry milling followed by wet milling. b, 5 g in a 50 mL milling cylinder with 100 metal beads was used in a dry form. After milling for 1-hour, the milled samples were much lighter in color, and settling was slower compared to non-milled samples, as seen in FIG. 58 A through D.

### Large Scale—CMC-Milling

Large scale milling of paramylon was prepared from with the following procedure using a bench top 2 HP High Speed Disperser in a two-gallon stainless steel mixing vessel.
Transfer slurry to mill feed tank equipped with low speed turbine style mixer to keep product blended and in suspension during milling.
Begin “recirculation” through CMC 1.5 Liter Horizontal Media Mill charged with a 75% load of 0.4-0.6 mm zirconium oxide beads.
Mill circulation rate at 9.1 gallons/hour. Note: product viscosity increased and became a problem as particle size decreased.
Stopped milling at 2.5 hours due to viscosity.
Sample pumped through the mill for one final pass into a container for shipment.
Approximately 1.2 gallons of milled paramylon slurry was created @10% solids.

### FTIR of Milled Paramylon in a Large Scale

As confirmed by thermal studies, milled paramylon contains around 16% water that is bonded to the glucan-chain and this could affect the vibrational environment of the functional groups. As shown using FTIR, there are few changes in the FTIR spectrum of the milled paramylon compared to its native paramylon granules.
a. The stretching vibration moves to a lower frequency.
b. A new band appears at 2977 cm⁻¹ that is related to the stretching vibrations of —CH₂ of C6. The hydrogen-bonding of the —CH₂OH with water molecules can lead to the —CH₂ stretching easier or lead to an asymmetric stretching vibration.
c. Not surprisingly, more bonding water was shown at 1646 cm′
d. The —OH related to vibrations are also changed: higher intensity at 1200 cm⁻¹, but lower at 1250 and 1309 cm⁻¹
e. The band related to —CH₂ scissoring motion at C6 was split into 1451 and 1423 cm which is a consequence of the changes of —CH₂ stretching vibrations shown at 2800 to 3000 cm
f. Sugar structure related bands at 1153, 1106, 1063, 1034 and 995 cm⁻¹ also appeared different. The band around 995 cm⁻¹ presents stronger intensity, which could be because of the crystalline or ordering structure of symmetric stretching of C—O—C. The thermal study had evidenced that the milled paramylon had higher melting enthalpy.

### GPC

The absolute molar mass distributions of the samples were measured using size exclusion chromatography (SEC) with multi-angle light scattering (MALS) detection. The samples were dissolved in dimethyl sulfoxide (DMSO) at a nominal concentration of 9.5 mg/mL. Each preparation was heated to approximately 70° C. for 90 minutes. At the end of the sample dissolution, the milled BGI sample was hazy. One milliliter of each solution was further diluted with 1.11% LiCl in DMAc solution in 10 mL volumetric flasks for a nominal concentration of 0.95 mg/mL, and then centrifuged for 30 minutes to remove any insoluble material. The insoluble portion could be gelation due to stronger inter triple helix hydrogen bonding According to the recovery found by GPC, the insoluble portion is more than 20%.

TABLE 78
The molecular weight information measured by SEC.

| Samples | Mn | Mw | Mw/Mn | Mass recovery (%) |
|---|---|---|---|---|
| BGI | 102,000 | 166000 | 1.64 | 99.8 |
| MP | 41700 | 85200 | 2.04 | 71.4 |

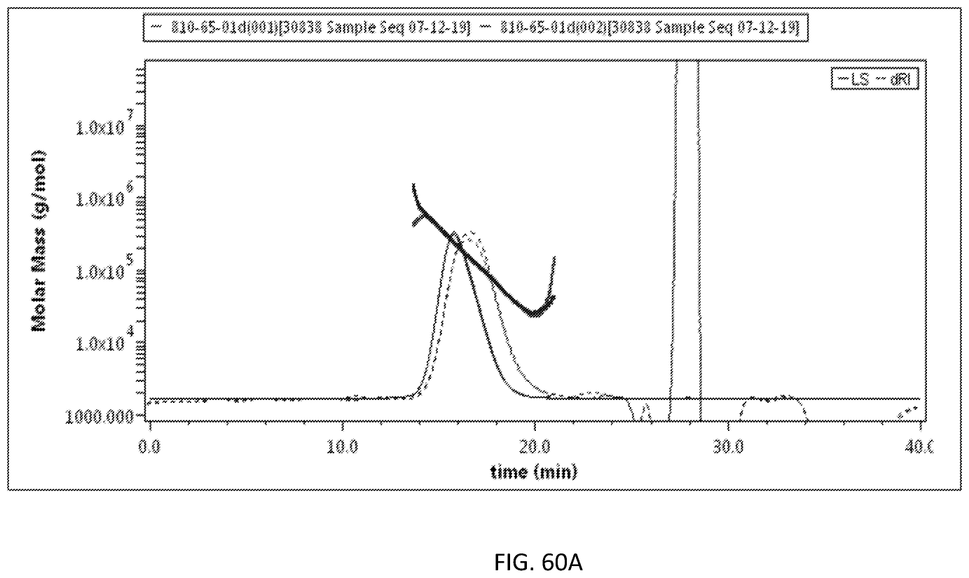

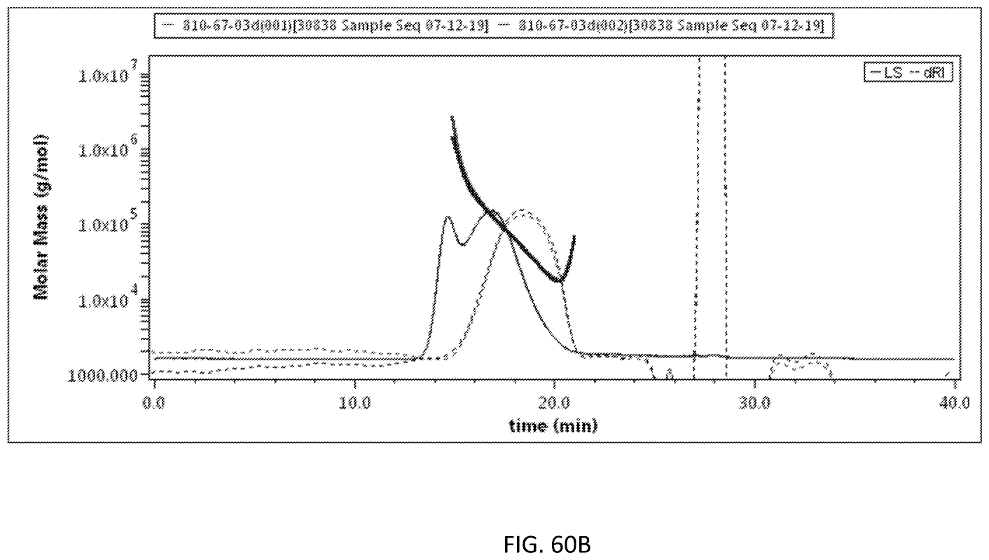

As seen in FIGS. 60 A and B as well as Table 78, the molecular weight of milled paramylon was 85.2 kDa, with wider PDI (2.4) compared to BGI. This is only half of the MW of BGI, suggesting that the large-scale milling condition broke the BGI chain. One can notice that the mass recovery of milled paramylon is only 71.4%. The loss could be the result of insoluble material or the existence of small molecules under the detection range of the SEC.

### Example 52: Comparison of the BGI Materials

In this study, different BGI products had been produced and studied. They are BGI granules, BGI gels, and milled BGI. Their differences were summarized in Table 79 below. It should be noted that the differences are raised mainly by their native force effects. As read in Table 79, BGI granules mainly contain intra hydrogen bonds in triple helix structures that are the native forces to form granule crystal; Milled paramylon (MP) contain both intra and inter hydrogen bonds in their triple helix structures; Gels contain different forces among BGI chains according to their preparation methods, for example, HCl-gel contains inter Hydrogen bonds among BGI chains, CaCl₂-gel has inter Ionic bonds among BGI chains, and Citric-gel is built by inter Carboxyl bonds/Hydrogen bonds among BGI chains. The variations of the native forces in BGI products offer the variations for their appearances, properties and applications. According to our studies, the BGI products are suitable for the food products such as whitening agent, pasta, icing, anti-freeze agent, Cream, Yogurt, coatings or Fruit Jelly.

TABLE 79
the overall comparison of the BGI materials in this study.

| | | MP | | Gels | | |
|---|---|---|---|---|---|---|
| Material | BGI | Complete | Partial | HCl | CaCl₂ | Citric (RTG) |

| | | | | | |
|---|---|---|---|---|---|
| Force | intra | intra and inter | inter | inter | Inter Carboxyl |
| | hydrogen | hydrogen bonds | Hydrogen | Ionic | bonds/Hydrogen |
| | bonds in | in their triple | bonds | bonds | bonds among |
| | triple helix | helix structures | among | among | BGI chains |
| | structures | | BGI | BGI | |
| | | | chains | chains | |

| | | | |
|---|---|---|---|
| Appearance | Donut-like | Continue texture | Texture in |
| | granules | with/without | freeze dry |
| | | paramylon | and particles |
| | | granules | in spray dry |
| WHC | 1.1-1.3 | 4-7 | 7-12 |
| Viscosity | Low | medium | high |
| Application | Whitening, | Cream, Yogurt, | Fruit Jelly |
| | pasta, | icing, whiteness, | |
| | icing, anti- | anti-freeze agent, | |
| | freeze | coating | |
| | agent | | |

### Water Holding Properties

To evaluate the water holding capacity of paramylon products, including paramylon granules, milled paramylon and RTGs. Water holding capacity is a measure of the total amount of water that can be absorbed per gram of material. It is based on the direct interaction of paramylon materials with water and other solutes. This study is to evaluate the water holding capacity of paramylon products including paramylon granules, milled paramylon and gels.

### Samples and Preparation

a. Paramylon granules: Two batches of Paramylon granules were used in this study, 1) BGI1: BGI-9Jun07-120-1 and 2) BGI2 BGI-8Dec13-1-184 were isolated from the Plant.
b. Milled paramylon is the one prepared using CMG-milling method.
c. RTG was prepared from BGI 1 using the optimization method as mentioned above.
d. Acid-gel and CaCl₂-gel were prepared using the standard method mentioned above,

### Testing Method's

Identification: Water holding capacity (WHC) is the water holding weight/g material. Given that certain amounts of paramylon material can be dissolved in water, a correction of WHC was provided as Cor. WHC.

WHC=(Ww−Ws)/Ws

Cor.WHC=(Ww−(Ws−Ws))/(Ws−Wd)

WSI=Wd/Ws
WHC: Water holding Capacity; WSI: Water solubility index; Ww: Weight of wet samples; Ws: Weight of samples; Wd: Weight of dissolved sample;

### WHC Test Methods

### General Method at Room Temperature (20° C.)

0.5 g samples were suspended in 20 mL of distilled water in a 50 mL test tube and were vortexed for 30 seconds to bring all the sample into suspension. The suspension was then allowed to rest for 10 min. The vortex process was repeated 7 times. The samples were centrifuged at 1600 g for 25 min, and the supernatant was collected and freeze dried to get WSI (water solubility index. The centrifuge tube was placed mouth down at an angle of 15 to 20 degree at 50° C. for 25 min for draining free water. The tube was weighted and The WHC is calculated based on the formulation above. WHC is recorded as g/water per g sample.

### Time-Dependence Testing Method

The standard methods were the same as 1). The modification was on the vortex step as vortexed for 20 seconds to bring all the sample into suspension every 30 min for first 2 hours, and then every 4 hours in day time. The total time was 2 hours, 24 hours or 48 hours.

### Temperature-Dependence Testing Method

The procedure was the same as method 1), but the sample was soaked in water at 4, 20, 50 and 100° C.

### Results and Discussions

### Effect of the Type of Samples

As seen in Table 116, WHC of the different paramylon granules is slightly different, but not significant. Milled paramylon has higher WHC than paramylon granules. This is because the granules of milled paramylon were broken and there are more —OH group free can reach to water than paramylon granules. As well, its inter hydrogen bonds between triple helix also increase its WHC. The freeze-dried milled paramylon (MPF) has a higher WHC than the oven dried paramylon (MPO). This can be explained by the higher surface area in MPF. Not surprisingly, RTG has the highest WHC. It should be noted that RTG prepared using the method above contains only 30% paramylon.

As seen in Table 116, the order of water solubility index (WSI) is RTG >milled paramylon >paramylon granules, while only WSI of RTG shows significant effect on the Cor. WHC. It should be noted that HCl-Gel and CaCl₂-Gel have similar WHC as citric acid-gel (RTG).

In this study, the appearances of the material were also observed. The viscosity and phase stability of water saturated (WS) paramylon products were observed to be different. The WS paramylon granules and WS milled paramylon look like viscous cream-like materials, but WS RTG looks like less viscous fruit jelly material. Furthermore, the phase stability of WS paramylon materials is also type dependent and soaking temperature dependent. The phase stability is in the order of milled paramylon >paramylon granules >RTG.

TABLE 116
WHC and WSI of paramylon products, MPF: Freeze dried
Milled paramylon; MPO: Oven dried Milled paramylon;
WHC; Water holding capacity; WSI: water solubility index;
Cor. WHC: Corrected WHC; RTGF: Freeze dried RTG;

| Sample | WHC | WSI | Cor. WHC |
|---|---|---|---|
| BGI 1 | 1.29 | 0 | 1.29 |
| | 1.30 | 0 | 1.30 |
| | 1.28 | 0 | 1.28 |
| BGI2 | 1.11 | 0.014 | 1.17 |
| | 1.14 | 0.012 | 1.19 |
| | 1.20 | 0.0099 | 1.24 |
| MPF | 5.94 | 0.020 | 6.23 |
| | 6.11 | 0.022 | 6.44 |
| | 6.05 | 0.024 | 6.40 |
| MPO | 4.36 | 0.033 | 4.74 |
| | 4.41 | 0.022 | 4.66 |
| | 4.43 | 0.030 | 4.77 |
| RTGF | 9.27 | 0.15 | 13.49 |
| | 8.91 | 0.14 | 12.90 |
| | 7.73 | 0.15 | 11.41 |
| Acid gel | 7.0 | — | — |
| CaCl₂ gel | 7.4 | — | — |

### Effect of Soaking Time of Materials

As the RTG is considered to be saturated by water easily, the effect of soaking time was only determined on Paramylon granules and milled paramylon. The WHC and WSI are included in Table 80. Results show that the soaking timer of materials does not have an obvious effect on both WHC and WSI.

TABLE 80
Soaking time dependence of the WHC (g/g). MPF: Freeze
dried Milled paramylon; MPO: Oven dried Milled paramylon;
WHC; Water holding capacity; WSI (g/g): water solubility
index; Cor. WHC (g/g): Corrected WHC

| Samples | Time(hours) | WHC | WSI | Cor. WHS |
|---|---|---|---|---|
| BGI2 a | 2 | 1.11 | 0.014 | 1.17 |
| BGI2 b | 2 | 1.14 | 0.012 | 1.19 |
| BGI2 a | 24 | 1.11 | 0.019 | 1.15 |
| BGI2 b | 24 | 1.14 | 0.018 | 1.18 |
| BGI2 a | 48 | 1.15 | 0.017 | 1.19 |
| BGI2 b | 48 | 1.13 | 0.016 | 1.17 |
| MPF a | 2 | 5.94 | 0.020 | 6.23 |
| MPF b | 2 | 6.11 | 0.022 | 6.44 |
| MPF a | 24 | 5.68 | 0.026 | 5.85 |
| MPF b | 24 | 5.58 | 0.033 | 5.80 |
| MPF a | 48 | 6.37 | 0.027 | 6.58 |
| MPF b | 48 | 6.44 | 0.023 | 6.61 |
| MPO a | 2 | 4.36 | 0.033 | 4.74 |
| MPO b | 2 | 4.41 | 0.022 | 4.66 |
| MPO a | 24 | 4.36 | 0.038 | 4.57 |
| MPO b | 24 | 3.96 | 0.042 | 4.17 |
| MPO a | 48 | 4.24 | 0.059 | 4.57 |
| MPO b | 48 | 4.27 | 0.044 | 4.51 |

### Effect of Soaking Temperature

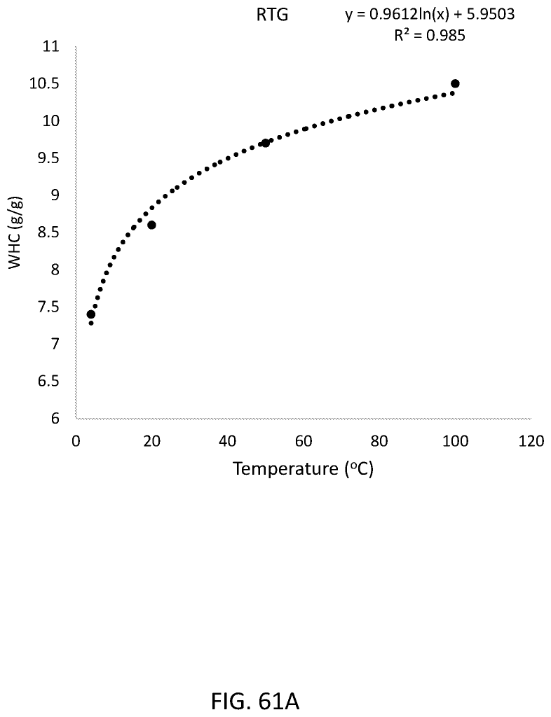

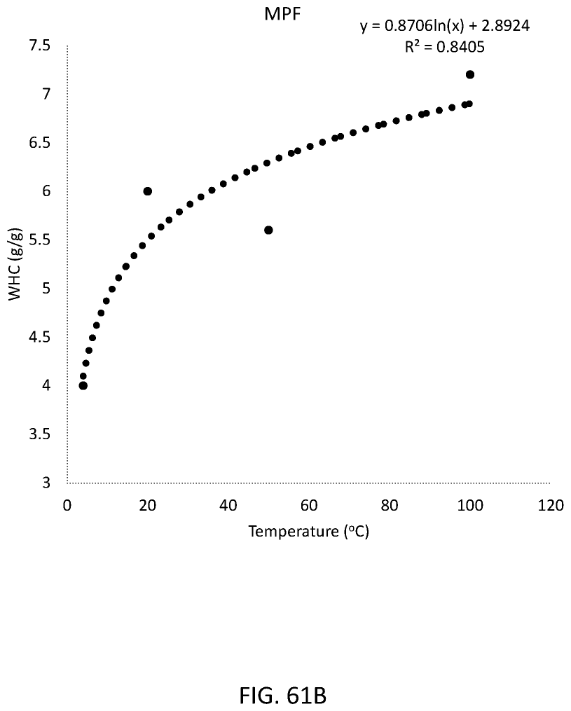

Four soaking temperatures (4, 20, 50, 100° C.) were selected based on the storage temperature, transporting and food processing temperature. As presented in Table 81, the WHC and WSI of paramylon granules are not soaking temperature dependent at the selected temperatures. Those of milled paramylon are not significantly different in 20° C. and 50° C., but decreased at 4° C., while increased at 100° C. This may be because the temperature has influence on the surface area of the milled paramylon. Perhaps 100° C. is up around the melting temperature of milled paramylon. This also suggests that the WHC of paramylon granules can be increased when the soaking temperature is up around the melting point. For RTG, its WHC exponentially increases with the increase of temperature, as seen in FIGS. 61 A and B. For WSI, the soaking temperature does not have an obvious influence.

According to the observation, it was found that the WS RTGF treated at different temperature gave different phase stability that measured by settling time of materials in a test tube after being shaken. RTGF treated at 4° C. has the most stable phase due to the lowest water content, followed by the one treated at 100° C. where the cross-linker became stronger after it treated at a higher temperature, and then the one treated at 20° C.˜50° C.

TABLE 81
Soaking temperature dependence of WHC (g/g) and WSI (g/g).
MPF: Freeze dried Milled paramylon; MPO: Oven dried Milled
paramylon; WHC; Water holding capacity; WSI: water solubility
index; Cor. WHC: Corrected WHC; RTGF: Freeze dried RTG

| Sample | Temperature (c) | WHC | WSI | Cor. WHC |
|---|---|---|---|---|
| BGI1a | 4 | 1.18 | 0 | 1.18 |
| BGI1b | 4 | 1.21 | 0 | 1.21 |
| MPFa | 4 | 4.84 | 0.019 | 4.95 |
| MPFb | 4 | 3.71 | 0.014 | 3.77 |
| RTGFa | 4 | 7.39 | 0.16 | 8.99 |
| RTGFb | 4 | 7.58 | 0.15 | 9.13 |
| BGI1a | 20 | 1.29 | 0 | 1.29 |
| BGI1b | 20 | 1.30 | 0 | 1.30 |
| MPFa | 20 | 5.94 | 0.020 | 6.23 |
| MPFb | 20 | 6.11 | 0.022 | 6.44 |
| RTGFa | 20 | 8.91 | 0.14 | 12.90 |
| RTGFb | 20 | 7.73 | 0.15 | 11.41 |
| BGI1a | 50 | 1.18 | 0 | 1.18 |
| BGI1b | 50 | 1.13 | 0 | 1.13 |
| MPFa | 50 | 5.65 | 0.024 | 5.82 |
| MPFb | 50 | 5.61 | 0.029 | 5.81 |
| RTGFa | 50 | 9.62 | 0.14 | 11.41 |
| RTGFb | 50 | 9.79 | 0.14 | 11.49 |
| BGI1a | 100 | 1.23 | 0 | 1.23 |
| BGI1b | 100 | 1.24 | 0 | 1.24 |
| MPFa | 100 | 7.27 | 0.021 | 7.45 |
| MPFb | 100 | 7.14 | 0.032 | 7.41 |
| RTGFa | 100 | 10.14 | 0.14 | 12.00 |
| RTGFb | 100 | 10.76 | 0.15 | 12.76 |

### Stability of Water Saturated Paramylon Samples

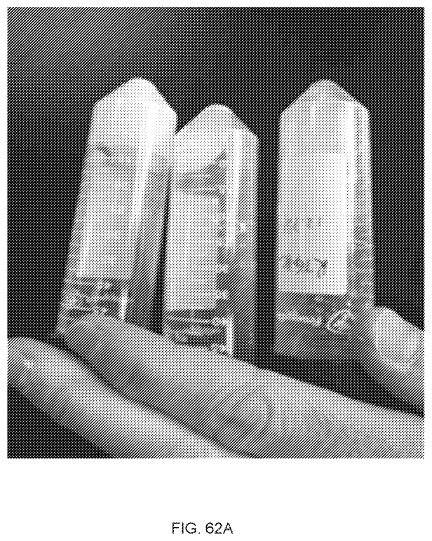

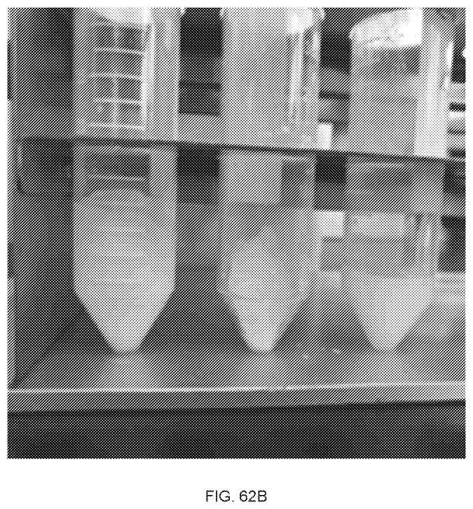

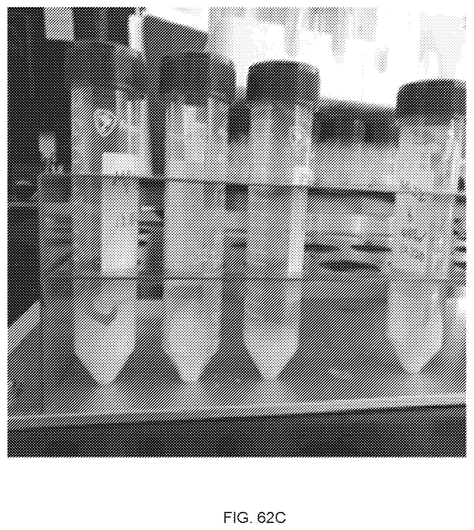

As mentioned above, the WS paramylon products have different appearances. WS paramylon granules and WS milled paramylon are viscous cream-like materials, while WS RTG is lease viscous fruit jelly-like materials, as seen in FIG. 62 A through C.

The settling times of WS paramylon materials are also different. The WS RTG was settle down in one hour, but the milled paramylon and paramylon granules can stay in the shape as shown in FIG. 62 A through C at least for one week. The settling times of WS RTG is found to be affected by the soaking temperatures. RTGF treated at 4° C. has the longest settling time, followed by the one treated at 100° C., and then the one treated at 20° C.˜50° C.

The less WHC can be an answer that it is stable at 4° C. While its crosslinking structure can be further stable at 100° C., which allows it to be more stable.

### Conclusions

Water holding capacities of paramylon products, including paramylon granules, milled paramylon, RTGs were measured and it was found that the water holding capacity of paramylon materials is highly affected by type of paramylon product, and soaking temperatures, but not soaking time. The gels including acid-gel, CaCl₂ gel and RTG gel have the highest WHC, followed by milled paramylon. The paramylon granules have the least WHC. The WHC of RTG and milled paramylon were affected by soaking temperature. Higher temperature gives higher WHC. However, the WHC of granule was not affected. The water saturated (WS) paramylon granules and milled paramylon are viscous cream-like materials that can be used to develop cream or paste product, while WS RTG is less viscous than jelly material that can be used to develop jelly product. Furthermore, the stability of WS paramylon materials is also type dependence and soaking temperature dependence. The stability is in the order of milled paramylon >paramylon granules >RTG. Interestingly, it was found that RTGF treated at 4° C. had the most stable phase, followed by the one treated at 100° C., and then the one treated at 20° C.˜50° C.

### Example 53: Washing Effect on the WHC of RTG

As one can see that the sodium content in RTG is high, and there is a safety consideration when it is used for food products. Washing is one of the efficient desalting methods. This study is to demonstrate the effect of washing on the WHC of RTG.

### Samples and Preparation

### Samples

RTG prepared from BGI-8DEC13-1-84 using the optimization as mentioned below and then freeze dried.

### Sample Preparation Method

Solubilize 70 g of beta glucan isolate in 1330 ml of 1 M NaOH solution (5% (w/v) concentration).
Measure pH.
While mixing, neutralize beta glucan solution by adding 35% citric acid until gelation occurs (295 ml).
Measure pH.
Centrifuge sample at 3250 rpm for 20 minutes.
Decant supernatant solution and weigh.
Remove 10 ml of supernatant for soluble solids determination.
Remove ‘Pre-wash’ sample.
Add the same amount of DI water as removed supernatant and mix vigorously.
Centrifuge sample at 3250 rpm for 20 minutes.
Decant supernatant solution and weigh.
Remove 10 ml of supernatant for soluble solids determination.
Remove ‘Wash 1’ sample.
Repeat centrifuge-decant-sample-wash procedure until there are 6 wash samples and 6 supernatant samples.
Place each wash sample in the −80° C. freezer until frozen.
Place each supernatant sample in the oven at 100° C., until all solution has evaporated. Weigh soluble solids.
Transfer wash samples to freeze dryer and dry until all moisture is removed.
Grind freeze-dried product into fine powder using coffee grinder and use these solids for the water holding capacity tests.

### Results and Discussions

Samples were taken before, and between washing steps during the production of RTG. Water holding capacity (WHC) and water solubility index (WSI) were determined for each sample and summarized in Table 82.

TABLE 82
WHC and WSI of washed RTG beta glucan samples. WHC
(g/g); Water holding capacity; WSI (%): water solubility
index; Cor. WHC (g/): Corrected WHC

| Sample | Label | WHC | WSI | Cor. WHC |
|---|---|---|---|---|
| Pre- wash | a | 8.89 | 50.29 | 18.89 |
| | b | 8.01 | 52.22 | 17.86 |
| Wash 1 | a | 9.29 | 43.46 | 17.21 |
| | b | 8.80 | 45.35 | 16.92 |
| Wash 2 | a | 6.91 | 38.68 | 11.90 |
| | b | 6.11 | 40.71 | 10.99 |
| Wash 3 | a | 8.38 | 30.63 | 12.53 |
| | b | 10.65 | 31.16 | 15.93 |
| Wash 4 | a | 10.64 | 25.93 | 14.72 |
| | b | 9.92 | 26.95 | 13.95 |
| Wash 5 | a | 10.49 | 18.85 | 13.16 |
| | b | 9.45 | 18.34 | 11.80 |
| Wash 6 | a | 11.05 | 13.03 | 12.85 |
| | b | 10.35 | 13.23 | 12.09 |

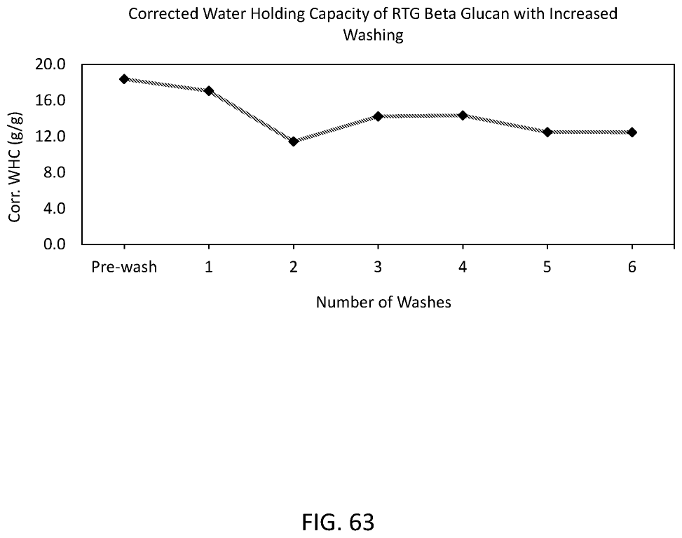

The WHC of the samples looks to increase as more washing occurs; however, when the amount of soluble solids after each wash is taken into account the corrected WHC follows the opposite trend. There was a large enough difference in soluble solids in the supernatant between the beginning and end of the wash cycle samples that the WHC, corrected by WSI, decreased as more washing occurred (FIG. 63). The decrease of soluble solids through the washing steps is in line with the decrease in sodium content that has been seen in previously washed RTG batches; each additional wash step helped reduce the sodium content. This decrease in soluble solids is also supported by the supernatant samples taken after every wash step during RTG preparation. Generally, the theoretical amount of solids decreases through each wash step and by the end of washing, less than half the amount of soluble solids are removed than in wash 1 (Table 2). Presumably, when the sodium content is highest (pre-washing, first few washes) the more soluble solids, in the form of salts (especially sodium citrate), would be present in the supernatant and be more likely to be removed.

Although the majority of the soluble solids are likely salts, it is also possible that some of the solids may be BGIs. Small fragments or loose bodies of paramylon that perhaps didn't hydrate or gel as well as the rest of the beta glucan isolate during neutralization could lack the density to settle well enough during centrifugation; making it plausible for them to end up at the solids/supernatant interface and be easily discarded while decanting. Additionally, there is a bit of an outlier at wash 2 and 3, as their initial WHC is amongst the lowest of all samples. Perhaps these samples were not reanimated as well after freeze drying as the other samples, causing it to lack available hydroxyl groups that are responsible for binding the water molecules. All water saturated samples look similar, with the samples that have a higher corrected WHC being slightly more mobile. The consistency is the same as our previous studies, which resembles a thinner jelly-like gel.

TABLE 83
Theoretical amount of soluble solids removed by each wash.

| | Soluble | Total | Theoretical |
|---|---|---|---|
| | solids | decant | total soluble |
| | per | solution | solids |
| | 10 ml | per wash | per wash |
| Sample | (g) | (g) | (g) |
| Wash 1 | 0.753 | 442.5 | 33.32 |
| Wash 2 | 0.603 | 412.5 | 24.87 |
| Wash 3 | 0.486 | 334.0 | 16.23 |
| Wash 4 | 0.416 | 516.0 | 21.47 |
| Wash 5 | 0.348 | 406.5 | 14.15 |
| Wash 6 | 0.295 | 515.0 | 15.19 |

### Conclusions

With each round of washing, soluble solids are recovered from the supernatant. As the number of washes increases, the amount of soluble solids in each wash decreases; this affects the water saturation index. One hypothesis is that these solids are in fact salts that are present from the solubilization and neutralization steps required to make RTG. This would be in line with previous washed RTG batches where there is a measurable decrease in sodium content after six washes. Multiple wash steps are required because the removal of sodium is gradual and cannot be done in one wash. Therefore, the corrected water holding capacity decreases as more washes are performed.

### Example 54: Viscosity

Viscosity is one of important parameters for food materials, and has great contribution to their functionalities, processing and application. This study is to investigate the viscosity of paramylon products including paramylon granules, milled paramylon and RTG and compare them to some commercial products and food additives.

### Sample and Preparation

### Materials

BGI slurry from Plant, milled paramylon, washed, solubilized beta glucan and reconstituted RTG beta glucan gel.

a) BGI slurry from Plant.
The BGI slurry is too thin to test the viscosity. It was centrifuged @500 g for 10 min and then used to prepare the following test samples (BGI1, BGI2, BGI3 and BGI3-2):

TABLE 84
BGI samples and their appearances

| Sample | Concentration | Appearance |
|---|---|---|
| BGI1 | 44% | white thick paste, phase stable |
| | | for more than 3 days |
| BGI2 | 35% | white cream-like, phase stable |
| | | for around 2 days |
| BGI3 | 31% | white milk-like, phase separation |
| | | after around 2 hours |
| BGI3-2 | 27% | similar to BGI3 |

b) Milled paramylon.
The milled paramylon was prepared using CMC-milling method, and was used to prepare the following samples as seen in Table 85:

TABLE 85
Milled paramylon (MP) samples and their appearances

| Samples | Concentration | Appearance |
|---|---|---|
| MP1 | 11% | off-white, ice-cream-like, phase stable for |
| | | more than 1 month |
| MP2 | 5.9% | off-white, cream-like, phase stable for at least |
| | | 1 week |
| MP3 | 2.7% | off-white, milk-like, phase separated after 4 |
| | | hours. |

c) Washed, solubilized beta glucan RTG.
While preparing solubilized beta glucan to be made into RTG powder, viscosity was tested before washing and after each wash step.

d) Reconstituted RTG gel.
Freeze-dried washed RTG powder was used to make gel concentrations of 5%, 7.5%, 10%, 12.5% and 15%.
2. Curdlan in water: 2.5% to 15%
3. Food thickeners in water: 0.25% to 3%
4. Food products: Fruit Jello, creamer, condensed soup, yogurt beverage and pudding and from the local grocer.

### Viscosity Test Instrument

Viscosity was tested on a CGOLDENWALL NDJ-5S Digital Rotational Viscosity Meter with a range of 1-100K mPa·s, rotational testing speeds of 6, 12, 30, 60 rpm, accuracy of ±3.0% of range, and four detachable rotors. The rotor and rotational speed were selected in order for the testing aperture angle percentage to fall between 20% and 85% for accurate viscosity measurements. All of the data was recorded after 30 seconds of mixing.

### Results

### Paramylon Materials

### BGI Samples

### BGI1

The viscosity of BGI1 was tested using rotor #2 at 4° C., Room temperature (RT) and 40° C. and rotor #3 at RT. The results were present in Table 86 and Table 87, respectively. When the sample BGI1 was tested on rotor #2, the angle was over detection range (>90%), as seen in Table 86. But the viscosity was independent of the temperature at this test condition. The viscosity of BGI1 tested by rotor #3 decreases slower than by rotor #2 as seen in Table 87. As well, it was found that the viscosity varied with the detection time, thus the viscosity in this study was recorded at 30 seconds mixing.

TABLE 86
The viscosity of the sample BGI1 was test using
rotor #2, and the results were recorded with
a testing angle of 96% (over ideal angle range).

| RPM | 6 | 12 | 30 | 60 |
|---|---|---|---|---|
| At RT | 4622 | 2312 | 925 | 462 |
| At 40° C. | 4627 | 2314 | 925 | 462 |
| At 4° C. | 4623 | 2314 | 325 | 462 |

TABLE 87
The viscosity of the sample BGI1 was tested using rotor #3
and the results were recorded with a testing angle between 20-40%.

| RPM | 6 | 12 | 30 | 60 |
|---|---|---|---|---|
| At RT | 3608 | 2118 | 1122 | 728 |

### BGI2

BGI1 was diluted to give BGI2 as per the sample section. Viscosity of BGI2 was tested using rotor #2 and rotor #1 at RT. When rotor #1 was used, the testing angles are over the ideal range of 20-85%. When a rotor #2 was used, the viscosity of BGI2 was recorded as seen in Table 88.

TABLE 88
The viscosity of BGI2 was tested using rotor #2 with
an angle 20-29%(shown in brackets), and rotor #1 with
an angle of 92-97% (shown in brackets) @RT.

| RPM | 6 | | 12 | | 30 | | 60 | |
|---|---|---|---|---|---|---|---|---|
| Rotor | 781 | (92.7%) | 458 | (96.2%) | 185 | (96.7%) | 92 | (96.8%) |
| #1 | | | | | | | | |
| Rotor | 196 | (20.5%) | 110 | (23%) | 49 | (26%) | 27 | (29%) |
| #2 | | | | | | | | |

### BGI3

BGI2 was further diluted to give BGI3 as read in the sample section. Viscosity of BGI3 was tested using rotor #1 at RT. It was found that the viscosity of BGI3 was similar to the BGI2. It is interesting that increasing temperature can slightly increase the viscosity at a lower rpm, but not apparently different when a higher rpm is applied, as seen in Table 90.

TABLE 89
The viscosity of BGI3 was tested using rotor
#1 with an angle of 30-60% @RT.

| RPM | 6 | 12 | 30 | 60 |
|---|---|---|---|---|
| RT | 290 | 178 | 89 | 55 |

TABLE 90
The viscosity of BGI3-2 was tested using rotor #1 with an
angle of 30-60%. The testing angles were recorded in brackets.

| RPM | 6 | | 12 | | 30 | | 60 | |
|---|---|---|---|---|---|---|---|---|
| At RT | 214 | (22.3%) | 124 | (26.5%) | 59 | (31.3%) | 35 | (36.9%) |
| At 4° C. | 213 | (22%) | 136 | (28.6%) | 69 | (36.7%) | 43 | (45.8) |
| At 40° C. | 265 | (27.8%) | 146 | (30.5%) | 67 | (35.3%) | 38 | (40.3%) |

### Time-Dependence of BGIs Using BGI 3-2 as an Example

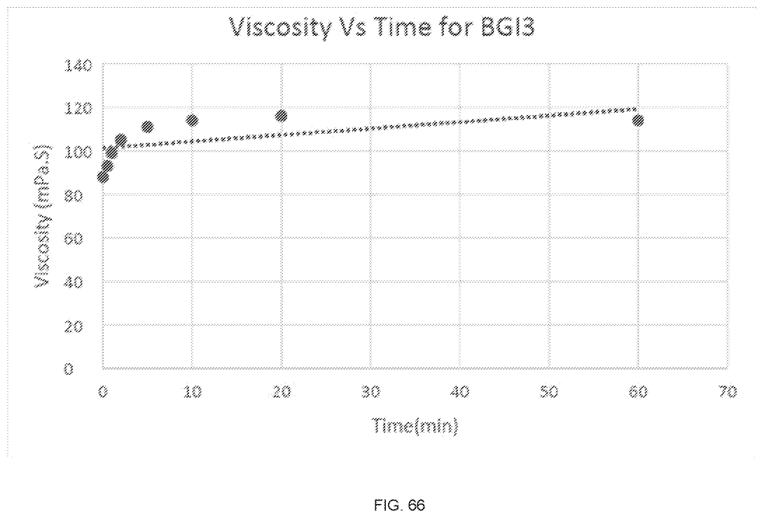

The variation of viscosity with time was investigated in this study based on BGI 3-2 at room temperature. The test was carried out using rotor #1. As seen in Table 91 and FIG. 66, the viscosity of BGI3-2 increases with time, especially in this first 10 min. It can be explained that the stirring stretches the paramylon granule and then brings water swollen in granules, increasing its viscosity higher with time.

TABLE 91
The viscosity of BGI3-2 was tested using rotor
#1 with angle of 30-60% @RT

| Time (min) | 0 | 0.5 | 1 | 2 | 5 | 10 | 20 | 60 |
|---|---|---|---|---|---|---|---|---|
| Visc. | 88 | 93 | 99 | 105 | 111 | 114 | 116 | 114 |
| (mPa · S) | | | | | | | | |

### Milled Paramylon

Milled paramylon contains ˜11% paramylon and is called MP1 in this study. MP2 was prepared by adding 117 g water into 134 g MP1, and MP3 was prepared by adding 150 g water into 50 g MP1. The viscosity of MP1, MP2 and MP3 were present in Table 92 to Table 94 using rotor #3 or #4, rotor #3 and rotor #1 or rotor #2, respectively.

TABLE 92
The viscosity of MP1 using rotor #3 or #4 at room temperature.
The testing angles were recorded in brackets.

| RPM | 6 | | 12 | | 30 | | 60 | |
|---|---|---|---|---|---|---|---|---|
| Rotor #3 @RT | 18509 | (96.8%) | 9259 | (96.8%) | 3703 | (96.8%) | 1852 | (96.8%) |
| (mPa · s) | | | | | | | | |
| Rotor #4 @RT | 62363 | (65.2%) | 29806 | (62.4%) | 16907 | (88.4%) | 9252 | (96.8%) |
| (mPa · S) | | | | | | | | |

TABLE 93
The viscosity of MP2 using rotor 3# at 4° C., room temperature
and 40° C. The testing angles were recorded in brackets.

| RPM | 6 | | 12 | | 30 | | 60 | |
|---|---|---|---|---|---|---|---|---|
| RT | 5091 | (26.6%) | 4022 | (42%) | 2045 | (53%) | 1258 | (65.5%) |
| 40° C. | 3688 | (20%) | 3160 | (33%) | 1300 | (33%) | 1224 | (64%) |
| 4° C. | 6653 | (33.8%) | 5417 | (56.6%) | 2959 | (77.3%) | 1850 | (96.8%) |

TABLE 94
Viscosity of MP3 was tested using rotor #1 or #2 at 4°
C., room temperature and 40° C. The testing angles were recorded in brackets.

| RPM | 6 | | 12 | | 30 | | 60 | |
|---|---|---|---|---|---|---|---|---|
| Rotor 1# (RT) | 468 | (48.2%) | 230 | (46.5%) | 103 | (54%) | 64 | (67%) |
| Rotor 1# (4° C.) | 797 | (81%) | 380 | (79.5%) | 165 | (84.9) | 92 | (96.2%) |
| Rotor 2# (4° C.) | 821 | (17.1%) | 406 | (16.8%) | 180 | (18.6%) | 102 | (21.4%) |
| 40° C. | 471 | (49.3%) | 233 | (48.8%) | 98 | (51.3%) | 53 | (53%) |

### Testing Time Effect on the Viscosity

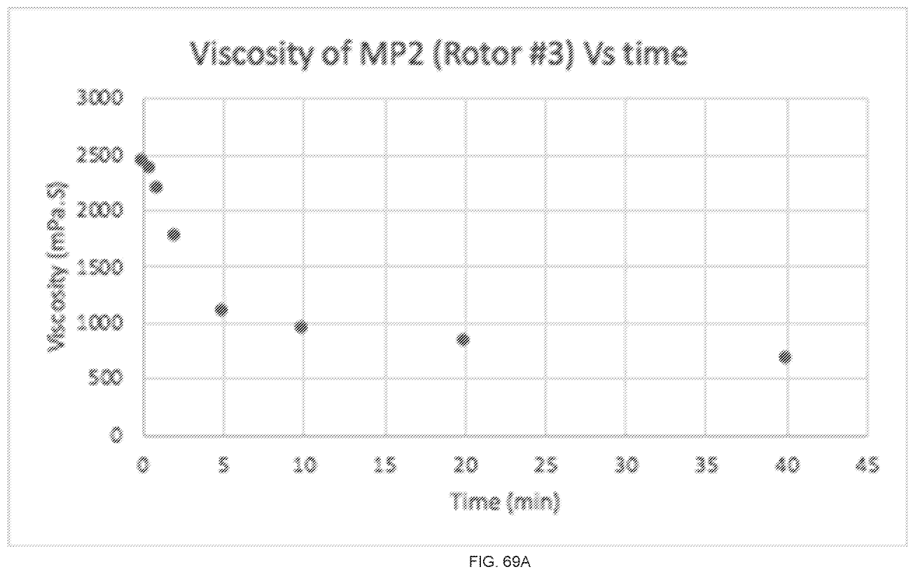

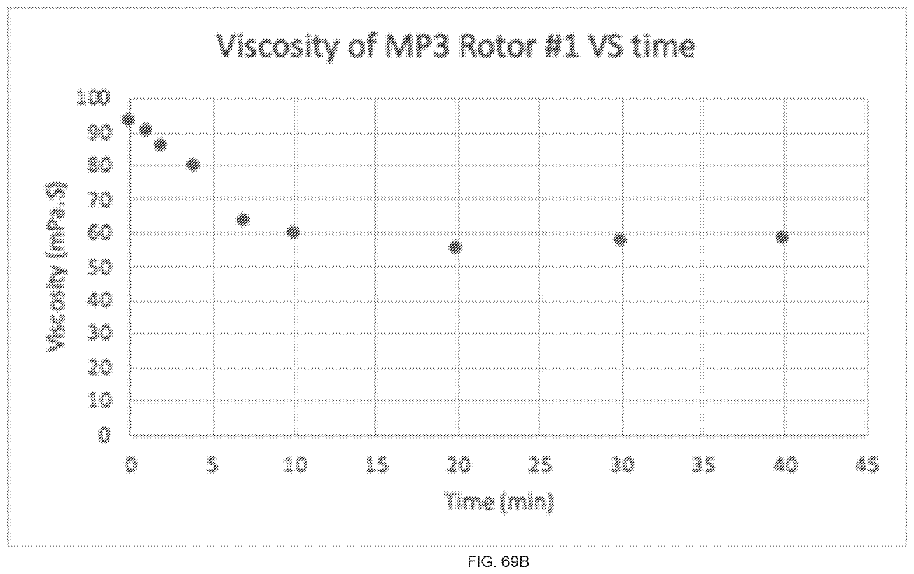

The effect of testing time on the viscosity of MPs was evaluated using MP2 and MP3 as an example. The test was carried out using rotor #3 at room temperature. The results were read in Table 95 and Table 96, as also seen in FIGS. 69 A and B.

TABLE 95
Viscosity of MP2 VS time (min) using rotor #3 @RT.

| Time (min) | 0 | 0.5 | 1 | 2 | 5 | 10 | 20 | 40 |
|---|---|---|---|---|---|---|---|---|
| Visc. | 2412 | 2366 | 2181 | 1763 | 1075 | 931 | 820 | 670 |
| (mPa · S) | | | | | | | | (<20%) |

TABLE 96
Viscosity of MP3 vs time (min) using rotor #1 @RT.

| Time (min) | 0 | 1 | 2 | 4 | 7 | 10 | 20 | 30 | 40 |
|---|---|---|---|---|---|---|---|---|---|
| Visc. | 93 | 90 | 85 | 79 | 63 | 59 | 55 | 57 | 58 |
| (mPa · S) | | | | | | | | | |

The Concentration Effect of BGIs and MPs on their Viscosities

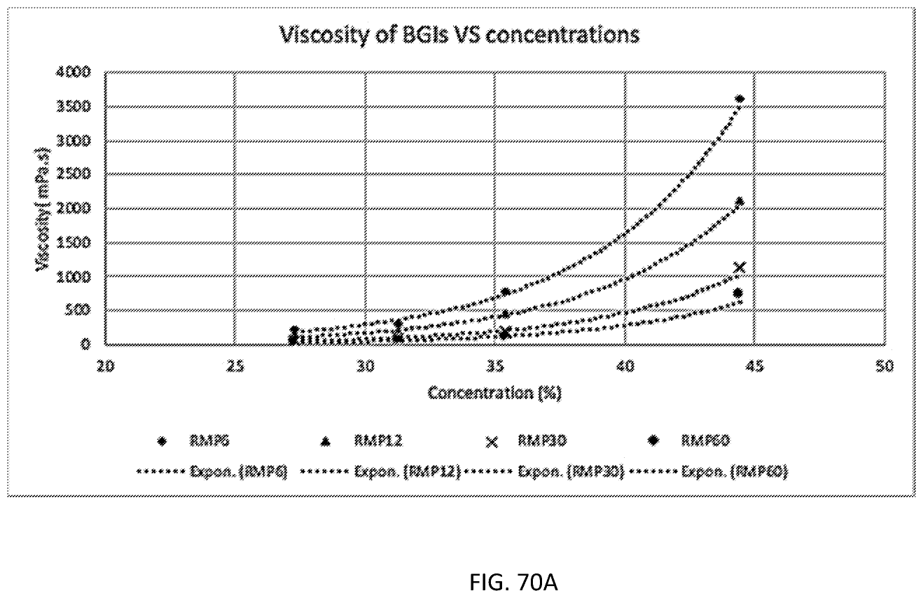

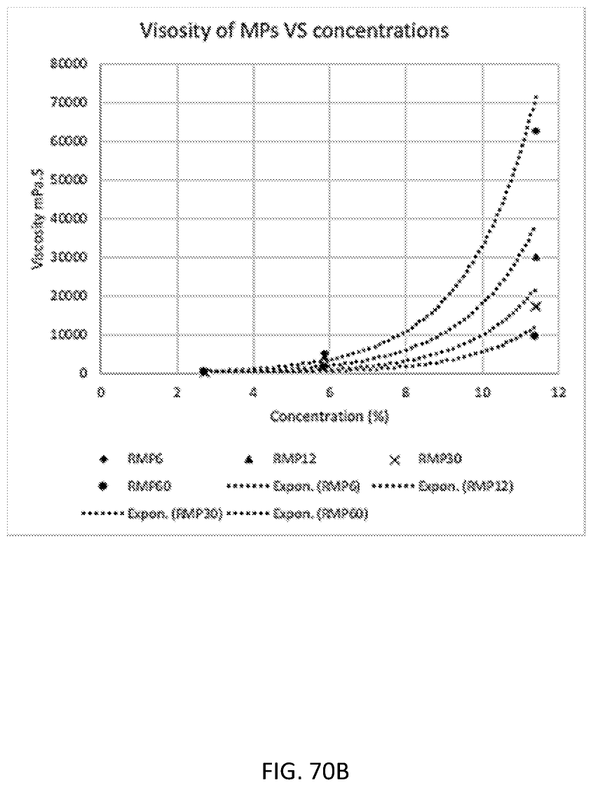

The effect of concentration of BGIs and MPs on their viscosity was evaluated and presented in FIGS. 70 A and B.

### Discussions

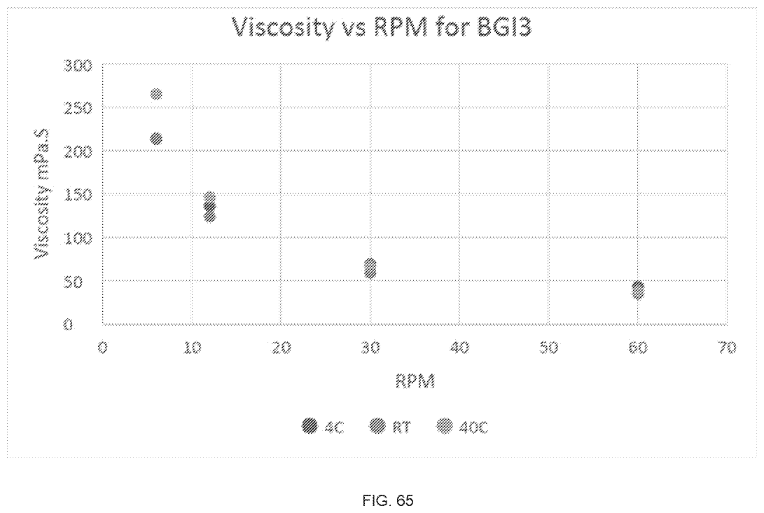

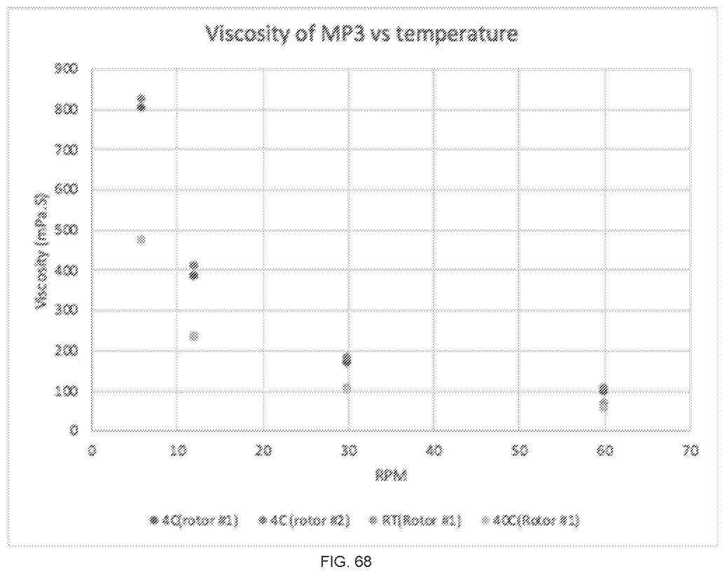

Not surprisingly, decreasing the concentration gives lower viscosity, as seen in FIGS. 70 A and B, both BGI and MP samples showed that their viscosity exponentially increases with the increase of concentration. But the viscosity of MP is much higher than BGIs. As well, the viscosity of MPs decreases with increase of temperature (seen in FIG. 68), which is different from those of BGI (seen in FIG. 65), where the viscosity at 40° C. is higher than at 4° C. and RT.

As seen in Table 95 and 96, the viscosity of MPs decreases with time increase (seen in FIGS. 69 A and B), which is also different from that in BGI (seen in FIG. 66). However, the dramatic change of viscosity for both BGIs and MPs are only within the first 10 min, afterward, the viscosity is unchanged.

### Washed, Solubilized Beta Glucan

During the washing process of making RTG powder, the viscosity of the solubilized beta glucan was tested before washing and after each wash step (washing was performed as in the water holding capacity study). As solubilized beta glucan is very thick, rotor #4 at 6 rpm (suggested settings for maximum viscosity values) was used in all tests to record the viscosity (Table 97). Pre-washed solubilized beta glucan was the only sample to not fall between the desired 20-85% aperture angle percentage; therefore, for that sample, the first viscosity value that registered below 90% was recorded. Although not recorded, the viscosity of all samples decreased as each test's duration increased; which was similar to milled paramylon.

TABLE 97
Viscosity of solubilized beta glucan gel
at varying steps of wash procedure.

| | | Rotor Speed | Range | Viscosity |
|---|---|---|---|---|
| Sample | Rotor # | (rpm) | (%) | (mPa · s) |
| Pre-wash | 4 | 6 | 89.8 | 85031 |
| Wash 1 | 4 | 6 | 71.9 | 68360 |
| Wash 2 | 4 | 6 | 48.1 | 46380 |
| Wash 3 | 4 | 6 | 61.0 | 58325 |
| Wash 4 | 4 | 6 | 65.4 | 62535 |
| Wash 5 | 4 | 6 | 41.3 | 39564 |
| Wash 6 | 4 | 6 | 45.0 | 43067 |

Similar to the water holding capacity of RTG beta glucan gel, the viscosity does not decrease in a completely linear fashion. Overall, after 6 washes the viscosity is much lower than the unwashed sample; however, after decreasing until wash 2, the viscosity increases after wash 3 and 4 before decreasing again until washing is complete. Another way to look at it is that wash 2 is an outlier. The decrease in viscosity would be relatively linear if the data for wash 2 was removed (the same argument could be made with the water holding capacity). However, it is possible that there is some kind of interaction occurring in the early wash steps that are causing these discrepancies; perhaps as some of the sodium begins to be washed away, the remaining sodium species are able to form stronger interactions with the solubilized beta glucan attributing to the swings in viscosity. This could also explain why the viscosity does not decrease between wash 3 and 4 and wash 5 and 6. A potential next step (which has been done with a couple other RTG powder batches) would be to have the sodium content measured between each wash step to see if there is any correlation to viscosity (or water holding capacity as well).

### RTG Beta Glucan Gel

The washed, solubilized beta glucan was freeze-dried to create RTG powder and reconstituted into varying concentrations of gel in order to test their corresponding viscosities. Just as with the solubilized beta glucan, the smallest rotor (#4), at the slowest speed (6 rpm) was used because the viscosity of the gels was thought to be very close to the maximum measuring value of the instrument. The only viscosity reading that was in the desired 20-80% range was the 7.5% gel; the higher concentration gels were above the range, while the lower concentration gel was below range (Table 98). Although the viscometer determined that the viscosity of the 10%, 12.5% and 15% gels were almost identical, this can be attributed to the lowered measurement accuracy from not being within the desired range and the 3% internal measurement error. Conversely, as the gels were being prepared, it is apparent that the viscosity is proportional to the gel concentration; theoretically, if a more robust instrument was used, the viscosity readings would allow for higher and more accurate values and follow this observed trend.

TABLE 98
Viscosity of varying concentrations of RTG beta glucan gel.

| | | Rotor Speed | Range | Viscosity |
|---|---|---|---|---|
| Sample | Rotor # | (rpm) | (%) | (mPa · s) |
| 15% RTG | 4 | 6 | 97.0 | 92769 |
| 12.5% RTG | 4 | 6 | 96.8 | 92595 |
| 10% RTG | 4 | 6 | 96.8 | 92560 |
| 7.5% RTG | 4 | 6 | 61.3 | 58692 |
| 5% RTG | 4 | 6 | 3.0 | 2941 |

### Curdlan

Viscosity measurements of varying curdlan concentrations were recorded in Table 99.

TABLE 99
Viscosity of various curdlan concentrations.

| | | Rotor speed | Range | Viscosity |
|---|---|---|---|---|
| Sample | Rotor # | (rpm) | (%) | (mPa · s) |
| 2.5% | 1 | 60 | 5.2 | 5 |
| 5% | 1 | 60 | 8.4 | 8 |
| 6% | 1 | 60 | 12.5 | 11 |
| | | 30 | 8.6 | 16 |
| | | 12 | 7.2 | 34 |
| | | 6 | 7.0 | 67 |
| 8% | 1 | 60 | 37.8 | 35 |
| | | 30 | 27.1 | 51 |
| | | 12 | 20.3 | 97 |
| | | 6 | 17.5 | 168 |
| 10% | 1 | 60 | 96.8 | 92 |
| | | 30 | 96.8 | 185 |
| | | 12 | 96.7 | 462 |
| | | 6 | 96.7 | 925 |
| | 2 | 60 | 43.1 | 205 |
| | | 30 | 28.5 | 272 |
| | | 12 | 19.5 | 465 |
| | | 6 | 15.0 | 717 |
| 12% | 2 | 60 | 96.8 | 462 |
| | | 30 | 96.8 | 925 |
| | | 12 | 96.8 | 2314 |
| | | 6 | 96.8 | 4628 |
| | 3 | 60 | 44.8 | 857 |
| | | 30 | 32.0 | 1223 |
| | | 12 | 25.7 | 2469 |
| | | 6 | 23.2 | 4442 |
| | 4 | 60 | 10.5 | 1011 |
| | | 30 | 7.9 | 1520 |
| | | 12 | 20.7 | 9904 |
| | | 6 | 14.5 | 13872 |
| 14% | 4 | 60 | 96.8 | 9255 |
| | | 30 | 96.8 | 18508 |
| | | 12 | 96.8 | 46309 |
| | | 6 | 96.8 | 92560 |
| 15% | 4 | 6 | 96.8 | 92552 |

Curdlan concentrations below 8% were very dilute and resulted in the angle to be well below range. These mixtures produced solutions that closely resembled water, so it was not a surprise to see very low viscosity values. Even the 8% mixture, although it measured within the acceptable range, was extremely dilute; only reaching 97 mPa×s at 12 rpm with rotor #1. The viscosity notably increased at 10% concentration (465 mPa×s at 12 rpm with rotor #2); however, the mixture still resembled nothing more than a slightly thicker solution. One common characteristic of all the mixtures 10% and under is that upon mixing the curdlan and water, a significant amount of froth is produced. This froth is not present at higher concentrations when a gel is produced.

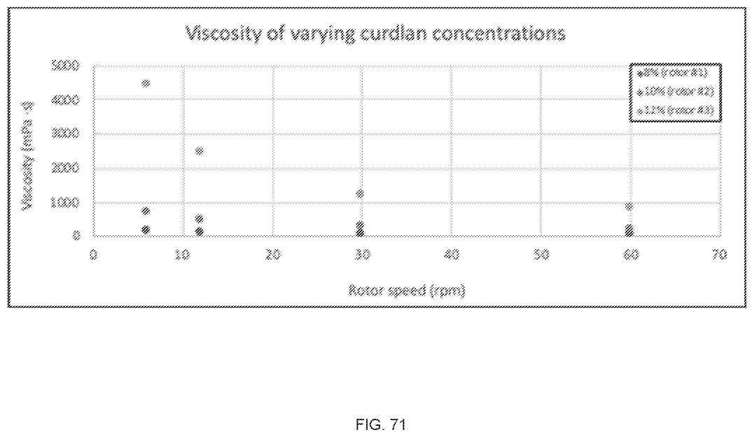

The real jump in viscosity takes place above 10% concentration. The increase in viscosity is dramatic once the 10% threshold is crossed (FIG. 71). Upping the concentration over 10% sees a physical change in the sample, from a solution to a gelled mixture. Although it may not be extremely accurate to compare two samples when using this viscometer if the rotor and rotor speed are not the same between samples, the significant difference in viscosity can be appreciated when using the viscosity values as a reference more than absolute values. Even with the slight 2% increase in concentration, from 10% to 12%, there is an approximately fourfold to six fold increase in viscosity. The same type of viscosity increase, perhaps even more so, is seen when the curdlan concentration increases from 12% to 14%. Again, this is more of a generalized conclusion as the viscosity of the 14% mixture causes the aperture angle to fall out of range, but the increase is definitely visible when blending the sample.

With a better instrument, the viscosity of higher curdlan concentrations could be measured; as there did look to be a difference between 14% and 15% mixtures but unfortunately, they both registered maximum viscosity values on this viscometer. Future testing will include measuring the viscosity of consumer products (i.e. pudding, dressing, non-dairy creamer, etc.) in order to compare their values with those in these tests and previous tests on paramylon products. That will provide a generalized idea of what applications might our paramylon products be best suited for.

### Common Food Thickeners

The selected common food thickeners in this study are xanthan gum, gellan gum and cellulose gum as seen in Table 100.

TABLE 100
Food thickeners and their physical characteristics. Concentrations
of the thickeners are in brackets in the column of pH.

| Sample | Molecular weight | pH Appearance | |
|---|---|---|---|
| Xanthan | 2000 kDa (average) | 6.28 (@ 1.5%) | Thick, off-white |
| gum | 300 kDa to | 6.07 (@ 3.0%) | (almost light |
| | 8 MDa | | grey) mixture |
| | (range) | | |
| Gellan gum | 500 kDa to | 4.82 (@ 0.25%) | Thick, off-white/ |
| | 1000 kDa | | light greyish |
| | (range) | | mixture |
| Cellulose | 50 kDa to | 6.71 (@ 2.5%) | Translucent, |
| gum | 800 kDa | | smooth-looking |
| | (range) | | mixture |

Viscosity measurements of the food thickeners were recorded in Table 101.

TABLE 101
Viscosity of varying concentrations of food thickeners.

| | | Rotor speed | Range | Viscosity |
|---|---|---|---|---|
| Sample | Rotor # | (rpm) | (%) | (mPa · s) |
| 0.5% xanthan gum | 2 | 60 | 83.9 | 401 |
| | | 30 | 73.9 | 707 |
| | | 12 | 64.8 | 1560 |
| | | 6 | 59.8 | 2860 |
| | 3 | 60 | 25.1 | 480 |
| | | 30 | 21.7 | 835 |
| | | 12 | 19.2 | 1844 |
| | | 6 | 17.9 | 3437 |
| 0.75% xanthan gum | 2 | 60 | 96.7 | 462 |
| | | 30 | 96.7 | 924 |
| | | 12 | 96.4 | 2306 |
| | | 6 | 96.7 | 4626 |
| | 3 | 60 | 41.9 | 802 |
| | | 30 | 37.6 | 1441 |
| | | 12 | 33.3 | 3189 |
| | | 6 | 30.1 | 5763 |
| | 4 | 60 | 20.1 | 1929 |
| | | 30 | 18.2 | 3483 |
| | | 12 | 16.2 | 7754 |
| | | 6 | 14.8 | 14213 |
| 1.0% xanthan gum | 3 | 60 | 60.7 | 1161 |
| | | 30 | 55.9 | 2139 |
| | | 12 | 48.4 | 4629 |
| | | 6 | 42.6 | 8153 |
| | 4 | 60 | 28.2 | 2704 |
| | | 30 | 24.8 | 4750 |
| | | 12 | 21.2 | 10207 |
| | | 6 | 18.6 | 17860 |
| 1.25% xanthan gum | 3 | 60 | 80.6 | 1539 |
| | | 30 | 71.9 | 2753 |
| | | 12 | 61.7 | 5900 |
| | | 6 | 54.8 | 10491 |
| | 4 | 60 | 36.6 | 3496 |
| | | 30 | 32.1 | 6148 |
| | | 12 | 27.6 | 13239 |
| | | 6 | 24.3 | 23248 |
| 1.5% xanthan gum | 3 | 60 | 96.7 | 1849 |
| | | 30 | 86.4 | 3305 |
| | | 12 | 73.3 | 7011 |
| | | 6 | 65.3 | 12495 |
| | 4 | 60 | 43.4 | 4155 |
| | | 30 | 37.9 | 7258 |
| | | 12 | 32.9 | 15760 |
| | | 6 | 29.4 | 28181 |
| 1.75% xanthan gum | 3 | 60 | 96.7 | 1850 |
| | | 30 | 96.6 | 3694 |
| | | 12 | 96.5 | 9214 |
| | | 6 | 91.0 | 17400 |
| | 4 | 60 | 54.8 | 5240 |
| | | 30 | 48.4 | 9269 |
| | | 12 | 42.8 | 20477 |
| | | 6 | 39.3 | 37635 |
| 2.0% xanthan gum | 4 | 60 | 64.5 | 6174 |
| | | 30 | 58.2 | 11131 |
| | | 12 | 51.9 | 24835 |
| | | 6 | 46.1 | 44108 |
| 2.25% xanthan gum | 4 | 60 | 70.0 | 6701 |
| | | 30 | 62.7 | 11199 |
| | | 12 | 55.9 | 26750 |
| | | 6 | 49.5 | 47412 |
| 2.5% xanthan gum | 4 | 60 | 80.2 | 7676 |
| | | 30 | 72.7 | 13910 |
| | | 12 | 64.6 | 30907 |
| | | 6 | 55.7 | 53322 |
| 2.75% xanthan gum | 4 | 60 | 86.0 | 8225 |
| | | 30 | 79.4 | 15192 |
| | | 12 | 71.4 | 34155 |
| | | 6 | 63.1 | 60394 |
| 3.0% xanthan gum | 4 | 60 | 96.8 | 9257 |
| | | 30 | 96.7 | 18490 |
| | | 12 | 96.7 | 46203 |
| | | 6 | 94.4 | 90296 |
| 0.25% gellan gum | 2 | 60 | 96.8 | 462 |
| | | 30 | 96.8 | 925 |
| | | 12 | 96.6 | 2313 |
| | | 6 | 96.7 | 4622 |
| | 3 | 60 | 47.5 | 910 |
| | | 30 | 33.3 | 1274 |
| | | 12 | 22.9 | 2194 |
| | | 6 | 18.3 | 3517 |
| | 4 | 60 | 25.8 | 2474 |
| | | 30 | 20.8 | 3984 |
| | | 12 | 15.8 | 7658 |
| | | 6 | 13.3 | 12794 |
| 0.5% gellan gum | 4 | 60 | 96.7 | 9251 |
| | | 30 | 96.4 | 18448 |
| | | 12 | 83.3 | 39749 |
| | | 6 | 66.9 | 63963 |
| 0.75% gellan gum | 4 | 60 | 96.7 | 9255 |
| | | 30 | 96.7 | 18496 |
| | | 12 | 96.7 | 46203 |
| | | 6 | 96.7 | 92595 |
| 0.5% cellulose gum | 1 | 60 | 96.8 | 92 |
| | | 30 | 96.7 | 184 |
| | | 12 | 47.4 | 226 |
| | | 6 | 23.5 | 233 |
| | 2 | 60 | 38.9 | 186 |
| | | 30 | 21.7 | 207 |
| | | 12 | 9.8 | 235 |
| | | 6 | 5.1 | 248 |
| 1.0% cellulose gum | 2 | 60 | 96.8 | 462 |
| | | 30 | 96.6 | 924 |
| | | 12 | 50.2 | 1201 |
| | | 6 | 27.6 | 1337 |
| | 3 | 60 | 45.5 | 870 |
| | | 30 | 27.4 | 1048 |
| | | 12 | 13.7 | 1314 |
| | | 6 | 7.8 | 1504 |
| 1.5% cellulose gum | 3 | 60 | 96.7 | 1849 |
| | | 30 | 85.4 | 3264 |
| | | 12 | 46.9 | 4490 |
| | | 6 | 27.1 | 5192 |
| | 4 | 60 | 58.1 | 5560 |
| | | 30 | 37.3 | 7150 |
| | | 12 | 20.1 | 9631 |
| | | 6 | 12.0 | 11544 |
| 2.0% cellulose gum | 4 | 60 | 96.8 | 9255 |
| | | 30 | 96.8 | 18513 |
| | | 12 | 58.8 | 28149 |
| | | 6 | 36.2 | 34641 |
| 2.5% cellulose gum | 4 | 60 | 69.8 | 9255 |
| | | 30 | 96.7 | 18496 |
| | | 12 | 96.6 | 46175 |
| | | 6 | 69.0 | 66048 |

The viscosity testing of the food thickeners/stabilizers was predictable; increasing concentrations demonstrated increasing viscosities in the exponential/cubic growth range. The main takeaway was the difference in inclusion rates that were necessary to produce increased viscosity for each product. Although all three products required very low inclusion rates, differences between products could still be seen.

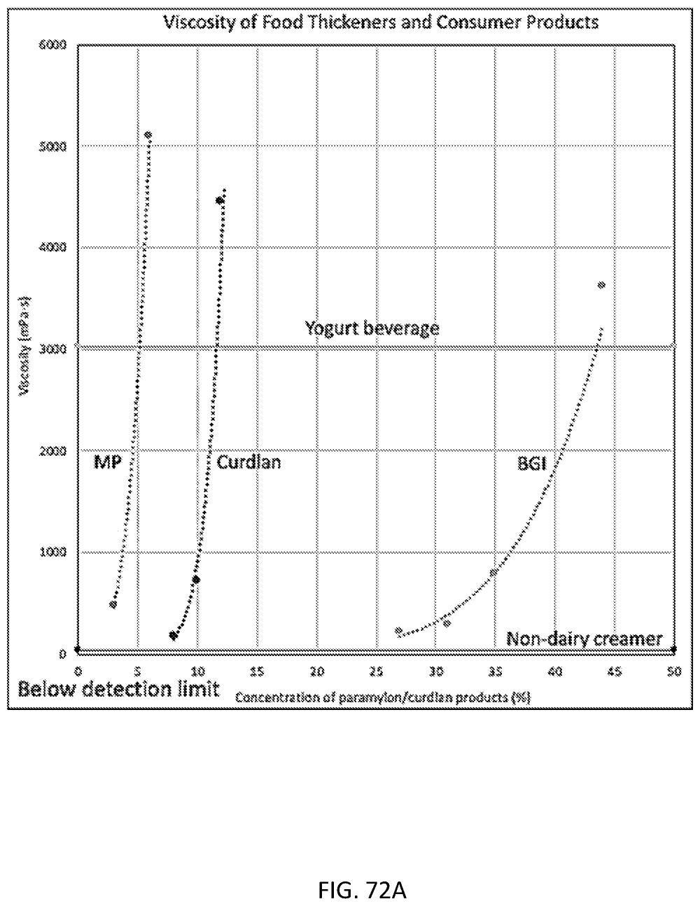

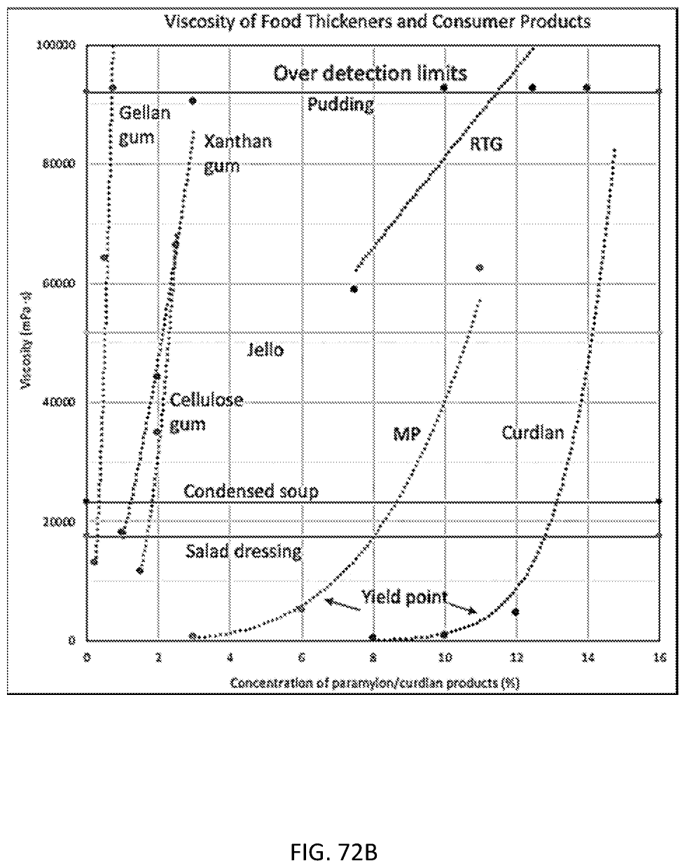

Gellan gum was by far the most effective food thickener (effectiveness' being measured by the ability of the product to produce an increased viscosity with a low inclusion rate, nothing to do with quality or usability of the thickener); while xanthan gum and cellulose gum were reasonably comparable to each other (FIGS. 72 A and B). A 0.5% gellan gum mixture was able to produce similar viscosity as mixtures of 2.75% xanthan gum and 2.5% cellulose gum, needing about one fifth of the other two products to produce similar viscosity.

When compared to cellulose gum, xanthan gum looks to be more viscous at lower inclusion rates (up to 2%) but by 2.5%, the viscosity of a cellulose gum mixture is slightly more than that of a xanthan gum mixture. The limitation of the viscometer didn't allow to test an inclusion rate higher than 3% for these thickeners but it is possible that cellulose gum produces higher viscosities than xanthan gum above a 3% inclusion rate. However, something like that is difficult to ascertain given the small sample size and range that was tested.

When compared to the viscosity of curdlan, paramylon products and commercial food products (yogurt, creamer, salad dressing, condensed soup Jello and pudding), based on the ratio of percent inclusion to viscosity, these three food stabilizers are more effective (again, in a less inclusion equals more viscosity assessment) (FIGS. 72 A and B). When compared to 0.5% gellan gum, 2.5% xanthan gum or 2.5% cellulose gum, it would take an inclusion rate of about 8.0% RTG BGI, 11.0% milled paramylon, or 13% curdlan to create a similar level of viscosity.

Conclusions regarding value (as it pertains to inclusion rate and price per unit weight), interactions with other ingredients, and function in certain products cannot be made through this study alone and would require more extensive testing and research.

### Conclusions

The viscosity of the paramylon products including paramylon granules, RTG and milled paramylon under different concentrations has been detected using a NDJ-5S viscometer, and was compared to the common food thickeners and some commercial products. The results show that the viscosity of paramylon granules was much lower than milled paramylon, and RTG is most viscous. The effect of work temperature, stirring rate and stirring time on the viscosity of the products had been evaluated. The key effects are as:
1. The viscosity of paramylon granule at 40° C. is higher than at 0° C. and room temperature, while that of milled paramylon increases with the temperature.
2. The viscosity of paramylon granule increases with stirring time up to 10 min, and then be stabilized, while that of milled paramylon decreases with stirring time up to 10 min and then be stabilized

Compared to commercial food products in terms of viscosity, the stable BGI granules with a ˜30% concentration is similar to yogurt beverage, Milled paramylon with 6% (w/v) to 11% (w/v) is in the range from salad dressing, condensed tomato soup to Jello, and RTG can be up to Pudding.

This study suggests that the paramylon can emerge into some food thickener or food products, or even replace them.

When compared to xanthan gum and cellulose gum, one fifth of the amount of gellan gum was able to produce the same level of viscosity. Cellulose gum produced a translucent, smooth-looking mixture while xanthan gum and gellan gum produced similar thick, off-white/light grey coloured mixtures. When compared to current paramylon products, in order to generate a similar viscosity as cellulose, xanthan and gellan gum, a higher inclusion percentage of paramylon product is needed.

### Example 55: Rheological and Textual Properties

This study was to investigate the rheological and textural properties of paramylon products including RTG, Milled paramylon and Paramylon granules, and then to assist to understand the BGI materials structure, and explore their potential application. The study was mainly on the viscosity vs shear rate at different concentrations and temperatures, storage/loss modulus at different concentrations, and the compressive modulus (Young's modulus) for RTG. Commercial products were used to level our products.

### Materials

RTG, milled paramylon and Paramylon granules were used. Milled paramylon was prepared using CMC milling Co. using a reported method in our previous milling paramylon study. RTG was prepared using citric acid and NaOH as what we reported in RTG study. The solution with different concentrations were listed in Table 102.

TABLE 102
The samples and testing Parameters in this study

| | Viscosity vs. | Gel | |
|---|---|---|---|
| Sample | Shear Rate | Strength | Comments |
| RTG 7.5% | X | | gel |
| RTG 10% | X | X | gel |
| RTG 15% | X | X | hard gel |
| MP 3% | X | | milk-like |
| MP 6% | X | | yogurt-like |
| MP 11% | X | | icing-like |
| BGI 27% | X | | white milk-like |
| BGI 35% | X | X | white cream-like |
| BGI 44% | X | X | white thick paste, |
| | | | phase stable |
| Sample #1 (Condensed | X | | comparable to MP |
| Tomato Soup) | | | |
| Sample #2 (Yogurt | X | | comparable to BGI |
| beverage) | | | |
| Sample #3 (Jello) | | X | comparable for RTG |

### Instrument and Methods

Viscosity Vs. Shear Rate Test

The shear thinning properties of the samples were measured using the Discovery Hybrid Rheometer (from TA Instruments) operating under a 20 mm diameter parallel-plate geometry and a plate spacing of 1 mm. A shear sweep between 0.1 to 100 rad/s was used to measure the viscosity at 4° C., 25° C., and 40° C. Each measurement was taken from approximately 0.4 mL of sample. All measurements were repeated 3 times using independent samples, with error bars representing one standard deviation of the replicated measurements (n=3).

### Rheological Test (Strain and Frequency Test)

The rheological properties of the samples were measured using the Discovery Hybrid Rheometer (from TA Instruments) operating under parallel-plate geometry with a plate diameter of 20 mm and a plate spacing of 1 mm. A strain sweep from 0.1 to 100% strain was first conducted at 1 Hz to identify the linear viscoelastic range of the hydrogels. A strain was then selected from within this linear range and set as a constant to perform a frequency sweep from 1 to 100 rad rad/s to measure the storage modulus (G′) and loss modulus (G″). Each measurement was taken from approximately 0.4 mL of sample. All measurements were conducted at 25° C., with error bars representing the standard deviation of the replicated measurements (n=3 independent samples).

### Elasticity Testing

The compressive modulus of the samples was measured using the MACH-1 (Micromechanical System) under unconstrained compression with the plate diameter of 12.7 mm. The probe was brought to contact, and the sample was subsequently compressed to 20% of its original height at a rate of 0.03 mm per second. All measurements were conducted at 25° C., with error bars representing the standard deviation of the replicate measurements (n=3 independent samples).

### Results

Viscosity Vs. Shear Rate

In rheology, viscosity or shear viscosity is defined by the ratio of shear stress and shear rate. The relationship between viscosity and shear rate can give the information of fluid behaviours, such as Newton fluid, shear-thickening or shear-thinning fluid.

### BGIs

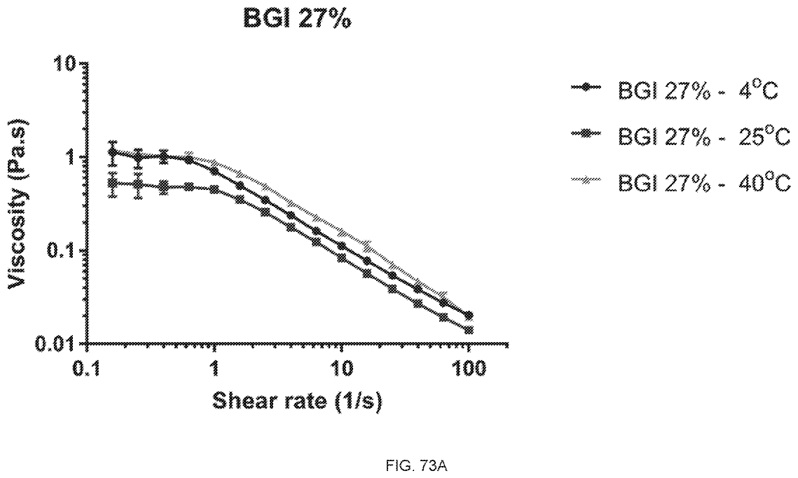

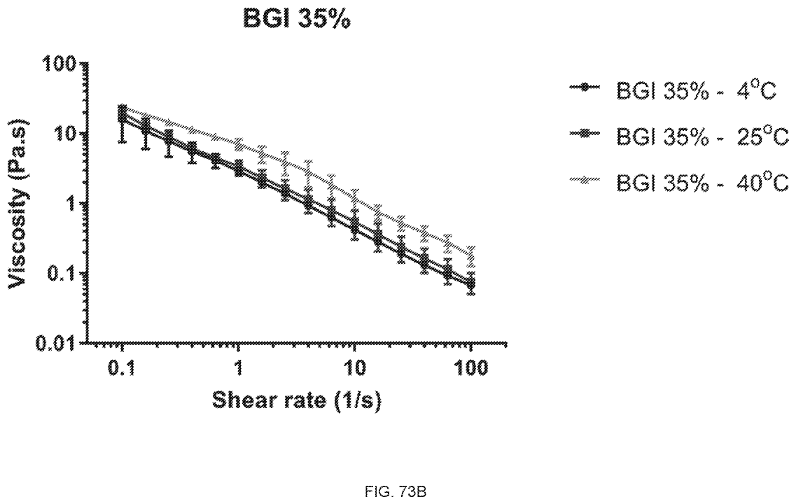

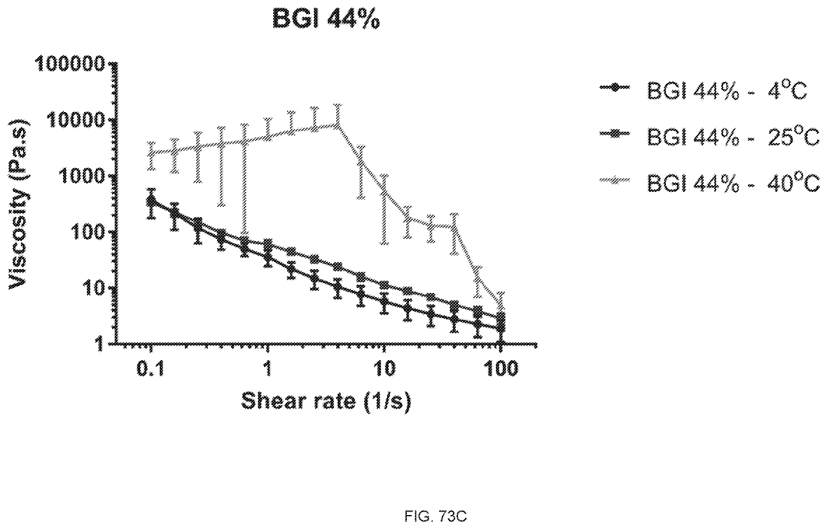

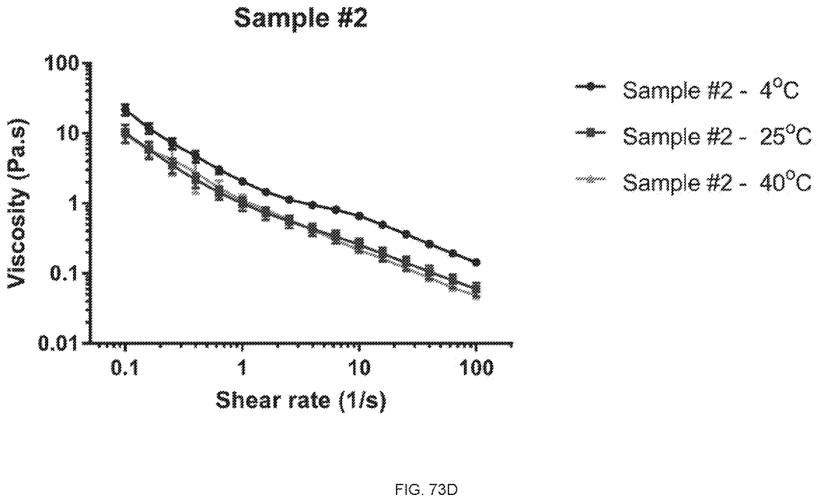

The viscosity of the BGIs at concentration of 27%, 35% and 44% was measured at increasing shear rate at different temperatures. Interestingly, the viscosity of the BGI samples at 40° C. was higher than at 25° C. and 4° C., more appeared at higher concentration. This could be because the particles become softened and the interaction increases. Generally, the shear-thinning behaviours were observed in BGI granules as seen in FIG. 73 A through D. The sample at 27% showed newton behaviours at low shear rate (<1 l/s), while the sample at 44% at 40° C. seems shear-thickening fluid when shear rate is less than 5 l/s. This reason for this finding is not clear yet, but it is believed that the interaction between the particles plays a key role. A Yogurt beverage was used to measure the level of the viscosity of BGI materials. One can see that the viscosity of BGI at concentration of 35% matches the Yogurt materials.

### MP

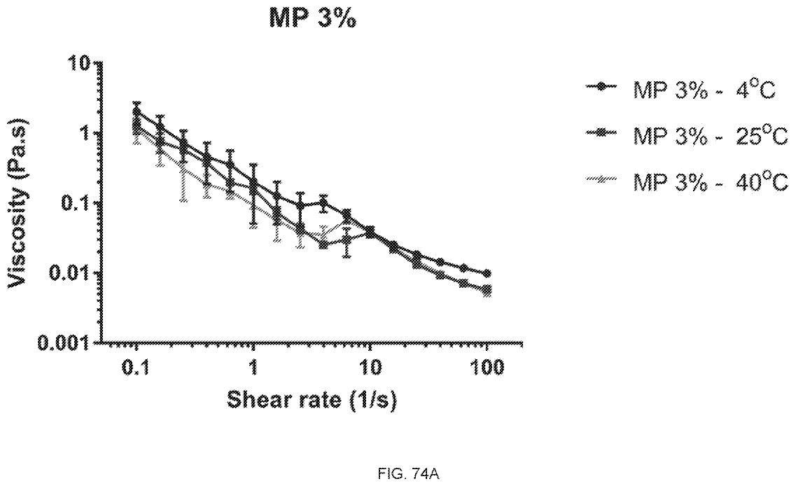

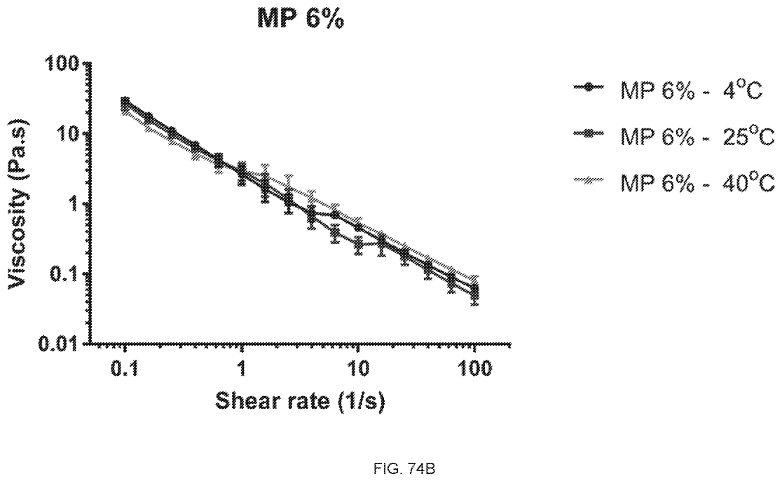

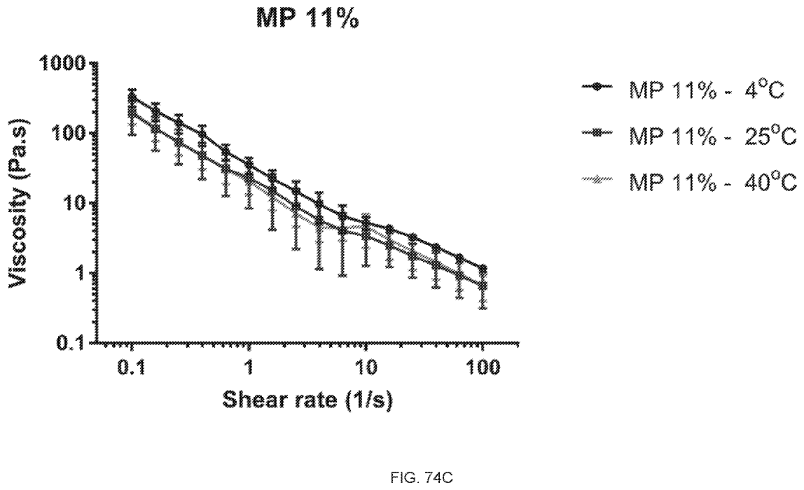

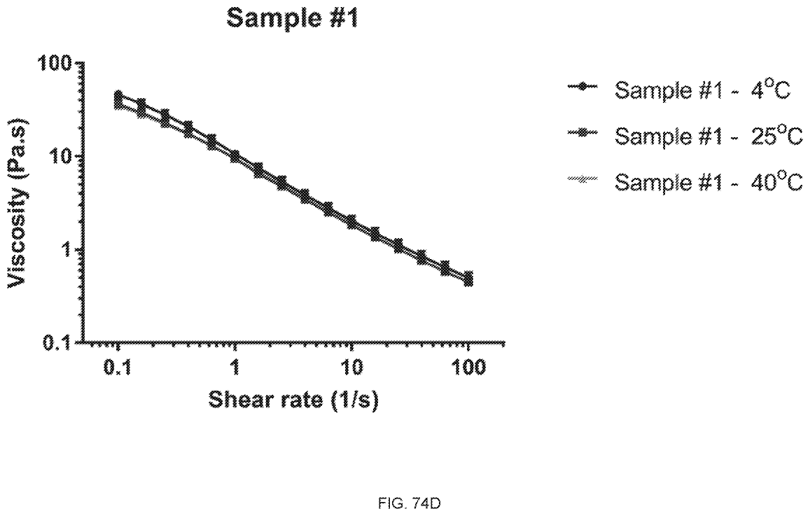

As seen in FIG. 74 A through D, the MPs are general shear-thinning fluid. At the certain shear rate range, there are enhanced interforce (considered as hydrogen bonds) appearing, which allow the MPs as Newton or shear-thickening behaviours. The exchange shear rates are 2 to 10 l/s for MP-3%, around 1l/s at 40° C. and around 10 l/s at 4° C. and 25° C. for MP-6%, and around 10 l/s for MP-11%/. A condensed tomato soup was used as a comparison for MPs. One can see that the viscosity of condensed tomato soup is between the MP-6% to MP-11%. Compared with BGI, the viscosity of MP-3%, MP-6% and MP-11% is similar to BGI-27, BGI-35% and BGI-44%, respectively.

Not surprisingly, the viscosity of the RTG decreases with an increase of temperature. An exchange critical shear rate was detected at around 5 to 10 l/s, which could be the shear rate to break the gel, reaching a gel point.

### Storage Modulus (G) and Loss Modulus (G′)

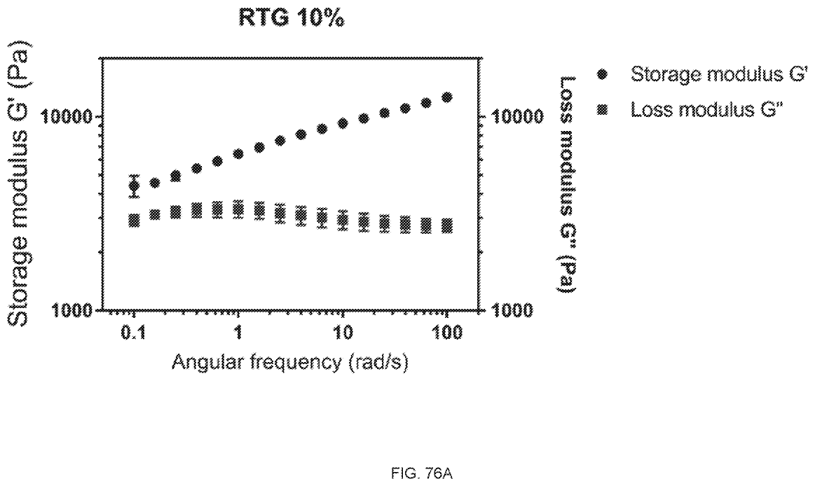

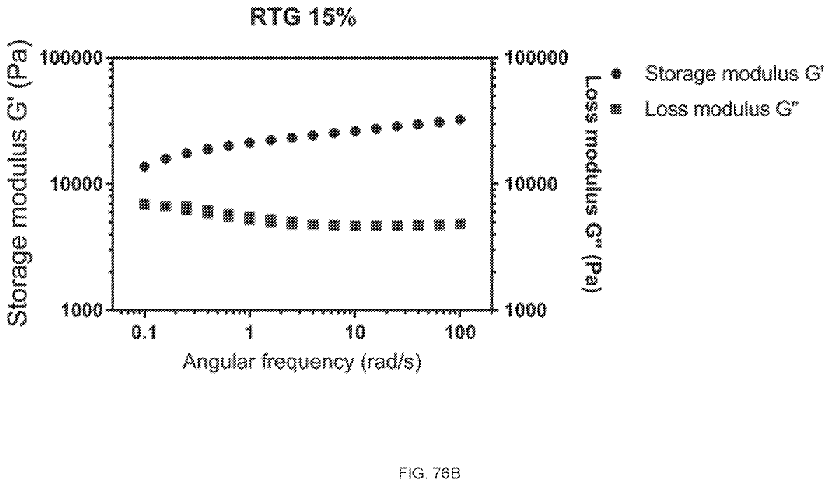

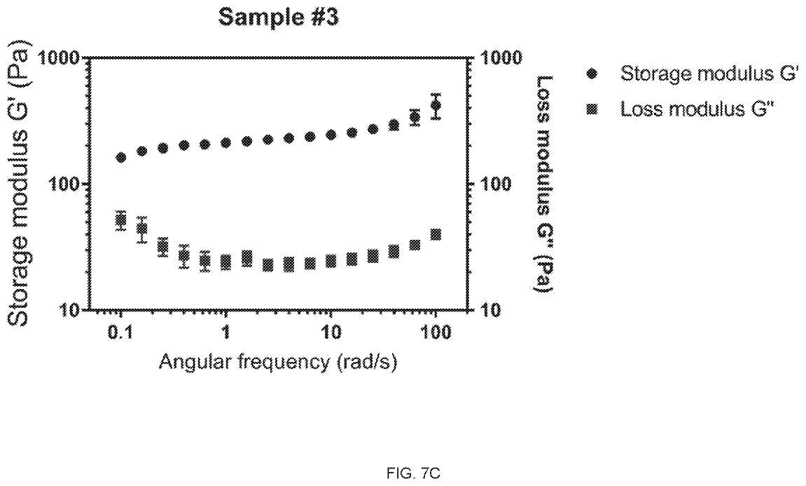

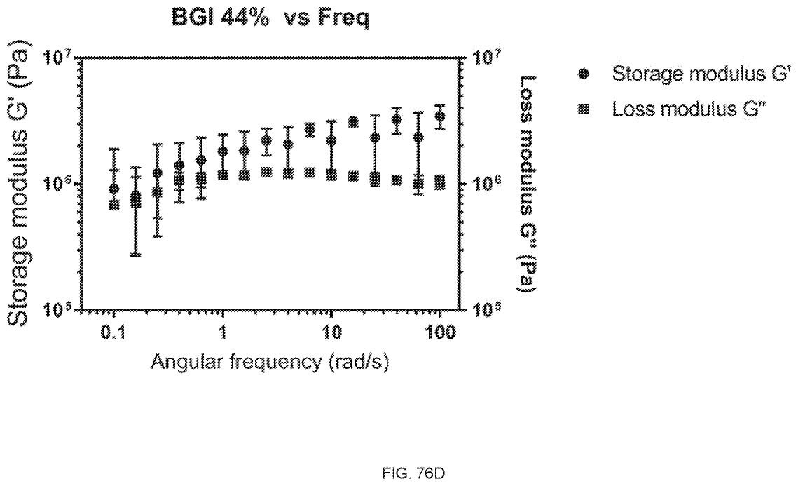

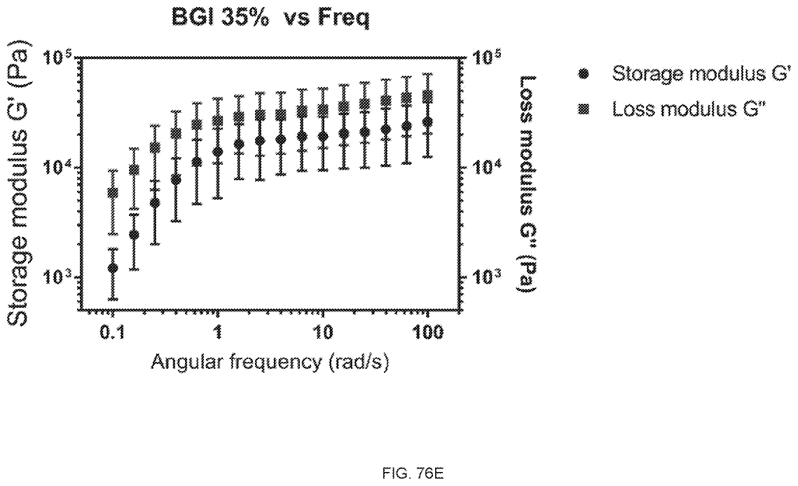

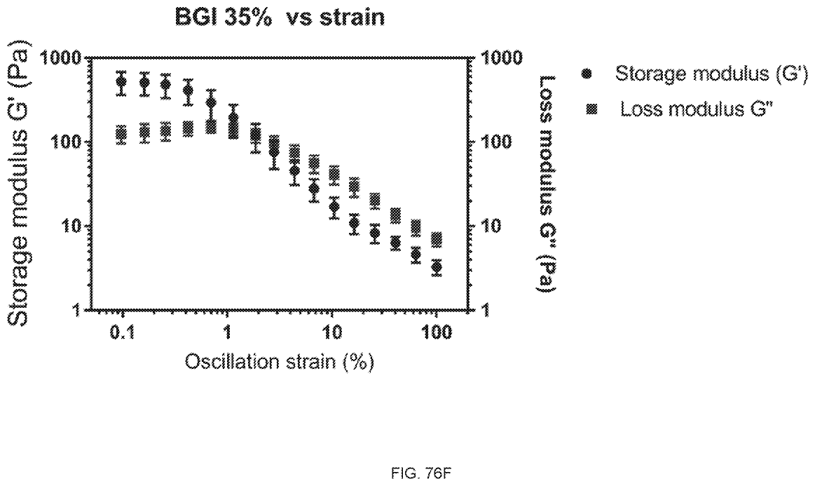

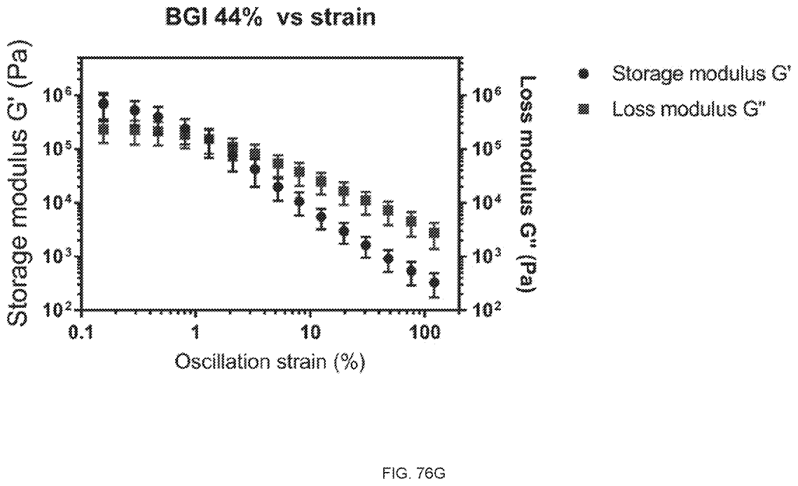

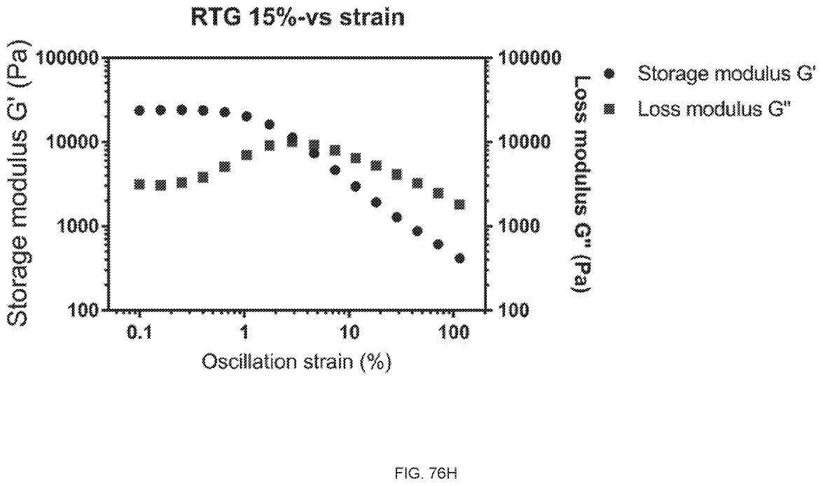

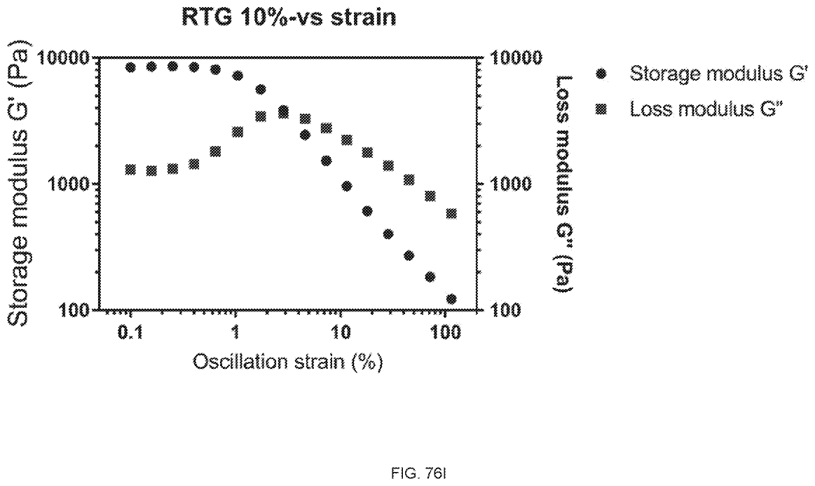

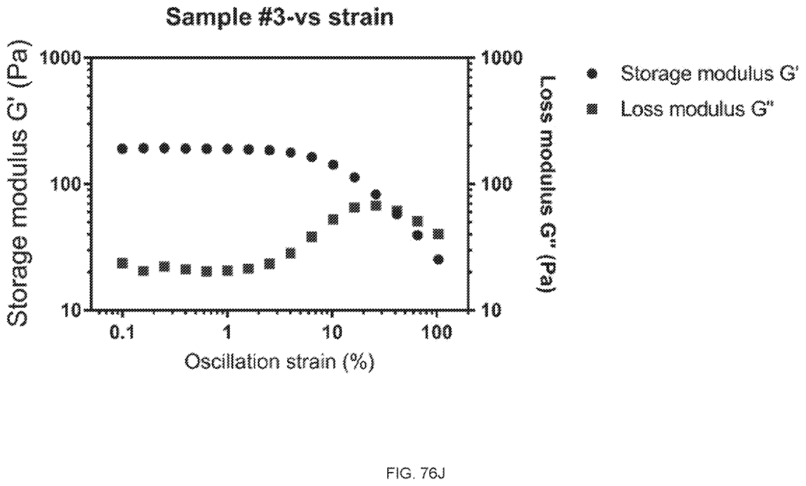

The storage and loss modulus were measured using oscillatory tests to give viscoelastic behaviour. The results were shown in FIG. 76 A through J. Storage modulus represents the elastic portion, and loss modulus of the viscoelastic behavior. As seen in the graphs of modulus vs strain, the gel point of RTG was at around 5% deformation, but a Jello (as comparison) has a gel point at around 12% deformation. The portion of elastic of Jello is in between RTG-10% and RTG-15% according to the tan delta which is the ratio of loss modulus/storage modulus.

The rheological test of BGI at different concentrations (35% and 44%) was also carried out for storage/loss modulus vs strain/frequency at 40° C. It was found that, with the concentration of BGI increasing from 35% to 44%, the modulus increases dramatically from 1000 Pa to 10⁶ Pa. At the testing range, BGI-35% is a viscous fluid, but BGI-44% can be an elastic material when frequency is up to 1 rad/s under a 0.5% strain.

### Elasticity Testing

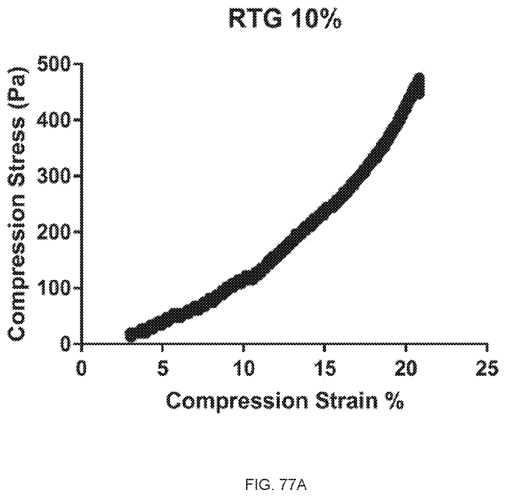

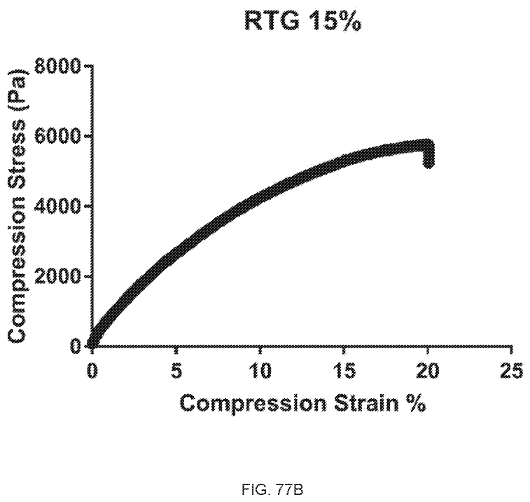

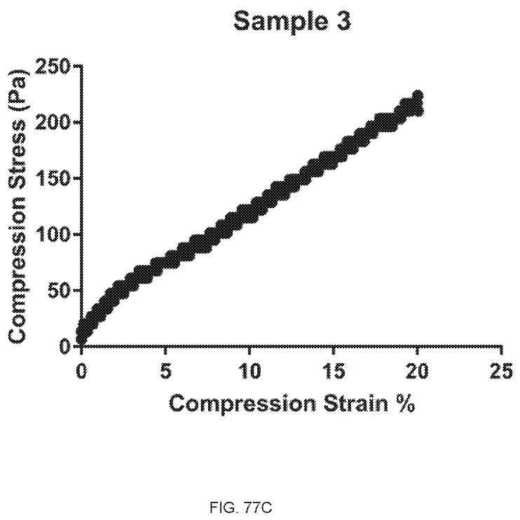

The mechanical property of a material can also be measured by Young's modulus or compressive modulus using a compression test, given by the slope of the curve between compression strain and stress. As seen in FIG. 77 A through C, RTGs are stiffer than the Jello, the comparison. These results were supported by their storage modulus.

### Conclusions

The rheological and textural properties of Paramylon materials including RTG, milled paramylon and paramylon granules were investigated in this study. Generally, the subjects showed shear-thinning behaviour. However, there were some critical shear rate ranges giving fluid behaviour exchanges due to the interaction in MP and BGI, or gel point in RTG. The viscosity or fluid behaviour of BGI and MP was similar to their comparisons such as Yogurt and condensed tomato soup, respectively.

Gel properties of RTG were also measured by storage/loss modulus in a rheological test, or Young's modulus in a compression test. Gel point of RTG appeared at a strain of ˜5%, lower than a Jello which is at ˜12%. Storage/Loss modulus of RTG suggested that the elastic portion increased with an increase of concentration, as well as hardness (stiffness).

Elastic properties of BGI at different concentrations (35% and 44%) were also measured by storage/loss modulus vs strain/frequency at 40° C. The results showed that the storage/loss modulus of BGI-44% was much higher than that of BGI-35% (10⁶ pa vs 1000 pa). At the test range, BGI-35% appeared as viscous fluid. However, there was a clear crossover point for BGI-44% when frequency at around 1 (rad/s), indicating that BGI-44% became an elastic material.

The rheological results give similar information as what we found in viscosity studies. The Paramylon materials can be compared with commercial food products, directing our product development.

### Example 56: Thermal Stability and Thermal Behaviours

This study is to understand the thermal behaviour and thermal stability of our paramylon products including paramylon granules, wet milled paramylon (Freeze dried) and RTG samples. This will benefit to process our paramylon products and understand their thermal behaviours, such as water holding capacity vs temperatures.

### Samples

TABLE 103
Samples name tested, its appearance and notes

| Sample | Appearance | Note |
|---|---|---|
| BGI1 | White solid | BGI-9Jun07-120-1 |
| MPF | White solid | Freeze dried Milled samples MPF), |
| | | Milled paramylon was |
| | | prepared using CMC-milling method |
| RTGF | White solid | Freeze Dried RTG, prepared using |
| | | the optimized method |
| | | from BGI and Citric acid. |
| RTGS | White solid | Spray Dry |
| WS | White solid | Water Saturated, prepared using the |
| BGI | | method listed in water holding capacity, |
| | | and then freeze dried. The Water content |
| | | is around 50%. |

### Instrument and Methods

Thermogravimetric Analysis (TGA) was carried out on a Mettler Toledo TGA/DSC 1 Star System. 10 mg samples was directly weighted into a ceramic pan and then heated from 25 C to 500° C. at a heat rate of 10° C./min

Dynamic Scanning calorimetry (DSC) was carried out on Mettler Toledo Polymer DSC. 3 mg sample was directly weighted into an aluminum pan, and heated from −20° C. to 300° C. at a heat rate of 5° C./min with a 5-minute isothermal hold at −20° C.

Both TGA and DSC data were analyzed using Software—Mettler STARe version 16.

Note that DSC results in this study reflect the thermal memory of materials, meaning that the results are related to the sample's processing methods.

### Results and Discussions:

### Thermal Behaviours by DSC

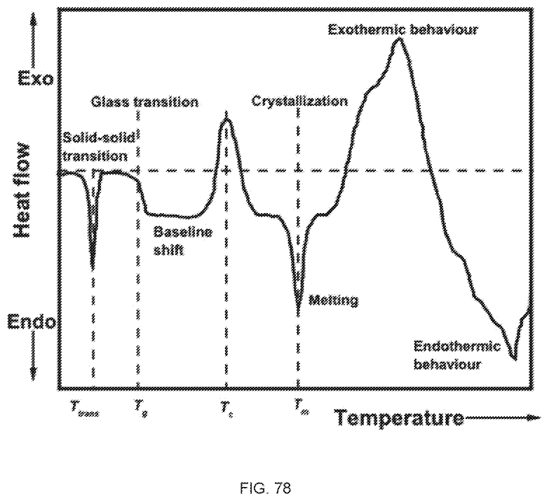

Differential Scanning calorimetry (DSC) is used to determine the thermal behaviour of the materials, including glass transition temperature (T_{g}), crystallization temperature (T_{c}), and melting temperature (Tₘ), as well as reactions (for example, crosslink or decomposition), as seen in FIG. 78. In this study, the melting behaviours are the main consideration. Normally, for a certain material, higher melting temperature means more stable crystal or ordering structures by a stronger inter-force; sharper melting range means perfecter crystal structure; higher melting enthalpy means more crystal.

Five samples were tested on DSC in the temperature range −20-300° C. below their decomposition temperature (around 300° C.). The results were summarized in Table 104.

TABLE 104
DSC results of paramylon products. Tₘ: melting temperature;
Tₘ₂: secondary melting temperature; Tₘ range: melting range;
T_{g}, glass transition temperature.

| Sample | Tₘ | Tₘ₂ | Tₘ range | Enthalpy | | T_{g} |
|---|---|---|---|---|---|---|
| BGI | 153.0 | | 152.1-159.76 | 94.07 | J/g | |
| MPF | 142.9 | ~123 | ~115-153 | 288.73 | J/g | |
| RTGF | 162.9 | | 161.8-171.1 | 72.01 | J/g | |
| RTGS | 151.7 | | 150.3-169.0 | 103.25 | J/g | 77.6 |
| WS BGI | 162.27 | | 161.27-168.9 | 58.89 | J/g | |

As seen in Table 104, the melting point of paramylon granules is around 153-160° C., which matches the reference where 340° F. were reported as melting temperature.

Interestingly, Water Saturated BGI (freeze dried) (WS BGI) showed higher melting point, but lower enthalpy compared with BGI granules, suggesting that WS BGI has better crystal or/and more ordering structure than BGI granules. SEM images show that the surface of WS BGI presents amorphous structure, which cannot contribute to melting behaviour. This can explain why the melting enthalpy in WS BGI is lower. Higher melting point suggests that the crystal or/and ordering structure in BGI granules is different between out-layer and inner-layer of granules.

Milled paramylon has the lowest melting temperature, but broadest melting range and highest enthalpy. There are two phase change temperatures (Tₘ and Tₘ₂), Tₘ₂ related phase change is considered as water evaporation. TGA had shown that there is around 17% water in MPF. It is interesting that melting phase change related to water (at ˜0° C.), suggesting that the water in MPF was bonded onto beta-glucan (BG) chain, and preventing the formation of water crystal (ice). This finding suggests that the MPF can be used for anti-freeze agent. As well, MPF has lower molecular weight and wider molecular weight distribution, which gives the broader melting range. Higher enthalpy can be related to more ordering/crystal structures.

RTGF presents very similar melting temperature and melting range as WSBGI, only with higher melting enthalpy. It can be explained that the melting phase in both of RTGF and MPF is likely based on similar ordering structure, but the structure density is higher in RTGF that in WSBGI.

Compared to RTGF, lower melting temperature but broader melting range were found in RTGS. The higher sodium citrate content in RTGS can be a reason for this finding. The melting behaviour of sodium citrate interacted with the melting behaviour of RTG. T_{g} at 78° C. coming from sodium citrate is the evidence that free sodium citrate presents in RTGS, but not apparently in RTGF. The spray drying could also break down the cross-linking structure.

### Thermal Stability by TGA

TGA (thermogravimetric analysis) is used to determine the weight loss of the samples under temperature. The weight loss comes from the evaporation of vapours arising from low boiling point materials or fractions of decomposition. TGA is a normal tool to test the thermal stability of a materials, and further to understand the thermal degradation mechanism.

TABLE 105
TGA results of paramylon products. T_{d}: degradation temperature;
1, first step, 2, second step, 3, third step; WL: weight loss.

| Sample | T_{d1} | WL_{d1} | T_{d2} | WL_{d2} | T_{d3} | WL_{d3} | Ash |
|---|---|---|---|---|---|---|---|
| BGI1 | 80-100 | 3.6% | 300-320 | 74% | | | ~15% |
| MPF | 80-100 | 16.6% | 280-300 | 63.0% | | | ~21% |
| RTGF | 80-100 | 4.9% | 210-220 | ~40% | 280-300 | ~10% | ~30% |
| RTGS | 80-100 | 6.6% | 210-220 | ~41% | 280-300 | ~12% | ~42% |
| WS BGI | 80-100 | 3.4% | 280-300 | ~65% | | | ~22% |

In this study, five paramylon products were tested, and the results presented in Table 105. For the paramylon products, there are mainly two degradation steps except in RTGs. First step at 80-100° C. is related to water evaporation. MPF contains the largest water content up to 17%, and the water was confirmed to be bonded onto glucan chain, as well as other. WS BGI (freeze dried) and BGI have similar water content as around 3-4%, but RTG has around 5-7%. As well, the RTGS has higher water content than RTGF. This can be risen by sodium Citrate that is higher content in RTGS than in RTGF. Second step for BGI, WS BGI and MPF is between 280 to 320° C., suggesting that the polysaccharides linkages were mostly broken down in this temperature. The results match curdlan very well. In this temperature range, BGI have largest weight loss, leading to a low ash content. Compared to BGI, MPF and WSBGI have more surface, therefore give more ash content. For this finding, there is no clear answer yet. Assumingly, the surface of paramylon products can absorb materials from the environment, or form cross-linking structure that prevent the degraded fraction from evaporation, and then product ash leftovers. In this view, higher surface area gives higher ash content.

In RGT samples, RTGF and RTGS, the second degradation step moved to the temperature of 210-220° C., and much higher ash content. Both of them can be explained by the existence of sodium citric acid.

### Conclusions

Five paramylon products including Paramylon granules, Milled Paramylon and RTG were tested on DSC and TGA. The thermal behaviour and thermal stability are product related. Higher melting points were found in RTGF and WSBGI, but larger enthalpy was found in MPF. Sodium citric acid was found to interact with the thermal behaviour of beta-glucan.

3-17% water was found to remain in the samples. Mostly likely, the water is bound on to the glucan chain, but not free water, evidenced by DSC, suggesting that the Paramylon materials can function as anti-freezing materials. The glucan linkage was decomposition at a temperature of 280-320° C., suggesting the processing temperature of paramylon products (except RTG) is no more than 230° C. (50° C. below their decomposition temperature). Due to the existence of sodium citrate, the degradation of RTG samples was brought down to 210-220° C.

### Example 57: Functions of Paramylon in Plant-Based Protein Drink Product

This study investigated whether Euglena paramylon granules prevent or delay settlement of the protein powder in the plant protein shake drink.

### Methods and Materials

An unsweetened plant-based protein shake which has acacia gum in the formulation, spray dried paramylon granules, and deionized water were used to prepare protein drinks in the absence (control) and presence of paramylon isolate at different concentrations.

The plant protein shake powder and paramylon granule are mixed together prior to addition of water. The amount of each powder is seen below:

According to the powders' label instruction, one scoop of the powder (39 g) must be mixed with 1.5 cups of water (12 fl.oz.). This is approximately 10% of the powder in the drink, making a total solid of 10% (w/v).

2 sets of prototypes were made both including 0, 1, 3, and 5% paramylon granules in the formulations.

Variable total solids (1st set): 0, 1, 3, and 5% (w/v) paramylon was included in addition to 10% powder, therefore the final total solid content became 10, 11, 13, and 15% (formulations are shown in Table 106).

Constant total solid content (2nd set): the total solid content was kept at 10%, therefore 0, 1, 3, and 5% of plant protein powder was substituted with paramylon (formulations are shown in Table 107).

After vigorously shaking, pictures of each prototype were taken at time 0, 5, 10, 20, 30, 60 min and after overnight storage to investigate the effect of paramylon inclusion in the settlement of the plant protein powder in the drink.

TABLE 106
Formulation of plant protein drink containing 0, 1, 3, and 5%
in addition to plant protein powder. Variable Total Solid

| | Control | 1% | 3% | 5% |
|---|---|---|---|---|
| | (0%) | Paramylon | Paramylon | Paramylon |
| | % | % | % | % |
| Water | 90 | 89 | 87 | 85 |
| Plant Protein | 10 | 10 | 10 | 10 |
| Powder | | | | |
| Paramylon granules | 0 | 1 | 3 | 5 |
| Total | 100 | 100 | 100 | 100 |

TABLE 107
Formulation of plant protein drink containing 0, 1, 3, and 5%
in substitution for plant protein powder. Constant Total Solid

| | Control | 1% | 3% | 5% |
|---|---|---|---|---|
| | (0%) | Paramylon | Paramylon | Paramylon |
| | % | % | % | % |
| Water | 90 | 90 | 90 | 90 |
| Plant Protein | 10 | 9 | 7 | 5 |
| Powder | | | | |
| Paramylon granules | 0 | 1 | 3 | 5 |
| Total | 100 | 100 | 100 | 100 |

### Results

The results showed the following:

When paramylon was added in addition to the 10% protein powder especially at high paramylon concentration such as 5%, the presence of paramylon delayed the settlement of the protein powder for about 10-20 min (which could be within the timeline many people finish their drink), and even after 20 min, up until one hour, less settlement was observed in the presence of paramylon (especially at higher paramylon concentrations).

When the total content was kept constant (10%), paramylon especially at higher concentrations delayed the protein settlement for the first 5-10 min but lesser of the “settlement prevention” effect was observed compare to when paramylon was added on top of the 10% protein powder.

Regardless of the total solid being constant or variable, paramylon concentration has a direct positive effect on delaying the settlement of the protein powder in the drink (more paramylon delays the plant powder settlement more).

Regardless of the total solid being constant or variable inclusion of paramylon showed a whitening effect on the plant protein drink which again was in a direct relationship with the paramylon concentration.

In all prototypes, the presence of paramylon did not adversely affect the sensory profile of the prototypes, in fact paramylon seemed to mask the earthy taste of plant based protein drink.

The delayed settling of the powder showed an effect between the paramylon and the protein powder. In order to determine if it is a synergistic effect with the acacia gum (gum arabic) present in protein powder with Euglena's paramylon, an interaction experiment is performed in the example below.

The viscosity synergism index is used to determine if there is a synergistic effect or not. The equation is below:

Viscosity Synergism Index (Iv)=nⱼ₊ᵢ/(nⱼ)+(nᵢ)

Where nᵢ and nⱼ are the measured viscosity of the individual hydrocolloids, and nⱼ₊ᵢ is the measured viscosity of the hydrocolloid blend. If the index number is greater than 1, than there is a synergistic effect. If the number is 1, there is an additive effect. If the number is less than 1 then there is an inhibitory effect. The measured viscosity is in cp/min at 20° C.

In addition, the sedimentation rate is measured to determine the rate of which the particles fall out of solution. The formula is as follows:

Sedimentation rate (%)=100−((Height of the sedimentation (in mm)/Total height of the liquid (in mm))×100)

Where the height of the sedimentation is measured in mm and the total height of the solution is measured in mm. Sedimentation refers to the particles in the solution, in these examples they are the plant-based protein shake, as well as the paramylon granules. A lower number indicates that the particles stay suspended in the solution, while the higher number indicates that the particles fell out of the solution.

TABLE 108
Sedimentation rate of variable total solid solutions
containing plant protein drink and paramylon granules
Variable total solids (set 1)

Percentage inclusion of paramylon granules

| Time | 0% | 1% | 3% | 5% |
|---|---|---|---|---|
| (min) | (control) | paramylon | paramylon | paramylon |
| 0 | 0 | 0 | 0 | 0 |
| 5 | 62.5 | 30.4 | Not clear | Not clear, |
| | | | | close to 0 |
| 10 | 62.5 | 43.5 | 8.7 | 2.2 |
| 20 | 61.5 | 52.0 | 16.0 | 4.0 |
| 30 | 64.0 | 54.2 | 25.0 | 8.3 |
| 60 | 66.7 | 58.3 | 37.5 | 12.5 |
| Overnight | 62.5 | 60.9 | 54.3 | 39.1 |

In Table 108, the sedimentation values for the variable total solid samples (from Table 106) are reported. The control showed the highest sedimentation of particles over all time points where as the highest inclusion of paramylon showed the lowest amount of sedimentation. Both the 3% and 5% inclusion rate of paramylon showed a decrease in the sedimentation in comparison to the control, the 1% inclusion showed a slight decrease in the sedimentation rate.

TABLE 109
Sedimentation rate of constant total solid solutions
containing plant protein drink and paramylon granules
Constant total solids (set 2)

Percentage inclusion of paramylon granules

| Time | 0% | 1% | 3% | 5% |
|---|---|---|---|---|
| (min) | (control) | paramylon | paramylon | paramylon |
| 0 | 0 | 0 | 0 | 0 |
| 5 | Not clear | not clear | 13.0 | 8.7 |
| 10 | 60.9 | 47.8 | 21.7 | 19.6 |
| 20 | 60.9 | 56.5 | 34.8 | 34.8 |
| 30 | 60.9 | 56.5 | 43.5 | 41.7 |
| 60 | 60.9 | 56.5 | 52.2 | 47.8 |
| Overnight | 62.5 | 60.9 | 60.9 | 60.9 |

In Table 109, the control had the highest sedimentation rate at all time points, where as the 5% inclusion of paramylon had the lowest overall sedimentation rate. 3% and 5% paramylon inclusion had the largest effect on settlement of the protein powder, where as the 1% inclusion had a slight improvement of the sedimentation rate. A not clear label indicates that there was not a clear distinction of the sedimentation line in order to make a measurement.

### Discussion

The results above showed that inclusion of paramylon can help with delaying the protein powder settlement in plant-based protein shake. Paramylon also whitens the drink which mellows its original darker murky green colour to a lighter, less turbid or less green colour. Also, the bitter taste of the original drink can be perceptually less in the presence of paramylon which could be of preference to some consumers.

### Conclusions and Key Findings

### Paramylon Characteristics:

Paramylon (beta-1,3-glucan) granules are produced from Euglena gracilis under a variety of conditions, in these examples they were produced by heterotrophic conditions. The final paramylon product (Beta-glucan isolate) has a purity of 98%, and a true density of 2.5 g/mL. The structure of BGI had been confirmed by glycosyl linkage analysis and Fourier-transform infrared spectroscopy (FTIR). Its molecular weight had been characterized as 166 kDa. In terms of its appearance, granules are oval-shaped structures with a size of 2-3 μm. When granules are exposed to water, they swell, as was seen using SEM imaging.

### Beta-Glucan Attributes:

### Solubilization:

The solubilization behaviors of BGI (Scheme 2) in an alkaline solution has been studied. It was found that the solubilization of BGI goes through 5 stages (forms): granules, swollen, elongation, solubilized, and gelation/shelled form based on the intra/inter-hydrogen bonding strength and density. The results show that the solubilization of BGI is pH and time dependent. At a higher alkaline concentration, less time was required to solubilize the beta-glucan isolate. However, when the alkaline concentration is up to 0.75M, the BGI linkages start to hydrolyze. In terms of function, it was found that the soluble forms can affect its interaction with protein, and then affect their functionality, such as emulsion stability as seen with pea protein and BGI, as well as foaming ability.

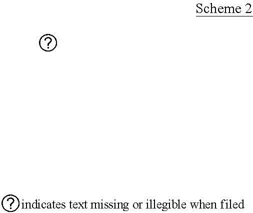

### Beta-Glucan Isolate in Water:

Observations of paramylon granules included in plant based protein powder drinks showed a change in the protein powder's water holding capacity by decreasing the plant protein WHC, as well as the sedimentation rates. When a suspension of the granules is in water, at high concentrations, such as 44% (w/v), it forms a viscous paste, and has elastic properties when a certain force/mixing frequency is applied.

### Beta-Glucan Isolate Whitening Capacity:

Beta-glucan isolate was also measured in buttercream icing and creamer applications to test its whitening ability. Results show that a 5% (w/w) inclusion of beta-glucan isolate is comparable to a 5% (w/w) inclusion of an alternative whitener, Avalanche, and comparable to a 0.1% (w/w) inclusion of titanium dioxide. Creamer results also showed a similar effect to standard creamer additions. Beta-glucan granules (isolate) showed that the granules had the similar whitening capacity to a comparable product, Avalanche as seen by whiteness index results (94.9). It also has the stability like titanium dioxide. For example, in the thermal stability experiment beta-glucan granules remained stable under N₂ as high as 280° C., in water under air it would be under 200° C. showing heat stability.

### Beta-Glucan Isolate Gelation:

Gel materials were prepared from an alkaline solution of paramylon using HCl, CaCl₂, or organic acid such as Citric acid as crosslinkers. The linkages (Scheme 3) in the gel are based on what cross linkers were used. In short, HCl provides hydrogen bonding to form the gel matrix, CaCl₂ gives ionic bonding through the calcium ion, and citric acid offers carboxyl bond. The strength, stability and reconstruction of gel materials were measured. It was found that the citric acid gel gives the best gel strength and reconstruction ability. After a citric acid formed gel is freeze dried to remove the water, and ground into a powder, it can be used as a ready to gel powder. When it is rehydrated, it forms a viscous gel back. The preparation methods have a significant effect on the reconstitution of the citric-acid gel. Freeze drying results in a higher yield and better reconstruction ability from a dry form than spray dried material, likely due to the highly viscous material having a lower atomization and evaporation of the mixture. Optionally, spray drying can be used, however freeze drying is preferred.

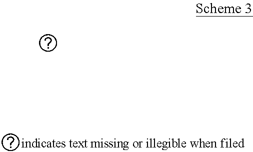

### Tested Application of Citric Acid Gel:

As an application, the citric-acid gel was shown as fruit gel or Pudding-like material, with a viscosity range of 2,900-92,700 mPa*s, dependent on the concentration of washed RTG material. In addition, the salt content of citric-acid gels can be washed down to as low as 2.4 g/100 g sample.

### Physical Modifications of Beta-Glucan Isolate:

Paramylon granules were physically modified by physically milling using a ball milller with metal balls under either wet or dry milling conditions. The grinding degree can be controlled by the grinding conditions, such as grinding media percentage, paramylon concentration, and grinding time. The milled paramylon (MP) was observed to be degraded when a harsh condition was used, but no apparent structural changes were observed when a mild milling condition was used in-house. The partial milled paramylon was elongated as fibers, and the total milled paramylon as continual textural materials.

Paramylon granule is formed by triple helix structures that have strong hydrogen-bonding, but it was elongated by a milling force (either wet or dry milled). The elongation brought strong inter-hydrogen bonding among Dal chains. Water was trapped by the strong inter-hydrogen bonding or swollen into a triple helix structure to for a gel-like material. As an application of the milled paramylon, it can be used as a creamer, yogurt, icing or soup material as it is stable. It was also found that the milled paramylon has a longer settling time and smaller final settling degree than paramylon granules. Co-milling with NaCl and Sucrose gave similar results as milled paramylon alone. It is found that the milled paramylon can form hard particles or pellets, as well as relative stiff rod-like fiber. This suggests that the milled BGI could be used as drug delivery, or regenerative medicine applications.

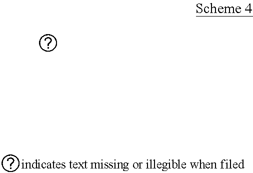

### Milled Biomass:

Biomass was also milled using the method mentioned above. The results showed that the milled biomass gave a much lighter color and its settling in water was much slower than unmilled biomass.

### Water Holding Capacity (WHC):

Water holding capacities of paramylon products, including paramylon granules, milled paramylon, and gelled paramylon were measured and it was found that the water holding capacity of paramylon materials is highly affected by type of paramylon product and soaking temperatures, but not soaking time. Gelled paramylon, such as the HCl acid-gel, CaCl₂ gel and RTG gel have the highest WHC, followed by milled paramylon. The paramylon granules have the lowest WHC of forms tested. The WHC of RTG and milled paramylon were affected by soaking temperature. Higher temperature gives higher WHC. However, the WHC of granule was not affected by temperature changes. The water saturated (WS) paramylon granules and milled paramylon are viscous cream-like materials that can be used to develop cream or paste product, while the WS RTG viscosity is more jelly-like and can be used to develop jelly or thicker based products. Furthermore, the phase stability of WS paramylon materials is also type dependent and soaking temperature dependent. Milled paramylon is the most phase stable, followed by paramylon granules and then finally RTG. The phase stability of the Water Saturated (WS) RTG was affected by the soaking temperatures. 4° C. had the greatest effect, followed by 100° C. and finally 20-50° C.

### Viscosity of Paramylon Forms:

The viscosity of the paramylon products including paramylon granules, RTG and milled paramylon under different concentrations has been detected using a NDJ-5S viscometer, and was compared to the common food thickeners and some commercial products. The results show that the viscosity of paramylon granules was much lower than milled paramylon, and RTG is most viscous. The effect of work temperature, stirring rate and stirring time on the viscosity of the products had been evaluated. The key effects are as:
1. The viscosity of paramylon granule at 40° C. is higher than at 0° C. and room temperature, while that of milled paramylon increases with the temperature.
2. The viscosity of paramylon granule increases with stirring time up to 10 min, and then be stabilized, while that of milled paramylon decreases with stirring time up to 10 min and then be stabilized

Compared to commercial food products in terms of viscosity, the stable BGI granules with a ˜30% concentration is similar to yogurt beverage, Milled paramylon with 6% (w/v) to 11% (w/v) is in the range from salad dressing, condensed tomato soup to Jello, and RTG can be up to Pudding.

This study suggests that the paramylon can emerge into some food thickener or food products, ro even replace them.

When compared to xanthan gum and cellulose gum, one fifth of the amount of gellan gum

was able to produce the same level of viscosity. Cellulose gum produced a translucent, smooth-looking mixture while xanthan gum and gellan gum produced similar thick, off-white/light grey coloured mixtures. When compared to current paramylon products, in order to generate a similar viscosity as cellulose, xanthan and gellan gum, a higher inclusion percentage of paramylon product is needed.

The rheological and textural properties of Paramylon materials including RTG, milled paramylon and paramylon granules were investigated in this study. Generally, the subjects showed shear-thinning behaviour, other than the BGI-44% at 40° C. showed shear-thickening behaviour when a shear rate below 5 l/s. However, there were some critical shear rate ranges giving fluid behaviour exchanges due to the interaction in MP and BGI, or gel point in RTG. The viscosity or fluid behaviour of BGI and MP was similar to their comparisons such as Yogurt and condensed tomato soup, respectively.

The rheological test of BGI at different concentrations (35% (w/v) and 44% (w/v)) was carried out for storage/loss modulus vs strain/frequency at 40° C. The results showed that the storage/loss modulus of BGI-44% (w/v) was much higher than that of BGI-35% (w/v)(10⁶ pa vs 1000 pa). At the test range, BGI-35% (w/v) appeared as viscous fluid. However, there was a clear crossover point for BGI-44% (w/v) when frequency at around 1(rad/s), indicating that BGI-44% (w/v) became an elastic material, suggesting that BGI can be swollen or elongated into a gel materials at a certain force and mixing frequency.

Gel properties of RTG were also measured by storage/loss modulus in a rheological test, or Young's modulus in a compression test. Gel point of RTG appeared at a strain of ˜5%, lower than a Jello which is at ˜12%. Storage/Loss modulus of RTG suggested that the elastic portion increased with an increase of concentration, as well as hardness (stiffness).

The rheological results give similar information as what we found in viscosity studies. The Paramylon materials can be compared with commercial food products, directing our product development.

Five paramylon products including Paramylon granules, Milled Paramylon and RTG were tested on DSC and TGA. The thermal behaviour and thermal stability are product related. Higher Melting points were found in Freeze dried RTG (RTGF) and freeze dried water saturated BGI (WSBGI), but larger enthalpy was found in freeze dried Milled paramylon (MPF). Sodium citric acid was found to interact with the thermal behaviour of beta-glucan.

3-17% water was found to remain in the samples. Mostly likely, the water is bound on to the glucan chain, but not free water, evidenced by DSC, suggesting that the Paramylon materials can function as anti-freezing materials. The glucan linkage was decomposition at a temperature of 280-320° C., suggesting the processing temperature of paramylon products (except RTG) is no more than 230° C. (50° C. below their decomposition temperature). Due to the existence of sodium citrate, the degradation of RTG samples was brought down to 210-220° C.

### Food Applications Summary:

Additionally, the application of paramylon products in food products has been confirmed. They have been applied as whitening agent in diary/non dairy creamer, and buttercream icing, as a thickener for gelling fruit/candy, to bring emulsion capability and water holding capacity to cookies, and cream. They also bring their functions in plant-based protein powder beverages, affecting the sediment, WHC, emulsion and suspension properties of proteins. The utilization of paramylon, with plant proteins, especially pea protein, for making 50% oil-in-water emulsions at pH7, enhanced the emulsion stability of the paramylon-pea protein mixture by approximately 15% better than the emulsion prepared without paramylon. Apart from that, the inclusion of paramylon granules at pH 7 and 2 (where most of the beverages made) with pea protein yielded suspensions that could stay stable more than 24 h without settling, a desirable functional characteristics for food product development.

### Improvement of Flavor and Mouth Feel:

With the inclusion of Beta-glucan granules to pea protein based protein beverage, the granules were able to mask the off notes in the beverage, as well as improving the mouthfeel of the beverage. The mouth feel was improved by not being as chalky and removing the grittiness.

### Hydrocolloid Comparison:

Three common hydrocolloid thickeners were testing for viscosity and compared to beta-glucan granules and milled paramylon. When compared to 0.5% gellan gum, 2.5% xanthan gum or 2.5% cellulose gum, it would take an inclusion rate of about 8.0% RTG BGI, 11.0% milled paramylon, or 13% curdlan to create a similar level of viscosity.

TABLE 114
Summary of different functional properties measured for different paramylon
(beta-glucan) forms and modified forms i.e. gels and milled paramylon

| Paramylon | | WHC-Cor. | | | | | |
|---|---|---|---|---|---|---|---|
| (Beta- | | WHC | | Emulsion | Thermal | Crystal | |
| glucan) | Whiteness | range | Viscosity | stability | stability | melting | |
| form | Index | (g/g) | (mPa · s) | (%) | (° C.) | point | Comments |
| Granule | 91-94.9% | 1.1-1.3 | ~250-3750 in | ND | 300 | 152.1 | |
| | | | concentrations | | | | |
| | | | of 27-44% | | | | |
| Swollen | — | — | — | — | — | | |
| Elongated | — | — | — | — | — | | |
| Shell | — | — | — | — | — | | |
| Solubilized | — | — | | — | — | | |
| HCl-Gel | 87.8% | 7.0 | — | limited | — | | |
| | (5% BGI | | | | | | |
| | in icing) | | | | | | |
| CaCl₂ - | Appeared | 7.4 | — | — | — | | |
| Gel | less white | | | | | | |
| | than | | | | | | |
| | granules | | | | | | |
| | after freeze | | | | | | |
| | drying | | | | | | |
| Citric Acid - | Appeared | 7.7-13.5 | *washed and | — | Freeze | Freeze | |
| Gel | less white | | reconstituted | | dried | dried | |
| | than | | 5%: 2,941 | | form: | form: | |
| | granules | | 7.5%: 58,692 | | 210 | 161.8 | |
| | after freeze | | 10%: 92,560 | | | | |
| | drying | | 12.5%: 92,595 | | | | |
| | | | 15%: 92,796 | | | | |
| Dry Milled | Appeared | — | | — | | | |
| Granules | whiter by | | | | | | |
| | vision | | | | | | |
| Wet | Appeared | 4.4-6.4 | 500-60000 at | — | Freeze | Freeze | |
| Milled | less white | | the | | dried | dried | |
| Granules | than | | concentrations | | form: | form: | |
| | granules | | 3-15% | | 280 | 115 | |
| | after freeze | | | | | | |
| | drying | | | | | | |
| Dry & Wet | Appeared | — | | — | | | |
| milled | less white | | | | | | |
| granules | than | | | | | | |
| | granules | | | | | | |
| | after freeze | | | | | | |
| | drying | | | | | | |
| Milled | Appeared | — | | | | | Showed |
| Euglena | less white | | | | | | better |
| biomass | than | | | | | | foaming, but |
| | granules, | | | | | | not measured |
| | lighter in | | | | | | |
| | colour than | | | | | | |
| | biomass | | | | | | |
| | after freeze | | | | | | |
| | drying | | | | | | |
| Pea protein | — | — | — | PP-BGI | | | PPI-BGI |
| (PP)& | | | | blend | | | blends |
| BGI | | | | (4:1): | | | showed |
| blends | | | | 95% | | | enhanced |
| | | | | stable | | | suspension |
| | | | | after 4 h | | | stability |
| | | | | compared | | | (~24 h) at |
| | | | | to 82% | | | pHs 2 and 7 |
| | | | | for PP | | | with no or |
| | | | | alone | | | very minimal |
| | | | | | | | settling - |
| | | | | | | | PPI-BGI |
| | | | | | | | blends |
| | | | | | | | showed a |
| | | | | | | | foam |
| | | | | | | | expansion in |
| | | | | | | | the range |
| | | | | | | | 180-200% |

### Additional Application in Food Products

Incorporation of BGI with Other Food Hydrocolloids for their Functionality Enhancement and for Ingredient Development

Planned to blend paramylon with other food hydrocolloids such as pectin, gum arabic, alginate, xanthan gum etc., to establish the right blend ratio with optimal functionalities that are ideal to be used for the ingredient development of food product development with different protein, including Euglena protein. Consequently, we are planned to tune the pH, temperature and total biopolymer characteristics by controlled blending of BGI with other hydrocolloids for the betterment of BGI functionality. We will be investigating the different blending ratios of paramylon with the different food hydrocolloids and their rheological, mechanical and thermal parameters will be accessed and compared with commercial ingredients. This will give us insights and a mechanistic approach on how to control these hydrocolloids to control the product stability and their sensory attributes. The study extends its objective to see the interaction of optimally blended paramylon hydrocolloids with different proteins, which will be influenced by the biopolymer characteristics (size, distribution/type of reactive sites and confirmation) and the solvent conditions (pH, temperature, heat treatment and ionic strength). Apart from the rest of the physicochemical properties, the functionality measurement [foaming, emulsification, film forming, encapsulation, gelling, WHC and OHC] will be done and compared with homogenous biopolymers and biopolymer blends, and with commercial products to see the effect of surface blending. Findings from this work will lead to improved stabilization BGI or their admixture in aqueous food systems (e.g. BGI enriched beverages) and emulsified products (salad dressings and beverages), as gelling and thickening agents—as food industry looks for alternatives for animal derived proteins and Soy. Outcome from this project may lead to the enhanced utilization of BGI for food and non-food applications. Also, the interaction results give more insight in the utilization of the Euglena protein (which has the isoelectric point in the similar pHs as pea protein) by interaction with BGI and other hydrocolloids for food and non-food applications.

### Example 58: Impact of Homogenization Pressure and Pass Number on Total Soluble Protein

Purpose:

The purpose of this experiment was to investigate lower pressure homogenization combined with multiple passes to determine if a lower pressure operating homogenizer may be sufficient to effectively lyse cells and increase soluble protein yield.

Summary:

This experiment demonstrated clearly that the traditional operating pressure in homogenization of 12,000 psi is unnecessary in regards to maximal protein release.

It was found that simply adjusting the biomass to pH 10 released nearly as much protein as any homogenization condition tested at pH 7.

The suspected optimal homogenization condition in this experiment was a single pass 2000 psi, at pH 10.

pH 10 homogenization yielded a higher bias to protein content in the solubilized fraction than did pH 7, at 67% and 53%, respectively.

Higher operating pressures with multiple passes caused visible microscopic aggregation of paramylon granules/cell debris, especially at pH 10.

Next Steps:

Repeat at 10% solids to determine if soluble protein release actually doubles or is limited by coagulation at higher concentrations.

Carry out a complete downstream process using the new optimal homogenization conditions (pH 10, 2000 psi, 1 pass) and determine mass balance and composition of the protein concentrate prepared in this way.

Investigate maximal protein release in absence of any homogenization (˜½ of maximal soluble protein was already released by adjusting biomass to pH 10 with no mechanical treatment). Determine if extended stirs or alternative technology (eg. high-shear mixer) enough to perform a viable protein concentrate process.

Determine if additional temperature control necessary during homogenization operation to maintain protein solubility/functionality.

Both pH conditions yielded similar solubilization of all proteins based on SDS-PAGE, with no dramatic biases to particular proteins.

Methods:

For this experiment, 10 kg of biomass at 4.22% solids was prepared by diluting harvest #421_2020-01-28_TK4300-2 (19.3% solids, pH 2.93) with water and blending to mix. The pH of the diluted biomass was adjusted to 7 using 100 g/L NaOH and three 1 L sample jars were collected. The remainder of the diluted biomass was then adjusted to pH 10 and three 1 L samples were taken. For each pH (7 and 10), the homogenization pressures investigated were 2000, 4000, and 12000 psi. At each pressure, 50 mL samples were collected after 1 pass through the homogenizer, as well as after 2 passes, and 3 passes (see FIG. 1). The 50 mL samples were centrifuged (5000 rpm for 10 minutes) and the supernatants were decanted into separate 50 mL tubes. The pellet and supernatant for each sample were freeze dried to determine the soluble mass fraction at each condition. Total soluble protein in the supernatants was determined by Bradford Assay and the proteins were visualized by SDS-PAGE. Microscope photos were taken for each sample to assess cell lysis and clumping in the homogenate.

Bradford Assay: Total soluble protein was determined using the Pierce Detergent Compatible Bradford Assay Kit. All samples were diluted 1/10 in 0.9% saline prior to analysis except the pH3 biomass which was analyzed undiluted.

SDS-PAGE: All samples were diluted 1/10 in 0.9% saline prior to running SDS-PAGE. A 10-20% Tris-Glycine gel was used. 5% 2-Mercaptoethanol was added to the 2× sample buffer. 15 uL sample was mixed with 15 uL of sample buffer and the mixture was heated in the water bath (set at 80° C.) for 5 minutes. 15 uL of each sample mixture and 10 uL of the Spectra™ Multicolor Broad Range Protein Ladder were loaded on the gels. The gels ran at 225V for 35 minutes. The gels were stained with Coomassie Blue for 1 hour and then destained (20% methanol, 10% acetic acid). Gel images were taken with a phone camera.

Results: The biomass used in this experiment clearly demonstrated sensitivity to pH adjustment, as can be seen by the clearly lowered visible cell density moving from pH ˜3 (unadjusted) to pH 7 and 10. Especially at pH 10 a majority of cells were already completely disintegrated or clearly beginning to disintegrate, as indicated by a transparent and faint appearance, relative to the dark cells observed in unadjusted biomass. Interestingly, even at pH 7 there appears to be a reduced density and increased transparency of the cells, indicating that the cells were lysing in this experiment to some degree even at the mild pH of 7. However, previous work has yielded inconsistent results in this regard and it must be further elucidated why biomass is sometimes dramatically sensitive to pH adjustment. This may be tied to harvesting conditions, the heat treatment step and the cold-storage method. Furthermore, future work should control time at each pH more rigorously, and perhaps use a hemocytometer to directly quantify lysis over time at these conditions.

As can be seen in FIG. 3, at pH 10, a single pass at the low pressure was enough to lyse essentially all the cells, leaving only paramylon granules behind visible by light microscopy. Additional passes did not have a significant impact on bulk appearance, at this low pressure.

However, at more elevated pressures, as seen in FIG. 4, the increased number of passes caused the average particle size observed in the homogenate to actually increase. This result may be the result of the high forces at such elevated pressures causing deformation of beta-glucan granules and their collision with other damaged granules to cause them to form larger aggregates.

1-93. (canceled)

94. A paramylon composition comprising;
paramylon having a purity of at least about 70%,
wherein the paramylon is derived from Euglena sp, and
wherein the paramylon is of a form selected from the group consisting of granule, swollen, elongated, shell, solubilized, gelled, milled, and combination thereof.

95. The paramylon composition of claim 94, wherein the paramylon is substantially free of at least one of a form selected from the group consisting of granule, swollen, elongated, shell, and solubilized.

96. The paramylon composition of claim 94, wherein the paramylon is in a wet form.

97. The paramylon composition of claim 94, wherein the paramylon is in dry form.

98. The paramylon composition of claim 94;
wherein the paramylon composition is a food additive for use in a food product, and
wherein the food product contains an amount of about 0.1% to about 50% w/w of the paramylon.

99. The paramylon composition of claim 98, wherein the food product is selected from a dairy product, a dairy substitute product, a bakery product, a confectionery product, a sauce, a drink product, a drink mix product, a meat product, a protein substitute product, a spreadable food stuff product, a jam, a jelly, a nut butter, a chocolate with a hard coating, a chocolate without a hard coating, a marshmallow, an icing, a fondant, a jelly bean, a hard candy, a gummy candy including a soft gummy candy, a chocolate syrup, a flavoured syrup, a fruit snack, a fruit gel bar, a gelatin substitute product, an aspic, a creamer, a yogurt, an ice cream, a whipped cream, a pudding, a powdered milk base product, a cheese, a cream cheese, a sour cream, non-dairy milk base product, a low fat dairy product, a non-dairy creamer, a non-dairy yogurt, a non-dairy cream cheese, a non-dairy sour cream, a low fat non-dairy product, a protein shake, a meal replacement shake, a soup, a dumpling, a pasta, a toasted pastry product, a donut, a muffin, a cookie, a protein bar, a granola bar, a cake product, a meat casing, a sausages such as a pork, a beef, a chicken, or a turkey sausage, a patty such as a beef, a chicken, a pork, or a turkey sausage, a ground meat such as a beef, a chicken, a pork, or a turkey sausage, a protein substitute product such as a chicken meat substitute, a beef substitute, a pork substitute, a turkey meat substitute, an egg substitute, an egg protein substitute, a soy protein substitute, or a pea protein substitute, a salad dressing, a mayonnaise, a ketchup, a mustard, a tomato pasta sauce, a tomato sauce, a vinaigrette, a marinade, a BBQ sauce, or a gravy.

100. The paramylon composition of claim 98, wherein the paramylon is used as a gelling agent, a thickening agent, an emulsifying agent, a whitening agent, a water-binding agent, or sweetening agent in the food product.

101. The paramylon composition of claim 98, wherein the paramylon is provided as a dried powder, a ready to gel powder, a wet gel, or as a solution.

102. The paramylon composition of claim 98, wherein the paramylon is for used to increase the viscosity of the food product, and
wherein the paramylon increases the viscosity of the food product by about 1 mPa·s to about 100,000 mPa·s at 25° C.

103. The paramylon composition of claim 98,
wherein the paramylon increases the tensile strength of a food product by about 0 g/cm² to about 3000 g/cm² after maintaining a temperature of about 0° C. to about 100° C. for about 2 minutes to about 2 hours, at a pH of about 2 to about 10.

104. The paramylon composition of claim 98, wherein the paramylon composition further comprises calcium chloride at about 0.05% to about 1.5% w/v.

105. The paramylon composition of claim 98, wherein the paramylon is a whitening agent,
wherein the paramylon has a refractive index of between about 1.3 and about 2.6 at λ=about 589 nm; and
wherein the paramylon increases the refractive index of the food product by between about 0.1 and about 1 at λ=about 589 nm.

106. The paramylon composition of claim 96, wherein the paramylon is spray dried, using a method of spray drying selected from the group consisting of spray drying, drum drying, falling film evaporation, oven drying, vacuum drying, freeze drying, and solar drying.

107. The paramylon composition of claim 98, wherein the paramylon is used for water binding the food product; and
wherein the paramylon has a water holding capacity of about 0.70 g to about 1.50 g water per gram paramylon.

108. The paramylon composition of claim 96, wherein the paramylon is treated with a beta-glucanase at from about 37° C. to about 42° C. for about 16 hours to 24 hours to produce hydrolyzed paramylon,
wherein the hydrolyzed paramylon is used to sweeten a food product,
wherein the hydrolyzed paramylon has a sweetness of about 0.1 to about 0.7 relative to sucrose,
wherein sucrose is assigned a sweetness value of 1.0.

109. The paramylon composition of claim 98, wherein the paramylon has a taste masking effect on the food product.

110. The paramylon composition of claim 94, wherein the Euglena sp. is selected from the group consisting of Euglena gracilis, Euglena sanguinea, Euglena deses, Euglena mutabilis, Euglena acus, Euglena virdis, Euglena anabaena, Euglena geniculata, Euglena oxyuris, Euglena proxima, Euglena tripteris, Euglena chlamydophora, Euglena splendens, Euglena texta, Euglena intermedia, Euglena polymorpha, Euglena ehrenbergii, Euglena adhaerens, Euglena clara, Euglena elongata, Euglena elastica, Euglena oblonga, Euglena pisciformis, Euglena cantabrica, Euglena granulata, Euglena obtusa, Euglena limnophila, Euglena hemichromata, Euglena variabihs, Euglena caudata, Euglena minima, Euglena communis, Euglena magnifica, Euglena terricola, Euglena velata, Euglena repulsans, Euglena clavata, Euglena lata, Euglena tuberculata, Euglena contabrica, Euglena ascusformis, Euglena ostendensis, and combinations thereof.

111. A method for producing a Euglena sp derived paramylon composition comprising;
i) suspending about 5% to about 15% w/w Euglena sp biomass in an aqueous solution,
ii) homogenizing the aqueous solution containing Euglena sp biomass,
iii) centrifuging the homogenate,
iv) collecting the pellet containing the paramylon,
v) washing the paramylon pellet with aqueous solution by resuspending the paramylon pellet, and
vi) repeating steps iii) to v) at least five times, wherein the paramylon pellet is the Euglena sp derived paramylon composition.

112. The method of claim 111, wherein the homogenization method of ii) is high pressure homogenization.

113. The method of claim 111, wherein step vi) further comprises adjusting the pH to about 9 to about 11.
